(19) United States
(12) Patent Application Publication
(10) Pub. No.: US 2017/0213127 A1
(43) Pub. Date: Jul. 27, 2017

(54) Method and System for Discovering Ancestors using Genomic and Genealogic Data

(71) Applicant: Matthew Charles Duncan, Plano, TX (US)

(72) Inventor: Matthew Charles Duncan, Plano, TX (US)

(73) Assignee: Matthew Charles Duncan, Plano, TX (US)

(21) Appl. No.: 15/413,479

(22) Filed: Jan. 24, 2017

Related U.S. Application Data
(60) Provisional application No. 62/286,427, filed on Jan. 24, 2016.

(51) Int. Cl. G06N 3/04; G06N 5/04; G06N 3/00; G06N 3/08

(52) U.S. Cl. CPC G06N 3/0445; G06N 3/082; G06N 5/04; G06N 3/006; G06F 19/26

(57) ABSTRACT

Described invention and its embodiments, in part, facilitate discovery of ‘Most Recent Common Ancestors’ in the family trees between a massive plurality of individuals who have been predicted to be related according to amount of deoxyribonucleic acids (DNA) shared as determined from a plurality of 3rd party genome sequencing and matching systems. This facilitation is enabled through a holistic set of distributed software Agents running, in part, a plurality of cooperating Machine Learning systems, such as smart evolutionary algorithms, custom classification algorithms, cluster analysis and geo-temporal proximity analysis, which in part, enable and rely on a system of Knowledge Management applied to manually input and data-mined evidences and hierarchical clusters, quality metrics, fuzzy logic constraints and Bayesian network inspired inference sharing spanning across and between all data available on personal family trees or system created virtual trees, and employing all available data regarding the genome-matching results of Users associated to those trees, and all available historical data influencing the subjects in the trees, which are represented in a form of Competitive Learning network. Derivative results of this system include, in part, automated clustering and association of phenotypes to genotypes, automated recreation of ancestor partial genomes from accumulated DNA from triangulations and the traits correlated to that DNA, and a system of cognitive computing based on distributed neural networks with mobile Agents mediating activation according to connection weights.

### FIELD OF THE INVENTION

Computer software and systems for Genomics assisted Genealogy

This disclosure relates generally to computer software and the systems and methods encoded therein, to address problems in Genomics assisted Genealogy. Central to this is a unique holistic application of computer automated Data Mining, Knowledge Management, Machine Learning techniques and Distributed Intelligent Agents towards the discovery of common ancestors between a plurality of individuals who have various degrees of matching DNA, and various degrees of completed and correct genealogical family trees.

### BACKGROUND OF THE INVENTION

Preface and Outline

The following verbose background sections, composed and revised over the span of several years, are intended to present the problems motivating this invention, and introduce the philosophy of the computer automated solutions, to a reader sufficiently familiar with the ideas and processes of genealogy, and one who is generally familiar with computer software used for genealogical research. This structure and strategy is deemed necessary due to the complexity of the field of genealogy, and the overlaps with the complex and nascent field of genomic analysis, and the emerging fields of computer data mining and artificial intelligence strategies. The ‘Related and Prior Art’ sections present some known services which provide tools to help researchers solve similar problems. This background presentation, including the section on ‘related and prior art’, are conceptual in intent, and are based on observations at the time of writing, and are not factually verified by any authority. The reader is asked to not make any opinion on the Vendor tools discussed, and to only consider the potential solutions of this invention with respect to its stated objectives and features. One objective of the discussion is to explain the benefit of the invented system being external to any particular DNA-Genealogy vendor, in order for it to take advantage of all data sources, and to be independent of the limitations each vendor or service has placed upon themselves. The system described herein assumes the availability of resources provided by various 3^{rd} party genealogy services vendors to their customers, including DNA data and genealogic GEDCOM files.

Finally, in preface, the discussion is intended to be read outside of the viewpoint of the traditional genealogist who is accustomed to seeing an ancestor as primarily a collection of documents and evidence, and a family tree as a set of relations between such ancestor profiles. In the invention description presented herein, it is important to primarily visualize the problem in terms of abstract graphs (in the computer science graph-theory paradigm), including the concept of ‘network flow graphs’ of DNA segments propagating through connections and recombination vertices, and ‘evidence networks’ designed to facilitate implicit Bayesian-like inference propagation and allow for logical operations on those networks, and the reader should recognize manifestations of various other forms of networks such as artificial neural networks taking inputs from these graphs and networks, and creating outputs potentially affecting the same. And finally, the results of application of the invention will be, in part, an optimization of a very large, distributed constraint-satisfaction assignment problem which, in any particular state, may be wrong or sub-optimal with respect to some assignments, but will incrementally improve the best assignment given the evidences provided. That is, the assignment problem is an optimization problem, wherein the objective function is multi-part, hierarchical, and operating on real-time dynamically changing data. The Users (Customers, Researchers) will be expected to discern which assignments and suggestions are good enough, and which others would benefit from further evidences accumulation. Thus, in the end, the whole of the invention may be classified as a ‘decision support system’.

Perspectives on Genealogic Social Media Services and Massive Data

Discovering one's ancestors and building a Family Tree has, in recent years, become an endeavor accessible to anyone with a computer, internet connection, and sometimes nominal fees for searching the various databases provided by Genealogic Research and Ancestry companies. There are many computer programs available for assisting researchers in building their family trees, for collecting records associated to ancestors in those threes, and various means for researchers to collaborate in their research. Since about 2008, several Vendors have been offering genetic sequencing services to further facilitate relative and ethnicity discovery [1]. Popular companies providing these Genetics assisted Genealogic Social Media services include Ancestry.com™, 23 andMe™, and FamilyTreeDNA™ to name a few key vendors [2]. These companies have digitized billions of historical records pertinent to genealogy, along with millions of User's ‘family knowledge’ inputs, commonly known as ‘Family Data Collection’ records. Ancestry.com™ alone, according to their 2013 financial report [3], had over 55 million family trees containing 5 billion profiles (Ancestors) and over 12 billion records including census data; ship passenger lists; military documents; birth, marriage and death certificates; immigration documents; casualty lists and newspaper clippings. Likewise, several of these companies have each accumulated over 1 million member's DNA kits [2], resulting in about 1000-6000 DNA matches per member to other members of the same Vendor, depending on their heritage's overlap with the sampled population of the Vendor. This is a phenomenal depth of data, with huge potential for assisting people in genealogic discovery and understanding of their history and each-other. It is also important to recognize, that each of the vendors are essentially accumulating the data provided by other entities (DNA and records warehouses), indexing them into massive databases, and then applying various data-mining algorithms, or providing search engine front-ends, to assist Users in research. This invention is in the same field as these Vendors, and likewise collects data, but applies different algorithms, systems and methods to attain results that have eluded the Vendors and Users.

Problems and Paper Outline

It has been reported by AncestryDNA™, that even with billions of historical records, billions of ancestral profiles, and billions of DNA test matches between members, the typical genealogic User is getting no further than about the 4^{th} great-grandparents, and apparently 52 % of the members have a sharp drop-off in rate of pedigree development after the 2^{nd} great-grandparents [Ancestry.com reference no longer available]. The background description here will present some problems suspected of contributing to these low success rates, and connect the concepts of how the problems may be formulated, and how the data may be ‘feature engineered’, for computer automated analysis. These problems are first categorized below by
1. A need for digitized knowledge management of the confidence of veracity and completeness of evidences suggesting ancestors and their relations according to associated records,
2. A need for a systematic means of elucidating most probable, and ignoring unlikely, candidates for most recent common ancestors (MRCA's) in the pedigrees between any pair of DNA matched users, given the often massive, intractable numbers of DNA matches presented to Users,
3. A need for a structured computing platform for sharing information between the Users' results from various vendors, and for combining results into a common family tree system, and benefiting from the added assimilated information,
4. A need for a distributed computing system and advanced algorithms to operate on the shared data of the points above, in a manner that avoids the NP-complete complexity of analyzing all data simultaneously.

After the four basic problem areas are described, various aspects of the associated problems are presented with examples, and the concepts of the solutions in the invention are then presented. The need for a ‘holistic’ solution to integrate the various results, cannot be appreciated without this background. The term ‘automatically’, implies use of the computerized automation of the tasks described. The term ‘holistic’ implies use of, and integration of, all constraints, associations, fuzzy logic, clusters and algorithms by the methods and systems described in the invention. These problem/solution areas include the following list.
1. ease of error creation by casual researchers, and lack of computer automated visibility into confidences intended by those researchers (aka ‘Users’) when viewing their personal family trees,
2. lack of ability for Users to automatically vote on validity or relevance of records associated to an Ancestor, in order to assign it a confidence metric, and lack of ability to automate this process of grading data
3. The ease of copy of unintended and intentional (speculative) errors, between User's trees. Equivalently: lack of ability to automatically tag an ancestor profile or sub-tree as ‘speculative’, or ‘placeholder’, or ‘missing-link’,
4. lack of ability of Users to automatically map their shared genome data according to known ‘most recent common ancestors’ (MRCA's), and inversely, from all MRCA's to a chromosome/surname map, which is commonly called ‘chromosome mapping’. This should be enabled without the User's needing to expose their actual DNA information. It should enable resolution set to various generations back.
5. lack of automated ability to easily find, link to, and cooperatively analyze in-common-with ancestors (ICW) across DNA matched Users' trees, with benefit of the holistic system described.
6. lack of automated ability to discover mating eligible and likely ancestors residing in the family trees of DNA matched Users, based on proximity of co-location during the same time period, and use that data in automated MRCA analysis,
7. lack of automated ability to use various data points shared across DNA matched User's trees to focus MRCA search efforts, including documents shared between Ancestors of different pedigrees, in a manner similar to K-means classification,
8. lack of automated ability to ‘data-mine and cluster’ in-common-with (ICW) matching members between two matching members, such as a 3^{rd} member who matches both of a pair of matching members. This is beyond the facilities provided by several vendors, which only provide the User a list or table of such ICW matches.
9. lack of ability to apply constraint satisfaction algorithms to the mapping problem of thousands of DNA cousins per user in combined sets of over a million each of DNA participants, using as constraints (for example) the aforementioned holistic factors of confidence, DNA mappings or isolations, various data points, in order to highlight the most likely branches for the MRCA between any pair of DNA matched Users.
10. lack of ability to automatically create speculative trees or connecting ancestors, and re-evaluate local DNA matching completeness, with the holistic support of constraints, fuzzy logic and various clustering systems,
11. lack of ability to automatically propagate confidences of discovered MRCA's to descendants across all involved trees (i.e., DNA matched Users' trees), or into a common tree such as a Virtual World Tree.
12. lack of ability to automatically share high quality ancestors from one DNA Users' triangulation-confirmed pedigree to those of DNA cousins who share some or all of that pedigree, through a shared world tree,
13. lack of ability to automatically incrementally recreate virtual Ancestors' genomes from User's who have that Ancestor as an MRCA, and to automatically re-use those virtual Ancestor's partial genomes in the general matching system as a regular User, but with only partial DNA.

First Problem Detailed: Erroneous Data and Unknown Confidences Impeding Sharing

1. A need for digitized knowledge management of the confidence of veracity and completeness of evidences suggesting ancestors and their relations according to associated records:

Social media based genealogy trees are notoriously rife with errors due to the varying levels of experience, interest and discipline of casual, time limited Users (subscribers), and the ease of replication of other Users' family trees and consequently, others' errors. On some Genealogy sites, such as Ancestry.com™ and myHeritage.com™, Users are provided tools to search billions of records pertinent to genealogy, and may be presented with hints on thousands of records which might be relevant to any given ancestor. The Users may, with evaluation rigor spanning from a whim to strict consideration, attach or assign these records to various Ancestor's profiles in their family trees, with just a couple clicks of a mouse button. Thus, a User can collect many records for a presumed Ancestor in a very short time. After accumulating varying numbers of records for a particular ancestor, the User may have a subjective or calculated general feeling of confidence or doubt in the veracity of the ancestors' accumulated data and relationships. If they are ‘reasonably’ confident, the User will typically move on to research another ancestor, which often is the parents or children of the ‘satisfactory’ ancestor. Unfortunately, the User will likely forget the level of veracity given to the data associated with the prior Ancestor study, and the overall confidence of the derived data and relationships. This confidence, or knowledge, is not readily quantized nor stored or visible in known systems—unless the user manually calculates and writes it into notes or images on the profile of the Ancestor in question. Other Users who see each other's Ancestor profiles, may see what records are attached, and may make their own private opinion about the confidence of components of evidence, or the conclusions in terms of vitals and relationships. But, they too, are not able to input their ‘votes’ in any manner other than notes on a profile. Even then, the captured knowledge (notes) are not amenable to computer automated processing. Thus ‘Knowledge Management’, and ability for Users to share knowledge via voting, is considered a key step towards automating much of the ancestry discovery and validation process. Working with these various forms of statistical data to form aggregate indicators, is commonly called Feature Engineering in the data mining terminology.

Second Problem Detailed: Massive DNA Match Data Intractable to Human Processing

2. A need for a systematic means of elucidating most probable, and ignoring unlikely, candidates for most recent common ancestors in the pedigrees between any pair of DNA matches users, given the often massive, intractable numbers of DNA matches presented to users:

In recent years Users (members or subscribers) of several Genealogy services have been afforded the revolutionary benefit of DNA testing, with thousands of relatives discovered for them. These relatives (mostly distant cousins), are usually presented to the User in the form of a list of User-id's of other Users to whom the first User purportedly matches, a relationship confidence (e.g. ‘extremely high’, ‘very high’, high, medium, low) and a range estimate on the familial relationship distance, or equivalently, degrees of separation (ie, 4^{th}-6^{th} cousin), an email address or other means to contact each other, and in some cases, a link to the relatives' pedigree family tree—if one exists. Given an estimated DNA match to another participant, the User may be confident (to the suggested extent) that somewhere in their family tree pedigree, in the range according to the given relationship (genetic) distance, there exists a putative ‘Most Recent Common Ancestor’ (MRCA) who shared the DNA segment(s) with both the User and the reported DNA matched relative. If the relationship is very close, and well known, or if the two Users have both correctly completed their pedigrees out to the MRCA such that the MRCA exists in both, then this DNA match serves to greatly enhance the confidence in the relationship evidenced in the respective trees. With potentially thousands of DNA cousins, the cases of matched cousins having an already discovered MRCA for any DNA match are quite rare. The User is thus faced with the daunting task of systematically searching through the pedigree trees of ‘DNA cousins’ for any Ancestors who might be related to any of the Ancestors in the User's own pedigree. However, comparing just the Ancestors at exactly the 8^{th} cousin distance between two pedigrees may result in (2^{̂9} )²/2=131072 mental comparisons. Logically, what the User will do is focus efforts on most likely branches of the pedigree first—starting with branches which share the same Surnames, or where the Ancestors lived in locations common to the both DNA matched Users. Current Vendors do provide tools to help Users manually search DNA matched cousin's pedigrees based on Surname and/or location filters of the data. But there are no known automated means to discover the MRCA between DNA matched participants which employ knowledge of confidences saved and shared by other members, and which employ data mining across multiple DNA matched members and their respective confidences and constraints augmented onto virtual pedigrees. In other words, there is a vast gold-mine of data available to facilitate the User's search for, and discovery of MRCA's to each DNA cousin, and there exists a great potential for sharing this information across member's trees to enable a global search and discovery system. As a preview to one of the methods employed, consider that the mapping of thousands of DNA matches to a much smaller set of MRCA nodes, creates a multi-dimensional SUDUKO-like multi-constraint assignment problem. If the User has visibility only on their personal pedigree, and that of each match, they can only painfully track-down a few MRCA's through pains-taking surname and location checks. Now also consider that millions of DNA match participants have the same assignment problem, and that an automated intelligent data-mining system can tease out the correlation data between putative MRCA related pedigrees, and simultaneously excite or inhibit potential branch combinations between trees. To this effect, a unique form of Competitive Learning Network will be described, which continuously structures all available data into a weighted network in order to propagate confidences, inferences and constraints, and then incrementally applies several algorithms which employ forms of combinatorial optimization in tandem with constraint satisfaction, in order to rank the potential common ancestors or branches between all DNA matched cousins, in terms of their potential to be, or harbor, the MRCA.

Third Problem Detailed: Platform and Data Structures for Data Sharing:

3. A need for a structured computing platform for sharing information between the Users' results from various vendors, and for combining results into a common family tree system, and benefiting from the added assimilated information,

Given the dynamic, messy and unstructured form of the various data sources, their distributed locations, and the similarity of billions of data sets (trees, DNA data, ancestor profiles, attributes), the method of inference propagation via constantly evolving connection weightings of a vast network, is highly amenable to distributed computing. Due to privacy laws, policies and normal competition, genealogy oriented DNA testing Vendors do not share DNA match data between themselves, although, they have been noted to cooperate on standards. Since several of the major vendors have over a million DNA tested subscribers each, if a User only tests with one of them, they are potentially missing out on critical DNA matches in the others, whose data might fill missing links. Thus, some Users get DNA tested at multiple Vendor's. But, of course, the DNA matches report that the User receives from each Vendor is only in relation to the subjects of that particular Vendor's cohort (data set), and is limited to the tools provided by the Vendor. For the described invention herein to work optimally and employ the data distributed across the genomes and pedigrees of Users scattered across various Vendor's systems, the DNA matches of Users from any Vendor, along with their family trees, should be accessible or input into the described system. Initially this can be done with simple GEDCOM (family tree) uploads along with sequenced DNA genome data. But in general, a lightweight infrastructure is needed, and will be described, which supports the aforementioned Knowledge Management, MRCA hinting system, a Virtual Family Tree (VFT) for each User, a shared Virtual World Tree (VWT), and the representation of weighted connections used for competitive learning network analysis. The data structure system needs to support and interface to traditional linear processing computers, and also to coordinated distributed processing systems, including massive numbers of independent Intelligent Agents. An ‘Intelligent Agent’ is a lightweight, modular program that performs a set of tasks. One key item to be noted, is that the DNA segment match information between users should be encrypted, processed discretely by the system described herein, and no User need expose any of their DNA information to other Users, unless they explicitly approve it.

Fourth Problem Detailed: Data Analysis Systems and Distributed Coordination

4. A need for a distributed computing system and advanced algorithms to operate on the shared data of the points above:

As family trees in social genealogy sites are constantly updated by Users, and new DNA matches are likewise constantly streaming into existence, the data involved in the discussed invention is intractable to a standard non-distributed compute system. Thus a distributed, coordinated processing system is needed, that reacts to User's inputs, as well as new information provided by other sub-systems (usually, various Agents performing data-mining and analysis tasks). The various data mining algorithms and systems need to be coordinated (when to run, on what), where to save the data. The systems (again, usually Agents) for example, need to create nodes and connections where warranted, need to analyze nodes to create confidences, need to evaluate fuzzy logic and in general, need to handle multiple constraints to reduce the set of branches for MRCA searches. As a corollary, certain Agents collect data to build the network, similar to bees building a honeycomb. Other Agents tend to the monitoring of the network, similar to spiders listening for prey. This will benefit from a custom implementation of a ‘Multi Agent System’ (MAS), including an Agent Management System (AMS), Agent Communication Language (ACL), message passing system (MPS), and an ontology for the representation of genealogic data and relations. The system must be generalized to support extensions of data captured, and thus to support application of a multiplicity of algorithms.

Evaluation of the Problem Statements in the context of existing art

The following sections explain the four problem areas in more detail, providing guidance towards the invention's solutions. The discussions are relevant to understanding why each of the inventions sub-systems is necessary, and how they work together to provide computable data to automate the process of MRCA discovery.

Observations on Historical Trends and Relevance to Data Mining Strategies

Extensive experimentation has suggested that various strategies and algorithms will benefit different eras of genealogic analysis. It is relevant to note, that 4 billion profiles averaged across 34 million trees, equates to 117 profiles (Ancestors) per tree, on average. That is under 126, which suggests the average User gives up or hits a genealogic ‘brick wall’ while working on about their 4^{th} Great-Grandparents (GGP). Note the number of ancestors to 4^{th} GGP is: 2+4+8+16+32+64=126. This era or ‘zone’ around the 4^{th} GGPs is particularly interesting, in that ancestors before this are either well known or fall into the era of detailed census data and other records proliferation or more modern times. While, in the Colonial North America, as one recedes back into the 1700's to the first landings in 1620's, the (European) population narrows to a very small set, and there happens to be considerable documentation on immigration, land deeds, marriages and military records. Moreover, proceeded back in number of generations, the number of descendants of those generations grows exponentially. Therefore, it appears there is a ‘dark zone’ in the 1800's where colonists scattered westward into the wilderness, after being fairly well documented in immigration stages. This structure or pattern in the data, is pertinent to a bottoms-up and top-down analysis of genealogic data that lies within the scope of DNA match assistance. That is, in the bottoms-up case, the base generations, through genomic analysis (aka chromosome mapping) and recent documentation trends, can be used to significantly reduce the set of branches that must be studied for any particular MRCA case. While, in the tops-down view for Users with deep Colonial North American histories, the explosion in number of DNA matches provides an opportunity to apply analytic means, along with machine learning inspired distributed constraint satisfaction, to further narrow down the likely branches that each MRCA might lie on. This is further facilitated by the reduction in number of surnames existing in that era, and various techniques to focus on statistically rare events (i.e. wars) or states common between DNA matches (ie, ethnicity, nationality).

Rate of Pedigree Completion and Opportunities for Evidence Chaining

According to a White Paper on AncestryDNA Family Circles [4], the pedigree-depth completeness proportion of AncestryDNA™ member's trees is, roughly [self: 100%][parents: ˜95%][GP: ˜84%][GGP: ˜70%][2^{nd} GGP: ˜52%][3^{rd} GGP: ˜30%][4^{th} GGP: ˜18%][5^{th} GGP ˜8%][6^{th} GGP: ˜6%][7-10^{th} GGP: ˜3%]. That data suggests that, even with DNA evidence, User's pedigrees typically, per branch, only reach to the 2^{nd} GGP (52%) before declining rapidly. Unless the User is an orphan or ‘distanced’ from the family, this lack of depth even to the 2^{nd} and 3^{rd} GGP is surprising. This implies, as will be discussed, that the flood of DNA correlation data lies mostly untapped and intractable to the User. What is also particularly interesting in this data, is that there are, for example, in the 4^{th} GGP to 6^{th} GGP range, a rate of 18% scaling down to 6% of pedigree branches completed (to some unknown accuracy, since confidence and accuracy data are not available). Thus, if there happen to be on average more than 5 DNA participants (of any and all Vendors) who share an 4^{th} GGP, then there is a reasonable chance that one of them has a pedigree branch completed out to the actual MRCA (assuming that 18% of the 5 or more have completed a pedigree to the 4^{th} GGP). If such a pedigree to the MRCA of a ‘first User’ exists and is sufficiently qualified by any means (documentation, DNA, logic, triangulation), and if a DNA-match and documentation path can be found in the pedigree of the 2nd User which potentially intersects (has sufficient hints of similarity), in any manner, the good pedigree of the first User, then the 2nd User can potentially isolate the MRCA in the 1st User's known pedigree as the connection between themselves and the first User. The 2nd User might then manually add annotation to their tree, or take other notes, to record the possibility of such an intersection stemming from the particular branch of his/her pedigree, and thus reduce the search space for the MRCA between the 1st and 2nd User. Reducing the search space in a tree search is generally referred to as ‘pruning’. In the case that the index (first) User has mapped a segment of DNA to the MRCA, and the 2nd User matches on that segment, then although the 2nd User may not know exactly which of their own pedigree branches this MRCA actually lies in, they will know that the MRCA to which the DNA is mapped, has to be in the path of the DNA from their respective MRCA to the 2nd User. Also, if they have a name and location, it is a data-point ‘flag in the ground’ in terms of sorting out the rest of the DNA matches ‘top down’, and for steering research up a particular branch of the pedigree. The utilization of such evidences, and the implicit confidence of an triangulated MRCA, are used throughout the invention, to narrow down the possible set of pedigree branches and nodes that a particular MRCA might lie on.

Creating these flags suggesting most likely branches for particular MRCAs everywhere possible is a key objective of this invention. As will be shown in the ‘speculative tree search’, the stake-in-the-ground for the 2nd User may be (if there is a path which seems to lead to the MRCA on the 2nd User's pedigree, but which meets a dead-end), used by a ‘Speculative Tree Search System’ to add a virtual branch with virtual-ancestor placeholders at each generation—which may eventually get merged into the actual pedigree as ancestors are found. As will be described in the invention, any full path to an MRCA will result in a DNA segment assignment to that MRCA. Any User, of all Users, who has this DNA segment, or any part of it sufficiently large enough to be IBD, can add this Ancestor as a high-probable MRCA . . . even if they do not have a path to it yet. This concept of finding DNA cousins with the best tree, and sharing that info to other DNA cousins, is termed ‘chaining’ below. The general idea of completing the trees between MRCA′a and the index Users', based on information from tops-down, bottoms-up or ‘In Common With’ analysis, will be bundled into the middle-ground strategy.

Phenomenon of ‘Very Influential Persons, Endogamy and Strange Attractors

The generalization that Users ‘give up’ at their 4^{th} GGPs makes the incorrect assumption that family trees are evenly developed in terms of depth. Realistically, a family tree may fill out obvious well known family members to the 1^{st} or 2^{nd} Great-Grandparents, and then proceed deeper only on a few branches. Some of those branches, however, may reach back in time quite far, and may branch out to very large pedigrees at some point. This is typically due to an ‘influential person’ or family phenomenon, wherein an ancestor, or historical figure, had such influence and recorded impact in a time period, that many generations of descendants benefited and also were well recorded (ie, nobility, politicians, military figures and the industrious). These ‘Very Influential Persons’ (VIPs) have been observed to create a form of a ‘strange attractor’ [5]. That is, many family trees get drawn into these VIP sets (or clusters) by virtue of the plethora of documentation generated, and the desire of the User to have an affiliation to such VIPs. Furthermore, the social circles that VIP's tended to associate with, often lead to complex cases of endogamy—which in turn tends to amplify the prevalence of the associated genotype.

This concept of VIP attractors, as with middle-ground ‘chaining’ above, is useful in at least steering a researcher who is trying to find the MRCA of a DNA match. Even if the exact path into, or through an endogamous tree is unknown, simply knowing that the path must end up therein somewhere, allows the researcher to link (associate) the MRCA to a particular region and society of history. Such a collection forms a ‘Cluster’ wherein a group shares a common attribute, or set of attributes. Connecting an DNA-Match set to a VIP cluster, is described in the section on ‘Disembodied Cousin Triangulations’ in the invention description. To note, this does not apply just to VIP's, but also to any ancestor who shows up in multiple trees of a User's DNA cousins. These ancestors are generally described as ICW (In Common With). Having an ICW ancestor between multiple DNA cousins does not prove that person was an ancestor to any particular User. However, even if the ICW ancestor is just a ‘collateral line’, it implies that some of the ancestors of the involved cousins (all who have this ICW person, and who DNA match to one of each other) lived in a ‘connected’ community (a Cluster). That connection may be a physical location or social network (military, political, religious, education). Thus, to guide search for the MRCA between cousins associated by an ICW ancestor into the associated network, an ICW ‘disembodied cousin’ node may be created for each case of clustering, with attributes for the characteristics in common with the members. The above ideas on VIP attractors and ICW data mining, will be handled by ‘Intelligent Agents’ executing smart algorithms, within the holistic system, and are considered to fall into the middle-ground strategies.

Operation of Social Media Genealogy Services and Crowd Sharing

The aforementioned Internet Genealogy companies typically provide a web based graphical user interface (GUI) to construct a family tree. The Family Tree data is usually saved on a farm of computer systems, and is accessible from anywhere that a User has internet access. The GUI typically has a search engine which enables the member to search the previously described databases of digitized and OCR (Optical Character Recognition) interpreted records. And finally, the program allows the member to associate data to the records in those trees. Moreover, the process is accelerated by allowing members of a particular Genealogic Social Media system, to browse each other's Family Trees, and to directly copy the records and connections of a particular ancestor into their own trees. On the positive side, this capability of ‘crowd sharing’ and comparing data, is a phenomenal example of the power of computer technology, social networking and sharing of resources and efforts. It works especially well in media such as Wikipedia.com, wherein there are strict rules on quality, and there are typically more experts than topics.

Error Copy in Crowd-sharing Genealogy and Strange Attractors to the Distinguished

In the genealogy field of crowd-sharing, the popular methods and systems currently available too easily facilitate creation of errors, and perpetuation and replication of those errors between users, such as assigning incorrect records to presumed ancestors, making incorrect relationship connections, and rampant copying of other's erroneous family tree information. An experienced Researcher (program User) may mitigate the problem by imposing self-discipline in creation of their own tree and in setting rigorous criteria in assigning records to ancestors in that tree. But, the accuracy and completeness of an ancestor's profile is likely only determined by novice Users by counting the number of records associated with it. Furthermore, the effort required even for an expert to attempt to build-out a tree is intractable in that a family tree grows in size as Σᵢ2^{̂i} with number of generations (i) in the past. The advantages of crowd-sharing with social-media are diminished, if the expert must research and discover every ancestor and every relationship. Novice and casual-interest Users are not likely to have time to invest in creating high-quality proofs for every ancestor for more than the above noted 6 close generations. After some point, observation indicates that there tends to be a practice of copying whatever looks good, and more often than one would expect, the ancestors chosen tend to be those that lead to the aforementioned distinguished or influential historical figures (VIPs). This problem is particularly confounding, as there may be many descendants with a surname of a particular VIP (eg Hamilton), and many of those descendants may be participating in a DNA match based genealogy, and some of them may create a false path to a VIP, to which they are in reality not related. The described invention can mitigate this problem in several ways, including 1) promoting high confidence documentation paths, 2) propagating DNA matches up the pedigree as MRCA are discovered, 3) providing a system which handles conflict resolution (if two sets of descendants claim a VIP ancestor, but their trees do not corroborate each other), with ‘dislodgement’ of the losing side.

Brick Walls and Speculative or Work-In-Progress Error Copy

Furthermore, when a User runs into a brick-wall in terms of lack of actionable information, they are easily enticed to assume, or hope, that records that match only on minimal data such as name and state, might be relevant. So, they might create an ancestor with specious records, just to see if it leads to an ancestor who appears in the pedigrees of DNA matched cousins. The practice of creating what-if or speculative ancestors, and then seeing if one or two guesses up a tree lead to a new, valid hint, is actually quite practical—and leads to an automated ‘speculative tree search’ system. However, the speculative tree should not be made public, or should at least be prominently flagged as ‘speculative’. The more people that follow an erroneous ancestral path, the more it becomes incorrigible, as people who copied the what-if paths may not realize that they are not researched by an expert, and not validated. When a new User comes along and studies this over-copied ancestor, they will see said ancestor appears in many trees, and then may assume that many people validated it. To determine if a set of User's have simply copied each other's errors, a User must investigate the source of each of the other User's claims. If, for example, there are 10 copies of an erroneous ‘wife’ for a particular ancestor, now residing in 10 User's family trees, then any new User might search all 10 to find if any of them are based on factual evidence. There may be 100's of User's repeating this same mindless dead-end task. This sort of house-keeping is well suited to Intelligent Agents which have the ability to calculate confidences on each item, can apply constraint satisfaction algorithms with fuzzy logic, and can propagate information up/down trees and to other trees which share the ‘facts’ and evidences. The concept of confidence, constraint and speculative search Agents are contained in the invention.

Summary of Social-Media Assisted Quality and Lack of Knowledge Capture

In summary of the first base problem: social-media assisted genealogic systems tend to invite and perpetuate error. Part of the solution will automatically check and qualify the correctness or relevance of documents, data and relations, and indicate on the attached records and relationship connections, their intended validity. High quality data will be made to automatically displace lower-quality data. The correctness and quality ambiguity solution described here, is relevant to the next section.

DNA Kits and the lumina HumanOmniExpress-24, and HaploScore

In recent years, it is estimated that over 1.25 million hobbyist genealogists have been empowered with affordable and fast turn-around DNA sequencing data to help with constructing their ancestral trees and discovering close relatives and distant cousins. As noted, there are many Ancestry and Genealogy companies that now offer autosomal DNA kits for under $100. AncestryDNA(™) and 23 andMe(™) both announced in 2015 surpassing 1 million DNA customers each, but we assume there is some overlap. That is, customers often test with 2 or more companies, after failing to get satisfactory results from one, or in hopes that they can (manually) consolidate the information from each Vendor to solve a personal global problem. The utilization of data from multiple vendors is a key objective of this invention.

Recent DNA testing systems focus on sequencing a reduced set of the genome, wherein the 1% of DNA which varies most between humans is targeted, with a further refinement of testing to only detect the Single Nucleotide Polymorphisms (SNPs) which effectively model that 1% of the genome, due to local correlations between a SNP and its vicinity. [6]. This results in a test sampling about 700,000 SNP's for each participant. From these SNP's, participating members' resulting genomic data are compared SNP by SNP to discover contiguously matched sequences (segments), and where identical along a segment length greater than a threshold, an ‘Inherited By Descent’ (IBD) match is considered probable, with confidence proportional to the length of the segment, or count and length of multiple segments. Every DNA kit is compared to every other kit in the Vendor's database. Given the claims of certain Ancestry DNA Testing Vendors on number of kits obtained, these Vendors could be running well over 1,000,000 kit comparisons, per each new kit. Upon completion of a run set (test of all new kits vs old), each Vendor will provide to all participating Users a list of other User's within the Vendors' participating set, to whom their respective DNA has been found to meet a minimum criteria of equivalence, according to the Vendor's matching algorithms. From these comparisons, a User may end up with several thousand prospective DNA ‘cousins’. Each DNA Cousin will be given an estimate of relationship distance, based on the length of the matching segments(s). The reader is referred to the references for clarification on the science behind SNP sequencing with the popularly used Illumina HumanOmniExpress-24 Beadchip [7], and the matching algorithms such as described in the HaploScore paper [8], which determine Identity By Descent (IBD) from matching segments. A ‘DNA test’ or ‘DNA match’ in this document, will refer tests done with such Illumina kits, or with a kit producing compatible data such that the results of a test can be compared with those from Illumina.

DNA Matches, MRCA Problem, Exponential Matching Problem, Exponential Cousins

From the point of view of the customer, once their DNA has been sequenced and run through a Vendor's match discovery system, they are usually presented with a huge list of other members with whom a segment of their DNA matches to a minimum degree, and the estimated relationship distance between the two individuals based usually on the length of the matching segments. These matches are presented to the User in a web page or spreadsheet. The web page may contain, for each DNA match, a Username, relationship distance estimate in terms of ‘N^{th} to K^{th} ‘cousins’, and a confidence, and a link to a profile page for the particular DNA match. On this page or on a spreadsheet, the Users are typically provided means to contact their DNA matches via email or messaging. They may see, as with AncestryDNA.com, a pedigree tree of the DNA matched Users' family tree extending out to the 7^{th} generation, with the User (or whomever is represented by the DNA kit), as the root of the tree. The User may then study this pedigree of first-names and surnames, in hopes of finding some hint of which branch the MRCA lies on.

The problem then for the Users, is to discover who the MRCA is that provided the genetic segment(s) shared between the two matching relatives. If both trees of DNA matched Users both have the same Ancestor, and that Ancestor is the most recent matching individual in the two trees, and that individual is within the expected relationship distance, then that is most likely the MRCA. That is, it is inferred to be the MRCA, if both trees have high quality proofs of everyone from the root person (usually the User) up to and including the MRCA. It may be the case that one or the other has this Ancestor in their tree incorrectly. In most cases, there is no existing MRCA in either pedigree, and the Users are forced to examine many branches at the level the MRCA is predicted to be found. For close relatives, 1^{st}, 2^{nd} and sometimes 3^{rd} cousins, finding the right branch for the MRCA is not terribly hard. Beyond this, it gets exponentially harder. But as well, the information and number of possible cousins, grows exponentially. The best confirmation of any MRCA will require not only a documentation path, but in the best case, also a DNA triangulation involving several User's finding unique paths to the MRCA. Furthermore, each Ancestor between the User and the MRCA should, in the best case, have its own triangulated confirmation, and should have accumulated the DNA which provided this confirmation. These factors and functions are described in the invention.

Typical Match Counts, 786,432,000 8^{th} cousin Comparisons, 629 trillion branches

In practice, DNA-match participants may have hundreds of DNA-matched close DNA cousins (1^{st}-3^{rd}) and thousands of DNA-matched distant cousins (4^{th}-8^{th}).Each of those cousins in turn, along with the User, have ancestry trees which could have hundreds to thousands of ancestors in the estimated range for an MRCA. Therefore, the Users must find common branches between their pedigree trees that have the highest likelihood of harboring the MRCA. At the 8^{th} cousin distance, there will be 2¹′9 node, or 512. Comparing each node between the two trees at this genetic distance, equates to 512^{̂2}/2=131072 comparisons. If a User has, for a simplified example, 3000 DNA match cousins at the 8^{th} cousin range, with no pruning's of branches, there will be 3000*(512^{̂2}/2)=393,216,000 comparisons to be made—just by one User. If an Ancestry company has over 1,000,000 DNA participants, then there are about 393/2 trillion branch nodes to compare (upper triangular of N*N) . . . if done blindly with brute force. But, this form of brute-force comparison only reveals that a pair of User's have a common ancestor, if a nearly-exact match is found between the pedigrees of two DNA matched Users. This sort of information is provided by AncestryDNA's ™ ‘hint’ system, which reports how two DNA cousins are matched by displaying the triangulation path between the two of them up through generations to the MRCA. This is extremely useful, for graphically illustrating the matches that the pair of DNA cousins have already resolved. It does not automate the process of solving all the others, or guiding the User to predict where an MRCA might be. In fact, the User can not even see in their pedigree displayed tree, where an MRCA has been discovered, unless they manually mark it with an image. This process of marking confirmed MRCA's is automated as part of the invented system herein.

MRCA Clues and Process of Elimination and Concentration

There are often clues regarding a particular MRCA, in the various trees of DNA match cousins. With sufficient effort, time and a good memory, a User can sometimes work out the hints and mentally remove the impossible branches to find the MRCA through a process of elimination. Clearly, most of the effort should be spent on finding clues and constraints, and annotating those to the respective ancestors in the pedigrees. None of the current Vendors provide systems to automate the sharing of clues and constraints with respect to finding MRCA between two DNA matched ‘cousins’ ... other than email, messaging and manually input ‘notes’.

Bottom-up triangulation of DNA cousin MRCAs:

When a User receives a list of DNA matching relatives, sorted by DNA relative closeness, they will typically start by finding MRCA matches from the bottom (nearest relatives) up. This is logical, of course, as you establish the first links with little to no error. As well, any MRCA found between DNA cousins is considered a triangulation, which are inherently ascribed a vaulted position in terms of bestowing a high degree of confidence on the ancestor. As the User moves up past the fairly easy 1^{st} cousins, the work begins to get intractable quit fast. The number of direct ancestors grows by 2^{N}. Fortunately, the number of descendants per ancestor typically grows much faster as you ascend the tree, and the average number of DNA kit participants from those descendants can be expected to grow proportionally.

Manual MRCA Search by Surnames, Biographic Similarity, Proximity, Intractable Beyond Few Generations

The Users will usually investigate those branches with common surnames first. Depending on the depth of each of the pedigrees, there may be numerous Surnames in common between them. If the User is lucky (or very skilled), they might find an ancestor in the two trees who matches, or has similar biographic information, or who at least has a similar surname and lived in the same general time and location. This sort of hunt-and-peck manual methodology is feasible for resolving the MRCA of close relatives. Beyond the nearest relatives, this process becomes a daunting challenge, given the User may have several thousand DNA cousin matches, each with 100's to thousands of ancestors at the expected distance of the MRCA match. In many cases, the User will not have the branch of the actual MRCA completed. However, of the many cousins who DNA match and whose common ancestor lies somewhere on that branch, there may be, for each ancestor, several cousins who have that ancestor (or similar ancestor) in their tree. Thus, starting from the index User, the challenge is to search through all DNA cousin's trees to see if there is an ancestor (or similar ancestor) who fits, in terms of various constraints. Per traditional Artificial Intelligence algorithms, all of the trees which have ancestors or descendants of an ‘dead-end’ node may be utilized to fit together the puzzle pieces and create a ‘virtual speculative tree’. This virtual tree building will benefit from the DNA connection between Users, matching algorithms and the general clustering affected of a weighted network of shared attributes that will be described in the invention. Note that, while any particular cousin's matches are searched, it can be assumed that all other cousins are themselves performing the same search and build. Thus, a different cousin who did not have the ancestor on their pedigree during one search, may have that ancestor anytime after—so the search should repeat if the searched cousin's ancestor tree has changed.

Base Case, AncestryDNA 1^{st} cousins MRCA triangulation

Example, Base Case: AncestryDNA™ currently bins DNA relative matches according to distance between the two members. The bins are parent,/child, 1^{st} cousin, 2^{nd} cousin . . . 3^{rd}, 4^{th} 4^{th -}6^{th} and 5^{th -}8^{th} cousins. Thus, if a match is calculated to be a 1^{st} cousin, then the two DNA matched cousins only need to complete their respective trees, correctly, out to the 1^{st} grandparents. There will be only two possibilities for the MRCA, either the paternal or maternal grandparents. If the two members have matching surnames on either grandparent, they can be pretty sure the MRCA is along the line of the matching surname. This is the simplest case of DNA triangulation.

Distant Cousins Case, 960 potential MRCA nodes at 5^{th}-8^{th} Cousin

For 5^{th}-8^{th} cousin relatedness, they both have to consider 2^{̂6}+2^{̂7}+2^{̂8}+2^{̂9}, or 960 potential MRCA ancestral nodes. Generally, a User would compare surnames between the two DNA cousin's trees, and for any overlaps, check to see if that Surname line has people living in the same area, and in the same general time.

Chaining Cousins and Single Success Ripple Effect

If it were the case that MRCA's were spread out evenly across the 960 nodes at the 5^{th}-8^{th} cousin range (they probably are not), and the User had (to generalize an actual example) 3840 cousins whose MRCA is predicted to be in the 5^{th -}8^{th} range, then there would be on average 4 cousins triangulating to each MRCA (3840/960=4). This is useful in that, in this example, there are potentially four cousins working on the same problem, and between them there might be enough evidence and clues to nudge the Researchers' focus to the right pedigree branch. In actuality, the number of cousins who realistically connect to an MRCA grows proportionally to the number of descendants of the MRCA's at each generation upwards. So, the number of cousins from a particular pair of Ancestors at generation N, could be on the order of (for example) 4 ^{N} . So for N=8, there may be 256*4⁸ cousins, or over 16 million. This is interesting to note, as there will likely be, in the population of DNA test participants, a large number of them who are descendants of a MRCA, but who do not share DNA with most of their cousins. If any of these descendants finds a good, well documented path to the MRCA, and if there exists a chain of DNA-match relatedness from them to other cousins, then by simple progressive automated spread of this information, every cousin descended from the ancestor can benefit from the proofs of all of them.

Traditional search and Thousands of Cousins knocking on each others doors

If the two family trees of the DNA matching cousins do not have obviously similar ancestral lines, or are not filled out to the range of the DNA matches predicted distance, then they have the conundrum of trying to figure out which line (branch) the MRCA lies on, in order to successfully focus further research. the User may simply give up on the DNA match and move on to another (given that there may be thousands), with hopes that another match will reveal an MRCA quickly. Or, the User may decide to copy the other member's pedigree and attempt to complete it further. This of course, creates a mess for the User in terms of junk trees lying around.

Branch Clues, Elimination Process and Weighting of Options

Fundamentally, and fundamental to this invention, the User needs clues as to which branch in their pedigree they are most likely to find an MRCA between themselves and a particular DNA matched participant. Generally, the clues lie in common surnames, temporal and spatial proximity, connections implied in documents such as birth and baptism certificates, marriages, and Wills, or through labor-intensive ‘chromosome mapping’ (described further below). This invention provides an automation of the above and with extensions to accumulate inferences across all available DNA match sets and pedigrees, as will be described in the claims of this invention.

Inability to Process Matches of Matches in any Vendor Tool.

Making inferences across DNA match sets is not easy for normal Users with existing tools. Users are not, of course, enabled to directly view or download the opposing matched User's DNA match list. For each pair of DNA matched Users, if they both match to a third User, then that will be captured into the holistic system for analysis. In the least, the 3-way matching suggests that the three individuals share DNA from ancestors who may have crossed paths. When there are many shared matches between two DNA matched Users, there exists an opportunity to data-mine the set of matching Users to find similarities. This looser form of kinship chaining affords the ability to cluster subsets of User's, with the general idea that somewhere in their pedigrees, there are people who were related in some manner. It should be noted that such match sets, are very similar in utility to chromosome mapping, with the caveat that the location of the matched segments are unknown. Similarly, besides the ‘full-match’ between a User's cousins, there is also the partial-match that can be seen when a User' tabulates all DNA matches, listing the matching segment's chromosome number, segment starting point in mega base pairs, and ending point. Sorting the table by chromosome, then by starting and ending points, one can calculate the overlap between a User's cousins's DNA segments. According to length of the overlaps, an ‘association’ link may be made between the cousins. That is, the bit of information should lead to clustering and sharing of evidences.

Summary of Introduction to DNA Match Analysis Tools and Techniques

In summary, the User is faced with a flood of mostly unmanageable information in the form of a list of DNA matched relatives. They know that, if they could find the MRCA between themselves and each of their thousands of cousins, they would have a high probability of an accurate family tree—if both Users have accurate lineages to the MRCA. The massive amount of data makes the problem intractable to human analysis. However, there are many ways to extract clues out of the data, to indicate which ancestors between two Users may be related, and/or which branches lead to common places and times. This process will be greatly enhanced if data is rated according to validity or likelihood. The use of Virtual trees to patch together sub-trees from various Users, and to enable searches and connections, provides a platform for the various systems. These processes may be automated, and most of the analysis may be done asynchronously by distributed ‘Intelligent Agents’.

### RELATED AND PRIOR ART

GEDCOM and DNA Data Download, Use by 3^{rd} Party Tools

The Vendors do not pool or share their DNA match information between themselves. They do, however, allow the User to download their personal DNA sequenced genome data. All known vendors also allow Users to download their family trees in the standard GEDCOM format. This has facilitated and motivated several 3^{rd} party groups and individuals to write utilities which accept DNA genome kits of the common formats, and the GEDCOM′ represented trees. Each of these independent groups attempt to process and present the data in a particular way, to help the User sort out where to look in their Ancestral trees for the MRCA between them and each DNA matched User. Several of the more useful systems are described below, including ‘in common with’ extractors, triangulation reports, and chromosome mapping to spreadsheets. In-common-with tools (ICW) generally create lists or spreadsheets of ancestors who appear in multiple DNA-matched User's trees. Triangulation tools compare the DNA of many users, and find those who co-match each other to various degrees (called ‘family groups’ or ‘DNA circles’). Chromosome mapping tools, generally attempt to assign surnames to parts of a User's genome according to a triangulation with others who share a particular DNA segment. In summary though, none of these 3^{rd} party tools use any of the data to automatically guide the User in deduction of which branches an MRCA might lie on, or employ advanced machine learning capabilities to combine the logic and inferences of various sources of data—for example.

AncestryDNA™ Surname Search, and Invention Extension to Multi-Occurring Ancestors

AncestryDNA™ provides a simple means of ‘In Common With’ discovery via a ‘Surname Search’ on the DNA home page for each User. This is fairly useful if the User has a rare surname in their pedigree. In such a case, DNA-match relatives who have the same surname are interesting candidates for further, tedious, manual research. The surname search also allows the User to enter a location, to narrow the search. The output of this search is a list of Users with links to the profile page of that DNA match. The tool does not, unfortunately, allow the User to search across all DNA matches for Ancestors who are similar in various ways to indicate they might be the same person. These multi-appearance ancestors may form the MRCA for the owners of the trees they were found in, including the User doing the search. If there is not already a direct lineage from the User to the Ancestor in the User's pedigree, and if there are potential branches upon which that ancestor might lie, then this Ancestor's potential to to lie in each of the branches needs to be captured for processing.

AncestryDNA™ geographical mapping tool, and Invention Extension to CPA Clues

AncestryDNA™ provides a useful geographical mapping tool for a manual (labor intensive) geographical proximity check, which shows google-maps landmark tacks of differing colors for the two Users. Each thumb-tack shows a list of Ancestors in the location, regardless of date. That is, the Researcher may see a list of people spanning across hundreds of years. They can not tell, without some study and looking at every thumbtack, and memorizing the dates, which reproduction eligible ancestors crossed paths in the same time windows. This sort of ‘closest point of approach’ (Naval term) is described in the invention and provides a useful positive factor to the likelihood of a subset of Ancestors being ‘eligible for mating’ and possibly having issue. Several other new capabilities, as part of this invention, are described below.

AncestryDNA™ MRCA Lineages Hint and Extension to Annotation of Trees with DNA State

AncestryDNA™ provides a useful notification ‘hint’ system, wherein after an equivalent Ancestor has been added to both pedigrees of two DNA test participants who have a DNA match, with a complete path from each user to the Ancestor, and given that the Ancestor in both trees has generally the same name and date of birth, then the DNA match profile page will show a two-column (direct line of descent) pedigree tree from the Users to the MRCA couple. This is certainly beneficial, as the User's may not know they already have these MRCA's in common, or may not realize that in their independent research and tree updates, they have created the path to the MRCA. The system does not, however, propagate this confirmed match information back into the family trees of the Users. From the family tree view, the User has no feedback that a particular ancestor is a confirmed MRCA, or on the direct path between a User and an MRCA. This sort of visual representation will be described in the invention.

AncestryDNA ‘Family Networks’/DNA Circles and Limitation to Resolved MRCA's

AncestryDNA ‘Family Networks’ patent and the implementation, presumably called “DNA Circles” in implementation, takes a leap in the right direction of implementing what GEDmatch.com has in terms of a Triangulation Utility for 4^{th} cousins and less. The DNA Circles, according to the white paper [4] have the DNA Matches restricted by the Family trees of DNA matching Users. That is, a pair of Users' must simultaneously have a sufficient IBD segment match, at least one common Ancestor, and one common ancestor has to fit the criteria of an MRCA in their direct-line pedigree tree. The invention described herein differs from the claims of patent US20140278138 A1, Family Networks, which states “By analyzing the DNA samples, potential genetic relationships can be identified between some users. Once these DNA-suggested relationships have been identified, common ancestors can be sought in the respective trees of the potentially related users. Where these common ancestors exist, an inference is drawn that the DNA-suggested relationship accurately represents a familial overlap between the individuals in question.” Thus, in this wording, common ancestors must be manually sought by the Users, in their respective trees, and apparently must be found in some of the respective trees of the DNA matched User. That is, the MRCA is already identified for at least some of the Users. For other Users who have DNA matches to at least one of the Users who have the identified MRCA, an inference is made that the identified MRCA might apply to them as well. Although a very useful tool, this system has several limitations with respect to solving all MRCA's (in its own solution) which are addressed by the invention described herein. For example, the system does not systematically check whether Users' pedigrees are correct. If several people who are direct relations all have DNA tests taken, and have their ‘kits’ managed under the same family tree, then just one error automatically gets amplified to three DNA triangulations confirming it. Next, in actual use of the tool it has been found that, if a User DNA matches two other (second) Users, and those second Users DNA match variously to several (third) others who have a true MRCA, then the above system has the tendency to erroneously make the inference that the first User is part of a family circle with the set of third Users. There have been many cases of this error reported. The invention described herein, through the employment of holistic computation, avoids this error. Thirdly, the above system does not help a User solve an MRCA puzzle when a DNA match does not fit into a pre-existing ‘family circle’. Finally, although DNA Circles cover 6 generations, and thus could result in about 120 DNA circles, their reported data-mining revealed that, for all individuals who had at least one DNA Circle, the average number of Circles was just 5.1.

AncestryDNA In-Common-With Matches

AncestryDNA provides to the User, from the profile page of a match between the User and a second User, a tool called ‘Shared Matches’, which lists third User's who share significant IBD DNA with both the first User and second User. The list does not reveal how much DNA each matching second and third Users share, nor any information about which segments, length of segments, or location. The information is still useful for further data-mining and analysis in the holistic invention described herein.

GEDmatch.com Triangulation Utility with Segment Lengths between Matched individuals

The statements above, regarding ‘common ancestors’ between DNA-suggested relationships, appear to be common knowledge, found throughout the various genealogy blogs and guides [9]. Moreover, the non-profit site GEDMATCH.com has provided a service of showing an array of triangulated matches for years [10]. The GEDmatch.com triangulation Utility takes as an input a DNA Kit number, the Kit having previously been uploaded to www.GEDmatch.com and processed, and outputs a plurality of matrices wherein, for each other member Kit (call it Kᵢ) to which the input Kit has been found to have a DNA segment match greater than a threshold number of matching centiMorgans (usually about 5 to 7), a matrix is made with the first column being a plurality of other Kits to which both the input Kit, and the current processed kit (K₁), both have a DNA match segment greater than the threshold, and with the second column listing the length of the largest segment shared between the input Kit and the member kit in each row, and the third column being the length of the largest segment shared from the (K₁) kit and the member kit in each row, the fourth column being the name provided by the member owning the kit of each row, and the fifth column being the email of that row's person—if any is given. Thus, although this tool is invaluably useful, it does not use this triangulation information in tandom with User's genealogy trees to discover and annotate MRCA's between the triangulated Users.

GEDmatch Segment Triangulation

GEDmatch provides another useful utility which tabulates all 3-way segment triangulations in order of chromosomes and start-end positions of the matching segments. The utility provides a graphical display of the length and position of the segment within the chromosome, in the right-most column. With this information, the User can see which of a User's matching cousins also overlap each other in terms of position of segments on the chromosomes. With 3-way triangulations as such, one can be fairly certain there is a MRCA between all the individuals who overlap in this manner. However, you need to have their pedigree with at least the first couple of generations completed in order to even start to find an MRCA. GEDmatch does not currently provide a link to the pedigrees in this utility.

Chromosome Mapping and Propagation to all Descendants of an MRCA

Chromosome mapping generally refers to the practice of indicating which parent, grandparent and so on, that a set of DNA most likely descended from. If a User has a DNA match with a cousin, and their MRCA is known, then that DNA segment may be ascribed to all of the ancestors in the direct descendant paths from the MRCA to the cousins respectively. That is, the DNA segment is tagged with the Surname of the MRCA whence it originated from. No known prior art automates this process, with annotation of the shared DNA segment to the records of the Ancestors. No known system holistically accumulates the clues described above, and converts them to positive and negative weighted evidences, to help reduce the problem size in determining which branch to search for a MRCA between two DNA matched members.

Chromosome Mapping and Ancestor Genome Reconstruction:

Ancestor Reconstruction: It is common knowledge that, if one were able to identify the DNA from descendants of an individual, which came from that individual, then one could partially re-create that individual's genome. For example, if one parent of a child is unavailable for DNA testing, but the child and another parent have tested, then by finding the DNA that matches between the tested parent and child, one can deduct that the remaining DNA segments came from the unavailable parent. This is termed ‘Phasing’. Thus, the unavailable parent's DNA is about 50% resolved. If more children are tested, this coverage obviously goes up, as each child gets about 50% of their DNA from each parent more or less randomly. For the purposes described in the invention below, we do not need a 100% coverage of a phased individual's genome. What we need are long, contiguous phased segments that can be used to compare the virtual genome against all others. The automated collection and creation of virtual genomes across a large set of DNA, is not known to have been claimed as a patented invention. There are papers and algorithms that do this sort of thing, given a complete set of existing descendants. [12]. The work herein is concerned with the method of propagating this information up the pedigree, to facilitate further discovery of hints and constraints to guide the researcher.

23andMe Countries of Origin list of matches with start/stop match and segment length

The Vendor 23 andMe™ provided a ‘Countries of Origin’ utility, which creates a spreadsheet of all matches, including the chromosome matched on, start and stop points in terms of mega base pairs from the beginning, and measures on number of mega-base-pairs matches, and number of centiMorgans. A graphical display shows the segments which associate an individual to a particular country area, mapped on illustrations of 23 chromosomes. The means by which these segments are matched to particular world areas (the IBS) is very useful as a clue as well. If a match pair of Users have the segment lying somewhere like Norway, they might be able to isolate the branch down to some folk who came from Norway. Notably, two User's who do not have matching IBD segments may still have IBS matches to a common ethnicity, such as Irish, Scandinavian etc. Given that this ethnicity DNA mapping becomes available [13], the invention below will show how it can be employed to create attractions between DNA related Users, and how that may propagate to strengthen branches on each which have evidence indicating the same ethnicity. Furthermore, any DNA equivalence between two individuals is indicative of some relationship, whether it be IBD or IBS. That is, it may only indicate both are human. As the SNPs selected are those that vary in humans, then for any matching segment >X in length, there should be a phenotype proximity estimate proportional to X.

### BRIEF SUMMARY OF THE INVENTION

It is determined from experimentation on real genealogic data and objective estimations, and the published reports of several genealogic vendors, that there are enough sufficiently deep (e.g. generations back), correct, or semi correct ancestral trees, which are referencing sufficient accumulated genealogic records across multiple online sites and resources, to facilitate identification of, and potentially hinted or automated correction of, many incorrect family trees, and also to further extend deep-history growth of many family trees through the use of hybrid machine-learning assisted logic and probabilistic means, with said information presented to the User in various formats including graphical user interfaces, and through automated tree generation. For example, this invention will help discover which sub-trees are most reliable, out of the billions available, through enhancement of confidences based in part on DNA triangulations, and in part on confidences of the evidences associated with the elements of sub-trees, and in part on application of fuzzy-logic evaluation of the likelihood of the data and relations in those sub-trees, and in part based on simultaneous processes of elimination of unlikely trees along with enhanced likelihoods based on reduced sets of possibilities for MRCA assignments based in part on DNA chromosome mapping, and intelligent methods of mapping patterns of relatedness (such as In-Common-With Matches and ‘Disembodied Cousin’ networks). This will become more apparent in the discussion of the Figures and in the following.

In particular, the cleanup and deep-history growth of involved family trees will be greatly enhanced by the phenomenal reach of DNA sequenced genome correlations between members. For example, observations have indicated a surprisingly high number of DNA matches which triangulate to MRCA at the 10th great grandparent distance. This invention will, in many cases, be able to sort out the assignment of a User's DNA matches to the most likely Ancestors in their pedigree tree, or at least to a sub-set of their pedigree. That is, with even the most subtle factual DNA correlations between members (non false-positive DNA matches), and with sufficient members participating, and with any sort of available historical data sufficient to corroborate an inheritance-by-descent (IBD) path from any (DNA match participating) member to a particular ancestor, the invention herein described can facilitate scalable distributed automation of the process of collecting and structuring logical and statistical inferences across a large set of genealogic data and a proportionally large number of participating DNA members, to discover and optimally complete the MRCA paths between pairs of DNA matched members, and thereafter to create ‘virtual Users’ from Ancestors whose partially re-created DNA serves to convert them into participating DNA members. The system automatically treats re-created, or ‘Virtual’, ancestors similarly to living Users, applying the same system of logic and inference to find their MRCA with other extant members and Virtual ancestors, and thence to incrementally continue to extend the Global tree further back in time. For example, if 2 siblings participate, and each has 50% of their parent's DNA, but have 50% shared DNA between them, then their combined DNA can recreate about 75% of each parents' DNA. Each parent's phased DNA would then be compared to the whole set of User's DNA. Each of those parent would then be assigned DNA matches. Even though the parents have less DNA to work with, they may have just as many ‘DNA cousins’ as the genetic distance between them and potential cousins is short. The genetic distance ‘reach’ of their DNA to MRCA's with 1st cousins, should again extend to the 10th great-grandparents. This, of course, will continue up the pedigree, although with diminishing returns as the lengths of accumulated, usable DNA segments decrease.

As noted in the background discussions, much of the strategy is based on experience and experiment in traditional genealogic research, with a vision towards a holistic computer automated integration of the various strategies. The described system is able to combine in an additive manner, the benefits of multiple strategies, including a ‘bottoms-up’ reduction of possible or most-probable branches likely leading to a particular MRCA, and a top-down strategy. In the bottoms-up case, an automated system of Chromosome mapping and/or ICW match mapping, along with confidence enhanced data on ancestors, will contribute to pruning some, and ordering (ranking) other possible branches that an MRCA might lie on. The top-down strategy involves associating the DNA matches (MRCA nodes) of a User to particular branches at various levels through a combination of attracting similarity metrics (VAN' s in a competitive network) and constraints satisfaction, and benefits from the increase in number of cousins that a user has through ancestors encountered as one ascends a tree, and the likelihood that these ancestors will have many more descendants across many family trees, as one ascends the tree. It will also benefit from the overlaps of DNA from a User's cousins, in the assignment problem, and the natural clustering that introduces. Thus, discovering the similarities and logical exclusions between trees through data-mining, in part, leads to potential to apply analytic means such as machine learning inspired distributed constraint satisfaction, to further narrow down the likely branches that each MRCA might lie on. The Tops-Down strategy is further facilitated by the reduction in number of surnames that existed in smaller populations (particularly, in colonial America), the reduced travel tendency as one moves back in time, and various techniques to focus on statistically rare events or states common between DNA matches. Thus, in summary, a unique form of Competitive Learning network is presented, which continuously structures all available data into a weighted network, which inherently propagates confidences, inferences and constraints. Several algorithms which employ forms of combinatorial optimization in tandem with constraint satisfaction utilize this network in order to rank the potential common ancestors or branches between all DNA matched cousins, in terms of their potential to be, or harbor, the MRCA between each pair or set of DNA matched Users.

The data-mining and its' analysis results (usually a set of nodes with various intents to be described in the figures) provide inputs to a set of cooperative sub-systems designed to operate on a multi-constraint satisfaction and optimization problem, wherein a significant part of the optimization objective is to discover maximally matched pair-wise nodes from two or more sets of nodes (Ancestors of each of the DNA matched Users). One set of nodes (to be call ICW-DNA, or In-Common-With DNA) each represent a connection between two users whose DNA partially match, and each holds, or references, the subsets or segments of DNA genomes of the respective Users that have been partially matched. Another set contains nodes of virtual Ancestors and represent place-holders of the ‘most recent common ancestor’ (MRCA) between the two Users in the matched node. Another set of nodes represents attributes (records, traits, etc) that are shared between various Ancestors. Another set of nodes are derived from data-mining the prior mentioned nodes to form hierarchical clusters. Another set of nodes called ICW-Match nodes, form a constrained network which can only be mapped to the VFT's (or the VWT) in a particular manner that honors DNA flows and genetic distances built into the network.

Each User will have a ‘Virtual Family Tree’ (VFT), which is a pedigree of that User, and has nodes for each direct Ancestor. There will also be a ‘Virtual World Tree’, which is a shared general family tree to which all Users' VFT's contribute, and from which all VFT's can import improved sub-trees. As will be explained in the detailed description of the figures, each pair of DNA matched Users will have place-holder MRCA-Vdna nodes which represent the shared Ancestor (known or unknown) between them. One primary objective is to map those MRCA nodes to Ancestor nodes in a Virtual Family Tree for each User, such that an Ancestor found in two family trees is found to be sufficiently similar, and sufficiently conforms to all constraints. So, if a User has 5000 DNA cousins, there will initially be 5000 MRCA nodes representing the common Ancestors between him/her and the DNA cousins. In the process of running the holistic system, the system will attempt to match the MRCA nodes with one node each from the pedigrees of DNA matched cousins. Usually this is done pair-wise, but may be done as a set, wherein all of the members of the set (a cluster) share the same DNA segment. This is the general idea and does not represent an exact implementation. Many of the MRCA nodes will merge with other MRCA nodes, as the concerned ancestors are found to be the same. Every time an MRCA is found and confirmed through triangulations, the Ancestor and the direct-line paths to the Users (if meeting a criteria of quality in terms of confidences), are added to the VWT, along with all collateral lines which are of sufficient quality to warrant sharing. In this manner, the MRCA inferences of all Users are shared. Likewise, the MRCA Ancestor nodes of each User are updated with information indicating the number of such triangulations discovered. This same information is likewise added to the nodes in the VWT for global sharing.

There are several algorithms (presented in the Figures) involved in the discovery and assignment of MRCA-Vdna nodes to Ancestor nodes in the VFT of DNA matched Users. These assignments are made such that they satisfy constraints, and are optimal in the local and/or global sense. Recall that, each User may have 1000's of DNA matches, while most of those DNA Matche's MRCA's will map to just about 500 Ancestors. Thus, for every Ancestor a User has in that set, he or she may have 10 or 20 (for example) DNA cousins who triangulate to that Ancestor. If every User has the same situation, what we have is similar to a very large set of simultaneous linear equations and variables, wherein the number of equations is much larger than the number of variables. The variables in this analogy equate to the assignment of MRCA's to Ancestor nodes. The ‘equation’ would equate to the set of Ancestors a User has in her tree. In linear algebra, such a system of equations could be solved by Gauss-Jordan Elimination. But, this is not, of course, a system of linear equations, and even if it could be modeled as such, the computational complexity is at least O(n³). [53] This is an optimization problem, where there are several hierarchies of optimization.

There is the global optimality, similar to the analogy of simultaneous equations, wherein the assignment of MRCA-Vdna nodes to Ancestors in all User's VFT's will be optimal, in terms of several factors included 1) the cumulative measure of equivalence of the Ancestors chosen to be MRCAs, 2) The satisfaction of constraints across all such assignments and their satisfaction rates on the VFTs, 3) the resulting quality and completeness of the VFT's involved. One measure of optimality is a multi-part function of the confidence in the DNA matches being ‘Inherited By Descent’ (IBD) and the accumulated confidence in the veracity of data associated to ancestors in the lineage from the DNA participants to the MRCAs through the graphs (ancestry trees).

Various methods are necessary to extract, manage and process the clues, including a form of competitive artificial neural network modeling of ancestor's relations based on probability weightings and various forms of inference, data-mining of DNA matches across a population of DNA contributors to facilitate discovery of most-recent common ancestors, and employment of network modeling and data mining to populate lightweight virtual trees, and creation of virtual genomes of ancestors as their descendants are discovered and adding these genomes to the match discovery system, and utilization of world constraints such as provided by a temporal-spatial ‘closest point of a approach’ system to facilitate determination of which pairs of ancestors of two genetically matched Users theoretically could have physically recombined their DNA (mated), and World-model development around each Virtual ancestor, to represent their times (conflicts), citizenships (borders), values (eg religions), travel, restrictions, connections etc.

Central to the above holistic system, is the concept of a distributed Competitive Neural Network (CNN), which is equivalently referred to as a ‘competitive network’ throughout. To find which nodes in different trees are most similar, the concept of phase-space attraction is employed, by growing a large set of nodes connecting between Ancestors nodes, or between themselves, wherein each grown node represents some attribute or property which is either attractive or repelling the two (or more) nodes. For example, two Ancestors who share the same Surname will both connect to a node with that Surname as its attribute data. This node, furthermore, will have many Ancestors connect to it, and thus forms the center of a cluster. The confidence of the association between the Ancestor and the attribute node is captured in a connection weight. The connection weight modulates the amount of activation passing from one node to another, as in traditional artificial neural networks. Agents, in one embodiment, mediate the activation from one node to the next, and carry with them a packet of information describing the activation being sent. This packet enables complex functionality, such as tracing the path of the packet, differentiating packets at a receptor node, and applying constraint algorithms to packets in transit.

Regular Numerical Methods may be Used to Simulate the CNN (Sub-System 4900), given a large enough computer system. However, the preferred embodiment will entail execution on a distributed compute system, which may either be a farm of networked computer hosts, or may involve a global network of hosts, and which may include the computers of the Users themselves. The latter is preferred, as the number of computers should thus grow linearly with the number of Users. Assuming that each new User has one the order of 2000-5000 DNA cousins, the new User's machine will need to generate attribute nodes for each DNA cousin match, will need to run the several algorithms, and will need to update the User's Virtual Family Tree with the results. However, the order of processing the DNA matches begins from the closest relatives first and those matches who have the best quality family trees. The User will in short order, begin to see results on the nearest relatives in his/her VFT, and will be able to visual and analyze the results. It is unlikely that the User will outpace the computer in analyzing results, but in any case, the User will have various tools (mentioned in the Figures) to assist the system in enriching the Ancestor shared attributes data, and choosing what matches to analyze, or what complex cluster analysis to run.

In one of the embodiments of the analysis system, called the ‘ Global DNA Cluster

Generation and Analysis with Competitive Networks’ (sub-system 5000), there are two modes of activation propagation: Burst and Evolutionary. Burst mode relies on one burst of activations being sent out and then settling (decaying), until the winners are left. Evolutionary mode is more of a frequency analysis, in which an average of a rate of activation received is used to determine dominance. Exactly what is dominant, depends on the intent of the nodes and the type of calculation, but usually, the calculation will be to find pairs of nodes from two VFT's of two DNA matched Users, such that they are co-activated through the MRCA-Vdna nodes, and have been supported by attributes, constraints analysis of their trees, and have conformed to constraints set by DNA. This is a simplistic description meant to give the figures discussions structure and context.

Each of the embodiments of the invention can encompass various recitations made herein. It is, therefore, anticipated that each of the recitations of the invention involving any one element or combinations of elements can, optionally, be included in each aspect of the invention.

### BRIEF DESCRIPTION OF THE ILLUSTRATIONS

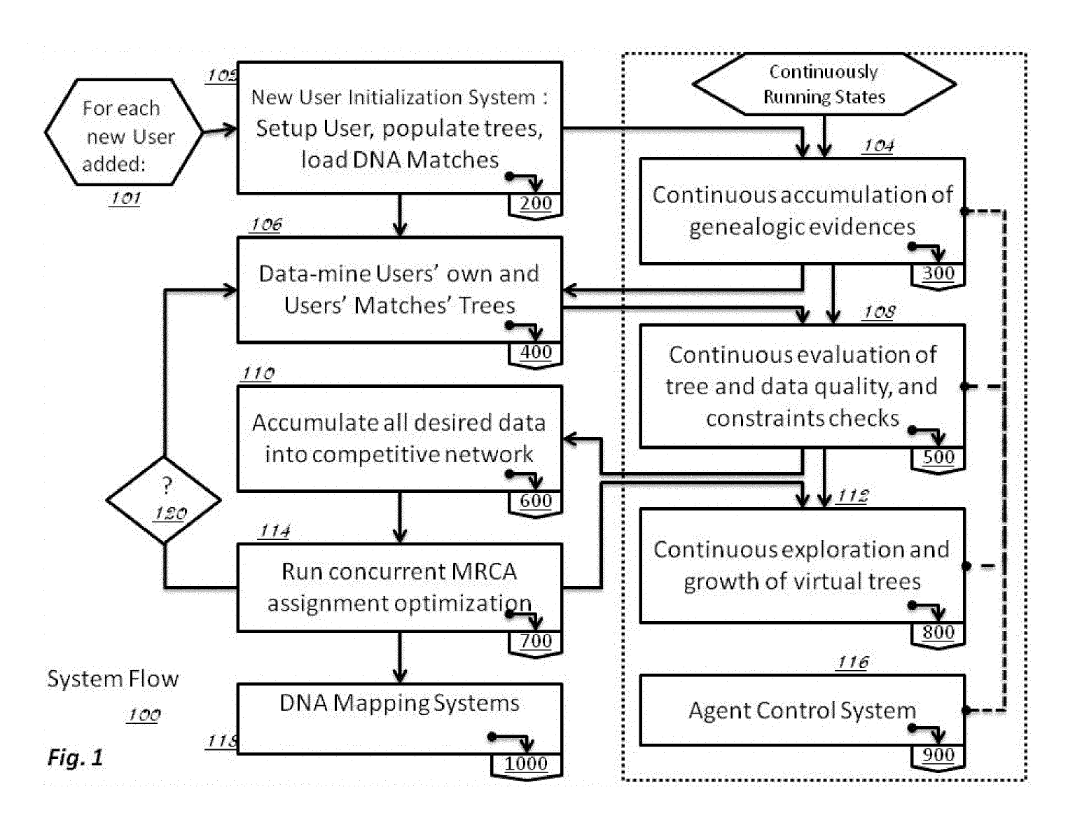

FIG. 1 is a flowchart illustrating the relationships of the sub-systems in one embodiment.

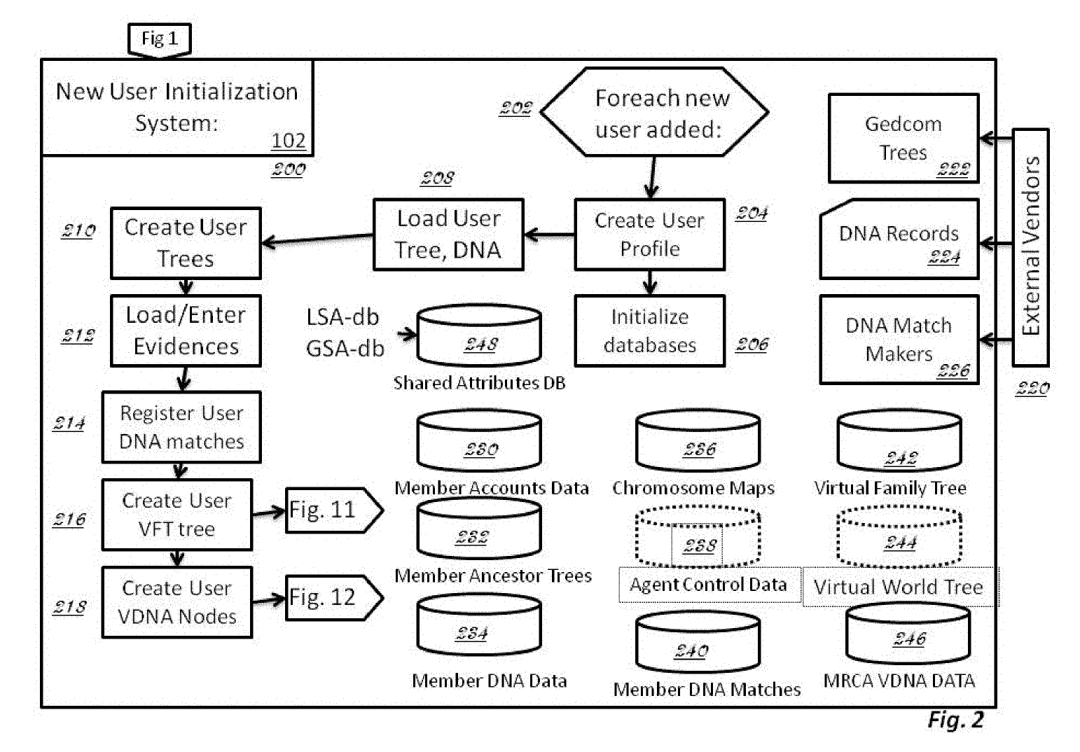

FIG. 2 is a flowchart of the ‘new user’ initialization and related databases involved in one embodiment

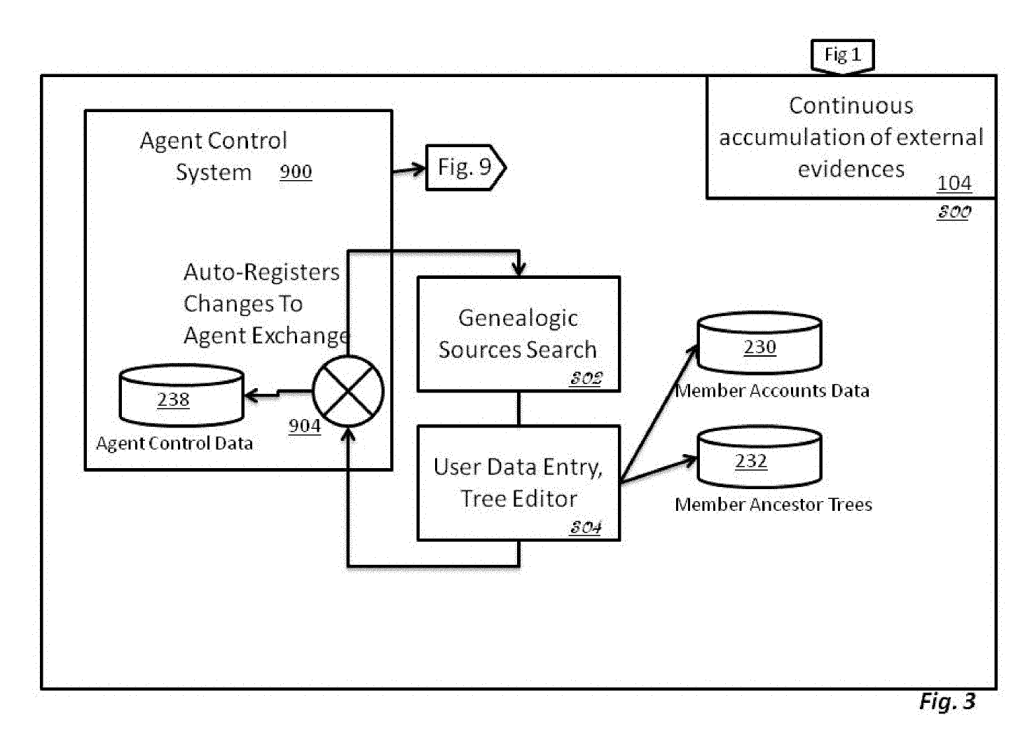

FIG. 3 is a flowchart of the interaction between genealogic data input and the Agent Exchange triggers, in one embodiment.

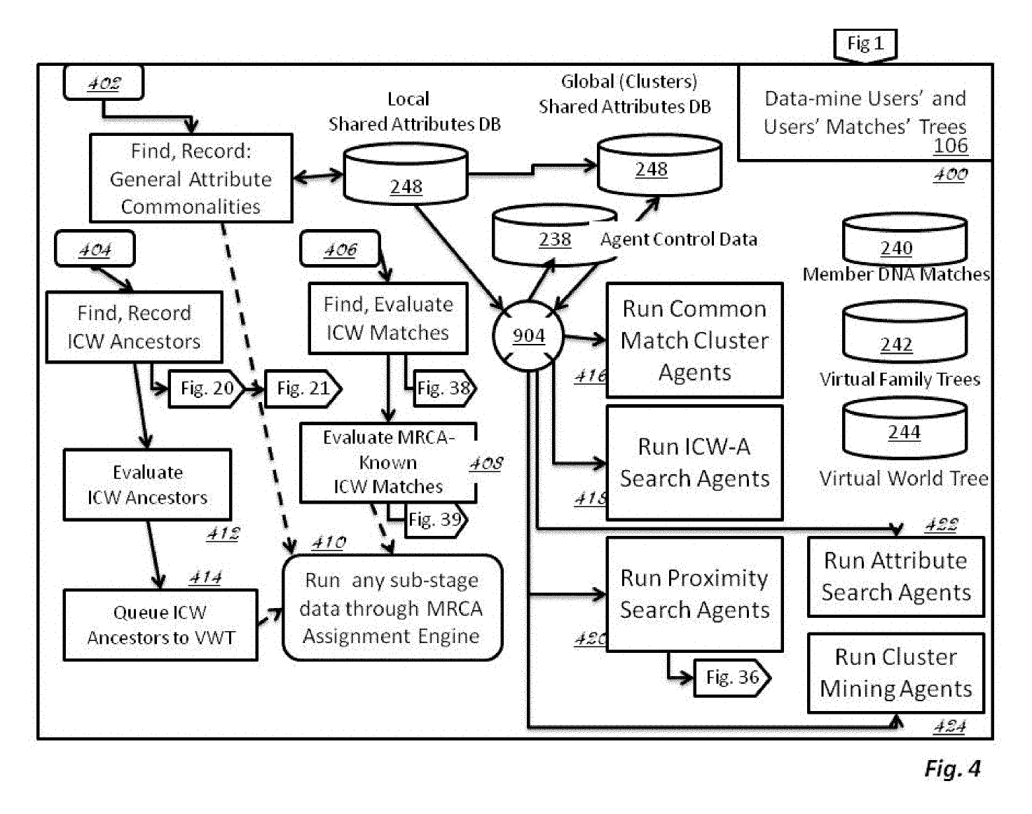

FIG. 4 is a flowchart of several of the data-mining sub-systems, and their related data exchanges, in one embodiment

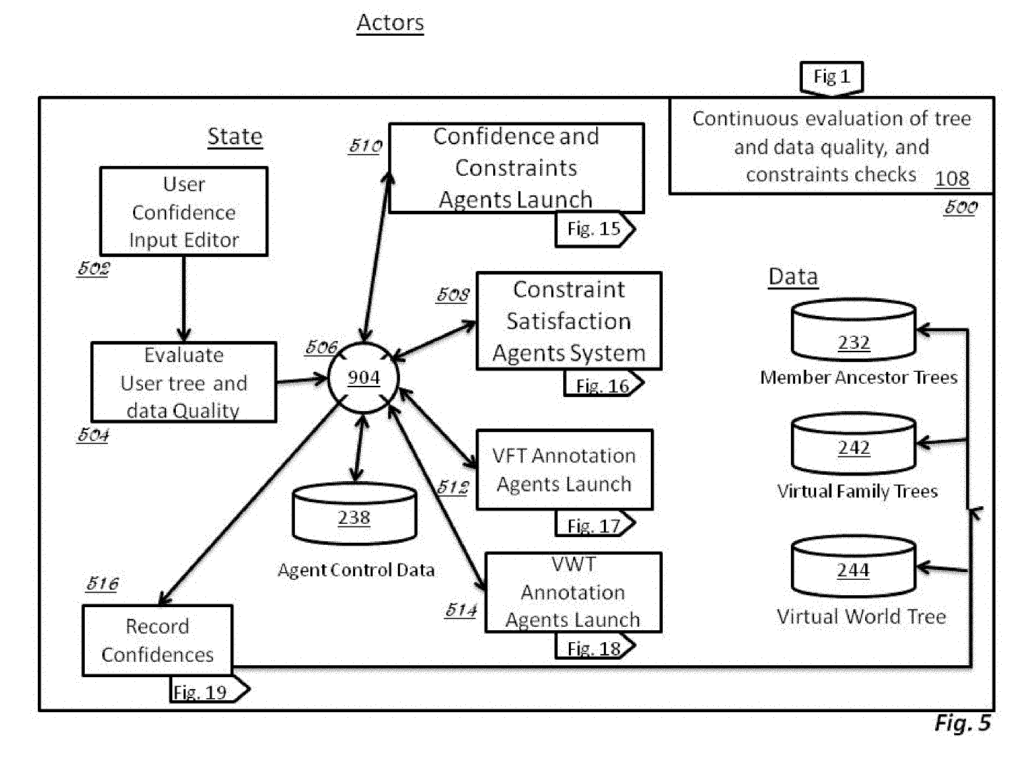

FIG. 5 is a flowchart of the trees data quality evaluation and annotation sub-system, in one embodiment

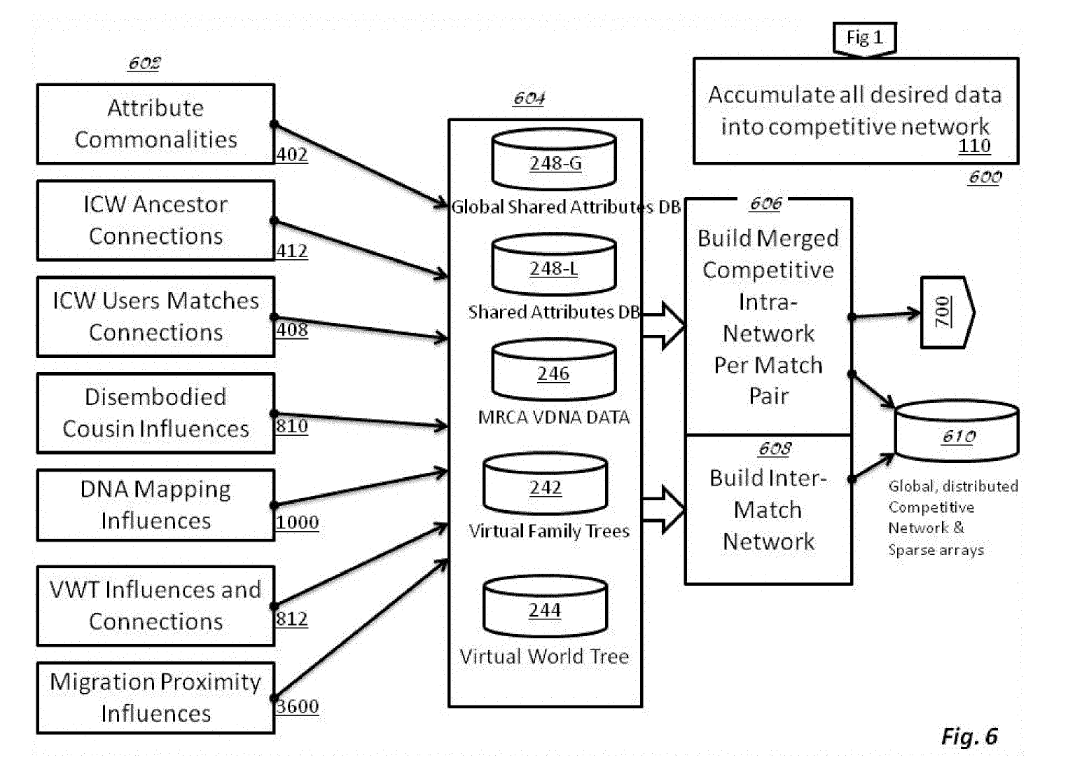

FIG. 6 is a flowchart of the collection of data for preparation for MRCA analysis, in one embodiment

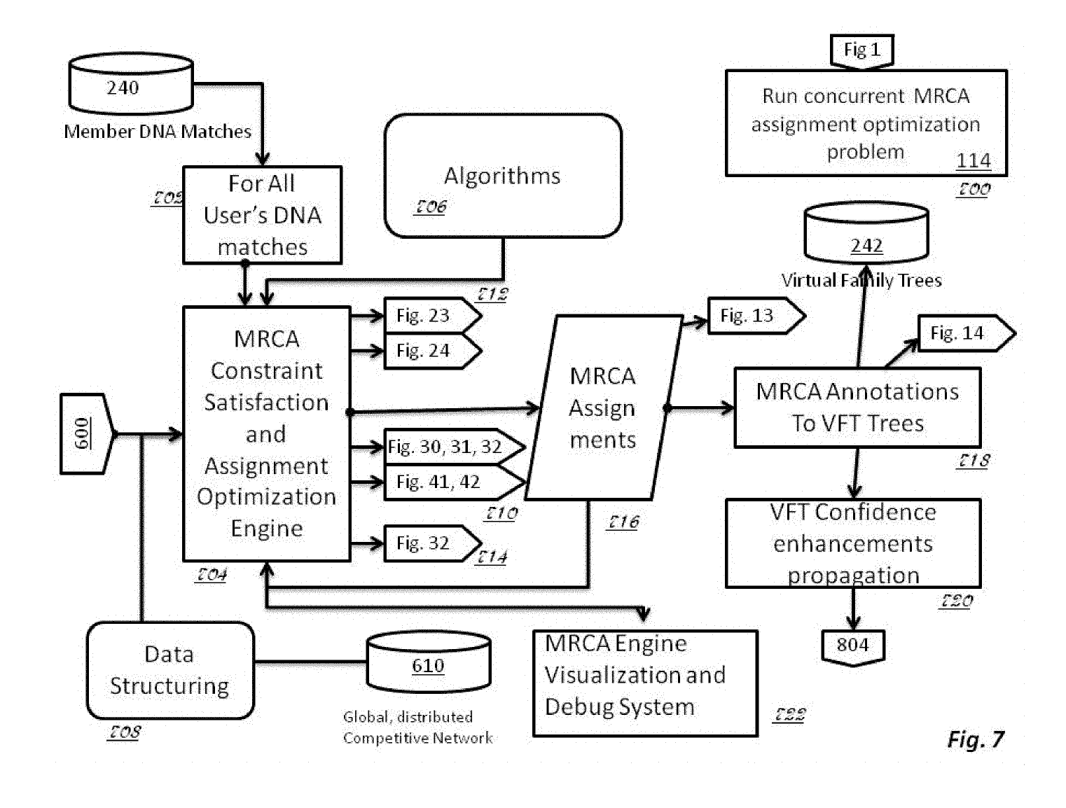

FIG. 7 is a flowchart of the MRCA assignment and optimization sub-system, in one embodiment

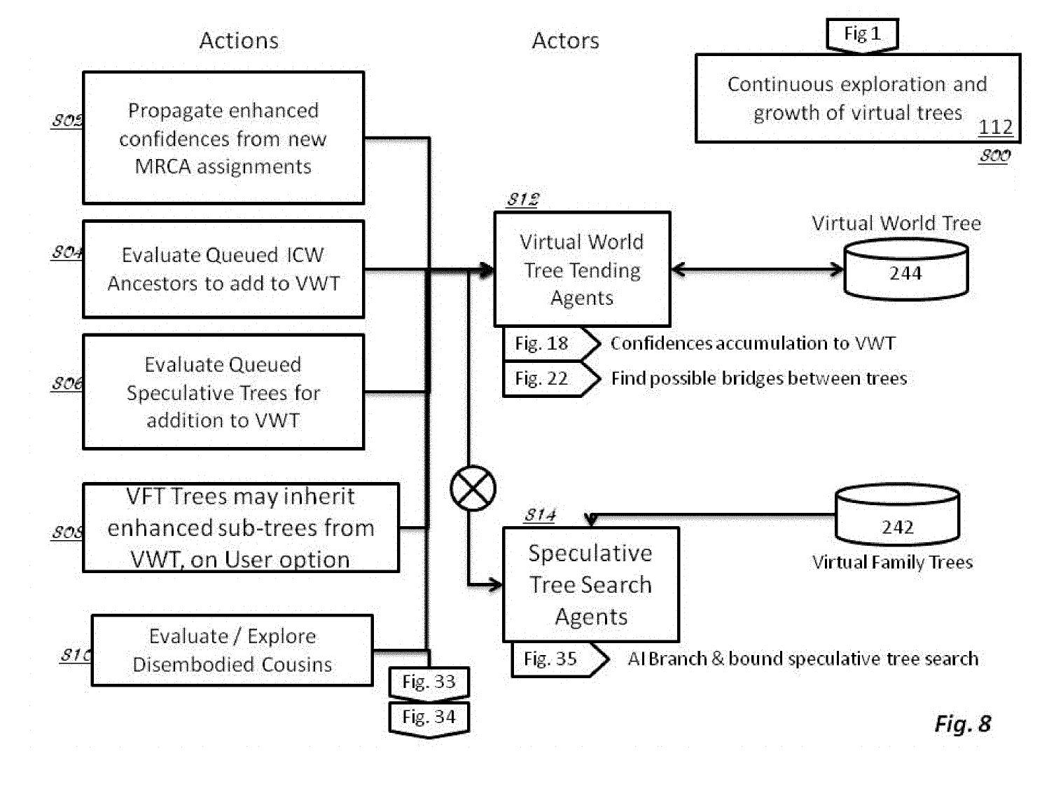

FIG. 8 is a flowchart of the continuous exploration and Virtual World Tree growth, in one embodiment.

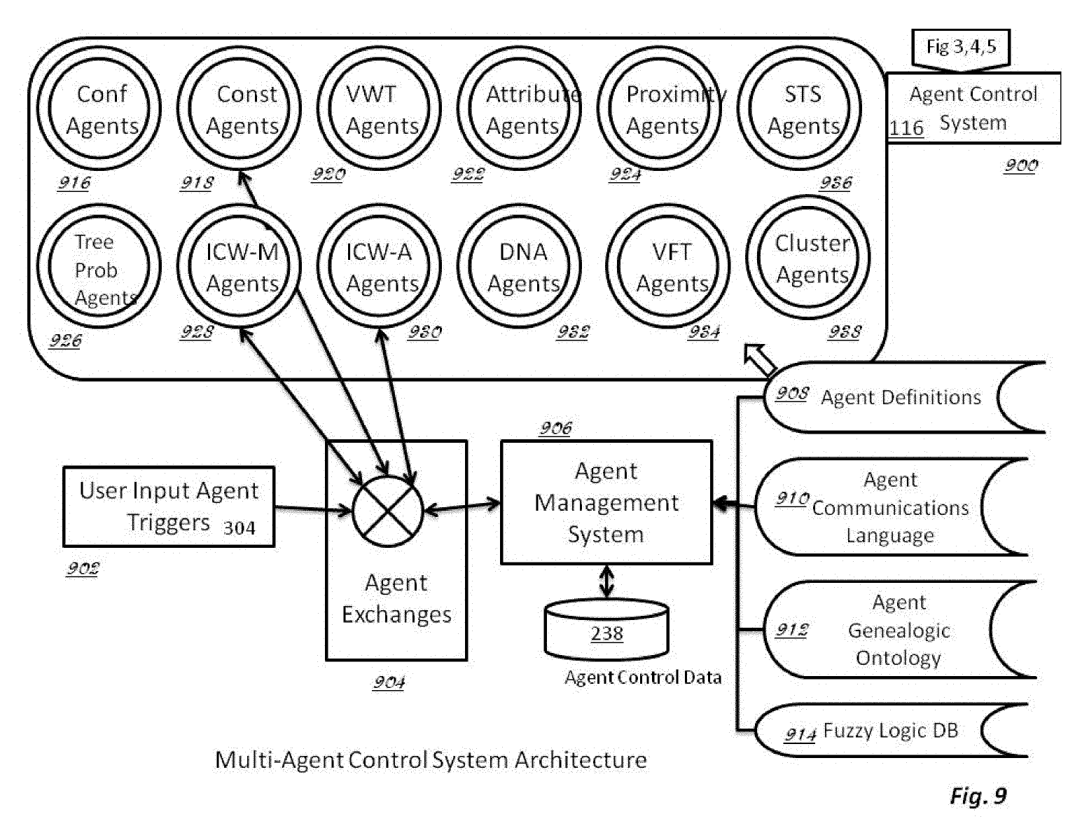

FIG. 9 is an illustration of the Multi-Agent Control System Architecture, in one embodiment.

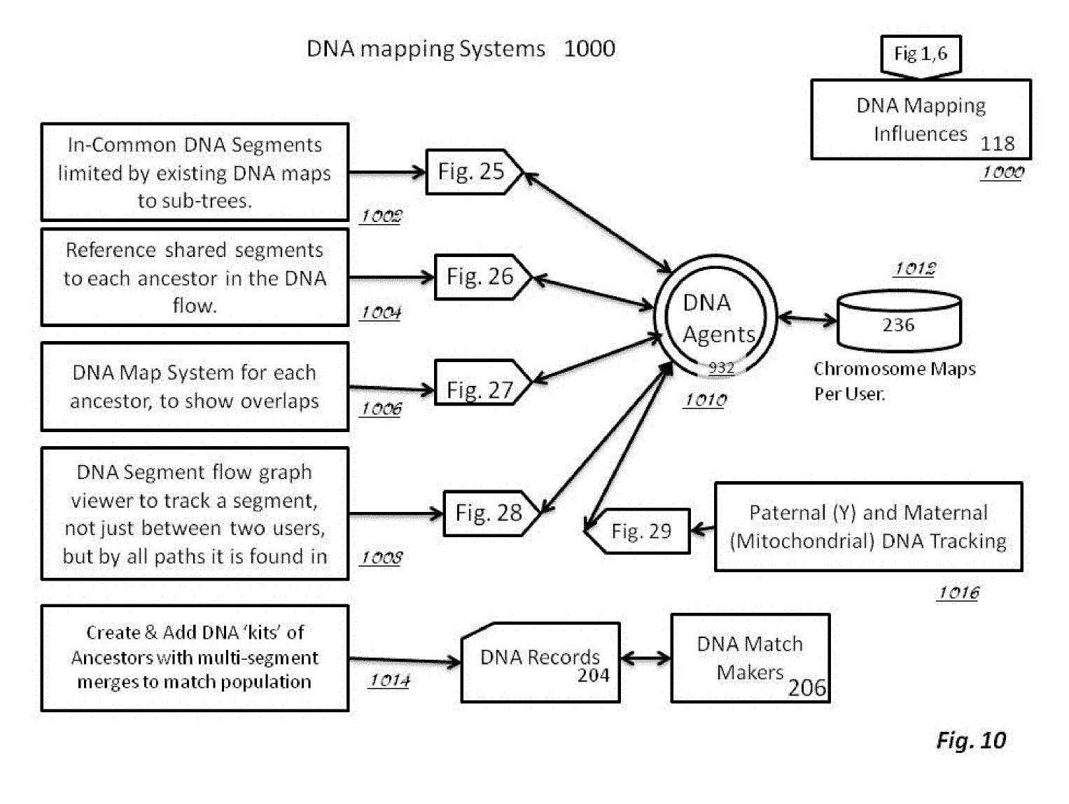

FIG. 10 is an flowchart of the analysis and accumulation of various DNA Mapping Influences, in one embodiment.

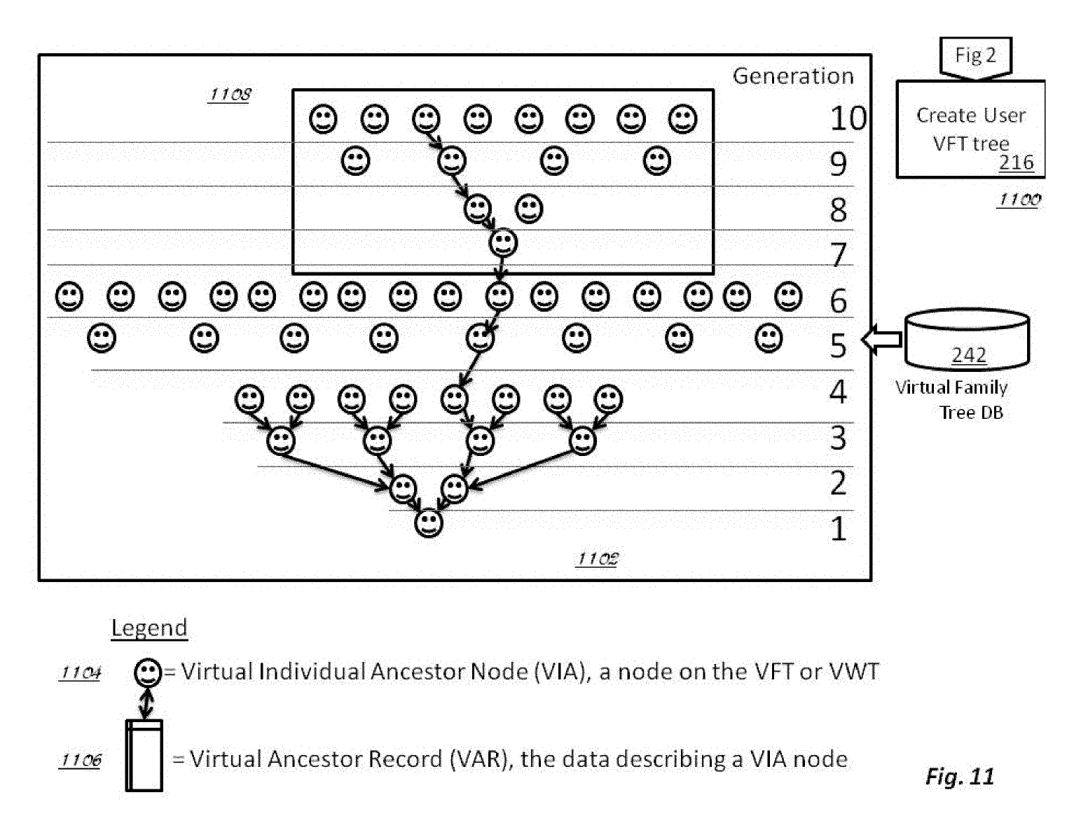

FIG. 11 is an illustration of the structure of a Virtual Family Tree, and its Virtual Individual Ancestor node's.

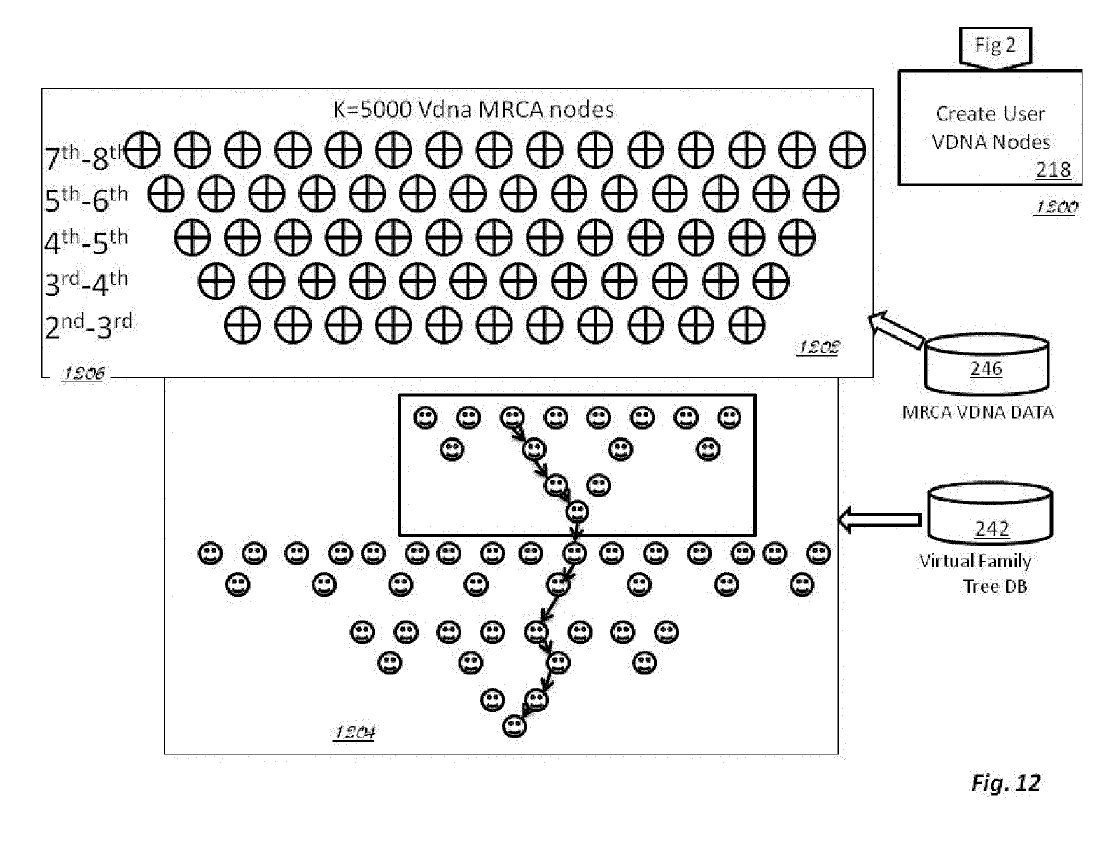

FIG. 12 is an illustration one embodiment of the VFT with a User's set of VDNA nodes, with implicit connections from each VDNA to each eligible VIA node.

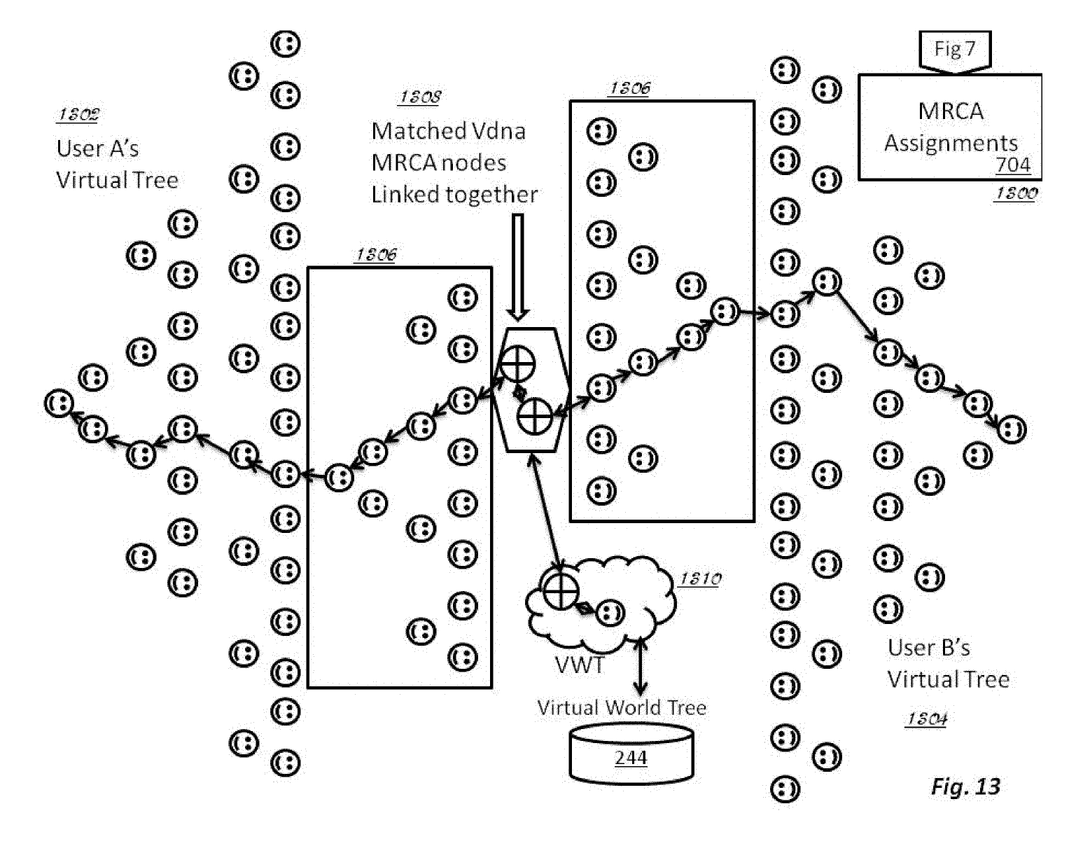

FIG. 13 is an illustration of two DNA matched User's, with a chosen VDNA, and a path through the VFT's to the User, in one embodiment.

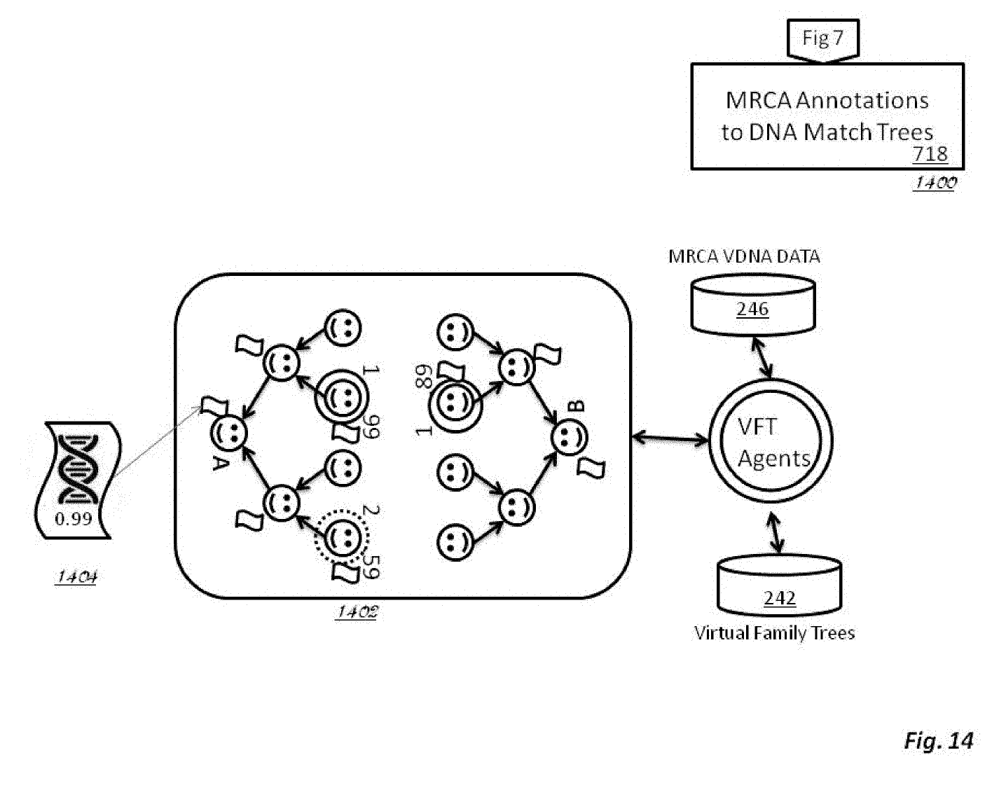

FIG. 14 is an illustration of the post-MRCA assignment information annotation to the affected Virtual Family Trees, in one embodiment.

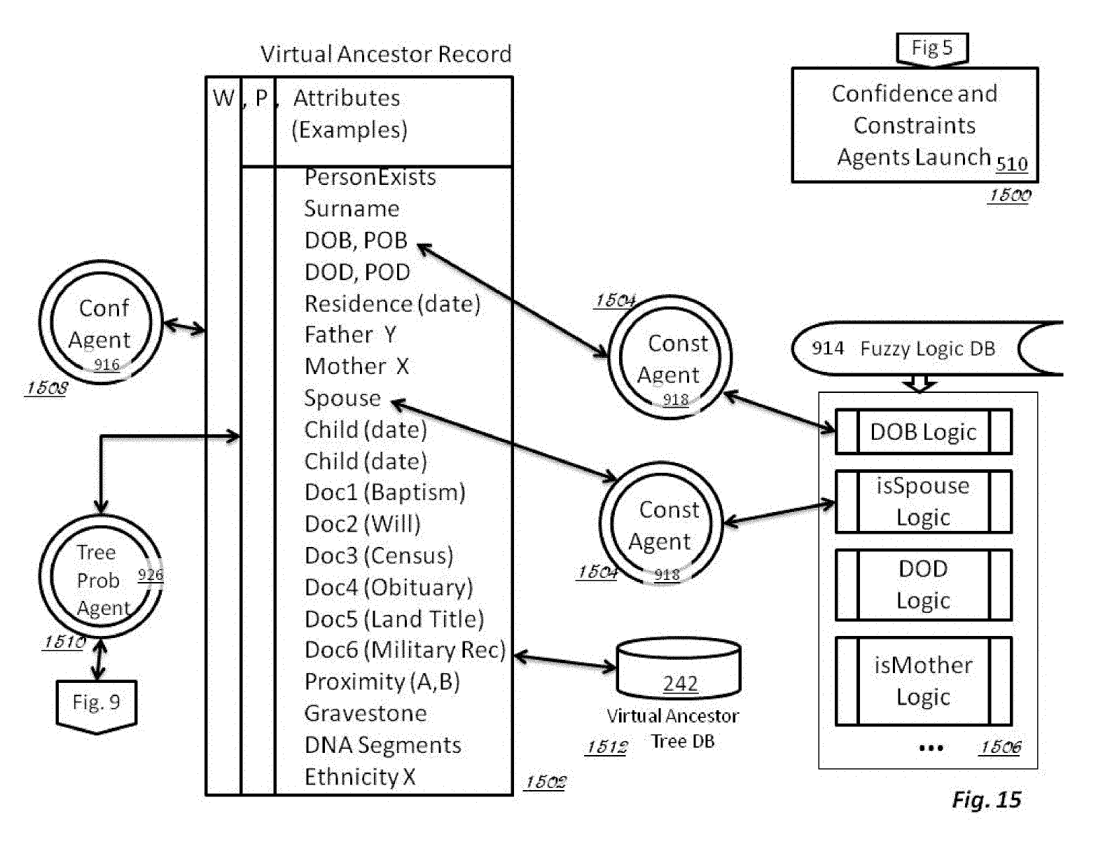

FIG. 15 is an illustration of the Virtual Ancestor Record, and several Agents interactions with it and the Fuzzy Logic DB, in one embodiment.

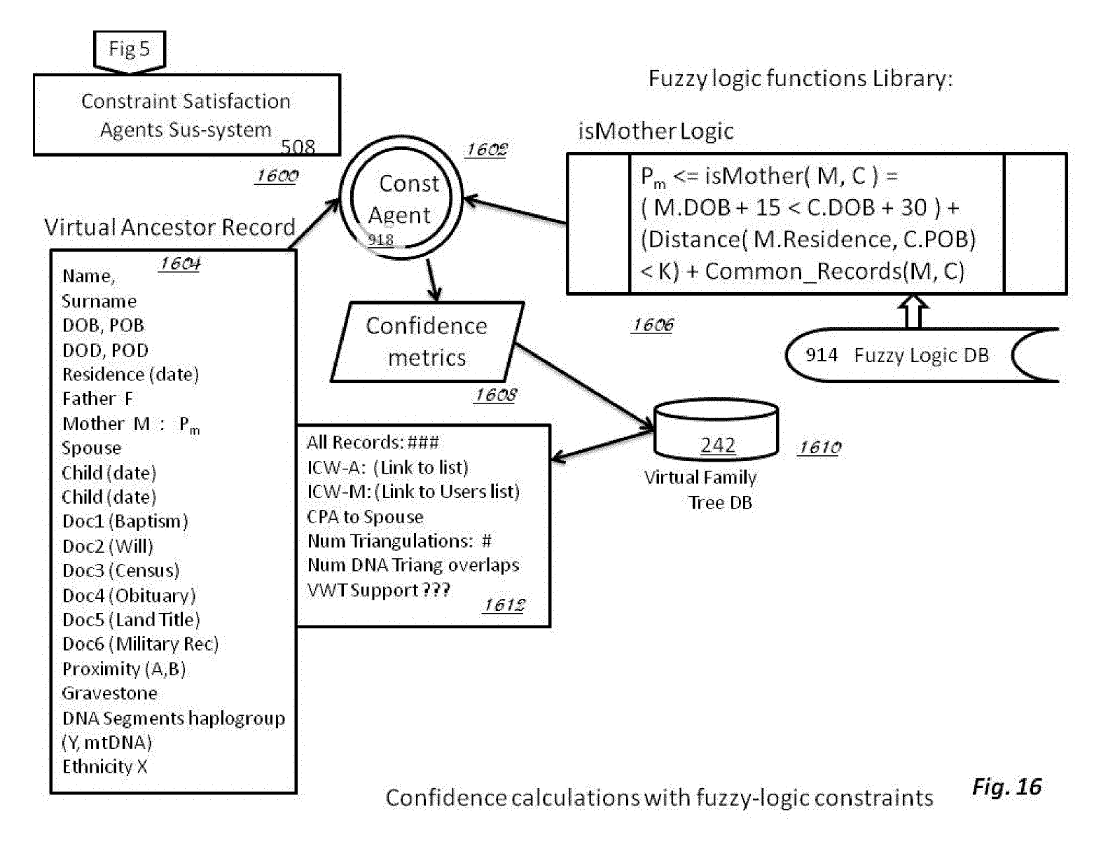

FIG. 16 is an illustration and flowchart of an Constraint Satisfaction Agent's interaction with the Virtual Ancestor Records and Fuzzy Logic DB, in one embodiment.

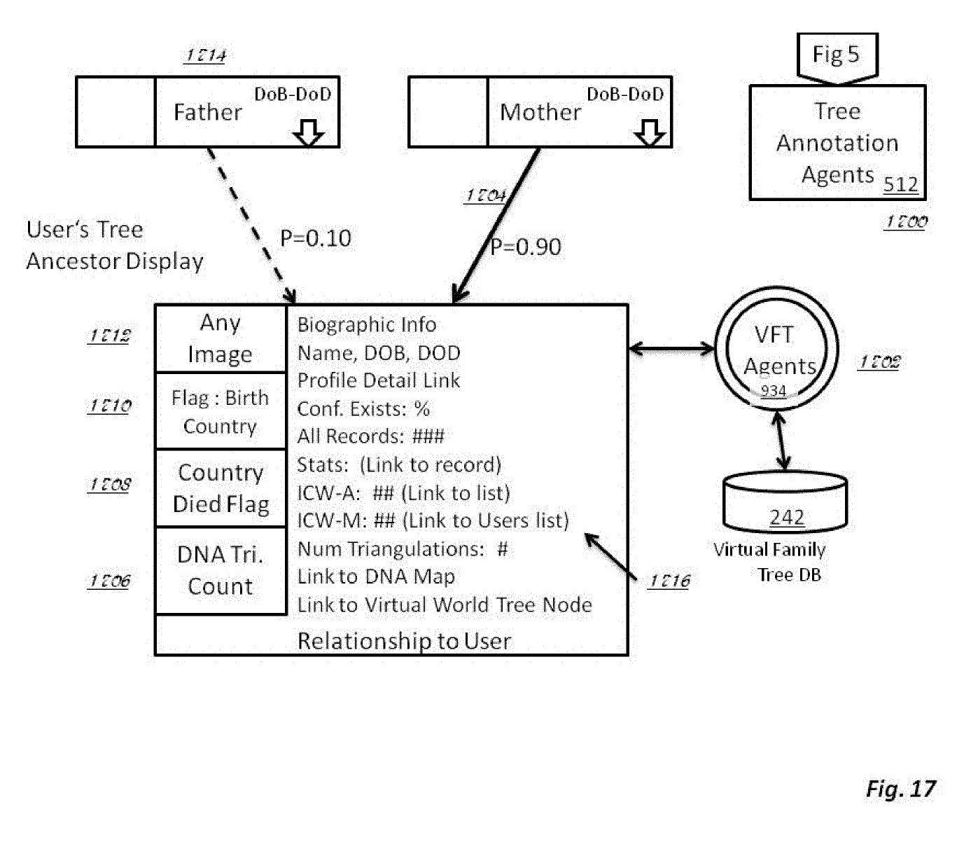

FIG. 17 is an illustration of the information display of one node from a Virtual Family Tree, in one embodiment.

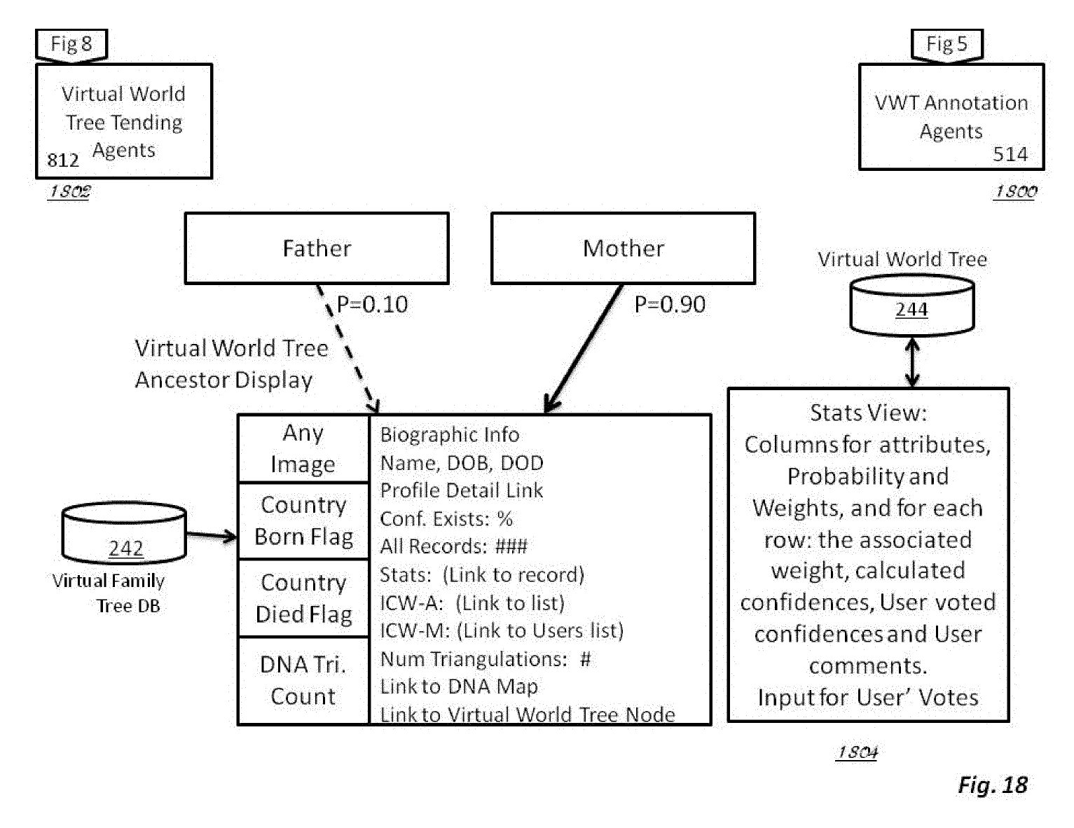

FIG. 18 is an illustration of the ‘Statistics View’ elements as related to a Virtual Family Tree node, in one embodiment.

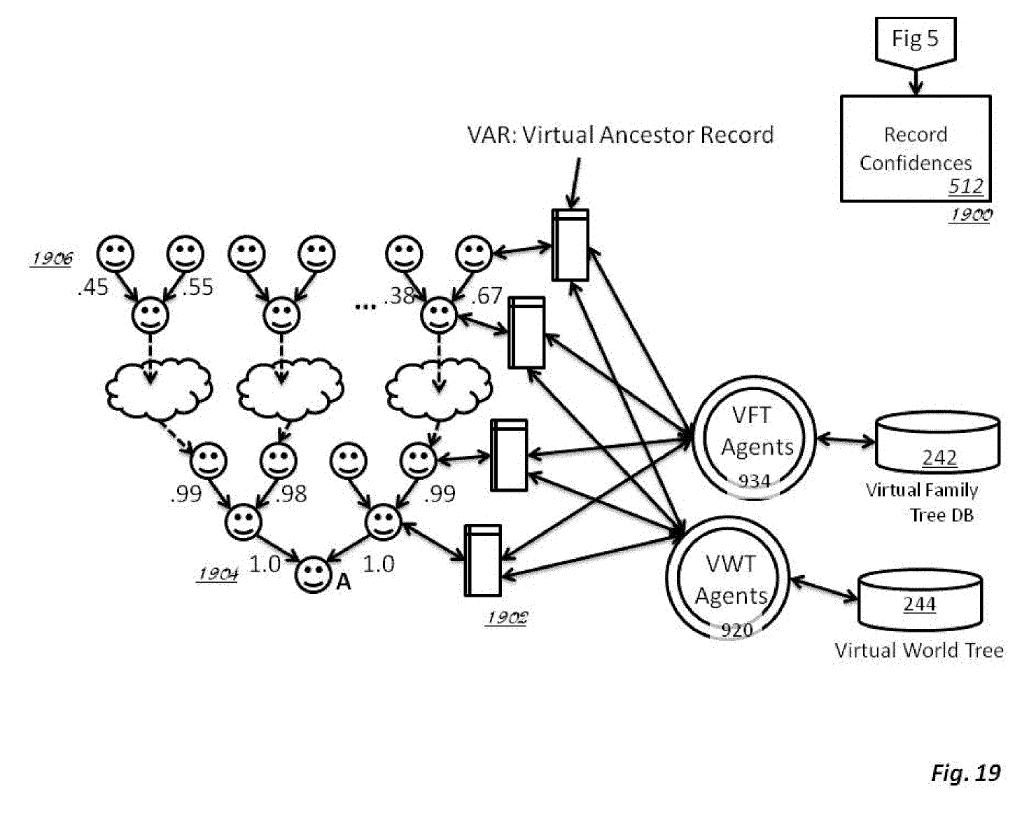

FIG. 19 is an illustration of the relationship of confidences (decreasing) going up a branch of the VFT, in a form of Bayesian Belief Network. in one embodiment.

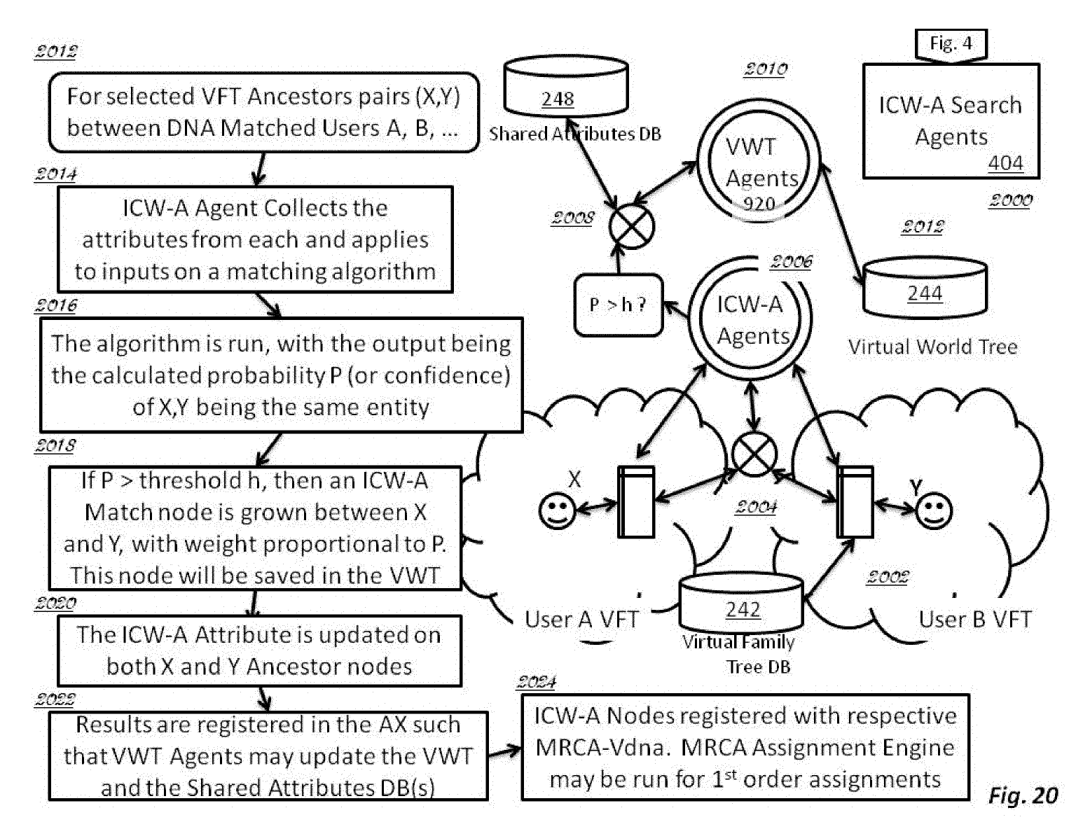

FIG. 20 is a flowchart and illustration of the operation of In-Common-With Ancestor discovery and integration, in one embodiment.

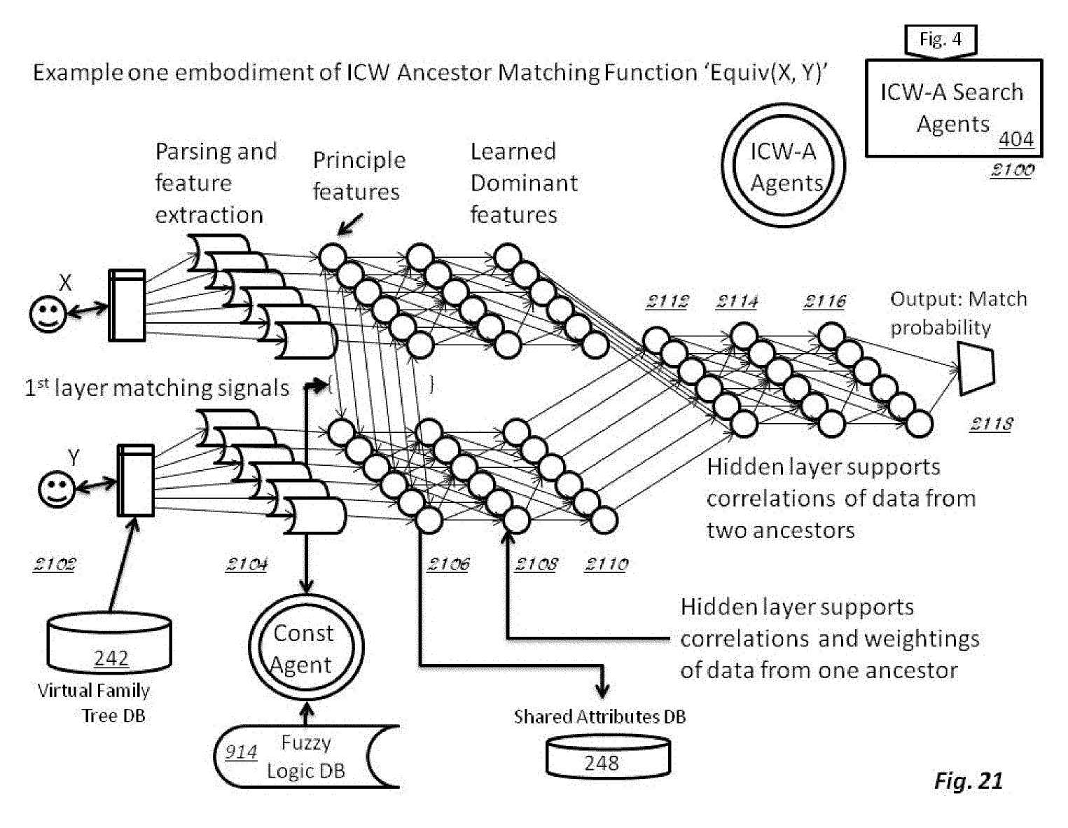

FIG. 21 is an illustration of a feed-forward Neural Network for In-Common-With Ancestor discovery via pattern matching, in one embodiment of the matching AI algorithms.

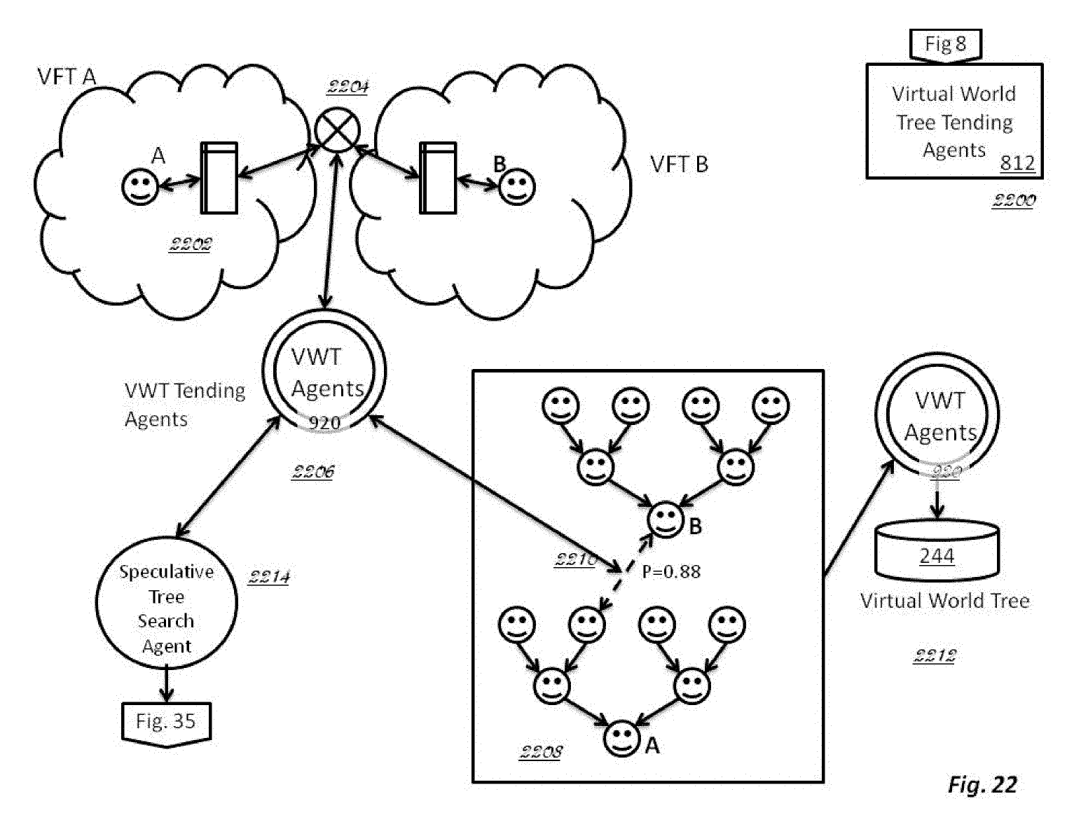

FIG. 22 is an illustration of a ‘Virtual World Tree’ Tending Agent harvesting commonalities between two trees to grow the VWT, in one embodiment.

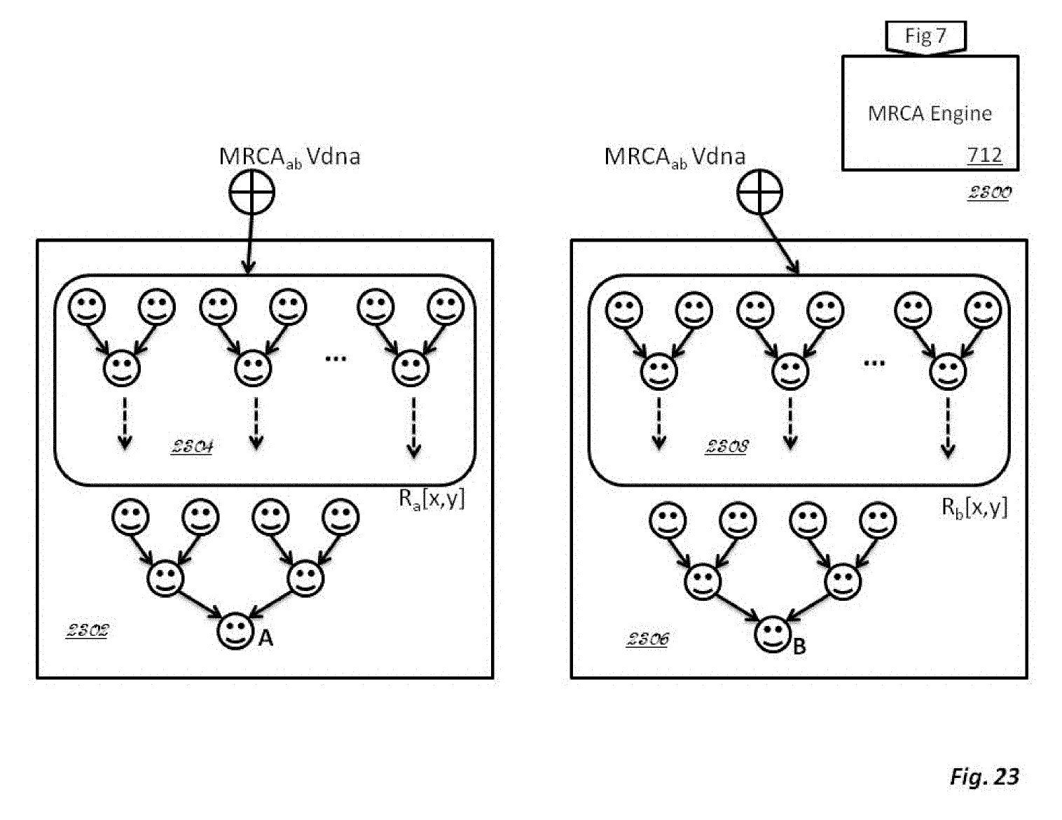

FIG. 23 is an illustration of initial MRCA-Vdna VIA candidate set assignment for one pair of DNA matched Users, in one embodiment.

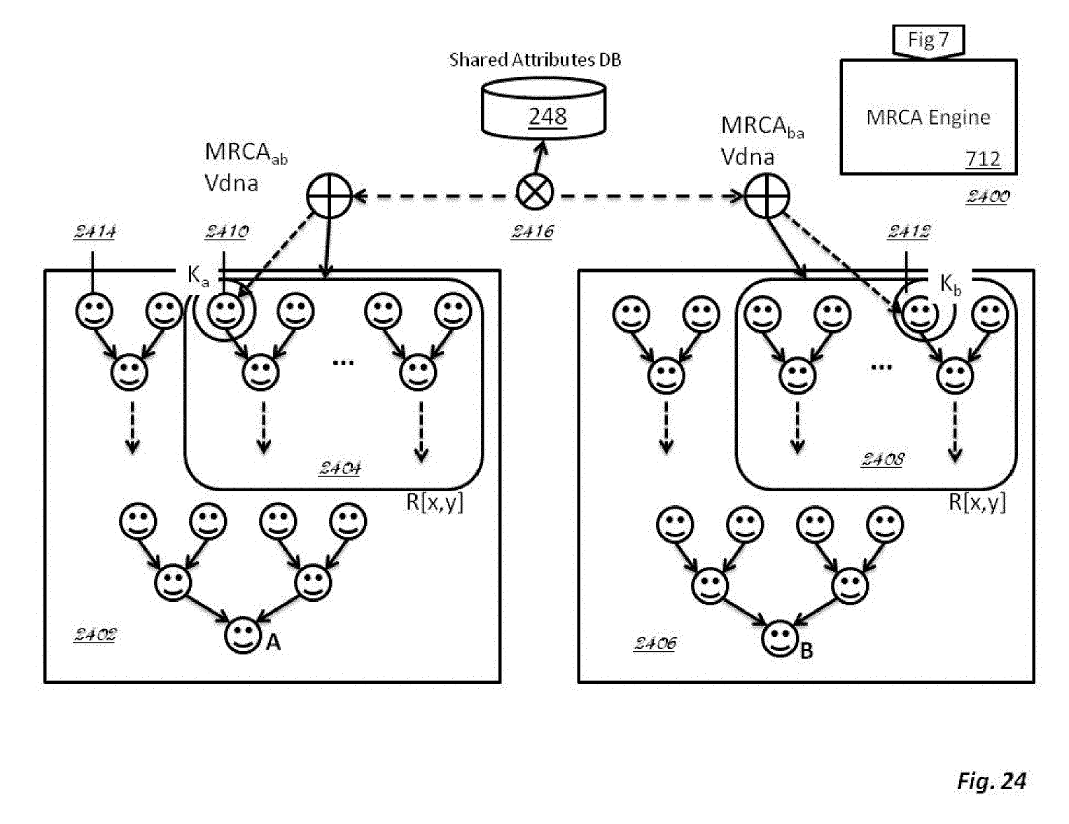

FIG. 24 is an illustration of reduced MRCA-Vdna VIA candidate set assignment for one pair of DNA matched Users, in one embodiment.

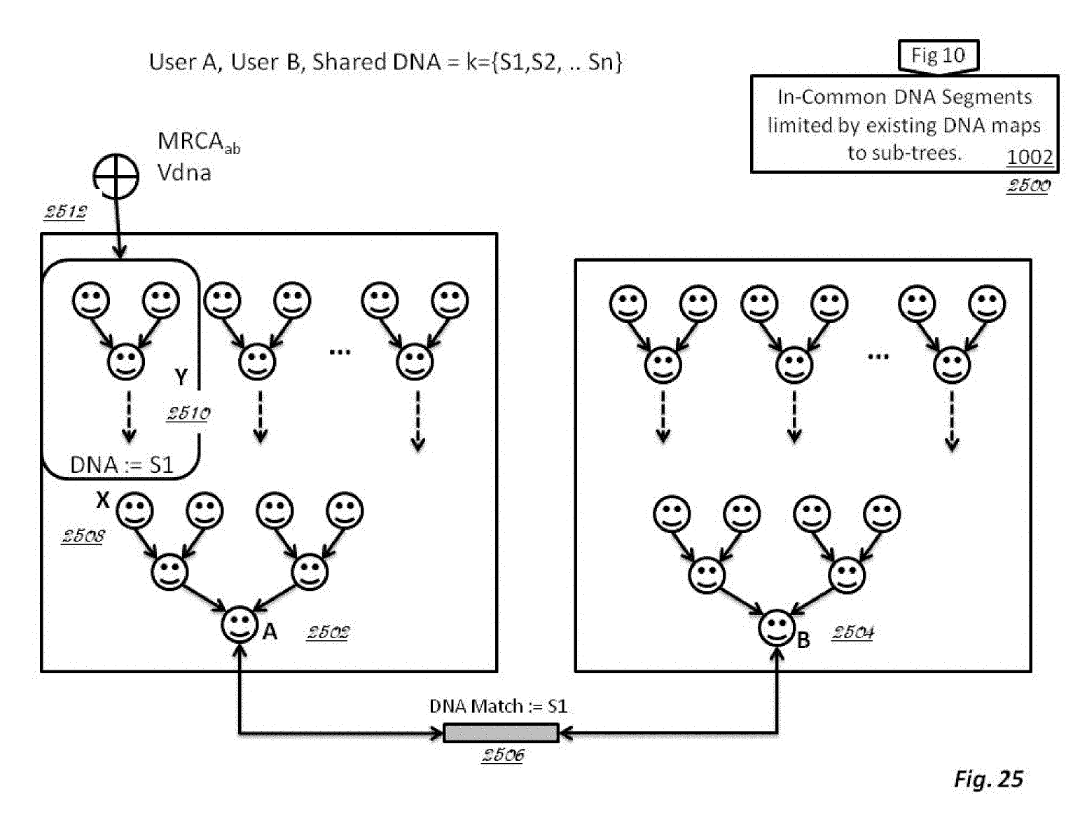

FIG. 25 is an illustration using DNA mapping to reduce the MRCA-Vdna VIA candidate set assignment for one pair of DNA matched Users, in one embodiment

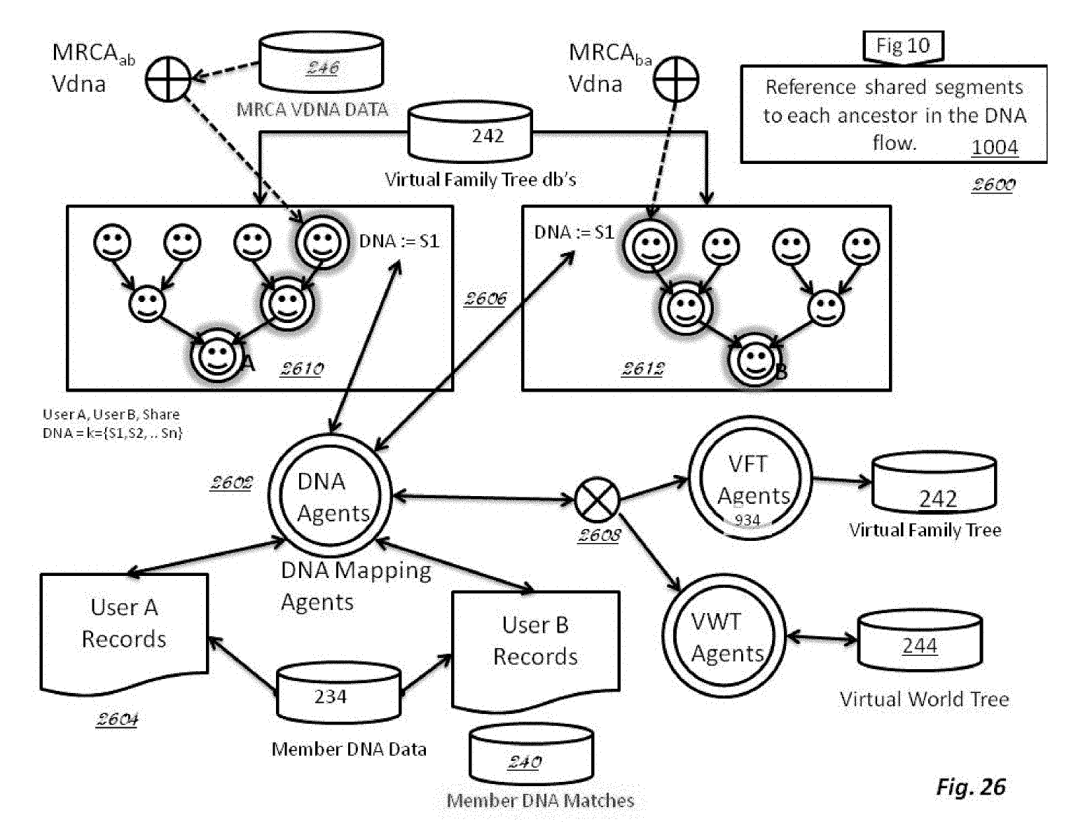

FIG. 26 is an illustration of DNA Mapping Agents assigning DNA segments to VFT VIA nodes, in one embodiment.

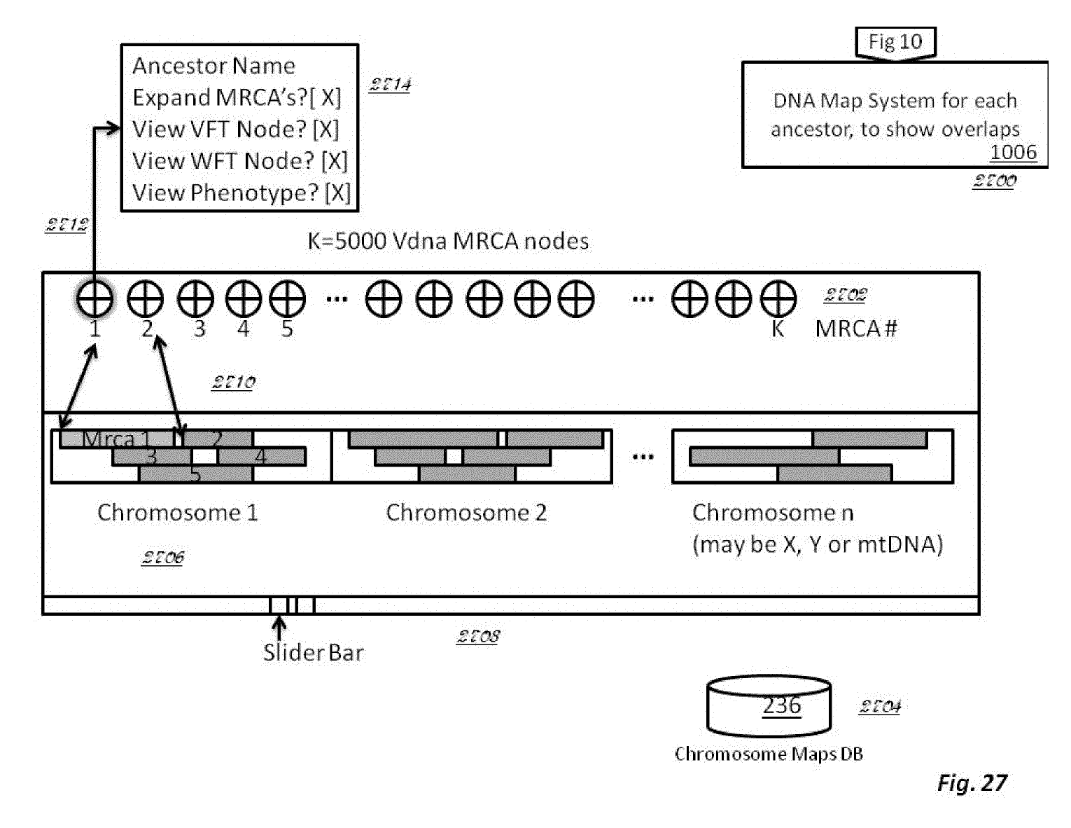

FIG. 27 is an illustration of the generation of a stacked chromosome map with links to associated MRCA-Vdna nodes, in one embodiment.

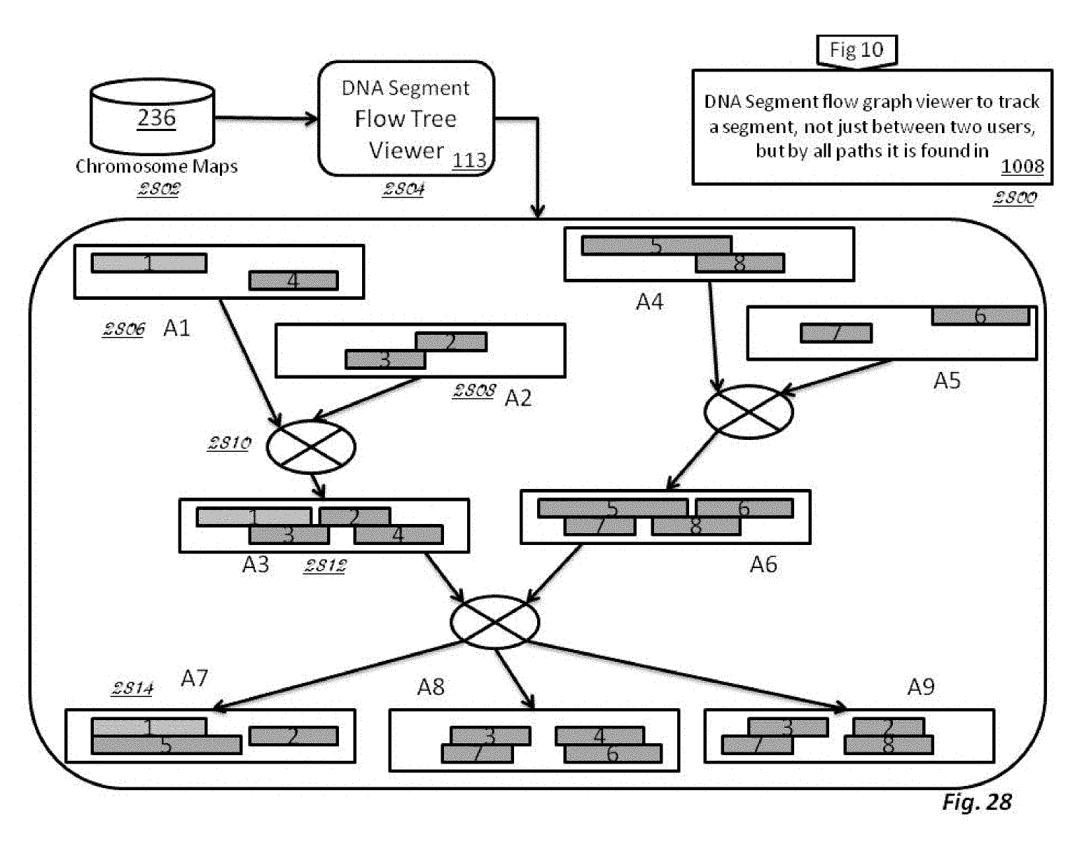

FIG. 28. is an illustration of a DNA segment flow graph viewer, in one embodiment.

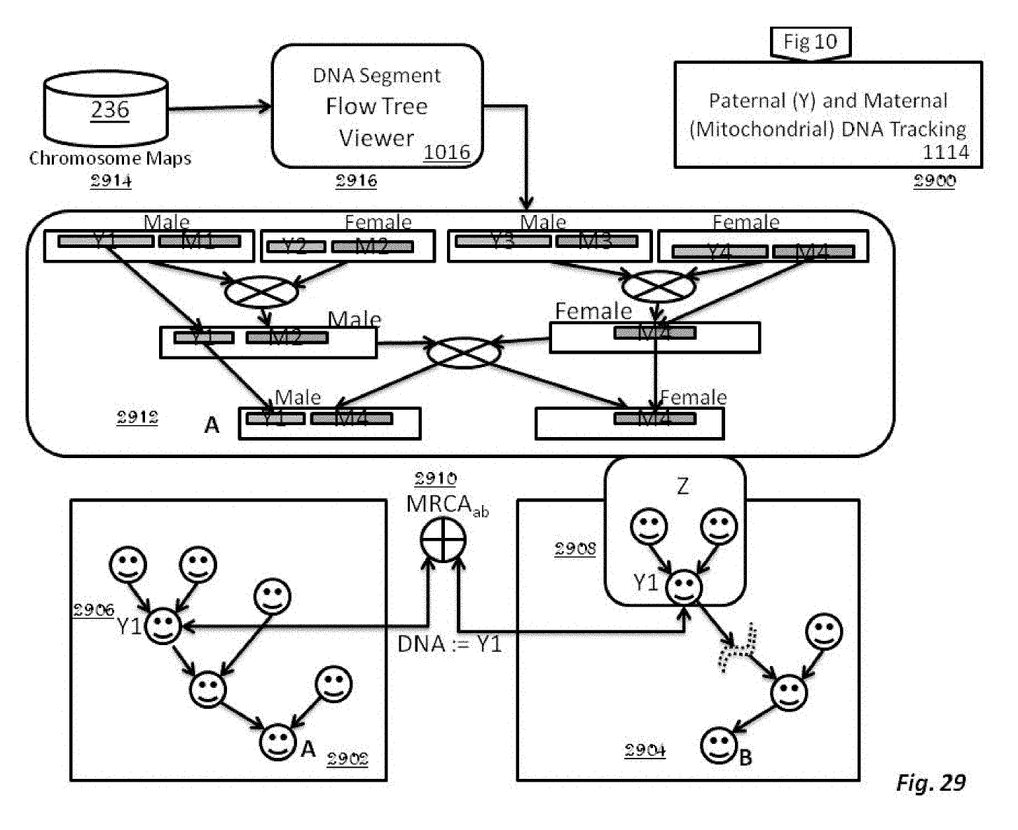

FIG. 29. is an illustration of Y and mtDNA specific MRCA-Vdna candidate set adjustment for one pair of DNA matched Users, in one embodiment.

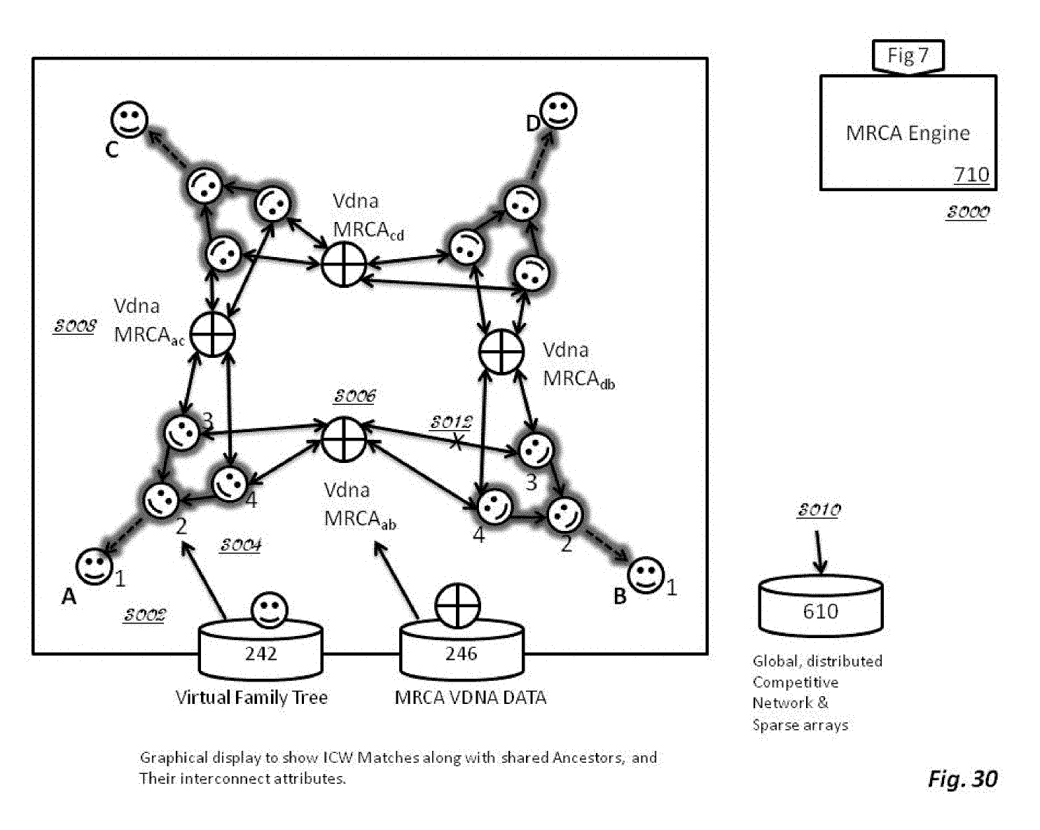

FIG. 30 is an illustration of an embodiment of the MRCA Engine' Competitive Network with Virtual DNA nodes connected to VFT nodes.

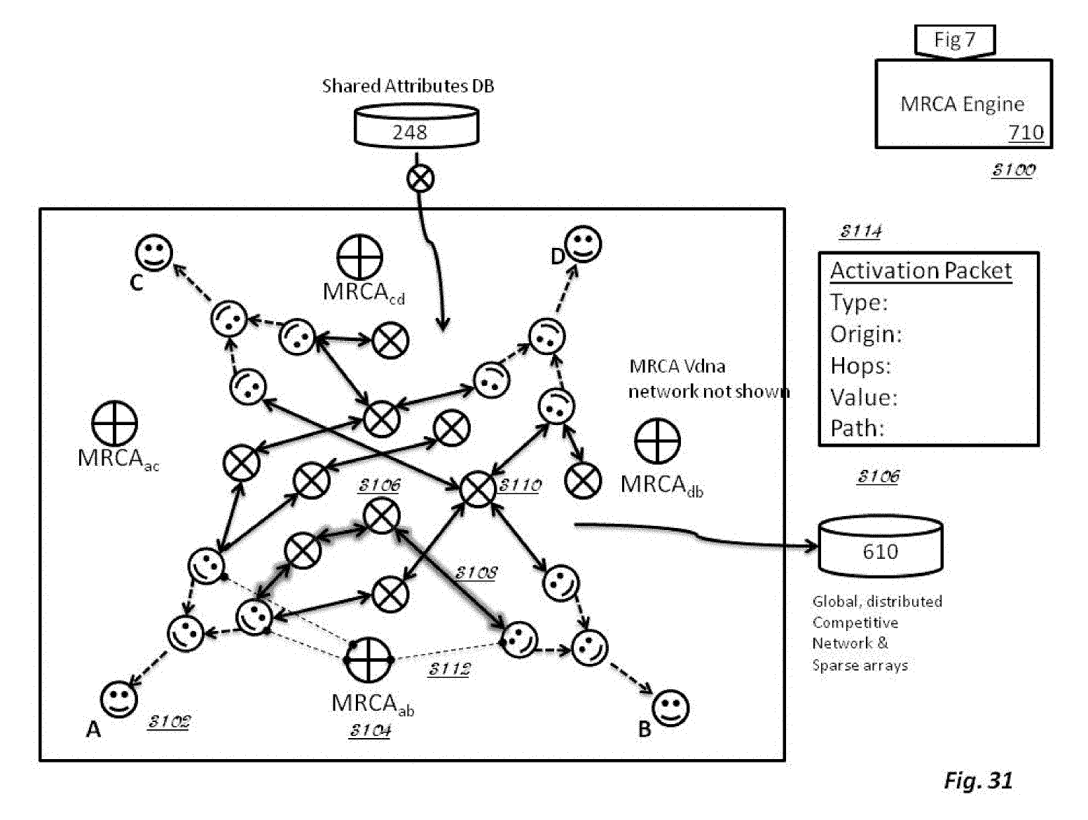

FIG. 31 is an illustration of an embodiment of the MRCA Engine' Competitive Network with Attribute nodes connected to VFT nodes.

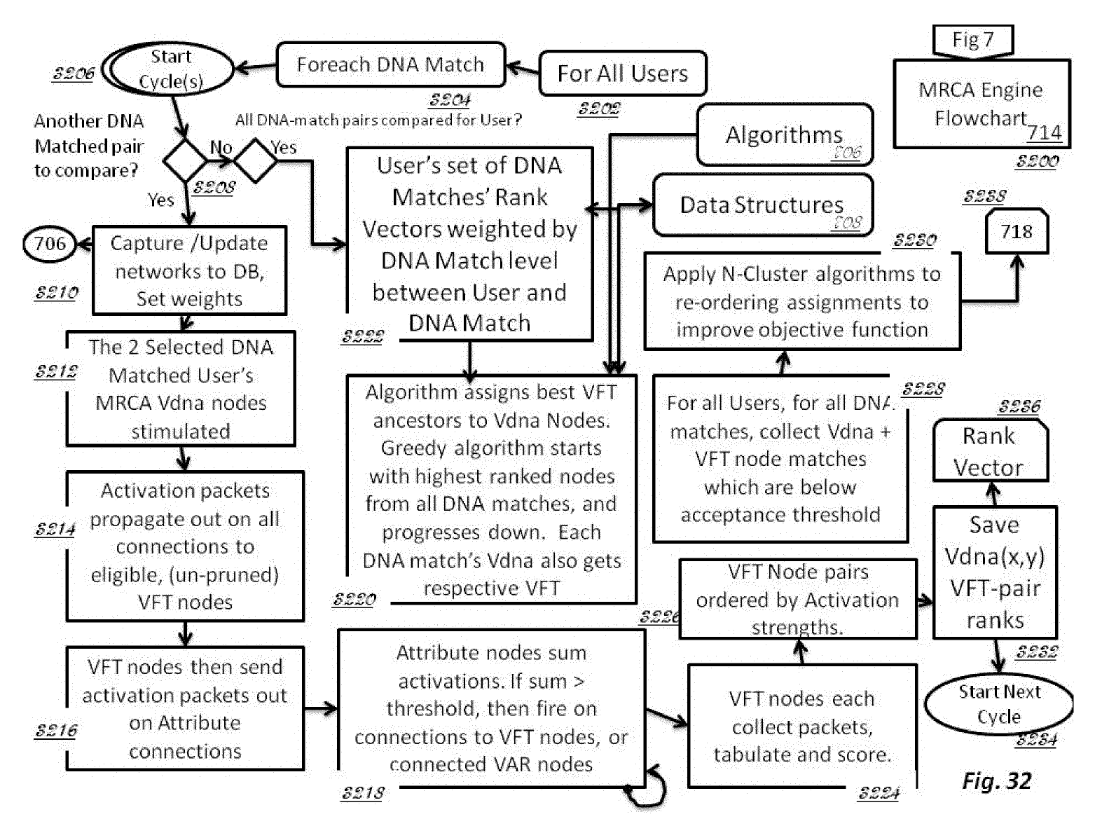

FIG. 32 is a flowchart of one embodiment of the MRCA Engine process of local and global optimization of MRCA assignments.

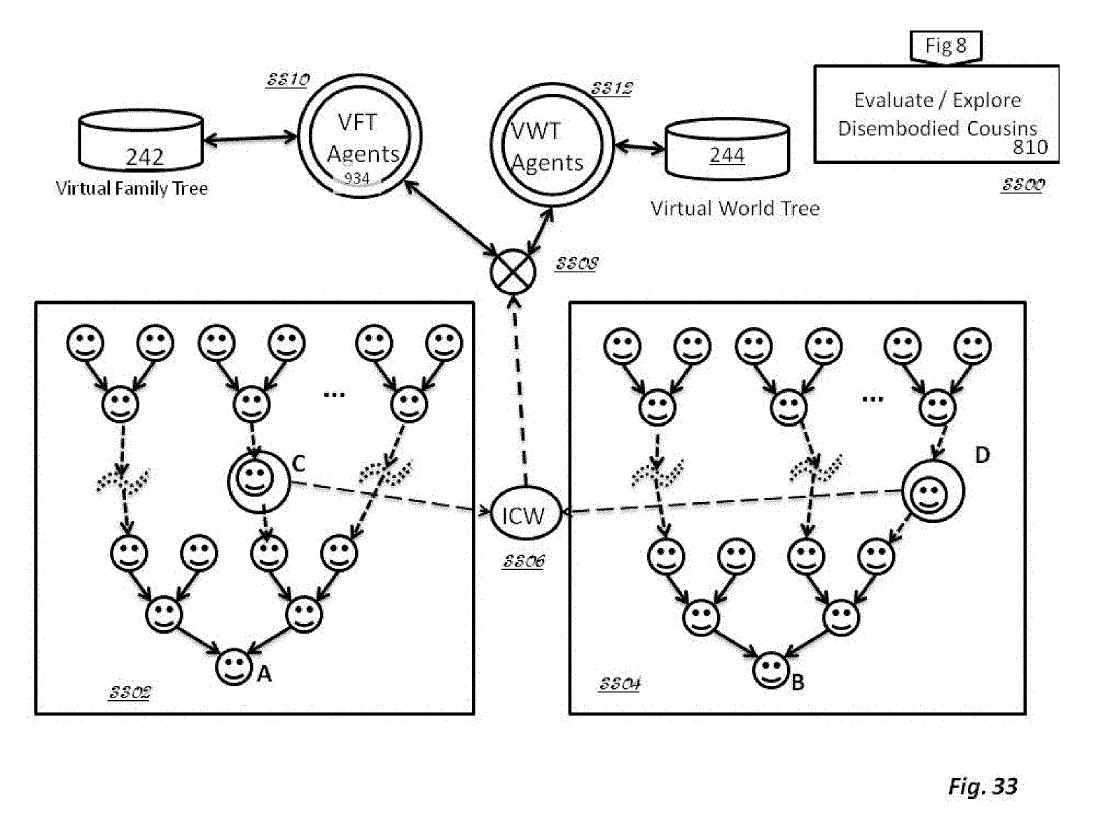

FIG. 33 is an illustration of Disembodied Cousin evidence accumulation and Triangulation, in one embodiment.

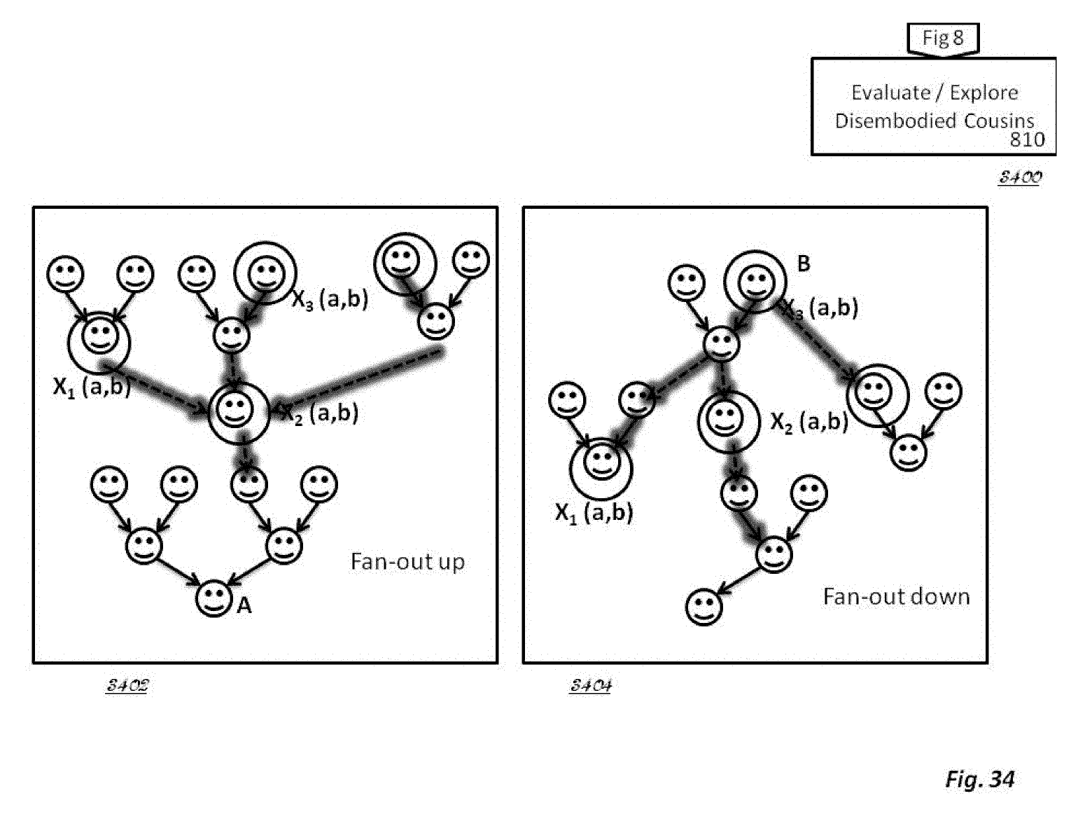

FIG. 34 is an illustration of Disembodied Cousin evidence accumulation and Triangulation, in one embodiment.

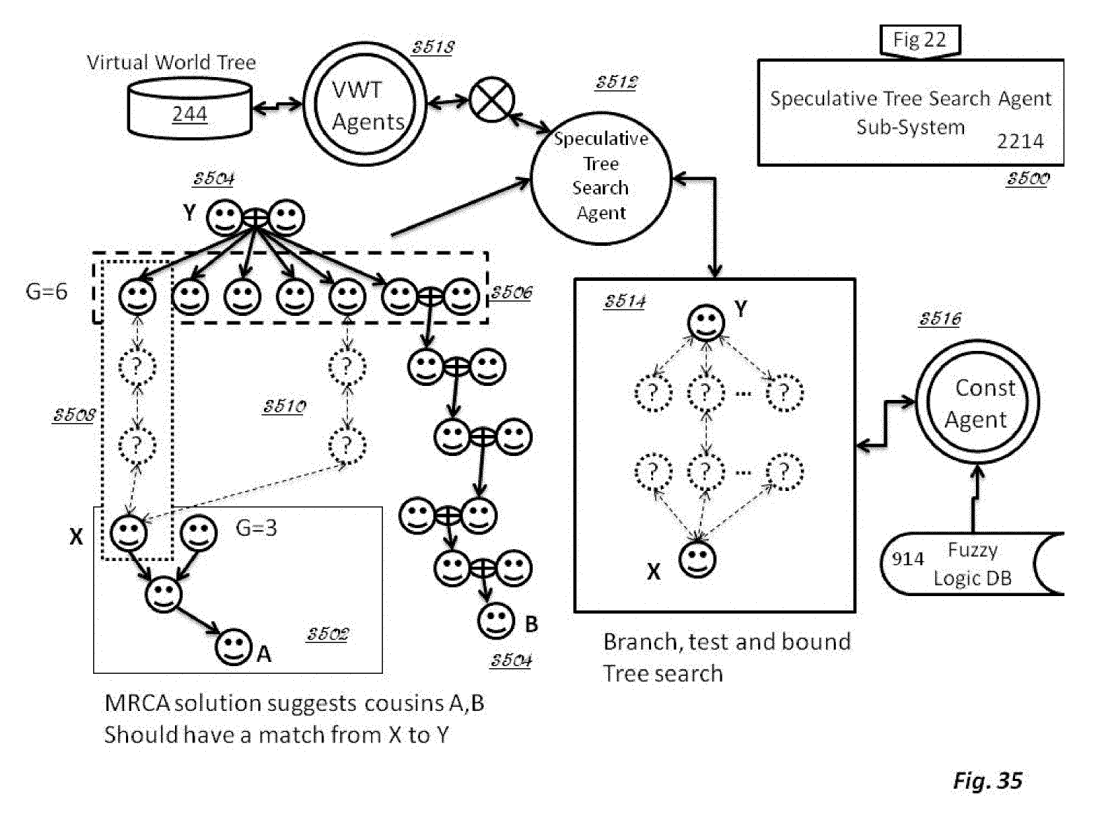

FIG. 35 is an illustration of one embodiment of Speculative Tree Search Agents attempting to connect nodes suspected to be related.

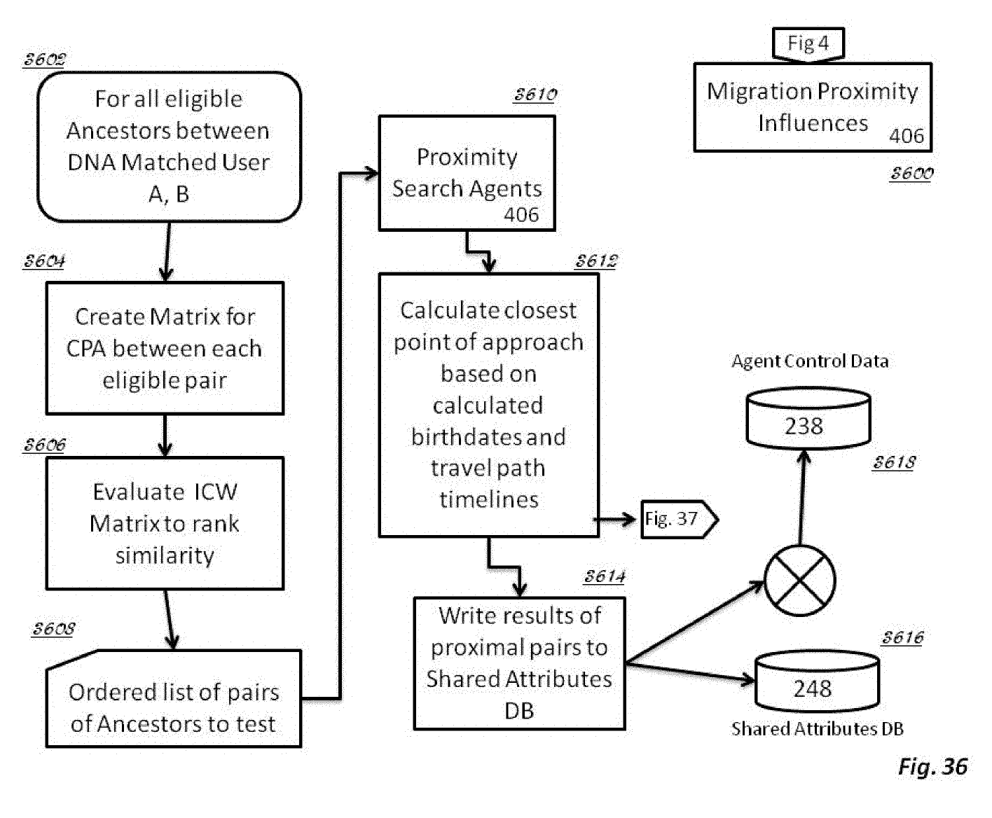

FIG. 36 is a flowchart of one embodiment of the Closest-Point-Of-Approach analysis of VFT's of DNA matched Users.

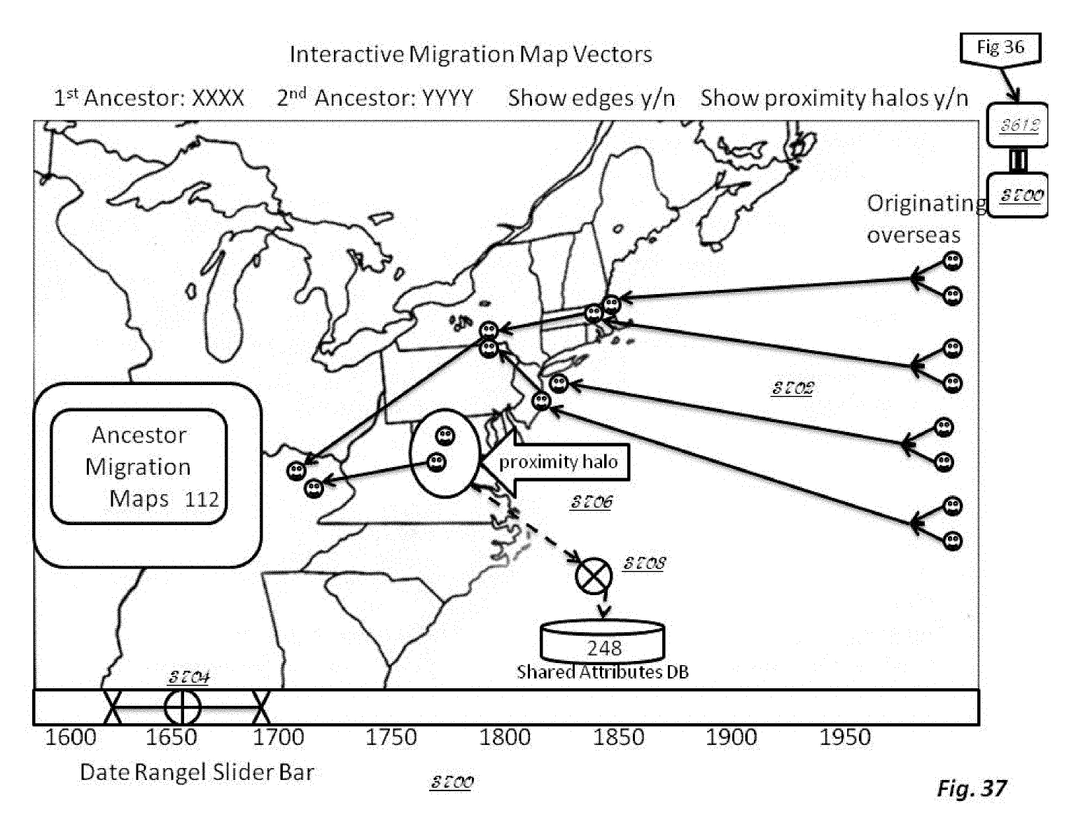

FIG. 37 is an illustration of an Ancestor Migration visualization tool with sliding time-windows, pedigree path traces, and proximity halos.

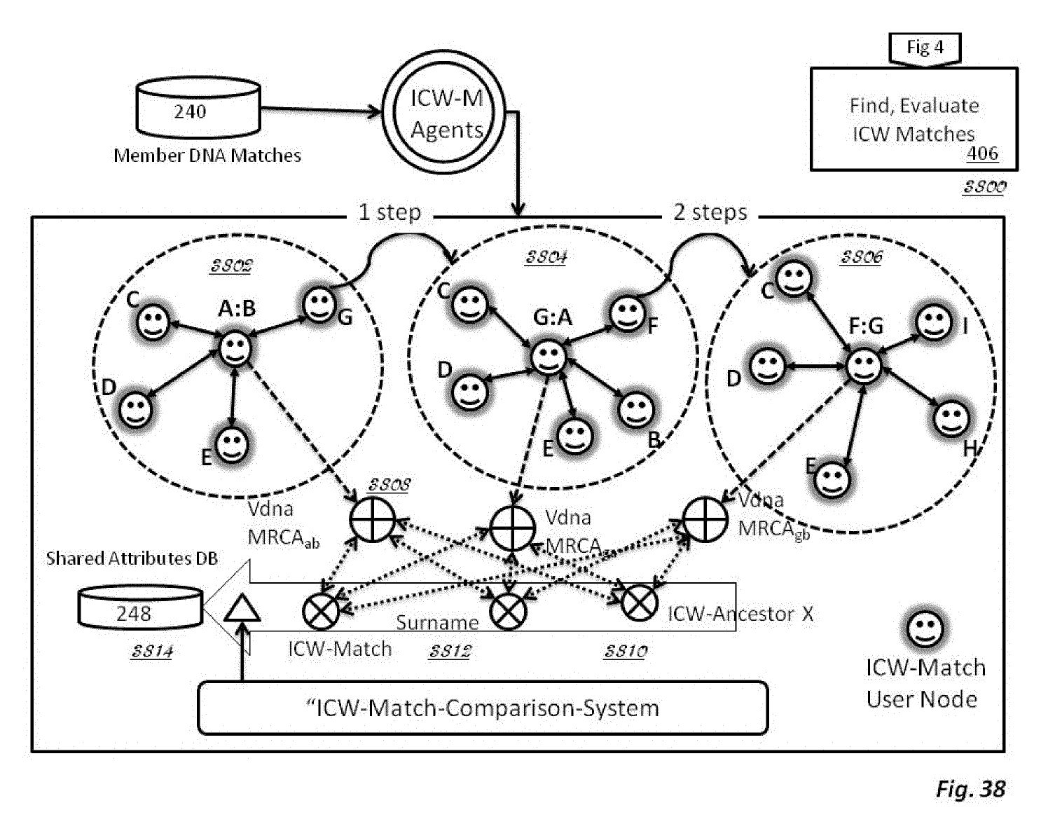

FIG. 38 is an illustration of an In-Common-With Matches data-mining and processing, in one embodiment.

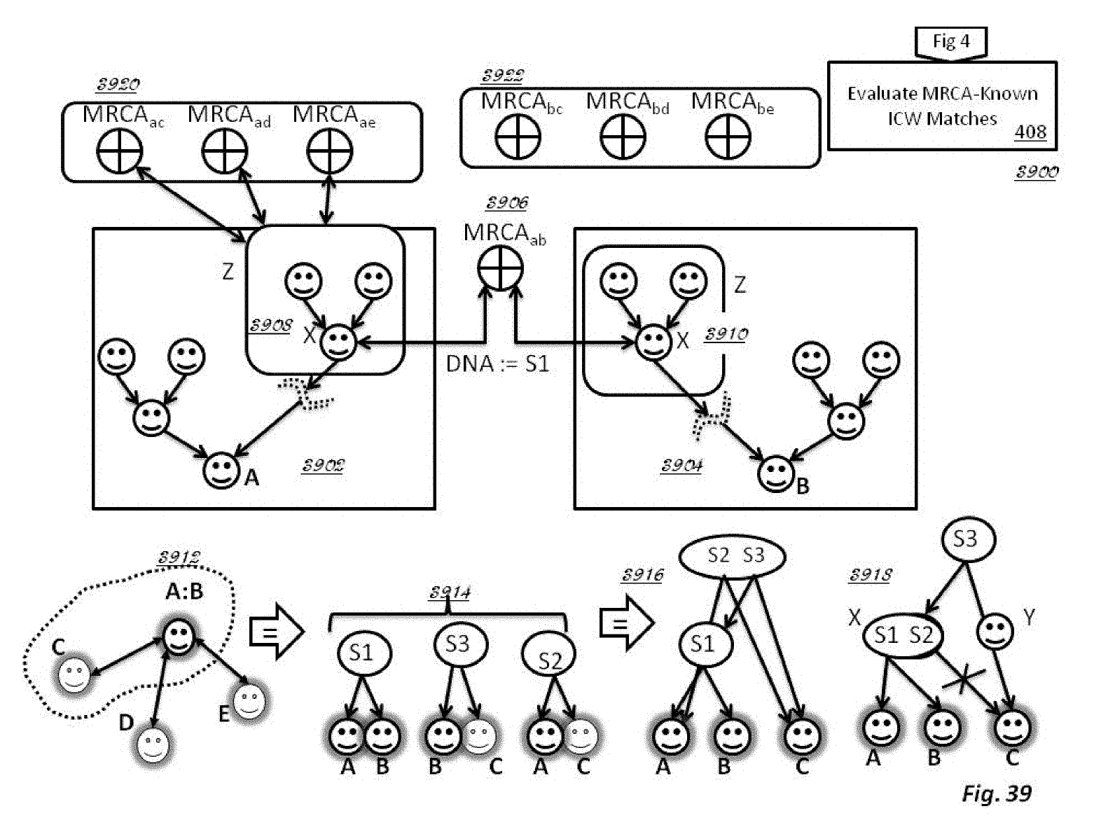

FIG. 39 is an illustration of using In-Common-With Matches along with good MRCA data to reduce some MRCA search spaces, in one embodiment.

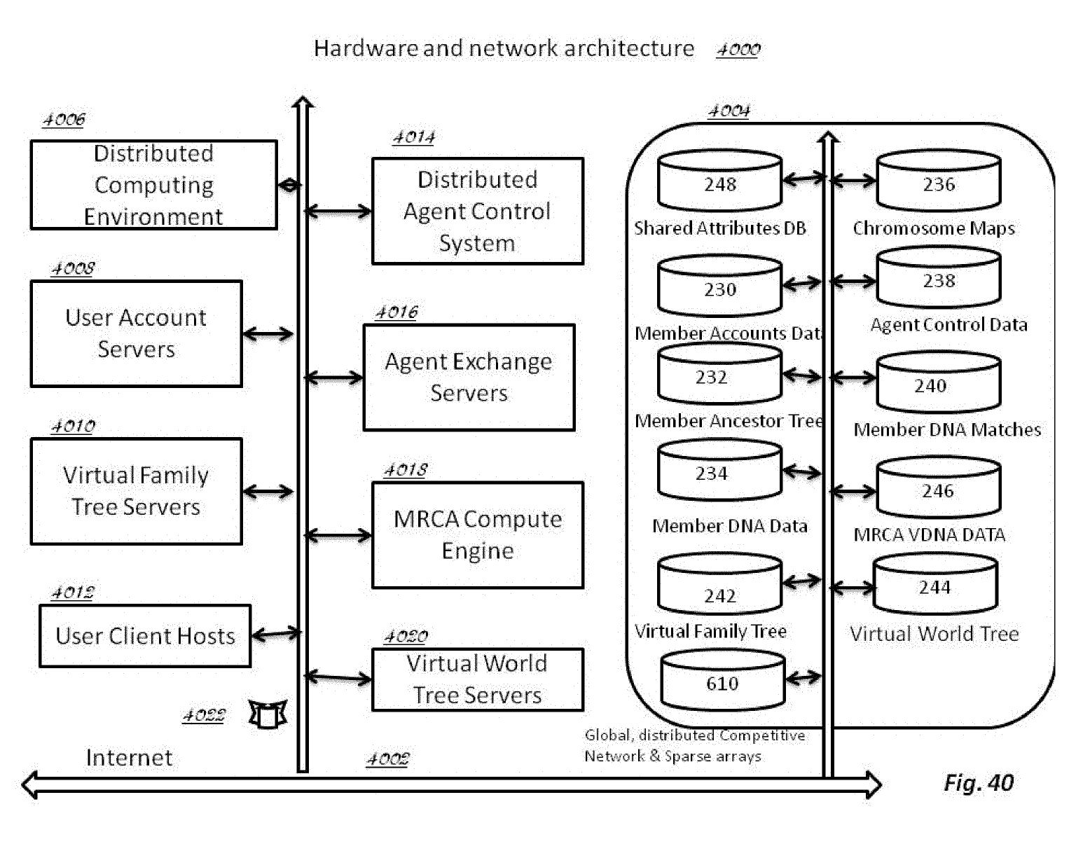

FIG. 40 is an illustration of one embodiment of the primary hardware and database components of the system.

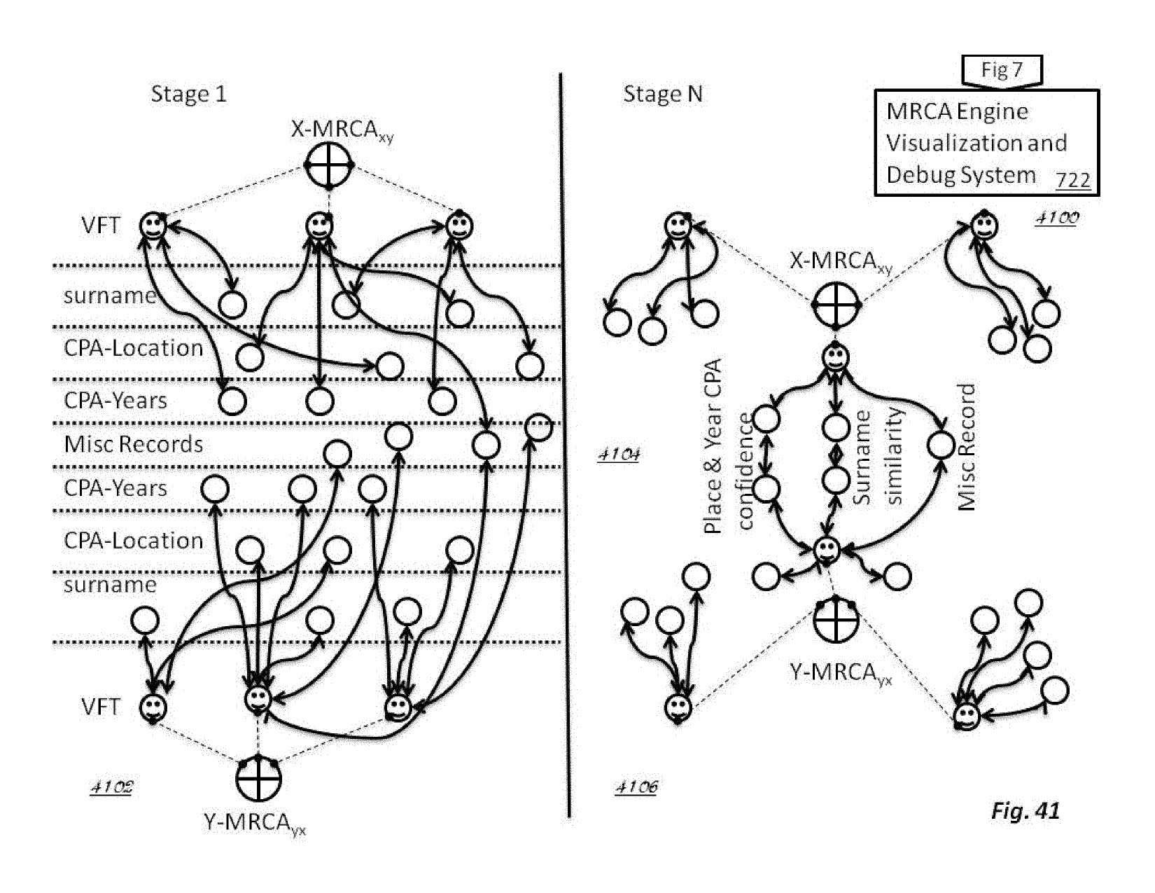

FIG. 41 is an illustration of the abstract visualization tool for visualizing network stimulation and settling states, in one embodiment

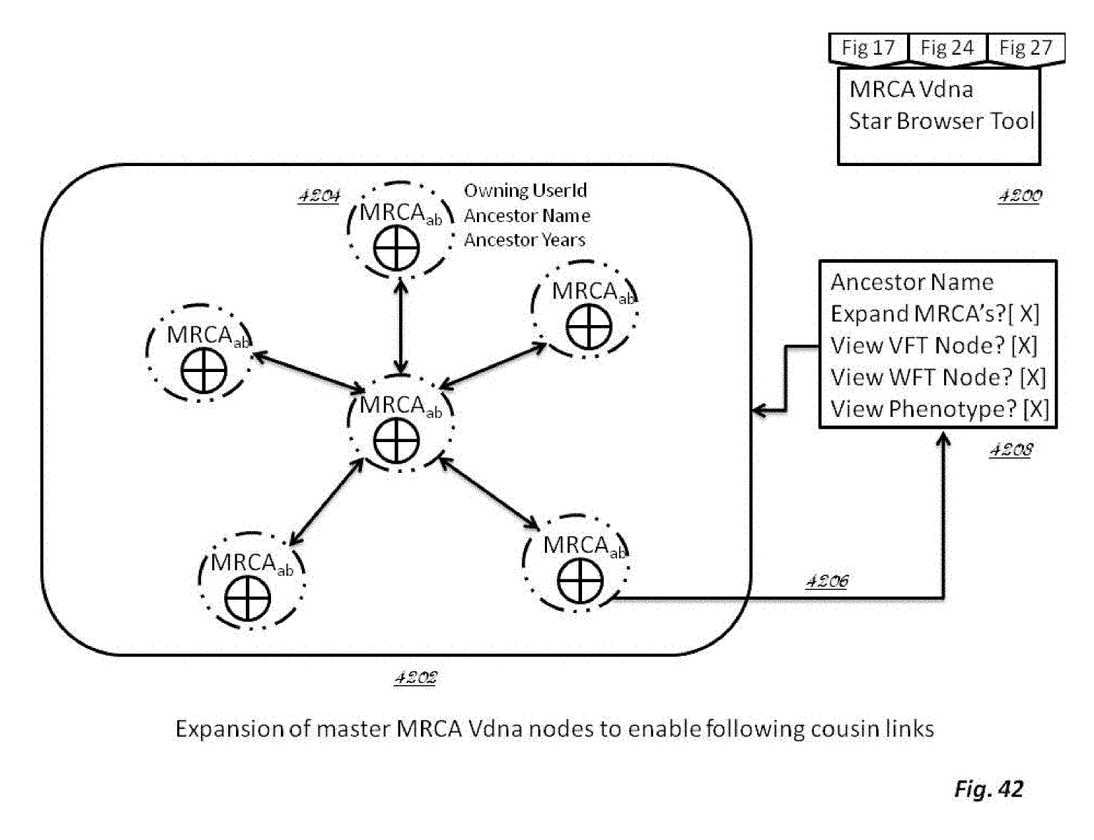

FIG. 42 is an illustration of an Merged-MRCA browser, in one embodiment

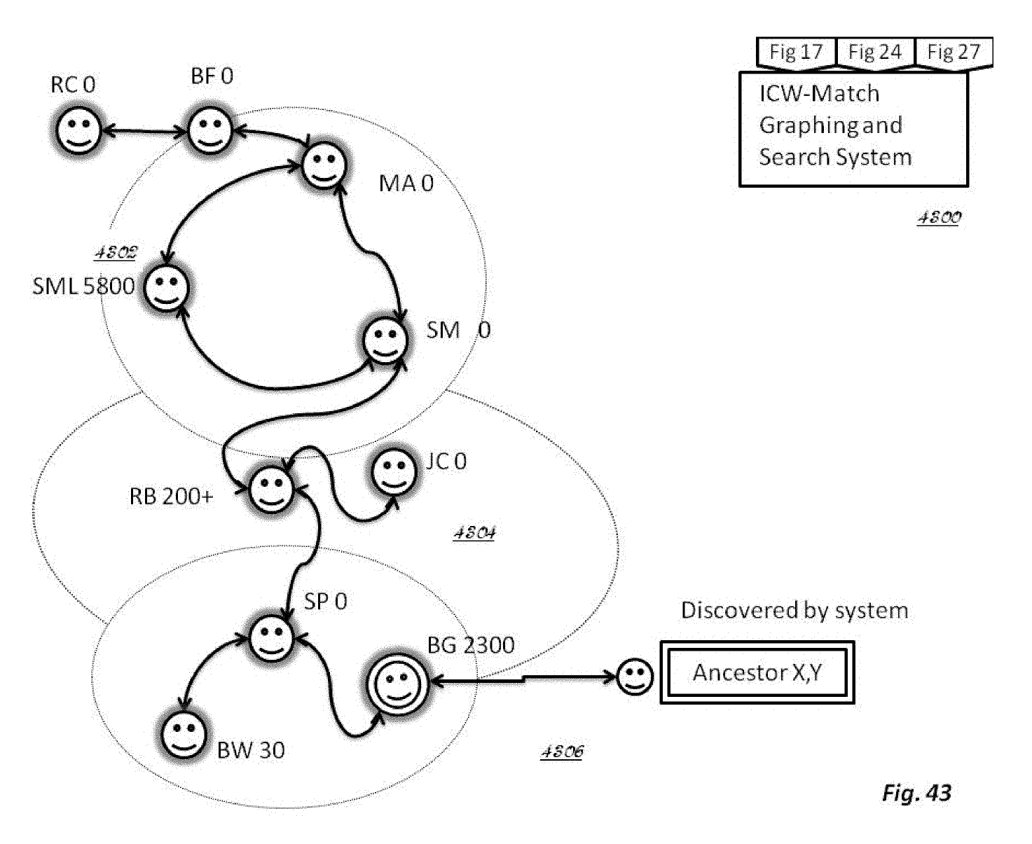

FIG. 43 is an illustration of one embodiment of an ICW-M Graphing System

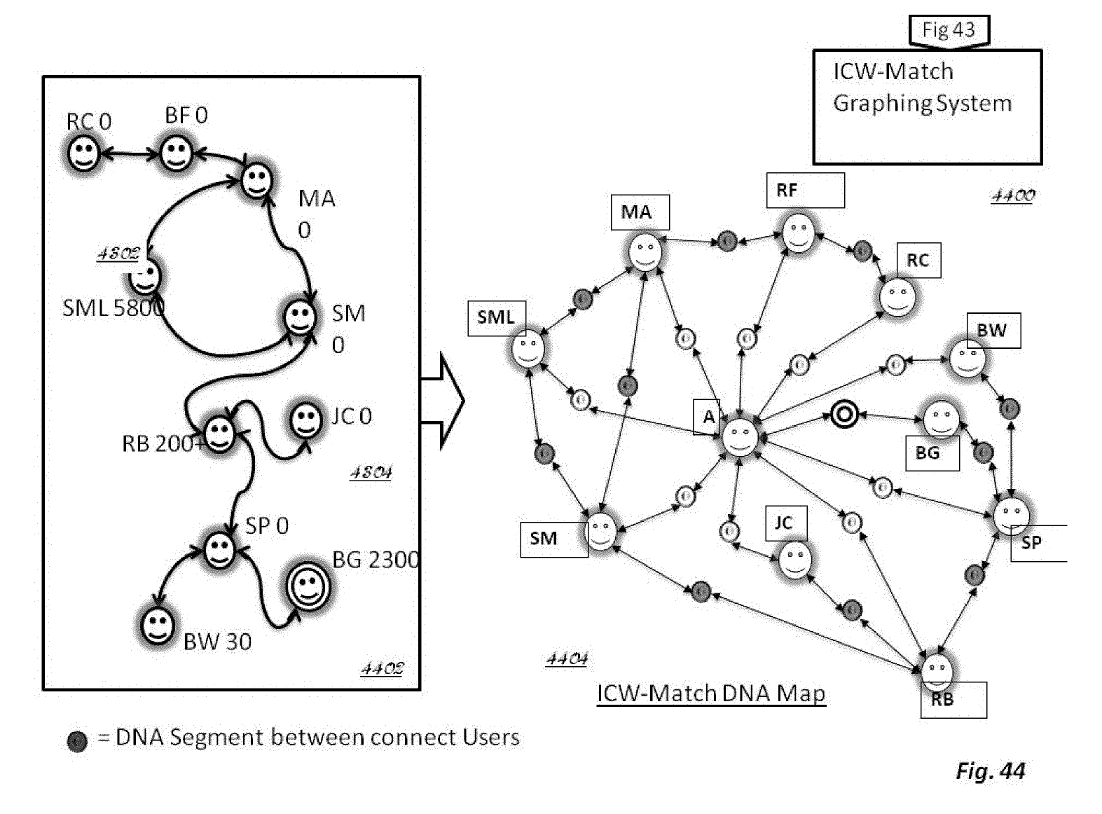

FIG. 44 is an illustration of one embodiment of an ICW-M Graphing System

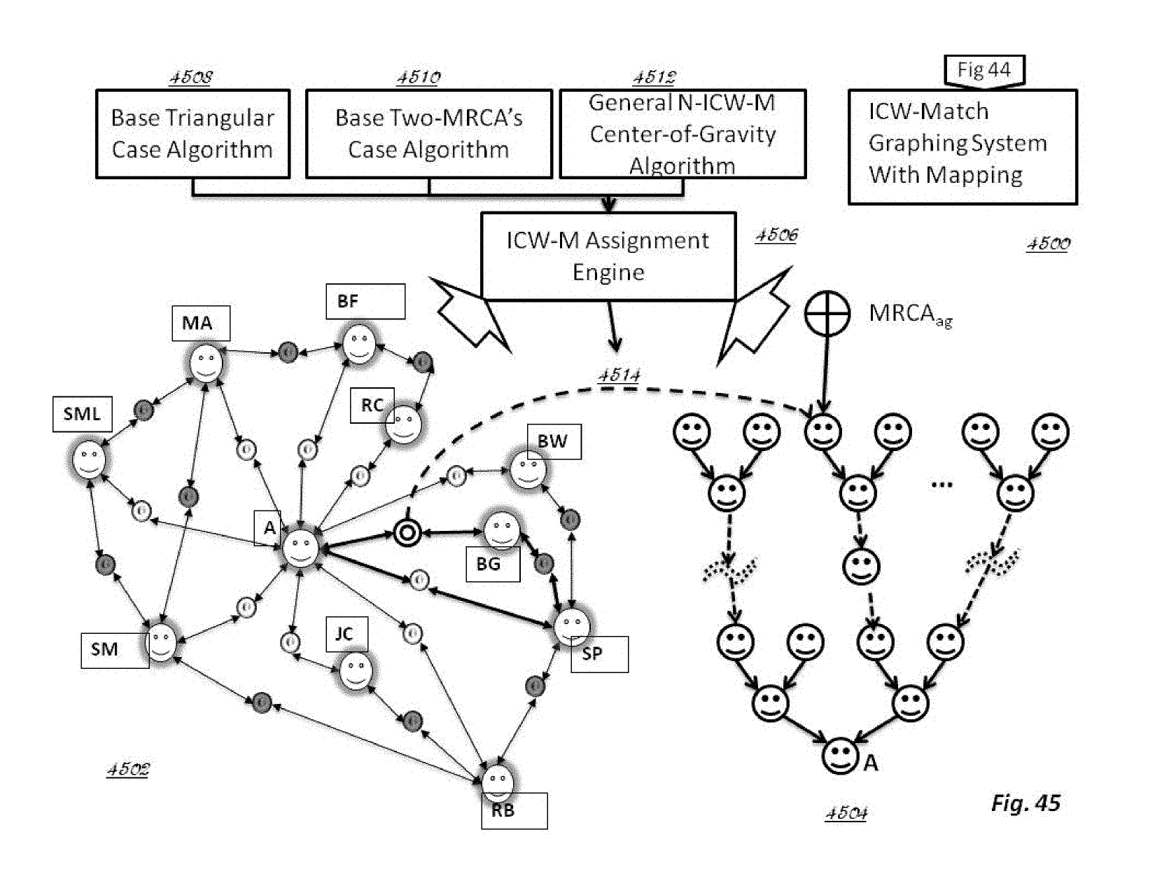

FIG. 45 is an illustration of one embodiment of an ICW-M Graphing System mapped to a VFT

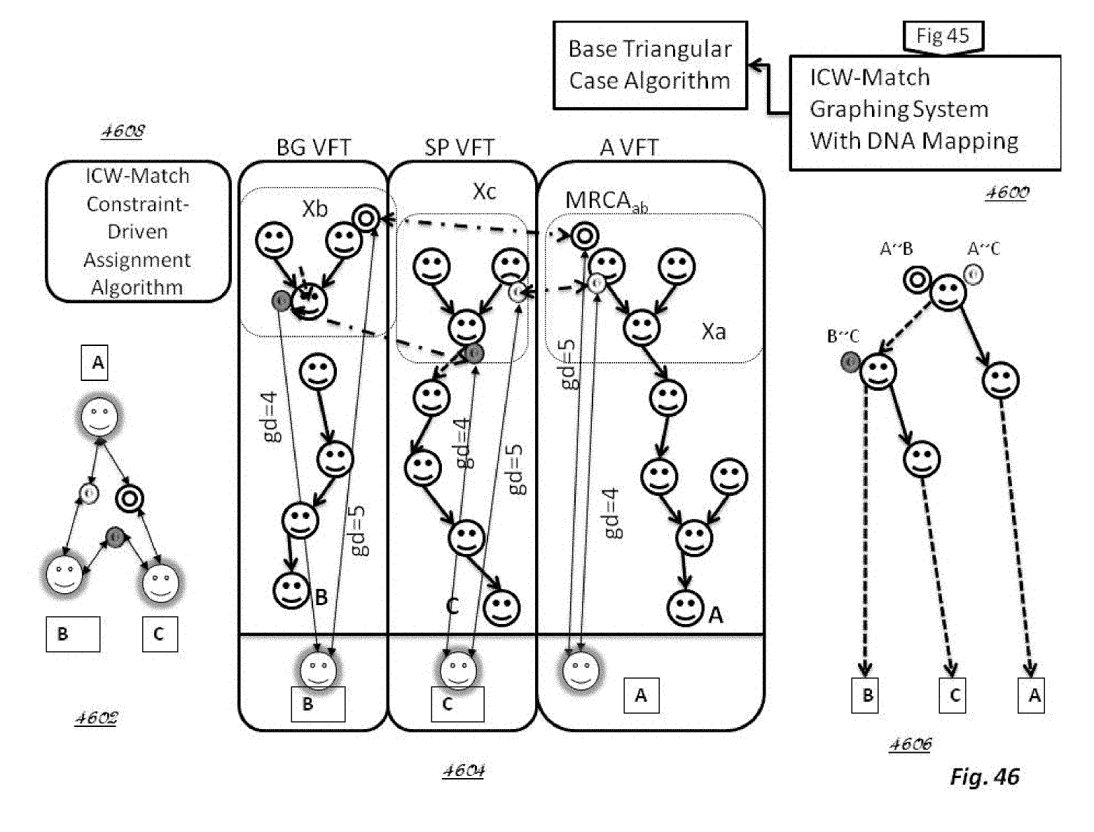

FIG. 46 is an illustration of one ‘base triangular case’ algorithm embodiment of an ICW-M Graphing System with constraint-driven DNA mapping to several Virtual Family Trees

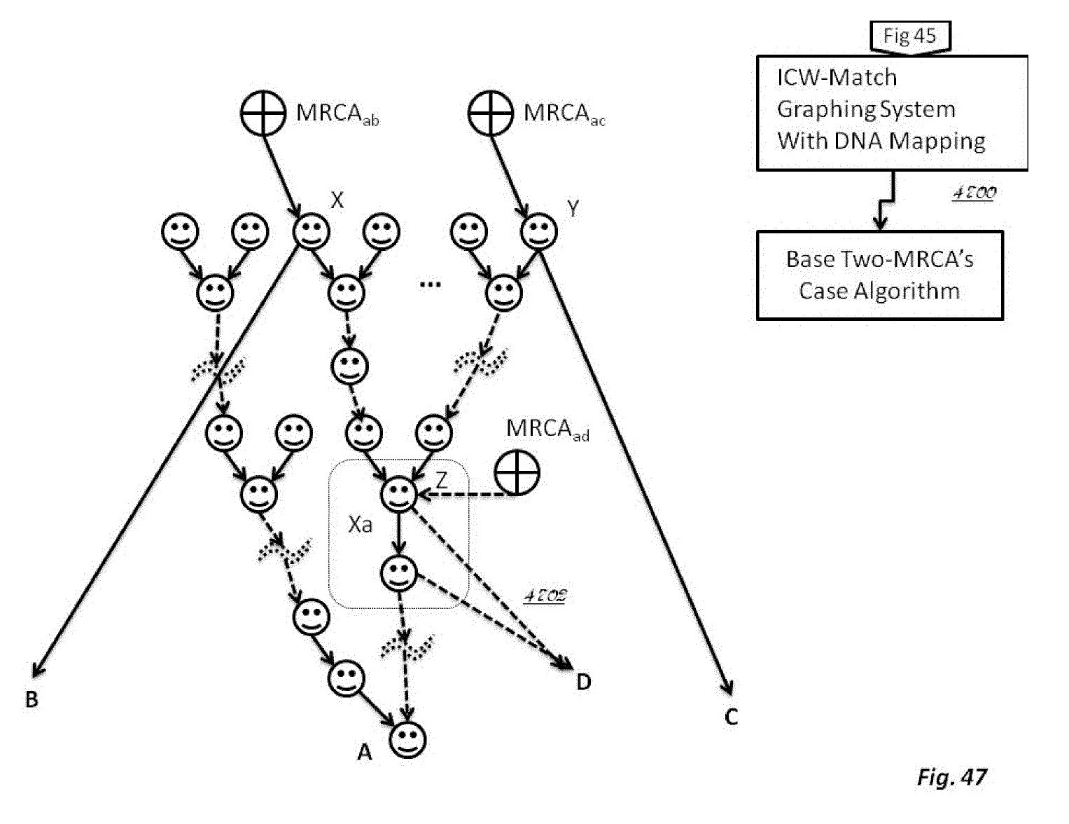

FIG. 47 is an illustration of one embodiment of an ICW-M Graphing System with constraint-driven DNA mapping

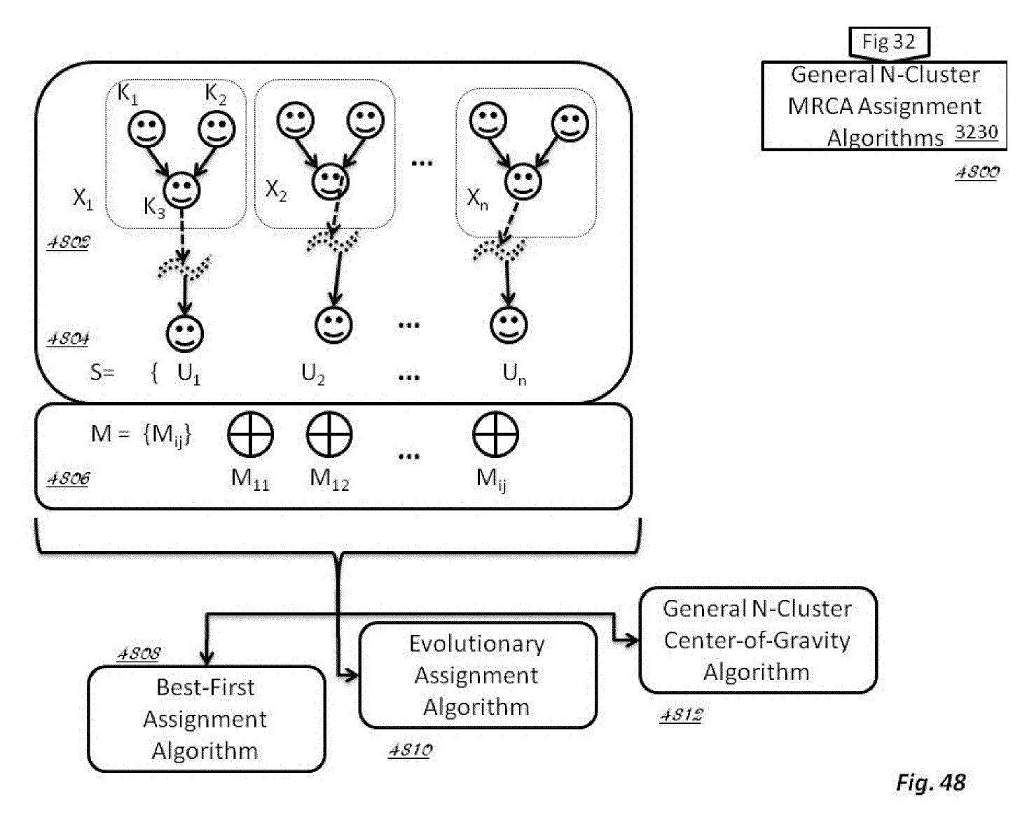

FIG. 48 is an illustration of one embodiment of a combinatorial MRCA assignment

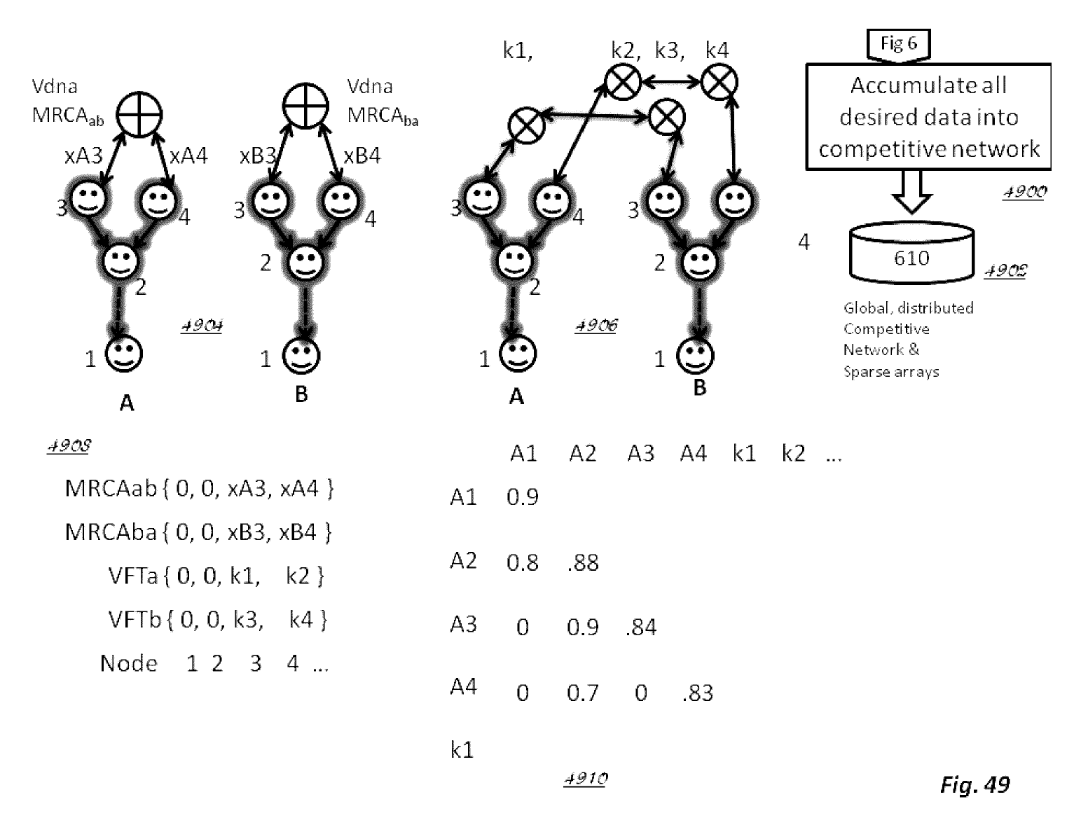

FIG. 49 is an illustration of one embodiment of extraction of the VFT, MRCA-Vdna nodes and Attributes networks to vectors and arrays

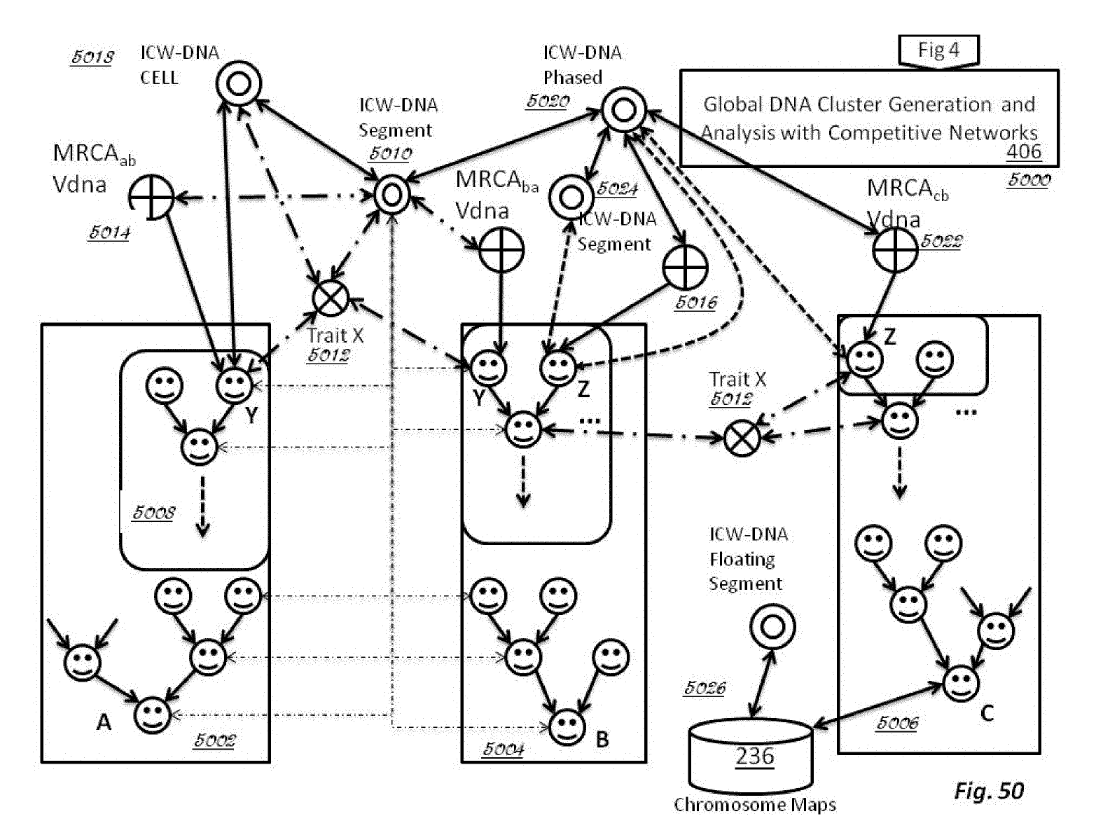

FIG. 50 is an example of one embodiment of a system for Global DNA Cluster Generation and Analysis with Competitive Networks

### DETAILED DESCRIPTION OF THE INVENTION

The following description of the system and methods are presented in a manner to enable one of ordinary skill in the art to make and use the invention and is provided in the context of a patent application and its requirements. Various modifications to the exemplary embodiments and the generic principles and features described herein will be readily apparent. The exemplary embodiments are mainly described in terms of particular methods and systems provided in particular implementations. However, the methods and systems will operate effectively in other implementations. Phrases such as “exemplary embodiment”, “one embodiment” and “another embodiment” may refer to the same or different embodiments. The embodiments will be described with respect to systems and/or devices having certain components. However, the systems and/or devices may include more or less components than those shown, and variations in the arrangement and type of the components may be made without departing from the scope of the invention. The exemplary embodiments will also be described in the context of particular methods having certain steps. However, the method and system operate effectively for other methods having different and/or additional steps and steps in different orders that are not inconsistent with the exemplary embodiments. Thus, the present invention is not intended to be limited to the embodiments shown, but is to be accorded the widest scope consistent with the principles and features described herein.

Although this description has been provided in the context of specific embodiments, those of skill in the art will appreciate that many alternative embodiments may be inferred from the teaching provided. Furthermore, within this written description, the particular naming of the components, capitalization of terms, the attributes, data structures, or any other structural or programming aspect is not mandatory or significant unless otherwise noted, and the mechanisms that implement the described invention or its features may have different names, formats, or protocols. Further, some aspects of the system may be implemented via a combination of hardware and software or entirely in hardware elements. Also, the particular division of functionality between the various system components described here is not mandatory; functions performed by a single module or system component may instead be performed by multiple components, and functions performed by multiple components may instead be performed by a single component. Likewise, the order in which method steps are performed is not mandatory unless otherwise noted or logically required.

Unless otherwise indicated, discussions utilizing terms such as “selecting” or “computing” or “determining” or the like refer to the action and processes of a computer system, or similar electronic computing device, that manipulates and transforms data represented as physical (electronic) quantities within the computer system memories or registers or other such information storage, transmission or display devices.

Electronic components of the described embodiments may be specially constructed for the required purposes, or may comprise one or more general-purpose computers selectively activated or reconfigured by a computer program stored in the computer. Such a computer program may be stored in a computer readable storage medium, such as, but is not limited to, any type of disk including floppy disks, optical disks, DVDs, CD-ROMs, magnetic-optical disks, read-only memories (ROMs), random access memories (RAMs), EPROMs, EEPROMs, magnetic or optical cards, application specific integrated circuits (ASICs), or any type of non-transitory media suitable for storing electronic instructions, and each coupled to a computer system bus.

Finally, it should be noted that the language used in the specification has been principally selected for readability and instructional purposes, and may not have been selected to delineate or circumscribe the inventive subject matter. Accordingly, the disclosure is intended to be illustrative, but not limiting, of the scope of the invention.

The exemplary embodiments herein relate to a system (and its sub-systems) and methods designed to facilitate expansion and improvement of genealogic family trees, with a key focus on discovery of Most Recent Common Ancestors between pairs or sets of Users (individuals) who have been predicted to be genetically related by some degree, or ‘genetic distance’, according to the lengths of the contiguous DNA segments shared between them. Assuming, as an example, that there are 2 million participating Users, and the average number of DNA matches per user is 3000, then there will be 6 billion DNA matches reported to the Users. Each of those DNA matches should map to an MRCA, wherein each User has about 1018 Ancestors in the 1st to 9th generations that these Ancestors are usually predicated to lie within. It should be apparent to those reasonably skilled in the computer sciences, that this is an NP-complete ‘assignment problem’ of astronomical proportions. To make matters worse, the data is constantly growing, much of it is changing, and most of the family tree data has no confidence information saved to it regarding its' viability or likelihood. However, there is a solution which turns the complexity into an advantage.

Given that the number of DNA matches a User typically has grows proportional to the number of generations back in time, and the actual population (candidate set of Ancestors) decreases proportionally, it is fairly reasonable to estimate that the estimated 6 billion matches (or 3 billion if we consider symmetry of A<->B is the same as B<->A) map to a much smaller set of actual Ancestors. Thus, each Ancestor may have many descendants in the pool of DNA matching candidates. Between each pair, or set, of DNA matching Users, there will be a number of clues, constraints and other factors which this invention will structure such that they may be used to reduce the set of potential Ancestor candidates for an MRCA between said Users. For example, this invention will enable several means of automating the manner in which the DNA shared between two Users may be limited to, or associated to, a particular sub-branch of a pedigree. Furthermore, this invention will enable means of drawing the common Ancestors of the family trees of two or more DNA matched Users, together in a phase-space, in a manner similar to K-means classification. Furthermore, this invention will enable means of imposing fuzzy logic constraints on the factors drawing together, or repelling, certain Ancestors in the family trees of DNA related Users. Furthermore, this invention will enable a means by which the above analysis, and all the analysis described herein or related to the system, may be done in parallel, on a system generally described as a form of customized cognitive computing.

The parallelism paradigm is not limited to simple partitioning of the problem and running those in parallel on many machines, but rather, enables and leverages several other forms of natural parallelism. For a first example, the smart genetic algorithms (4810), like traditional genetic algorithms, create a parallelism as a whole in its' search for an optimal solution. That is, the problem space may be viewed as a hyperspace, and the ‘gene's of the genetic and evolutionary algorithms compete to find optimal regions in that hyperspace, but are simultaneously restrained by ‘epistasis’, or dependencies or constraints between the genes. The objective function, applied to the whole representative population, implicitly evaluates all of these dependencies simultaneously.

For a second example of implicit parallelism, a kind of a ‘k nearest neighbor’ classification or clustering is implemented by creating a vast network between ancestor nodes and attribute nodes, and then having the system discover similar ancestors by a means of neural-network like activation passing, such that the Ancestors with highest activations after a simulation cycle, are the most similar according to the attributes and their connection weights between them. This forms a form of competitive neural network (CNN). In one mode, or embodiment, the activations are sent in a periodic pattern, traversing the network in parallel. That is, a million machines with thousands of nodes locally represented, may send activations messages to other nodes, letting the network implement a parallel analog race and implicit competition. The intent is to harness the same parallelism that electricity uses to find the shortest path to ground. In the Figures, this parallelism is compared to a spider and its web, wherein the spider can triangulate the location of prey by plucking threads and sensing return signals. So, for example, if we have two VFT pedigrees, and there have been billions of attributes connected between all VFT's, then we can determine the strongest connection between two VFT's (if one exists), by plucking the center of both VFTs (the MRCA-Vdna node connections to eligible VIA nodes), and then waiting to see which (if any) pairs of VIA's share the greatest co-activations after a sufficient propagation, summing and settling time.

The aforementioned CNN, along with the Agents and Agent Exchanges, along with the constraints and fuzzy logic, defines a general form of cognitive computing based on distributed networked computing systems with mobile Agents mediating activation between nodes proportional to connection weights, and, wherein said activations are transported as packets of information describing the type of packet, the path the packet (carried by an Agent) has traveled, and the distance the packet has traveled in terms of hops, and said Agents may carry with them fuzzy logic coded functions which may affect their actions at any nodes, according to their own state and the state of the node visited, and the states of other Agents presently at that node, which together form inputs to the fuzzy logic functions, and that fuzzy logic having as an output one or more of the following:
i. If a visited node is the destination node, then the Agent will register itself with that node, leaving its state and travel history, and thence terminate itself, and such that the visited node will have accumulated the registrations of all Agents that have visited it (since the last reset),
ii. If a visited node has only one connection, that being the connection the Agent came in on, then said Agent may register with the node the fact that it has visited, leaving its identification, type and state, and thence terminate itself, as it has reached a dead-end.
iii. If a visited node has a plurality of connections, and the visiting Agent discovers that it (or a copy of itself) has already visited the node, it will terminate itself, as this represents a loop condition.
iv. If a visited node has only two connections, one being the connection the Agent came in on, then said Agent may register with the node the fact that it has visited, leaving its identification, type and state, and thence continue onwards down the next connection to the next node
v. If a visited node has a plurality of connections, one being the connection the Agent came in on, then said Agent may register with the node the fact that it has visited, leaving its identification, type and state, and thence replicate itself with one copy each continuing onwards down the next connection to each of the next nodes,
vi. In the above conditions, if an Agent also carries with it certain constraints, its actions may be controlled by the fuzzy logic it carries, such that, for example, if the Agent represents a DNA segment, and must only flow downstream (from Ancestor to Descendants), then if it is traversing a VFT or VWT, it will thusly only propagate itself (or copies of itself) down connections which satisfy said constraints, that being the children of the node it is currently on, and such that, for another example, if an Agent is exploring paths for an ICW-Match analysis, it may have with it a maximum generation (hops) counter as determined by the estimated genetic distance between two Users, and may deduct one from the counter after each hop, and terminate or stop after its counter depletes,

. . . and wherein Agents may, according to their type and intent, initiate growth of connections or growth of connection strengths, such as when an Agent representing a particular origination entity, travels from one VIA node through the network to another VIA node, and there is evidence on that receiving node that the entity has been there previously, and the activation from that entity accumulated surpasses a threshold, and given this action the Agent thus reinforces the connection, or creates a shortcut.

. . . and wherein Agents may, according to their type and intent, initiate growth of a new node and connections, such as when an Agent representing a Trait or DNA segment, travels from one VIA node through multiple hops through the network to another VIA node, and there is evidence on that receiving node that the DNA or Trait has been there previously, and the activation accumulated surpasses a threshold, and thus the Agent creates a shortcut, and wherein the Agents may carry with them an ‘activation’ packet, and the value of said activation may decrease (decay) after each hop, and may likewise be amplified at a node which satisfies some constraint on the Agent, such as a constraint that total activation originating from a source and accumulating at a node must surpass a threshold. And wherein the nature of an algorithm requires Agents to compete in certain cases, such that (for example), if a receiving node collects several Agents, but can only let one win, then it may enhance the result of the most ‘strong’ Agent (perhaps according to the activation the Agent arrived with), while simultaneously sending the losing Agents home with an instruction to decrease the connection weights of the paths taken by those Agents.

Technical Brief for Those Skilled in the Arts of Genetic Genealogy and Computer Sciences

This discussion assumes the reader is familiar with genealogy assisted by genetics sequencing, and has some sophistication in computer sciences including machine learning algorithms, graph theory and computing architectures. The intent is to present the underlying framework of the invention directly in order to provide better context for the ‘background’ sections below, and allow the expert to see the problem and general solutions abstracted to the pure algorithms and computability space.

The problem of determining an MRCA in the pedigrees between DNA matched Users may be reduced to a graph-theoretic model, such that we consider as a base case, the pedigree trees as two binary Directed Acyclic Graphs, X & Y, which are also spanning trees, which are suspected to have one or more nodes (the MRCA's) which are equivalent between the two graphs. Each of the nodes and edges have a set of attributes (respectively), with varying values assigned to those attributes (quite often, no value assigned, or invalid or unlikely values). To determine which of the nodes and/or edges are probably equivalent, or at least similar, we can initially simply compare pair-wise the attribute values of every node X, and node Yⱼ, through a complex function P=Equiv(Xᵢ, Yⱼ). For nodes, this will also take into account the equivalence of the 2 progenitor nodes of X, and Yⱼ, and the descendant nodes. For edges, the comparison will be more complex, involving prediction of whether the two edges point towards potentially common nodes, (ie, towards the same time, place, family name, and node—if one exists, etc). The function ‘Equiv’ may implement a matching algorithm according to various criteria of equivalence of the various attributes' values. The attributes may be considered independent variables. Thus, in a simplified scenario, this matching is possible with Naive Bayes or Decision Trees [11], assuming that we have ability to discover or define the probability tables needed for Bayes, or a way to extract the training data for Decision Trees. However, we do not initially have this data so alternative, custom methods are required. For example, a neural net or genetic algorithm, or hybrid model, may be trained with existing data, if we have a way to determine from existing trees, whether specific nodes actually match. That is, known good matches between trees serve as training inputs to Agents (which encapsulate the various algorithms), which then adapt or compete with each other.

However, a brute-force exhaustive matching method is inefficient (complexity O(N²/2) for N total nodes in both trees), in that it does not ignore impossible and unlikely matches, nor ignores nodes which themselves are unlikely or attribute-poor. An efficient method will only compare nodes and edges which are already found to be ‘likely’ themselves (via constraint satisfaction), and which have equivalence in dominant attributes. Determining which elements (nodes, edges) are ‘likely’ to be equivalent demands some pre-evaluation of the elements' correctness and building data structures from evaluating various components of the attributes which are known to be dominant in match determination. Thus, a form of pruning and sorting is expedient. Examples of dominant attributes for sorting in the human genealogic domain might include ‘surname’ and ‘location’. One of these dominant attributes would be the range of genetic distance that an MRCA is expected to be found in between the two DNA matched Users. Another form of pruning benefits from bottoms-up chromosome mapping, wherein the segment(s) shared between the two Users might be limited to certain sub-trees (branches) going up the pedigree. For example, if the User has sequenced the DNA of one parent, and the segment from the DNA matched User matches that one parent, then the sub-tree of the other parent may be pruned for this match case. But clearly, the simple element-to-element matching problem is multi-layered and multi-typed, and would benefit from a custom algorithm. Assume for now that we have a system of algorithms that evaluate the two trees, applying all necessary methods to determine the most likely matching, and weighting all the elements accordingly. Also assume that each match may be captured, by a virtual node to which each of the matched nodes points, and all match correlation values for each pair of nodes are saved in a matrix (lower triangular to avoid redundancy).

The above presents the background of the general element-to- element matching problem of two simple pedigrees, without the benefit of considering massive forests of millions of trees with thousands of hypothesized DNA connections from each tree to other trees. In this case, the problem of discovering the MRCA for every DNA match pair can be seen as an optimization and multi-constraint assignment problem. That is, a single User may have K DNA matches (say, K>5000), which need to be resolved to match to MRCA's which lie in the first 9 generations. There are N=1024 ancestor nodes in a pedigree to 9 generations out. Thus, a match (or assignment) between the two trees of each of K DNA match-pairs, to N ancestors in the current Users' tree, needs to be accomplished. Since K>>N, we may have many User's triangulating to each MRCA. Now, assume that for a particular User, the tree-to-tree matching has been run for K pairs of trees, and for each pair we have an weighted ordering of all feasible candidates (nodes and edges) for MRCA. Now, we determine an assignment of MRCA's for this User, such that we maximize the sum of all weighting values for all matches made for this User.

We run the above two steps for all Users in parallel (asynchronously). That is, for each User, run the match comparison for each pair of trees in a distributed compute environment (noting that this compares not only nodes but also branch edges for similarity). Then, for each User, choose the most likely assignment of MRCA's starting from the highest weighted matches, and moving down. Negative correlations also carry valuable information, and must be recorded as well. Note that even small and subtle hints will matter in this system (although not acceptable to professional genealogists) as they will provide guidance for further research.

Now consider a particular node in a User's tree (an VIA Ancestor). Lets say that out of the K matches of the User, several of them have a significant positive match weight to this node. Now, also consider that for each of those Matches, the other User also has several positive matches to this node. And for each of those matches, there are likewise more matches, essentially rippling out through a network of trees. If we combine all of these nodes and match values and supporting evidences into a single virtual node, then we can check for consistency, and if satisfied, propagate the evidences to the contributing User's trees—where it will then be used to re-evaluate matchings.

Now consider that for a particular set of nodes in a User's tree, potential MRCA's have been found with high confidence (weights), and the relevant information has been propagated to the trees of DNA matches who have this MRCA. Now also consider for one DNA match, we are trying to find the MRCA, and have pruned out the unlikely nodes, and those that have already been assigned with high confidence (and are thus, unlikely). As noted above, we have a means to indicate for that DNA match, the set of nodes which are potential MRCA candidates, and the associated weights. Lets say that all Users's, all Matches have been processed such that each unresolved DNA match has a sorted table of potential matches. Since we have exhausted the local tree-to-tree information, and we have merged matched nodes between all trees, and propagated evidences to the common virtual nodes, we now need to rely on some more subtle pattern matching, and some speculative and logical tree building.

One key form of logical tree building and pattern matching is the discovery of ICW (In-Common-With) ancestors between pairs of trees of DNA matched Users. For example, several of a User's DNA matches may have the same person(s) in their pedigrees, although the User does not. The ICW is potentially a cousin or on the direct path of the MRCA between the User and the DNA match. If any of those DNA matches to the User, are not themselves DNA matched, then the existence of this ICW ancestor in both trees is unlikely (given a large population of individuals who could be in those trees), unless it happens to be related to the MRCA shared between the User and the others. ICW ancestors are not yet MRCA's, as they would have already been discovered by the above algorithms. For each such ICW ancestor found from a User's matches, that Ancestor is annotated (and graphically tagged) with attributes to indicate which Users have this individual in common. The ICW discovery and annotation may be run continuously on all User's and their matches. If a User's DNA match (aka cousin) has ICW the same ancestors with his/her DNA matches, which are not in the current User's ICW set, then those secondary ICW's may be annotated as well, with appropriate attributes to indicate secondary status. The ICW attributes may include the matched segment(s) of DNA of the matching Users. For only two Users, this does not imply the ICW ancestor passed that DNA, as the ICW ancestor may only coincidentally be in both pedigrees. If the ICW ancestor lies on a pedigree branch of one of the User's, but is too near to one of the User's in terms of predicted genetic distance, then it suggests that the MRCA should be in the pedigree of that ICW ancestor, in the predicted range. An evidential connection may be made between this ancestor and a virtual MRCA. The virtual MRCA is thus a target to which the User wishes to extend his/her pedigree. The virtual MRCA is given attributes that restrain it to the expected genetic distance, and which also limit it to the expected time, locations. Similarly, if there are multiple ICW tagged descendants of a particular ancestor, then the User knows that the DNA he shares with those DNA matches must have passed through that Ancestor. The MRCA may be above it, or it may actually be the MRCA—and the path to it from the User lies in one of its descendant's trees. In all cases of ICW ancestors, the pedigree of the User will be analyzed to find branches which could lead to an intersection with the ICW or its ancestors. Given all of the existing match-based weights for finding the pedigree branch to a User's DNA matches, adding weight based on the ICW attributes (demographics), there might be sufficient evidence accumulation to isolate the MRCA to a particular branch. In any case, the ICW cases should lend additional weight to specific branches to narrow down any ambiguous matches.

In summary of the above descriptions, and the multiplicity of inter-references of items, the following outline summarizes the basic components which are employed and described further in the following. The outline sections are organized into External Inputs, Databases, Data Structures, Actors, Systems, Methods and Displays. The ‘External Inputs’ are elements that the User's input into their personal accounts. The Databases represent the various media to which data are stored by the various systems and actors. The ‘Data Structures’ represent the inter-relationships of data and how they are collected for easy and fast access by the systems, actors and displays. The ‘Actors’ are usually Agents, which are programs which operate on the data, read it, modify it, and produce outputs for other components of the system. The ‘Systems’ are combinations of components into organized functional units with definable inputs and outputs. The Methods are the algorithms, processes and flows which are implemented by the Systems and run by the Actors. The Displays are the various means of interaction with the Users, which usually involves output to a terminal screen.

OUTLINE 1.

1) External Inputs
a) GEDCOM (222, in 200)
   i) Loaded into VFT's (1100)
b) DNA Records (Human Reference Build 37+) (234 in 200)
   i) Loaded into User's ‘Member DNA Data’ DB (234)
c) DNA Matches (Individuals a User is DNA matched to) (236 in 200)
   i) Used to create MRCA-Vdna nodes, and populate chromosome map db's

2) Databases
a) Member Accounts Data (230)
b) Member Ancestor Trees (232)
c) Member DNA Data (234)
d) Chromosome Maps (236)
e) Agent Control Data (238)
f) Member DNA Matches (240)
g) Virtual Family Tree (per User) (242)
h) Virtual World Tree (shared) (244)
i) MRCA Vdna Data (per User) (246)
j) Shared Attributes DB (local, per User) (248)

3) Data Structures
a) VIA node (Virtual Individual Ancestor)
   i) Contains a: VAR
b) VFT (Virtual Family Tree) (1100, 1400)
   i) Made of: VIA nodes and connections
c) VWT (Virtual World Tree)
   i) Made of: VIA nodes and connections
d) VAN (Virtual Attribute Node)
e) MRCA-Vdna (MRCA) (1200)
f) Association Network with weighted connections
   i) Consists of all nodes which are connected together by weighted connections
g) ICW Nodes: The various phyla of ‘In-Common-With’ association and clustering nodes
   i) ICW-Cell DNA Centroid (points to may ICW-DNA nodes)
   ii) ICW-DNA (Segment)
   iii) ICW-DC (Disembodied Cousin)
   iv) ICW-A (Ancestor)
   v) ICW-P (Proximity)
   vi) ICW-Cluster (may point to any set of nodes, if they have been found to have a useful commonality)

4) Actors
a) VWT Tending Agents (920, 812->1800, 2200)
b) Attribute Agents (922)
c) Proximity Agents (924)
d) Tree Probability Agents (926)
e) ICW-Match Agents (928)
f) ICW-Ancestor Agents (930)
g) Agent Exchanges 904
i) Reference ‘Agent Control Data’ databases
h) DNA Mapping Agents, assigning segments (932)
i) VFT Agents (934)
j) Speculative Tree Search agents (936, 814->3500)
k) Cluster Agents (938)
l) Constraint Satisfaction Agents (918, 1500, 1600)
m) Confidence Calculation Agents (916, 1500)
   i) Propagate enhanced confidences from new MRCA assignments
n) User Actions
   i) Genealogic Sources Search (308)
   ii) Data Entry, Tree Editor (Hand entered confidences if needed)
   iii) Use of any ‘Display’ tool to investigate and guide the systems search

5) Displays
a) MRCA Annotation to VIA VAR's and next to VIA icons as DNA (1400)
b) ICW-DC icons on non-pedigree common ancestors of a User's DNA matches
c) Display of two pedigrees showing path of MRCA to root of each (1300)
d) DNA segment flow graph viewer (1008, 2800)
   i) Paternal (Y) and Maternal (mtDNA) View (2900)
e) DNA segment overlaps viewer (1006)
f) VIA node's VAR (1500, 1700, 1800)
g) VFT tree with confidence of nodes, links (1900)
h) Interactive Migration Paths GUI (3700)
   i) MRCA Visualization and Debug System (4100)
j) MRCA Start Diagram (4200)
k) ICW-Match Expanding Relations Graph (4300)
l) ICW-Match ICW-DNA Graph for mapping to VFT (4400)
   i) See method of 4500, mapping of ICW-DNA to VIA nodes

6) Systems
a) Hardware and Network Architecture (4000)
b) Agent Management System (900)
   i) Agent Exchanges (904)
   ii) Agent Management System (AMS) (906)
      (1) Agent Definitions (908)
      (2) Agent Communications Language (910)
      (3) Agent Genealogic Ontology (912)
      (4) Fuzzy Logic DB (914)
   iii) Agent Control Data DB (238)
c) DNA Mapping Systems (1000)
   i) Limit ICW-DNA segments to sub-trees (2500)
   ii) Reference shared segments from MRCA->User descendants (2600)
      (1) From all concerned VFT's to VWT VIA nodes, back to VFTs
   iii) DNA map System for each Ancestor (2700)
      (1) Create VAN for share ethnicities between VIA nodes sharing said ethnicity associated segments
      (2) Create ICW-IBS (Inherited By State) for matching overlaps of unknown significance
      (3) Create ICW-DNA (Inherited By Descent) for overlaps of significance to be considered probable IBD.
d) Find and record ICW Ancestors between VFT's (404) (may include many DNA matched Users)
e) Run ICW-A by FF NN (404=>416=>2000=>2100)
   i) Inputs: 2 DNA matched Users (420)
   ii) Outputs: ICW-A (ICW Ancestor) nodes, with connection weights proportional to confidence in equivalence
   iii) Outputs: Register ICW-A nodes with P>threshold with respective MRCA-Vdna nodes
f) Run concurrent MRCA assignment optimization problem (704)
   i) Inputs: DNA matched Users (420)
   ii) Outputs: Ranking of Common Ancestor Matches, with ‘More Recent’ having higher ranking
   iii) Outputs: If no common Ancestors found, then if any branches have multiple similarities, such as Surname and Location, but do not reach back to the estimated genetic distance, then grow an ICW-Speculative node between the two, and register a request for STS-Agent Search.
g) MRCA Engine, flowchart 3200
   i) Discover Common Ancestor(s) by competitive network (704->3000)
      (1) View and sub-system 3000, VFT connections to MRCA nodes of a Cluster of Matching Users
      (2) View and sub-system 3100, VFT connections to VAN (attribute nodes) network, with MRCA implicit
   ii) Apply N-Cluster Algorithms (3230->4800)
h) MRCA Visualization and Debug System (4100)
i) Global DNA Cluster Generation and Analysis with Competitive Networks 5000
j) Run Common Match Cluster Agents (416, 3800)
   i) Inputs: A User's ICW-Matches
   ii) Outputs: ICW nodes which point to the various nodes which form a cluster of a particular type.
k) Run Proximity Analysis of Ancestors (3600)
   i) Inputs: DNA matched Users (420)
   ii) Outputs: ICW-PAN (Proximity Attribute Node) between each pair of individuals who crossed paths
   iii) Outputs: Interactive Migration Paths GUI (3700)
l) Run Attribute Search Agents (422)
m) Run Cluster Mining Agents (424)
n) Speculative Tree Search Agent Sub-system 3500
   i) Inputs: Two VIA nodes separated by at least one generation, which have various attributes in common, including DNA match hints
   ii) Action: Smart search of available family trees and genealogic information to find possible viable, defensible, paths between the two Ancestors
   iii) Outputs: Several node-to-node paths with accompanying evidences, held as semi-disjoint virtual trees in the VWT. Semi-disjoint meaning the nodes are connected by ‘speculative’ links, and the nodes are marked ‘speculative’
o) Evaluate/Explore ‘Disembodied Cousins’ (810->3300, 3400)
   i) Inputs: ICW-A tags from all of a User's DNA matches
   ii) Outputs: Determination of Fan-out Up or Fan-Out Down patterns
      (1) Create ICW-DC with constraints according to fan-up or fan-down

7) Methods
a) DNA Flows by Agent carriers (5000, 1008, 2800)
b) ICW-Match Methods (3900, 4300, 4400, 4500, 4600, 4700)
   i) DNA segment mapping constraints (3900)
   ii) Constraint driven ICW-Match ICW-DNA mapping
c) ICW-DC Methods (3300, 3400)
d) Confidence propagation by Bayesian Belief Network (916, 1500)
e) Proximity Analysis by ‘Closest Point of Approach’ (924, 3700)
f) Y and mtDNA specific MRCA-Vdna constraints (1016)
g) MRCA-Vdna candidate set with connection strengths to candidate VIAs (2300, 2400)
h) In-Common DNA segments limited to sub-trees by prior DNA segments mappings (2500)
i) Speculative Tree, node-to-node fill-in, 3500
j) Mapping of ICW-M ICW-DNA to VIA nodes (4500)

### DETAILED DESCRIPTION OF THE PREFERRED EMBODIMENTS

The detailed description of this invention is presented in the context of the detailed description of the figures, which follows in the next 50 sections, from System 100 Flowchart through the System 5000 Global DNA Cluster Generation and Analysis with Competitive Networks. This description shall follow from and continue from the prior ‘detailed description’, implementing the aforementioned systems, methods and strategies.

System 100 Flowchart

1. Illustrated in FIG. 1 is a flowchart of the relationships of the sub-systems in one embodiment. The Full-system hardware and network architecture on which this runs is illustrated in FIG. 40. States 101->102 are a one-time account creation and databases initialization event for each new User, which is detailed in FIG. 2, System 200 “New User Initialization System”. The rest of system Flow 100 represents a typical progress of the flow's execution, emphasizing typical paths of collecting and data-mining data (104, 106, 108, 110 112, 118), through MRCA analysis 114 and then using the information of new DNA triangulations to update DNA mappings in state 118, which thus implicitly propagates constraints through the MRCA-Vdna to VIA nodes looping back to 104. Generally, following setup 102, the User and System will initiate 104, “Continuous accumulation of genealogic evidences”, which is described in FIG. 3. Asynchronously, state 106 “Data-mine Users' own and Users' Matches' Trees”, is triggered by accumulating sufficient changes to the VFT and attributes of a User's, or a User's DNA matches. That is, the more changes recorded, the higher the priority for the data-mining as compared to other possible operations. Each node will have a change counter, as well as a grand-total table for each VFT, which the VFT tending Agents sum and report to the Agent-exchange. The Data-mining sub-system is detailed in FIG. 4, System 400. States 108 “Continuous evaluation of tree and data quality, and constraints checks” (detailed on FIG. 5) and state 112 “Continuous exploration and growth of virtual trees” (detailed on FIG. 8) are triggered, in part, by changes in the family trees, which is registered in the Agent-Exchange, in the Agent Control System 116 (detailed in FIG. 9). Another trigger is if the MRCA analysis adds MRCA bindings to a tree, thus pruning the search space for other MRCA analysis.

2. Following an completed run of 108 (confidences have been updated), a User initiated, or system initiated, MRCA analysis may be run. This consists of 3 stages: 1) State 110, “Accumulate all desired data into competitive network” (detailed in FIG. 6), 2) State 114, “Run concurrent MRCA assignment optimization”. (detailed on FIG. 7), and if an MRCA is found with high enough confidence, State 118, “DNA Mapping Systems”, (as detailed on FIG. 10) are initiated. Following MRCA discovery, various states will benefit from the results. As will be described, enhanced confidences will be propagated appropriately to involved VFT's and appropriate VIA nodes, and the VWT, DNA will be mapped from triangulated User's to the MRCA, and the involved DNA segments assigned to all appropriate nodes between the User and MRCA ancestor Node (VIA node) with ICW-DNA attribute nodes connecting specific VIA nodes in different trees. After updates have been completed, the system will test conditional 114, “Repeat data-mine 106 with support of new MRCA's, if sufficient new data added”.

3. The flow directions in FIG. 1 are an example of a typical path, but are not exclusive or restrictive. For example, each major stage of data collection may be followed by execution of an local or global MRCA analysis in 600 and 700, and the continuously running system 5000 ‘evolutionary’ DNA Cluster Generation and Analysis. The User will be able to invoke states through scripts, in order to input data, update confidences, invoke MRCA analysis, and test hypothesis. Thus, the User may be able to collect results from any stage of data collection and analysis, and determine where to focus attention and potential fixes.

4. The illustrated system 100 includes:
102: Sub-system “New User Initialization System. Setup User, populate trees, load DNA Matches”. Detailed on FIG. 2.
104: Sub-system “Continuous accumulation of genealogic evidences”. Detailed on FIG. 3. Detailed on FIG. 5
106: Sub-system “Data-mine Users' own and Users' Matches' Trees”. Detailed on FIG. 4.
108: Sub-system “Continuous evaluation of tree and data quality, and constraints checks”.
110: Sub-system “Accumulate all desired data into competitive network”. Detailed on FIG. 6.
112: Sub-system “Continuous exploration and growth of virtual trees”. Detailed on FIG. 8.
114: Sub-system “Run concurrent MRCA assignment optimization”. Detailed on FIG. 7.
116: Sub-system “Agent Control System”. Detailed on FIG. 9.
118: Sub-system “DNA Mapping Systems”. Detailed on FIG. 10.
120: Conditional: from 114, “Repeat data-mine 106 with support of new MRCA's, if sufficient new data added”.

System 200 New User Initialization

1. Convention: In FIG. 2, the in-pointing tab ‘FIG. 1’, pointing at the box with 102 inside, indicates this is an extension of FIG. 1 from the state 102, and this system itself is further described as System 200. This convention will be repeated in many figures.

2. Continuing from FIG. 1, state 102, illustrated in FIG. 2 is a flowchart of the ‘new user’ initialization and related databases involved in one embodiment. Sub-System Flow 200 illustrates basic setup steps for each new User and the databases involved. A new User may load a Gedcom representation of a family tree 222, may load DNA data from a 3^{rd} party vendor 224, and may load a set of DNA matches 226 possibly including the ‘User matched to’, genetic distance, confidence and links to their profiles and family trees within the same, or an external system. For each new User 202 an account will be made 204, and registered in the appropriate databases 206 (which includes databases 230, 232, 234, 236, 238, 240, 242, 244, 246). A Virtual Family Tree (VFT) will be made 216, covering the pedigree out to 10 generations (see FIG. 11). If a private family tree is uploaded 208, or a new one built 210, then the VFT nodes will be linked to corresponding nodes in the User's real family tree. Depending on 3^{rd} party Vendor's ‘terms of service’ the User may pull data directly from their web-based Family tree, or may populate their VFT with the data from their GEDCOM 212. After User's basic profile and tree information has been loaded, their DNA matches (commonly referred to as cousins) are registered in state 214, into the Member DNA Matches DB 240, which includes in each DNA-match record, fields for pointers to the Users involved, confidences, start-stop points, the actual DNA in encrypted form, and others described herein. After initial DNA Matches are loaded, a place-holder MRCA Virtual DNA node is created 218 for each of the User's matches (one in each tree for each DNA matched pair). Each MRCA (aka Vdna) node is linked to the eligible nodes in the User's VFT, as detailed in FIG. 12, and to the DNA record in 240 which purports the match. A local ‘Shared Attributes DB’ (LSA-db) will be initialized 248, and an account will be registered on the global ‘Shared Attributes DB’ (GSA-db) also described as 248). The existence of the new VFT will be registered in the Agent-Exchange, in order to trigger evaluation of the nodes by the Agents.

3. Each User will have a local Shared Attributes DB 248, into which all records which are related to Ancestors in his/her Virtual Family Tree will be recorded, and all records which are shared with any DNA matched User. This is necessary for the User's local copy of records and for fast local (client) analysis. There will be a Global Shared Attributes DB (also 248) which is updated occasionally with the contents of each Users' local Shared Attributes DB, but only with attributes which connect Ancestors between 3 or more VFTs. That is, the GSA-db is populated with data-mined clusters. The GSA-db is, in one embodiment, employed by the global analysis stage of the MRCA analysis, benefiting from the Cluster's inherent propensity for drawing likely relatives together, and thus optimizing the search for MRCA nodes. The Local MRCA analysis of just two Users should be able to rely on the LSA-db's of the participating Users. If the Local MRCA analysis is not successful, or sub-optimal, the algorithms of FIG. 48 , General N-Cluster MRCA Assignment Algorithm, may be employed. In FIG. 50, a DNA-centric cluster analysis is presented, which generates various ICW-DNA nodes that cluster DNA segments, sets of segments into Cells, and several forms of derived segment overlaps. These too are saved in the GSA-db.

4. The illustrated system 200 includes:
200: Sub-system: “New User Initialization System”, (connected from 102).
202: Foreach new user added
204: Create User Profile
206: Initialize databases
208: Load User Tree, DNA
210: Create User Trees
212: Load/Enter Evidences
214: Register User DNA matches. The new User is registered with the Agent Control Data sub-system
216: Create User VFT tree, is detailed on FIG. 11
218: Create User VDNA Nodes, is detailed on FIG. 12
220: Load Data from External Vendors
222: Load Gedcom Trees
224: DNA Records
226: DNA Match Maker's matches
230: Member Accounts Data DB
232: Member Ancestor Trees DB
234: Member DNA Data DB
236: Chromosome Maps DB
238: Agent Control Data DB
240: Member DNA Matches DB
242: Virtual Family Tree DB
244: Virtual World Tree DB. The new User is registered with the Virtual World Tree as a new, authorized client
246: MRCA Vdna DB
248: Shared Attributes DB. (Local and Global versions)

System 300, “Continuous accumulation of evidences”

1. Continuing from FIG. 1, state 104, Illustrated in FIG. 3 is a flowchart of the interaction between genealogic sources search and data input systems 302 and 304, and the Agent Exchange system 900 and its triggers registry 904, in one embodiment. User Data entry 304 includes linking to documents from various sources, or making note of those sources, adding confidence estimates, editing ancestor biographical information, editing the tree structure in general. This system works like conventional ‘distributed data management’ systems which maintain versions of data at the sources, have daemons which continuously check for changes in those versions, and when they occur, send a message to the master servers, which then run actions according to the type of data change. Various data change events and resulting actions are described throughout this description.

2. The illustrated system 300 includes:
300: Sub-system “Continuous accumulation of evidences” (connected from 104)
302: Genealogic Sources Search
304: User Data Entry, Tree Editor

System 400, “Data-mine Users' and Users' Matches' Trees”

1. Continuing from FIG. 1, state 106, Illustrated in FIG. 4 is a flowchart/State-Diagram 400 of several of the data-mining sub-systems, and their related data exchanges, in one embodiment. The sub-systems described here may run on all Users trees concurrently, asynchronously, as data-change triggers register with the Agent-Exchange 904. The Agent Exchange basically runs these data-mining Agents (416, 418, 420, 422, 424) as needed, prioritized by demand and importance, in a distributed-parallel fashion, on all sets of data, limited by the capacity of the compute resources, network bandwidth and other practical resource optimization constraints. Furthermore, as these Agents are running they will be, as a side-effect, creating attribute nodes linking clusters of Ancestors in the Global Shared Attributes DB 248, by the simple processes of associating those Ancestors to global attribute nodes.

2. Noted first ‘ Find, Record: General Attribute Commonalities’ 402, triggers the 422: ‘Run Attribute Search Agents’, which discovers attributes common between the Ancestors of User's trees and registers them in the Shared Attributes DB. The state 404: finds and records ICW Ancestors, which is detailed on FIG. 20 and FIG. 21, triggers system 418: Run ICW-A Search Agents. After these have run, state 412 ‘Evaluate ICW Ancestors’ begins, which runs the confidence analysis on each Common Ancestor discovered. It then runs state 414, ‘Queue ICW Ancestors to VWT’, which thus registers any ICW-A matches to the Virtual World Tree. Finally, since any ICW-Ancestor between two DNA matched Users is a strong hint towards their MRCA, the state 410 MRCA Assignment Engine may follow. Finally, the state 406: Find, Evaluate ICW Matches, which is detailed on FIG. 38, triggers system 416: Run Common Match Cluster Agents. In preview, the state 406 may rely on ICW-matches provide by a 3rd party vendor, or may be derived from an internal segment matching system. When working with internal segment data, the processes of FIGS. 26 and 29, which map DNA to ancestor nodes, will have been run by this state. This will then run state 408: Evaluate MRCA-Known ICW Matches, which is detailed on FIG. 39. As this ICW-M system may link ICW-A Ancestors, running the MRCA Assignment Engine afterwards may have a good chance of discovering the MRCA.

3. In ‘Run Cluster Data-Mining Agents’ 424, ‘Clusters’ are, in one embodiment, any set of attributes which are connected to a plurality of Ancestors nodes from VFTs or VWT's whose owners are usually DNA matches. Note that this includes, but is not limited to, data-mining of A to B to C chains of DNA matches (ie, any set of chained matches of Users), as well as User's DNA overlap chains, and DNA In-Common-With Match networks (this includes the classes of ICW-DNA described throughout). Clusters are ranked according to various metrics, including but not limited to, importance and quality (confidence) of attributes, quantity or density of attributes, and density of interconnected DNA matched User's networks. While MRCA analysis is generally run per User and his/her DNA matches upon registration of significant changes, another queue of MRCA analysis are run according to the creation of, and ranking of clusters, working from the highest ranked clusters down. That is, DNA matched User's who are part of a cluster and analyzed together. The benefit is to harvest the low hanging fruit' first, so as to significantly reduce the problem space for the harder MRCA cases, and to at least isolate the solution space for the Users' themselves to focus attention (eg, for decision support). Individual VIA nodes are associated to a set of clusters, as each cluster creation creates links to/from the involved VIA nodes, networks or other clusters. That is, clusters may form hierarchies of clusters (a cluster that includes sub-clusters) or cluster-intersects (cluster C=intersect(cluster A, B)) as well. For example: A cluster of a particular Surname built from many VFT's and/or the VWT, may be intersected with a cluster of the same Surname's temporal-spatially co-located (ie, North America, 1700-1750). Each VIA node is by default a cluster centroid based on the DNA that the Ancestor ‘distributed’. This concept of a DNA collection as a Cluster Centroid is used in FIG. 48, 4812 ‘General N-Cluster Center of Gravity Algorithm’ and in the system 5000. In FIG. 50, a DNA based cluster generation and analysis system, which is focused on ‘Cells’ is presented.

4. Moreover, after an MRCA analysis has been run between two Users, and no specific MRCA found (ie, no ICW-A on both pedigrees), the system will (814) take each pair of highly co-activated ancestors from the two User's eligible nodes, and pass them to the Speculative Tree Search (STS) Agent system (FIG. 35). For example, if there are two nodes in User A's tree (say A1, A2), which are on separate branches such that neither is the progenitor of the other, and there is one node B1 from User B's tree which activates, then two calls to STS will be made, STS(A1 B1) and STS(A2, B1).

5. The illustrated system 400 includes:
400: Sub-system “Data-mine Users' and Users' Matches' Trees” (connected from 106).
402: Find, Record: General Attribute Commonalities
404: Find, Record ICW Ancestors, is detailed on FIG. 20 and FIG. 21
406: Find, Evaluate ICW Matches, is detailed on FIG. 38
408: Evaluate MRCA-Known ICW Matches is detailed on FIG. 39
410: Run sub-stage data through MRCA Assignment Engine
412: Evaluate ICW Ancestors
414: Queue ICW Ancestors to VWT
416: Run Common Match Cluster Agents
418: Run ICW-A Search Agents
420: Run Proximity Search Agents is detailed on FIG. 36
422: Run Attribute Search Agents
424: Run Cluster Data-Mining Agents.

System 500, “Continuous evaluation of tree and data quality, and constraints checks”

1. Continuing from FIG. 1, state 108, Illustrated in FIG. 5 is a flowchart of the trees data quality evaluation and annotation sub-system, in one embodiment. Each auto-calculated confidence and/or connection weight will be examinable by the User. To summarize, 500: Sub-system includes the following states for “Continuous evaluation of tree and data quality, and constraints checks”, and is connected from FIG. 1, state 108. State 502: User Confidence Input Editor, allows User's to enter or modify automatically generated confidences. State 504: ‘Evaluate User tree and data Quality’, represents the changed-data triggers evaluation to send to the Agent Exchange, to launch appropriate Agents. Unlabeled state 506: Is the action and control done by the Agent Exchange. State 508: ‘Constraint Satisfaction Agents Launch’ is detailed on FIG. 16. State 510: ‘Confidence Agents Launch’ is detailed on FIG. 15. State 512: ‘VFT Annotation Agents Launch’ is detailed on FIG. 17, State 514: ‘VWT Annotation Agents Launch’ is detailed on FIG. 18. State 516: ‘Record Confidences to 232 Member Ancestors Trees’ which writes to the databases 242 Virtual Family Trees, 244 Virtual World Tree, is detailed on FIG. 19.

2. The illustrated system 500 includes:
500: Sub-system “Continuous evaluation of tree and data quality, and constraints checks” (connected from 108)
502: User Confidence Input Editor
504: Evaluate User tree and data Quality
506: Register changes to Agent Exchange
508: Constraint Satisfaction Agents Launch is detailed on FIG. 16
510: Confidence Agents Launch is detailed on FIG. 15
512: VFT Annotation Agents Launch is detailed on FIG. 17
514: VWT Annotation Agents Launch is detailed on FIG. 18
516: Record Confidences to 232 Member Ancestors Trees, 242 Virtual Family Trees, 244 Virtual World Tree, is detailed on FIG. 19

System 600, “Accumulate all desired data into competitive network”

1. Continuing from FIG. 1, state 110, Illustrated in FIG. 6 is a flowchart 600 (or more accurately, data flow diagram) of the collection of data for preparation for MRCA analysis, in one embodiment. The shared various data elements from various collection agencies such as those shown in state 602, may be ‘extracted’ into their relevant DB's 604, and stitched 606 into a ‘Competitive Network’ 606, and global Inter-Match network 608. The ‘Competitive Network’, in one embodiment, is basically the holistic combination of the existing Virtual Family Trees, their connections to Local and Global Shared Attributes DB nodes (and the attribute Clusters built therein), and their connections to MRCA Vdna nodes. Thus the competitive network embodies all evidences which could guide the User and System in sorting out which Ancestor(s) associates to which MRCA(s). Some of the evidence sources input to the competitive network include: 401 Attribute Commonalities, 412 ICW Ancestor Connections, 408 ICW User Matches Connections (See FIG. 38,39, 42-47 for background on ICW-Match data mining), 810 Disembodied Cousin Influences (ICW-DC nodes), 1000 DNA Mapping Influences, 812 VWT Influences and Connections, and 3600 Migration Proximity Influences via ICW-Proximity Attribute Nodes (ICW-Ps).

2. In another embodiment, at a mature stage of the trees' evaluations, the Virtual Family Trees will have been assimilated into the Virtual World Tree. The MRCA nodes and Attribute nodes are then connected to the appropriate nodes in the VWT, which are pointed to by the VFT. This forms a more compact model for the simulation.

3. In another embodiment, suitable when large compute capacity is available, the VWT, MRCA nodes, Attribute nodes and all other contributing elements, are extracted into one or more sparse matrices, as further described in FIG. 49. In any matrix, the rows and columns represent nodes, and the value of a row, column index represents, at least, its connection weight. Intra-Network 606 is usually a ‘per-match’ network, consisting of a mirror of the User's live VFT, Vdna, and user-to-user shared attributes.

4. To enable influences across match-pairs in different VFT's or between VFT's and the VWT, we need a global, Inter-match network 608. This network is described under the MRCA Engine topics. This will consist of nodes connecting between matched-user sets, such as ICW-Matches and attributes shared between more than two Users. Generally, this should enable the merging of same-ancestors into the VWT, due to concurrent activation of MRCA nodes between Users. One way to record this is through a global, Inter-match network 608. The Inter-Match Network nodes will also include DNA segment information, as discussed and derived in FIGS. 25-29. The Inter-match network is similar to a ‘snapshot’ of the current actively built VFT's and VWT, and a mirror of the local and global Shared Attribute DBs'. Each of these DB's must be paused (no updates), tagged for a time-stamp, copied and released. The copies are then static mirrors of the state at a time point. The 608 Inter-Match Network is used in global analysis such as FIGS. 48 -50.

5. In states 606, 608, all possible forms of evidence influencing the assignments of MRCAs should be collected and presented to the competitive network 610, as a result of the Agent actions.

6. The illustrated system 600 includes:
600: Sub-system: “Accumulate all desired data into competitive network” (connected from 110)
602: From any or all collection agencies, including
   401 Attribute Commonalities
   412 ICW Ancestor Connections
   408 ICW User Matches Connections: See FIG. 38,39, 42-47 for background on ICW-Match data mining.
   810 Disembodied Cousin Influences
   1000 DNA Mapping Influences
   812 VWT Influences and Connections
   3600 Migration Proximity Influences
604: Register current updates into relevant DB's
606: Build Merged Competitive Intra-Network Per Match Pair or Match Set
608: Build Inter-Match Network
610: Export Intra-Network and Inter-Match Network to “Global, distributed Competitive Network & Sparse arrays”

System 700, “Run concurrent MRCA assignment optimization problem”

1. Continuing from FIG. 1, state 114, Illustrated in FIG. 7, is a flowchart of the MRCA assignment and optimization sub-system 700, in one embodiment. In this system, algorithms and data structuring modules will be plug-and-play, and some will be made available on public domain such as github for academic and personal research. Sub-system “Run concurrent MRCA assignment optimization problem” 700 is connected to from 114. This system consists of the process: 702: For all User's DNA matches, run the 704: MRCA Constraint Satisfaction and Assignment Optimization Engine, which is detailed on FIG. 23, FIG. 24, FIG. 30-32, FIG. 48-50. It should be noted that there are local and global optimizations of MRCA assignments. The local optimization refers to assignments determined between a single user and his/her DNA matches. A global optimization refers to the simultaneous optimality of all local assignments. As noted in the description, the global optimality includes, 1) the cumulative measure of equivalence of the Ancestors chosen to be MRCAs, 2) The satisfaction of constraints across all such assignments and their satisfaction rates on the VFTs and VWT, 3) the resulting quality and completeness of the VFT's involved, and/or VWT.

2. The state 708: Data Structuring, prepares the data accumulated in 606, 608 for the current set of Users, or MRCA's to be evaluated, according to the Algorithms chosen in 706. The 706: Algorithms are input into this system by User or automated choice. In automated mode, depending on the source and size of the inputs to the MRCA engine, the algorithms will be chosen according to the following criteria: 1) For a small set, easily computed on a single multi-core workstation, the network system described in FIG. 30-32 may be employed. 2) For a larger set, perhaps involving hundreds or thousands of Users who have been found to have a high-density of interconnectedness (a min-cut, max flow partitioning), a distributed implementation of the network of FIG. 30-32 is used, wherein activation packets are sent between ‘nodes’ via TCP/IP or UDP datagrams. 3) For a global analysis (ie, FIGS. 49, 50), involving thousands or millions of Users, and when a large compute farm or cloud is available, the Users' VFTs and the global attributes DB may be converted to an Inter-Match Network (608), and then to distributed sparse matrices (FIG. 49). Operations are executed on the sparse matrices in parallel.

3. The MRCA Engine is further described by areas, including 710: the architecture of MRCA assignment competitive Learning system (which is illustrated in FIG. 30, 31, 41, 42), 712: the concept of MRCA assignment problem and search space reduction (which is detailed in FIG. 23, FIGS. 24), and 714: the MRCA Engine Flowchart diagram (which is detailed in FIG. 32). Following the MRCA Engine analysis, the 716: MRCA Assignments stage (which is detailed in FIG. 13), updates the MRCA nodes for involved Users, according to the criteria for acceptance. Part of this update is to enhance the strength of the connection weight from the MRCA-Vdna nodes to the respective winning VIA nodes in the VFT's, and to equivalently reduce the proportion of weights in the other (competing) VIA candidates for each MRCA. Each algorithm will have its own registry of candidate VIA nodes from each MRCA-Vdna node, such that they may be run independently, and concurrently (or overlapping). They will all be measured by the same objective functions, and thus the algorithm which has the best overall optimality (fitness), may be selected by a User for viewing and update of his/her personal family tree.

4. In state 718: the MRCA Annotations are registered to appropriate nodes in the Users' VFT Trees (detailed in FIG. 14), which thus enables the User to easily see which nodes in the pedigree are assigned MRCA, and how many triangulations support it. Following this, in state 720: the VFT Confidence enhancements are propagated through the User's tree (and all User's trees involved with the MRCA assignment). This state is continued on FIG. 8, 802. In state 722: the ‘MRCA Engine Visualization and Debug System’ enables the User to see the effect of the MRCA engine on the analysis of one pair or more of MRCA nodes, VFT and associated attribute nodes.

5. The illustrated system 700 includes:
700: Sub-system “Run concurrent MRCA assignment optimization problem” (connected from 114)
702: For all User's DNA matches:
704: MRCA Constraint Satisfaction and Assignment Optimization Engine, is detailed on FIG. 23, FIG. 24, FIG. 30, FIG. 31. FIG. 32
706: Algorithms: for small, large-distributed, and very large on high performance computing systems
708: Data Structuring
710: Architecture of MRCA assignment competitive Learning system (illustrated in FIG. 30, 31, 41, 42)
712: Concept of MRCA assignment problem and search space reduction (detailed in FIG. 23, FIG. 24)
714: MRCA Engine Flowchart diagram (detailed in FIG. 32).
716: MRCA Assignments stage (detailed in FIG. 13), is detailed on
718: MRCA Annotations to VFT Trees (detailed in FIG. 14)
720: VFT Confidence enhancements propagation (Step to FIG. 8, 804)
722: MRCA Engine Visualization and Debug System.

System 800, “Continuous exploration and growth of virtual trees”

1. Continuing from FIG. 1, state 112, Illustrated in FIG. 8 is a flowchart of the system 800 ‘Continuous exploration and Virtual World Tree growth’, in one embodiment. The intent of this system, in part, is to assimilate discoveries from all the various search systems, on all trees, and integrate them in a manner which propagates the inherent constraints and confidences, as discovered by many Users, into the VWT. First off, we have state 802: ‘Propagate enhanced confidences from new MRCA assignments’, in which it has been discussed that the assignment of an MRCA node with high confidence, conveys that confidence, in part, down the direct path of the Ancestor to the User in all VFT's which have the MRCA. And, this confidence is increased with each new additional triangulation to the MRCA. In state 804: ‘Evaluate Queued

ICW Ancestors to add to VWT’, we simply add reference to those ICW-Ancestors discovered in 404 and queued in 412, to the respective node-fields in the respective VFT's. This entails mostly house-keeping tasks such as updating properties, and building the ICW-A node in the global shared attributes DB. State 806: ‘Evaluate Queued Speculative Trees for addition to VWT’ may add sub-trees created by STS Agents 936 in the ‘Speculative Tree Search’ engine (FIG. 22, FIG. 35) for the User, to the VWT, if there is sufficient confidence and an in-common-ancestor between the Speculative Tree and VWT to which to tie the tree. Going the other way, in state 808: ‘VFT Trees may inherit enhanced sub-trees from VWT, on User option’, it is prudent for User's to absorb high-confidence sub-trees from the VWT, since these sub-trees are created from, and supported by, many other Users. In state 810: ‘Evaluate/Explore Disembodied Cousins’, which is detailed in FIG. 33, FIG. 34., the common ancestors (which are not in both pedigrees) between a User and a DNA match, are evaluated to create ‘fan-out up’ and ‘fan-out down’ collections. A ‘disembodied cousin’ is named as such, similar to a disembodied property list in programming languages, in that it has no name (common ancestor) to bind to between the VFT's. These collections of ICW-DC (In-Common-With Disembodied Cousins) suggest that any MRCA between the two Users most likely is not above a fan-out up vertex, nor below a fan-out down vertex, as explained in the noted Figures. Thus, processing of these vertex nodes, weighted by the number of supporting evidence participants, should prune the MRCA set of the two accordingly to the hypothesis. Next in the flowchart, 812: ‘Virtual World Tree Tending Agents; which are detailed in FIG. 18, FIG. 22., traverse the VFT's looking for confidences to update, or applying changes or mergers requested by other Agents. Finally, in state 814: ‘Speculative Tree Search Agents’ (detailed in FIG. 35) are triggered by the VWT's evaluation of data inputs from 802-810. Like all Agents, the Agent Exchange (AX) is given the request by a VWT Agent, to launch a STS Agent to attempt to connect two Ancestors residing in the VFT's of DNA matched Users. That is, Speculative Trees are built when an MRCA can not be found by two DNA matches, as one or the other has missing ancestors in the expected sub-graphs, and yet, there is evidence to suggest that two sub-graphs have some intersect. For example, if a surname exists in both trees, but the occurrences of each in the respective trees are generations apart, and thus no overlap is possible. The VWT Tending Agents will evaluate, after updating the VWT and determining that the VFT's of a DNA match pair have exhausted all basic explorations and updates, whether to ask the AX invoke the STS-Agents.

2. The illustrated system 800 includes:
800: Sub-system “Continuous exploration and growth of virtual trees” (is connected from 112).
802: Propagate enhanced confidences from new MRCA assignments
804: Evaluate Queued ICW Ancestors to add to VWT
806: Evaluate Queued Speculative Trees for addition to VWT
808: VFT Trees may inherit enhanced sub-trees from VWT, on User option
810: Evaluate / Explore Disembodied Cousins, is detailed in FIG. 33, FIG. 34.
812: Virtual World Tree Tending Agents, is detailed in FIG. 18, FIG. 22.
814: Speculative Tree Search Agents, are detailed in FIG. 35.

System 900, “Agent Control System”

1. Continuing from FIGS. 3, 4 and 5, and implementing state 116, Illustrated in FIG. 9 is the Multi-Agent Control System Architecture, in one embodiment.

2. The intent of this system is to support a scalable distributed compute environment in which modular Agents (computer programs) perform various tasks on data that resides either on the User's machine, on a local area machine, or on the main compute cloud. As described in FIG. 40, 4014, the Distributed Agent Control System hardware consists a set of servers which service the requests from Agents running on User's client hosts, family tree servers, the distributed compute environment, and which read/write to the Agent Control Data Db, for example. Also in FIG. 40, the 4016, Agent Exchange Servers, basically route messages between themselves, the Agent Control Servers, and to/from Agents in the field.

3. The illustrated Agents 916-938 are example Agents described herein, but these are expected to evolve and diversity to handle more specific tasks. Agents should be able to, in most part, operate asynchronously on the VFT's and databases of all User's, and should be able to evaluate data local to a User or set of DNA matched Users, wherein ‘local’ refers to a partitioning of the interconnected trees, such that the distance from a User's tree to the boundary results in sufficiently diminishing impact as to make a local analysis at the nodes on the border little impacted, and that border nodes analysis by Agents results in a complete and correct analysis as if the border had been infinite.

4. The Agent Exchanges (AXs) 904 receive inputs 902 (linked to 304) from sub-systems via various Agents, and cooperate through the Agent Management System 906. Agent Exchanges consist of a set of web servers geographically distributed to minimize access time for all client Users, balance loads, and provide outage redundancy. Agents initially communicate and travel through these servers. After establishing themselves as processes on target host computers (closest to the data of interest), they may use regular internet communication paths through TCP/IP and UDP message passing to communicate to the AX or to each other. The 906 Agent Management System, controls the accumulation of data-change triggers (queues), the spawning of new Agents, and the control of message passing between Agents and itself, and its domain-level servers. The 908 Agent Definitions—are a database of modular code run by a multiplicity of distributed Agents. Agent definitions include generic Agent self-transportation code, a communication protocol, interfaces to the databases they operate on (read/write), a state machine defining what it does with the data it reads, and, in some cases, loadable functions or soft-logic, which it applies to the data read to produce outputs. The communications protocol includes, minimally, the 910 Agent Communications Language—messages passed between the Agents, generally through the Agent Exchange to the Agent Management Systems servers. The communication protocol also includes, or consists of, an 912 Agent Genealogic Ontology—which is the language used by the Agents, and their meanings within the context of the system. The loadable functions, or soft logic, include 914, the Fuzzy Logic DB—a set of functions which take various inputs and return a result between 0 and 1.

5. There are numerous Agent types and purposes. Some common Agents described here are shown, including the 916 ‘Conf Agents’, or written out: Confidence Agents, which evaluate confidence using various statistical modalities such as Bayes theorem. In particular, if a node B, which is an ancestor of ‘A’, has a probability P of being an ancestor as specified, and its parents C and D are deduced from data ‘B’ has, along with other evidences confirming the existence of those parents, then the partial probability P(C|B) of C and P(D|B) for D are derived in part from the probability of B, which itself is derived from its descendants, and so on, until we reach the root ‘A’. Thus, the probability of relationship of any ancestor to ‘A’ must decrease as one travels up the family tree. However, the probability of existence of any particular ancestor is a separate calculation, depending on records which associate to that individual. Much of the calculations of likelihood of various data will not immediately derive from sound data, but will have to be estimated and refined. For example, frequency of surnames during certain periods in certain places must be estimated. This may be done by data-mining all evidences of people living in a place at a particular time, listing all the surnames and frequencies of occurrences. To determine the actual number of people with a Surname, the various records must be associated to the likely ancestors. That is, every record gets assigned to a virtual record node (VRN). That VRN may associate to one or more Ancestors in the VFT's of Users, and thence to the VWT. The data-mining system may create floating ancestors who do not associate to any tree yet, and may associate VRN's to those ancestors, with a probability of confidence that they are actually associated. These ancestors represent one-node VFT's, until made primary in the VFT of some User. These ancestors may be associated to each other as well, creating ‘disembodied’ VFT's (D-VFT's), which may continue to coalesce (acquire more members, depth and confidence). Eventually, any one of these D-VFT's will descend to the present era, suggesting that some living persons may be related. It is expected, however, that very few D-VFTs will stay ‘disembodied’ for long, before they become related to at least one User', either as a cousin or direct ancestor. In any case, the accumulation of ancestors and their VRN's into D-VFT's, will facilitate statistical approximation of frequency of surnames in a time and place, if we can assume that the ancestors are a representative sampling of the population living in that place and time. This might not be the case, if we consider that some peoples are less likely to have ‘records’, and perhaps less likely to have living descendants.

6. Continuing the Agents descriptions, the 918, ‘Const Agents’, or ‘Constraint Satisfaction Calculating Agents’, operate on the attributes, applying fuzzy logic patterns, and updating confidence numbers similar to ‘Confidence Agents’, but with pre-defined constraint definition systems. Constraint Agents are employed in evaluation of VFT's, VWT's and in the exploration of ‘Speculative Trees’. The logic used by a Constraint Agent may require the execution of other Constraint Agents to acquire data used in the current level of a constraint evaluation. Thus, a logic function may employ a hierarchy of Constraint Agents. For example, a constraint function may take into account DNA, location, time, place, sex, surname etc. Constraint Agents are also employed in the input stage of the 930 ICW-Ancestor comparison system.

7. Furthermore, Constraints Agents are given an ability to evolve the determination of whether a first VIA is really related to a second VIA by a particular relation ‘R’. This is evolved by letting a plurality of the Agents select sets of fuzzy logic related to the biographic information, and letting them apply weights to the parts, and then applying these Agents to known good or bad relationships, and keeping the best performing Agents. Along with this, a real-time evolution as MRCA-VIA pairings are discovered, by letting the Agents inspect the confirmed relationships, and enhancing weights of logic that fits the biographical data.

8. The 920, VWT Agents, Virtual World Tending Agents, receive inputs and update the VWT. Other duties are described throughout. But to summarize, VWT Agents assimilate high-confidence sub-trees of User's (for example, as resulting from DNA triangulations), and also communicate to other User's VFT Agents, who have an Ancestor that appears in the VWT, to enable them to copy into their VFT pedigree or close cousins sub-trees, the sub-trees from the VWT which help them resolve MRCA questions. The VWT Agents also continuously scan the VWT, and its speculative variation branches, to find probable duplicates, or inconsistencies (as determined by use of Constraint Agents. Furthermore, the VWT Agents may detect potential ‘missing links’ between two Ancestors residing in VFT's of User's who are otherwise DNA matched to some degree, and may trigger a Speculative Tree Search Agent to attempt to connect the two.

9. The 922, Attribute Agents, run data mining on VFT's to find common attributes, not focused on ICW-A matches, and store in a local or global shared attributes DB 428. (FIG. 4., 402). Similar to Attribute Agents, the 924 Proximity Agents, run a data mining on two DNA matched User's VFT elements to determine who could have been proximal to mate (FIG. 36, FIG. 37), and then create ICW-P attribute nodes between the relevant VIA nodes to record this information, if relevant.

10. The 926, Tree Probability Agents, propagate confidences up/down the tree based on new information to dependent variables. These Agents run secondary to Confidence and Constraint Agents.

11. The 928, ICW-M Agents, In Common With Match Agents, run data-mining on ICW-Matches of a pair of DNA matches Users. The theory and analysis of these Agents are described in FIGS. 38, 39, 43-47.

12. The 930, ICW-A Agents, In Common With Ancestor Agents, run data-mining to find ICW-A pairs, etc. as described in FIG. 4, FIG. 20, and FIG. 21 .

13. The 932, DNA Agents, run several DNA mapping sub-systems, partly described in FIG. 10.

14. The 934, VFT Agents, Virtual Family Tree Agents, receive inputs from various sub-systems such as the ICW-A, ICW-M, DNA Agents, and update a User's VFT. They also keep track of changes and report sums to the AX, such that it may prioritize and schedule actions. Actions of the VFT Agents are described throughout these figure reviews.

15. The 936, STS Agents, Speculative Tree Search Agents, perform combinatorial search on subtrees in attempts to find a path between nodes, and are described further in FIG. 22 and FIG. 35. As noted in FIG. 8, these Agents are triggered by the VWT Agents when it is suspected that two nodes (Ancestors) from two VFT's of DNA related Users, may be related, but are separated by at least one missing generation in bother trees.

16. Finally, the 938 Cluster Agents run complex data-mining, which may involve the results of clusters themselves, may span across multiple VFTs and/or areas of the VWT. The MRCA Engine itself, with the competitive network as the comparator function, is a complex, customized Cluster Agent. Other forms of Cluster Agents for MRCA analysis are described in FIG. 48., and (in some forms) are triggered at state 3230 in the MRCA analysis flowchart, FIG. 32. In this system, Cluster Agents 938, data mine the Local Shared Attributes' DB's (LSA-DB) 248 of each User, which contains attributes assigned to VFT nodes (VIA' s), some of which are shared by several or many other VIA nodes, from the User's VFT and his/her DNA matches. As the LSA-DB is populated by simple search Agents, there are a large set of correlated data residing in disparate LSA-DB's. Given that nearly all MRCA's will be discovered by finding the Ancestors, ‘Clans’, Tribes and Communities with common attributes, such that MRCA's are at least drawn together by Clusters, if not specific Ancestors, it becomes a key benefit of this holistic system to be able to actually structure this data, with confidences, constraints, and preliminary prunings (DNA mapping, ICW-Matches), such that these clusters may be discovered, ranked, and linked through activation passing attribute nodes between MRCA-Vdna nodes to draw them and their respective VFT VIA nodes together in a competitive network analysis (or, equally important, to leave them in a reduced set for a smaller combinatorial assignment problem).

17. The illustrated system 900 includes:
900: Sub-System “Agent Control System”, (Connected from 116. Called from FIG. 3, FIG. 4, FIG. 5)
902: User Input Agent Triggers (linked to 304)
904: Agent Exchanges.
906: Agent Management System.
908: Agent Definitions
910: Agent Communications Language.
912: Agent Genealogic Ontology.
914: Fuzzy Logic DB.
916: ‘Conf Agents’, Confidence Agents.
918: ‘Const Agents’, Constraint Satisfaction calculating Agents.
920: VWT Agents, Virtual World Tending Agents
922: Attribute Agents
924: Proximity Agents (FIG. 36, FIG. 37)
926: Tree Probability Agents.
928: ICW-M Agents.
930: ICW-A Agents (FIG. 4, FIG. 20, FIG. 21)
932: DNA Agents (FIG. 10).
934: VFT Agents, Virtual Family Tree Agents.
936: STS Agents, Speculative Tree Search Agents (FIG. 22, FIG. 35).
938: Cluster Agents.

System 1000, “DNA Mapping Influences”

1. Continuing from FIG. 1 and FIG. 6, state 118, Illustrated in FIG. 10 is an flowchart of the analysis and accumulation of various DNA Mapping Influences and the interaction with the DNA Agents, in one embodiment. The 1010 DNA Agents are coded to handle, in part, DNA comparisons, and search for equivalence between a DNA segment and the available DNA on a node's 1012 Chromosome map. To summarize, there are several objectives of DNA Agents, including mapping DNA segments to Ancestors (thus building an implicit chromosome map) after an MRCA is found between the User's. As MRCA's are generally found from the bottom-up (closest relatives first), the User's genome can rapidly partition (map) to the near ancestors, thus cutting the most-likely branch for other DNA matches to the upward sub-trees of the pedigree above whichever highest (most distant) ancestor has this segment. In this respect, the MRCA Vdna node connections to VFT nodes for a particular pair of DNA matched Users, gets pruned to those nodes above the ancestor mentioned (most distant having the DNA segment). The theory of this method is described in FIG. 25, and represented by state 1002, In-Common DNA Segments limited by existing DNA maps to sub-trees. Related to the above pruning of MRCA node connections, each DNA segment is mapped to all possible MRCA connected VIA nodes, as represented by 1004: Reference shared segments to each ancestor in the DNA flow. (Detailed in FIG. 26). Thus, a segment Xis linked, through a special ICW-DNA node, to a set of nodes in a VFT pedigree sub-tree, and in the equivalent tree in the VWT. Every User in the system that fully or partly matches this segment with one of their own segments, will thus have a path of activation to each other from each VIA node in their related VFT's, through the DNA. Thus, during the MRCA analysis via competitive network, all Users who are genetically related will contribute influences to the determination of which Ancestor the segment actually originated from. That is, whatever nodes in the various VFT's have the same or similar attributes (surnames, places, dates etc) will receive the majority of activation, benefiting from all User's evidences. This in effect propagates and shares constraints through the influence of DNA to all Users. As will be explored in FIG. 50, Global Competitive DNA competitive network analysis, on a Global Analysis scale, if every DNA segment is activated simultaneously, and all VFT's are represented in the competitive network, and given that activation packets carry the ID of the DNA from which it originated, and given amplification at nodes which receive multiple activations from the same DNA ID, and given a decay rate of the activations to ensure limited growth and eventual decay, and given further decay on nodes which have competing multiple DNA ID activations for the same chromosome map location, with negative activation sent back on the losing DNA ID paths, and given a similar competition resolution for each DNA ID which is on multiple nodes such that the top Node gains activation while the others decay proportionally, the entire system will ‘settle’ such that each DNA ID should end up with one progenitor Ancestor (and potentially his/her siblings), and that DNA ID should only appear in direct downstream paths from the progenitor(s), and each Ancestor will have no more than two DNA representations for any particular span on the chromosome map. This global analysis will not lock a DNA ID to any particular Ancestor node, but will result in an enhanced confidence of the DNA node being assigned to its ‘winner’.

2. For User facilitation of visualization of the DNA assignments, and potential correlations, there are several DNA tools. The 1006: DNA Map System for each ancestor, will show overlaps (as detailed in FIG. 27). The 1008: DNA Segment flow graph viewer, will enable the Users to track a segment, not just between two users, but by all paths it is found in. (as detailed in FIG. 28).

3. Along the theory of the popularly known ‘Lazarus Project’ [14], wherein the genome of a non-living Ancestor is potentially recreated from the DNA of descendants, the system 1014, via assistance by DNA Agents, will automatically create and add DNA ‘kits’ of Ancestors with multi-segment merges to match population. This system calls: DNA Records 204 and the DNA Match-Makers 206.

4. Not all Vendors provide autosomal DNA data, and some focus solely on the gender specific DNA. To utilize this information and it's unique constraints, the system 1016 supports Paternal (Y) and Maternal (Mitochondrial) DNA Tracking (as detailed in FIG. 29)

5. It is important to clarify, DNA records kept on System servers will be encrypted. As well, segment data shared to Users will be encrypted, and only the chromosome associated, and the ordering, made visible on chromosome browsers. Thus, a User may know that she shares a segment S1 with a cousin, and may know what chromosome it lies on, but will not be able to tell what it is . . . unless both User's share their DNA by some other service. DNA Agents thus must be able to access encrypted data, but must keep it in encrypted format in memory during analysis, to avoid malicious programs scanning the memory to find DNA signatures, and potentially harvesting that data to recreate a User's genome.

6. The illustrated system 1000 includes:
1000: DNA Mapping Influences (connected from 118)
1002: In-Common DNA Segments limited by existing DNA maps to sub-trees. (Detailed in FIG. 25)
1004: Reference shared segments to each ancestor in the DNA flow. (Detailed in FIG. 26)
1006: DNA Map System for each ancestor, to show overlaps (Detailed in FIG. 27)
1008: DNA Segment flow graph viewer (Detailed in FIG. 28)
1010: DNA Agents
1012: Chromosome Maps per User
1014: A system to Create & populate DNA ‘kits’ of Ancestors from solved MRCA triangulations
1016: A unique Paternal (Y) and Maternal (Mitochondrial) DNA Tracking System (Detailed in FIG. 29)

System 1100, “User VFT create and setup”

1. Continuing from FIG. 2, state 216, Illustrated in FIG. 11, is a representative example of the structure of a Virtual Family Tree, and its Virtual Individual Ancestor node's. In this illustration, the graph 1102 represents a draw ‘able part of a Virtual Family Tree. The smiley-face icons 1104, represent Virtual Individual Ancestor Nodes (VIA), and will be used in all figures. That is, a VIA node represents an individual human, in one embodiment. An individual, in the broader sense, represents a DNA mixing and re-combination machine or unit. A unit, in the infinite extension of the model, will represent any and ALL organisms which have received DNA from progenitors, and passed it on to descendants. There will be cases where a speculative, ‘placeholder’ or ‘missing-link’ VIA node is created, which represents no known individual, and may connect between two individuals who are separated by several generations, or even eons. Each node will be have a field in its' record to define the type, and this field will be checked by various systems, such as one calculating the confidence of a node and its' relations.

2. In the recent Human genealogy model shown, each unit receives DNA (computer coded data) from just two parents. It is assumed that the pedigree tree will always be a directed acyclic graph, or DAG. It will not always be a spanning tree. To be clear, this is but one embodiment of the general data flow model. The data in the model presented is DNA.

3. The ledger-icon of 1106, represents a Virtual Ancestor Record, which contains all information relevant to the node, and is further described on FIG. 15. Every VIA node has a VAR. In the graph, enclosed in the rectangle 1108 a sub-tree from 7^{th} generation is shown.

4. Each User is allocated a virtual family tree (VFT) 1102 with virtual ancestor place-holders out to the farthest extent that DNA matches predict a MRCA might lie. Here, the 6^{th -}9^{th} generations (1108) are shown for one ancestor. Nodes and edges form a traditional pedigree view of a family tree. All nodes below the top row have mother and father pointers, although they are not all shown here. Likewise, the continuation of the 6^{th} generation is only shown for one ancestor, both in the Figure and on a computer display, due to space limitations. A pedigree is a directed DNA flow graph, which will almost always be acyclic. An example of DNA flow from a 9^{th} generation ancestor (7^{th} Great-Grandparent) is shown. Some of the Virtual ancestors may be duplicates in reality, as a result of endogamy. The nodes form a light-weight scaffold for connections and confidence data. Only meta-data is stored on the node, and any large images or records must be saved on the User's real family tree. For 10 generations, there will be Σ_{i=1. . 10} (nⁱ)=2043 nodes, including the User root. The root node does not have to represent a living person, as it may be created from DNA collected from a non-living individual by other means. The necessity of creating all nodes to the 10^{th} generation, is that each node is going to be connected to some MRCA nodes, and will be part of the simulation to determine if that node is the actual MRCA.

5. In general, the network of VFT VIA nodes, connected to numerous Attribute nodes, as well as to many MRCA Vdna nodes, acts in a manner similar to multi-dimensional spider web. However, there are at least two networks involved in any MRCA discovery, including one for each side of every pair of Users who are DNA matches. Stimulating the MRCA node of both users causes stimulation (in the form of DNA-packets) to go to all of their eligible candidate VIA nodes in their respective trees. Then, by virtue of their having been pre-populated with connections to attributes, DNA, or ICW-A, ICW-M nodes, activations, in the form of packets, will cross between the VFT trees of the two Users. Given that the system has a built-in decay on these signals, and there are no loops that could lead to infinite amplification, the system will gradually converge down to a set of VIA nodes which surpass a threshold. Those nodes, ranked by final activation levels, are the nodes most likely to be common between the two Users.

6. The illustrated system 1100 includes:
1100: User VFT create and setup. (Connected from 216)
1102: Illustration of a partial Virtual Family Tree
1104: Virtual Individual Ancestor Node (VIA) are represented by a smiley-face icon in all figures.
1106: Each VIA node has, in part, a Virtual Ancestor Record, which contains all information relevant to the node, as described on FIG. 15.
1108: First 6 generations shown but edges are implicit. one sub-tree from 7^{th} generation shown

System 1200, “Create User MRCA Vdna Nodes”

1. Continuing from FIG. 2, state 218, Illustrated in FIG. 12 is an example of one embodiment of the VFT with a User's set of VDNA nodes, with implicit connections from each VDNA to each eligible VIA node.

2. Each User's DNA matches are each represented with a Virtual DNA node, of which several are shown arrayed 1202, which is a predictor for the MRCA between the two. (The terms Vdna, VDNA, MRCA-Vdna and MRCA node are equivalent, when used in appropriate context). Thus, if a User has K=5000 DNA matches, there will initially be 5000 VDNA nodes, as suggested in 1202. The system may create more, if a pair of User's have multiple ICW ancestors who pass confidence criteria.

3. The User's VFT 1204 is shown to illustrate the relationship between the two sets of nodes. The MRCA Virtual DNA (Vdna) nodes should each map to one VFT node. Each node will eventually (if successful) be mapped to one Virtual ancestor per User in the MRCA assignment and optimization stage. The MRCA (abbreviations for MRCA Vdna) nodes are represented at the top, as they signify the DNA shared by Users. This DNA will flow down through the pedigree from the actual common ancestor. We take a view of DNA from the ‘Selfish Gene’ perspective, in that organisms (the phenotype) are created as a secondary effect from DNA, and affects on the environment (attributes) are a tertiary affect. Of course, surnames and culture are parallel evolving entities (memes) which have loose connections to the DNA, and it will be noted that such items are abstracted to the greatest extent possible, to avoid anthropocentric biases and distorted assumptions.

4. MRCA Nodes Are ranked 1206 by Predicted genetic Distance between Matched Users. This ranking may be saved as a specific distance in generations, or as a span of generations, or as a probability distribution function. The ranking method will primarily depend on information obtained from the various Genetic Matching Vendors. The mapping of Vdna nodes to VIA ancestors is an optimization and constraint satisfaction problem, and should lead to overall improvements in the VFT's of involved Users.

5. The illustrated system 1200 includes:
1200: Create User MRCA Vdna Nodes. (connected from 218)
1202: Example array of MRCA Vdna nodes
1204: Example of related VFT VIA nodes
1206: Groups of MRCA Vdna Nodes ranked by genetic distance

System 1300, “MRCA Assignments Display”

1. Continuing from FIG. 7, state 704, Illustrated in FIG. 13 is an example of a display of two DNA matched User's, with a chosen VDNA, and a path through the VFT's to the User, in one embodiment. In the illustration, 1302 on the left represents the display of User A's Virtual Family Tree with a pedigree path of Virtual Individual Ancestor (VIA) nodes shown from the User to the MRCA-Vdna node selected. The path connectors will have a thickness proportional to the confidence in that connection. On the right, 1304 represents User B's Virtual Family Tree with a pedigree path of Virtual Individual Ancestor (VIA) nodes shown from the User to the MRCA-Vdna node selected. The rectangle 1306 around the VFT nodes represent, in this simplified view, the nodes to which the MRCA nodes connect. Only a sub-set of the 6^{th} -9^{th} generations (which in this case, are the eligible nodes) are shown inside the boxes, rather than attempt to show all nodes. The 1308 hexagon containing the two Vdna nodes represents that they have been linked together in a Master MRCA-Vdna node, which is associated with the corresponding Ancestor node on the VWT. Clicking on the Vdna node for any ancestor, wherein the Vdna node has been successfully assigned, will result in a star-diagram of all Vdna nodes connect to that node. (see FIG. 42). Clicking on any Vdna node in the star-diagram will display the DNA-match profile page between the primary User and the User represented by the particular Vdna node. In 1310, when there are multiple MRCA nodes associated to one ancestor (on the VWT), they each get registered in the ICW-Match list for the Ancestor, and are thus connected together. The ICW-Match system is described in FIG. 38,39.

2. The two DNA matched Users' A and B will eventually have at least two Ancestor VIA nodes connected via joined (Vdna) MRCA nodes, associated to the master MRCA-Vdna attached to the master VIA node in the VWT. The confidence level of a VDNA MRCA assignment is determined, in part, by the strengths of the paths from each root through their pedigree to the MRCA (the confidences in each node and relationship link). Note that the VDNA selection for User' A will contribute to a relative optimality metric for User's A's assignments, while the equivalent VDNA for User B will have a separate relative optimality metric for User's B's assignments. Each may lead to an optimal ‘local’ assignment, but may lead to a sub-optimal global assignment. Thus, a local assignment optimization (FIG. 7, 30-32) is accompanied by a global optimization analysis (FIG. 48). The local assignments should occur first, as it is predicted that at least 70 % of assignments will be optimal in the local assignment, which is computationally much more efficient and can be done in parallel on User's computers, or distributed compute farms. The global assignment optimizations require, in one mode, massive compute resources to run evolutionary algorithms. In another modality (FIG. 50), the entire system of computers and networks are involved in an on-going accumulation of data (activations) which lead to self-solutions (common ancestors between VFT's grow stronger in their connectedness).

3. The illustrated system 1300 includes:
1300: MRCA Assignments Display sub-system, (connected from 704)
1302: User A's Virtual Family Tree with a pedigree path of Virtual Individual Ancestor (VIA) nodes shown from the User to the MRCA-Vdna node selected.
1304: User B's Virtual Family Tree with a pedigree path of Virtual Individual Ancestor (VIA) nodes shown from the User to the MRCA-Vdna node selected.
1306: A set of nodes which are connect to the MRCA node of the currently reviews DNA match.
1308: The hexagon indicates two local VFT VDNA linked together in a Master MRCA-Vdna node.
1310: Multiple MRCA nodes associated to one ancestor (on the VWT), get registered in the ICW-Match list for the Ancestor,as described in FIG. 38,39.

System 1400, “MRCA Annotations to DNA Match Trees”

1. Continuing from FIG. 7, state 718, Illustrated in FIG. 14 is an example of the post-MRCA assignment information annotation to the affected Virtual Family Trees, in one embodiment.

2. After at least an initial MRCA assignment phase has completed, when a Users selects a DNA match to evaluate, they may choose to see two facing pedigrees 1402 (as per FIG. 13), one for themselves, and the other for the presumptive relative. Each ancestor that was assigned an MRCA (for any DNA match), will have an indicator of that match on the ancestor node (as a DNA icon 1404), along with the confidence in the match overlaid. The confidence that this match is correct is written to the icon. Clicking the icon will take the User to the respective DNA match page. Of course, if the DNA match to another User also is an ICW-Match, it is possible that several Users' share the MRCA. For the nodes with potential as MRCA, clicking the icon will display a page which lists the factors (dominant attributes) that were principle in the evidence used in the assignment.

3. If an MRCA node has been assigned for the current match, that node will be high-lighted (here shown as an extra circle around the node). For other nodes that could be the MRCA (ie, that have not been assigned to another match with fair to high confidence), the rank of each node will be indicated (1 for highest, counting up for each alternative node progressively, with the ranking ordered according to the calculated probability of the match). It is recognized that the pedigree display of two Users, out to the distance of an MRCA beyond the 6^{th} generation, will be prohibitively dense. Thus, various display control features will be provided, such as showing only the branch containing the MRCA, starting at several generations lower, such that the MRCA is shown with one generation earlier (in time), and several generations later. The User always has the option to display other branches.

4. The illustrated system 1400 includes:
1400: Sub-system “MRCA Annotations to DNA Match Trees” (connected from 718)
1402: A dual pedigree view of the two VFT of the User's A currently selected DNA Match, User B.
1404: DNA Icon indicating this node has been matched as an MRCA with another User.

System 1500, “Confidence and Constraints Agents Launch”

1. Continuing from FIG. 5, state 510, Illustrated in FIG. 15 , 1500 “Confidence and Constraints Agents Launch” is an example of the Virtual Ancestor Record, and several Agents interactions with it and the Fuzzy Logic DB, in one embodiment. The ledger-icon 1502, represents a Virtual Ancestor Record (VAR), which records all attributes assigned to the node, weights and confidence factors as metadata. Every VIA node is associated with a Virtual Ancestor Record. This record includes entries for every evidence item associated to the Ancestor, along with generic biographical information. The VAR is visited by the 1504 ‘Constraint Satisfaction’ Agents which operate on the data, using rules from the 914 Fuzzy Logic DB. The 1506 example Fuzzy logic DB contains definitions of logical calculations based on the VAR attributes, relationships, and expert opinions. The 1508 example ‘Confidence Agents’ traverse the tree looking for changed data, and when seen, updates the relevant confidences where possible.

2. When a record also points to an attribute node (in either the local or global shared attributes databases 248), the link to that node will be likewise updated (in terms of confidence weight). If an attribute node link goes to zero, and has no other links, then that attribute node is deleted. Generally, any change will cause a ripple-effect, in that most confidences are dependent on others. Thus, the system must take the particular tree ‘offline’ for a short time in order to figure out which nodes or fields to update first. The intent is to evaluate the probability that the elements or evidences are true, in light of the other evidence available, and with application of ‘expert’ knowledge in terms of likelihoods and logical constraints. Two columns per row include the W: Weight, and P: Confidence factor. The weight defines the importance of the element, and the column P is an estimate of confidence in the value.

3. The illustrated system 1500 includes:
1500: Sub-system “Confidence and Constraints Agents Launch”, (connected from 510)
1502: Virtual Ancestor Record (VAR), which records all attributes assigned to the node, weights and confidence factor.
1504: Example ‘Constraint Satisfaction’ Agents operating on the data, using rules from the Fuzzy Logic DB.
1506: Fuzzy logic DB contains definitions of logical calculations based on the VAR attributes, relationships, and expert opinions.
1508: Example ‘Confidence Agents’

System 1600, “Constraint Satisfaction Agents”

1. Continuing from FIG. 5, state 508, Illustrated in FIG. 16 is an example flowchart of a Constraint Satisfaction Agent's interaction with the Virtual Ancestor Records and Fuzzy Logic DB, in one embodiment. The 1600: Constraint Satisfaction Agents Sub-system flowchart illustrates one embodiment of a confidence calculation done by ‘Constraints Agents’, which may employ functions from the fuzzy-logic DB. (connected from 508). The 1602: Constraints Agents are triggered by change of data or new data events. The 1604: Virtual Family Tree ‘Virtual Ancestor Record’ (VAR) read and written to by the Agent. In state 1606: For each item in record, the Agent applies an appropriate fuzzy logic sub-routine from Fuzzy Logic DB 914, if needed. In 1608: New confidence metrics are generated. Interpretation of the fuzzy logic example in 1606: Was the child born after the mother was of child-bearing age, and before she reached 45, plus, is there evidence that the mother lived near the place-of-birth of the child, plus, are there any records common between the two, such as baptismal, census or Wills. This is an example of one embodiment of one function. For example, this function could be expanded to include an exclusion of multiple children born in the same year, but on different dates. When constraint violations are found, the field is accordingly flagged. In state 1610 the new data save to VFT DB. In state 1612: Confidences are updated back to the VAR. As with the ICW matching algorithm, the constraints fuzzy logic evolves over time, through direct programming and learned optimal coefficients.

2. Generally, If a path is found to an ancestor who is common to at least one other DNA cousin, a degree of confidence is assigned to that ancestor which is larger than just the sum of the confidences attained from its own accumulation of evidences. That is, the DNA match imparts a portion of confidence. If there is only one common ancestor found between two DNA matched Users, then that ancestor gets all of the ‘confidence bonus’ of the DNA match. If there are N matches found, then each gets 1/ N portion of the bonus.

3. As an example of one embodiment of a confidence calculation, the field ‘Num Triangulations: #’, represents the total number of unique DNA based triangulations to this Ancestor by various Users. This represents not just the triangulations found by the User of the VFT in which this VAR resides, but all triangulations to the same Ancestor, found by all Users. Thus, this information must be saved in the VWT. However, there may be many triangulations which originate from a same offspring of the MRCA individual. This sort of redundant triangulation is not as meaningful as those which originate from unique offspring of the MRCA, as that offspring with redundant triangulations might be false. Thus, for such redundant triangulations, the count will be incremented by a fraction which is, as an example of one embodiment, K32 1/ (1 +S+T), where S: number of triangulating offspring of the individual, T: number of redundant triangulations under the tested offspring). Thus, if an individual has 8 offspring, of which 3 have triangulations, and one of those has 5 triangulations, then K=1/(1+3+5). It should be clear that this function puts priority on unique triangulations through offspring, and reduces impact of the metric the more the count of redundant triangulation contributions.

4. The illustrated system 1600 includes:
1600: Constraint Satisfaction Agents Sub-system flowchart (connected from 508)
1602: Constraints Agents triggered by change of data or new data even
1604: Virtual Family Tree ‘Virtual Ancestor Record’ (VAR) read by Agent
1606: For each item in record, Agent applies appropriate fuzzy logic sub-routine from Fuzzy Logic DB 914
1608: New confidence metrics are generated
1610: New data save to VFT DB
1612: Confidences are updated back to the VAR.

System 1700, “Tree Annotation Agents”

1. Continuing from FIG. 5, state 512, illustrated in FIG. 17 is an example of the information display of one node from a Virtual Family Tree, in one embodiment, and describes 1700 Virtual Family Tree Annotation Agents, (connected via 512). In the figure, 1702 VFT Agents act on and update the VFT VIA node's display data. In this display, 1704 represents that the lines of the connections to the parents and children are weight and style adjusted to indicate confidence. Examples of the styles applied include: (where P is the confidence of the edge) Green: P>0.75, Orange: 0.5<=P<=0.85, Red: P<0.5, Size: proportional to P, for color-sight limited Users, and Dashed lines: Relationship person, may not exist, or may be speculative. The minor boxes on the left of the display box include
a. 1706: Nodes which are the MRCA of two or more Users have a DNA triangulation icon and count, Clicking this will take the User to the browser utility of FIG. 42. Note that the DNA triangulations here are not just from the User to his/her DNA matches, but from any User who has a DNA triangulation to this node. This relies on the VIA node being paired with a corresponding VIA node in the VWT (Virtual World Tree). All MRCA-Vdna discoveries are registered to the appropriate nodes in the VWT. If the DNA Triangulation count is 0, then this icon may display the number of ICW-Ancestors converging up to it, or down to it. The display is simply the letters ICW-U or ICW-D, and the number of such nodes above or below. This is further described in FIG. 34.
b. 1708: If known, the flag of the Country where the ancestor died is displayed
c. 1710: If known, the flag of the Country where the ancestor was born is displayed
d. 1712: A User-chosen image may be displayed

2. As indicated by 1714, relatives images will be collapsed to just an icon of the main image, the Name and Date-of-Birth (DoB) and Date-of-Death (DoD) . . . If relevant. The Down-arrow expands the view to the full view as shown in the central ancestor.

3. In the main fields of the individual display box, 1716 there are several standard fields. The field “ICW-M: ## (Link to Users list), if clicked, will display a dialog box with a list of other User's IDs, when those User's MRCA with the primary User have been narrowed down to be isolated to the current node, or vicinity. The ## will be replaced with the number of such ICW-Matches associated to the node. If the current node happens to be an ICW-A, then it will always have at least one ICW-Match. This is described further in FIG. 43.

4. Missing from most ancestry graphing systems, is the ability to quantify and display the confidence in an ancestor, and to easily see whether their POB/DOB and POD/DOD coincides or realistically overlaps with their parents and children. Enormous time is wasted jumping into profiles to examine details that could be visually displayed, and simultaneously compared with surrounding relatives. Also, it is not possible, in known systems, to see if an ancestor in a Users' tree is also in the tree of DNA matches.

5. The illustrated system 1700 includes:
1700: Tree Annotation Agents, (connected via 512)
1702: VFT Agents update displays on VFT VIA nodes
1704: Coded relationship lines
1706: MRCA count, clickable to display the browser utility of FIG. 42.
1708: Flag of the Country where the ancestor died
1710: Flag of the Country where the ancestor was born
1712: A User-chosen image may be displayed
1714: Collapsed boxes for relatives.
1716: Main fields with various biographical information as shown, in one embodiment.

System 1800, Virtual World Tree Annotation Agents

1. Continuing from FIG. 5, state 514, illustrated in FIG. 18 is an example of the ‘Statistics View’ elements as related to a Virtual Family Tree node, in one embodiment. Virtual World Tree nodes include data from all contributing User trees, but also allow said User's to input subjective votes on attribute confidences in the ‘Stats’ view. The 1804 Stats View includes columns for attributes, Probability and Weights, and for each row: the associated weight, calculated confidences, User voted confidences and User comments, and Input facility for User' Votes. The ‘Stats View’ is initialized and maintained by the 1802 Virtual World Tree Tending Agents, which determine what needs to be done to keep nodes up-to-date.

2. The illustrated system 1800 includes:
1800: Virtual World Tree Annotation Agents collect data from the VFT nodes
1802: Virtual World Tree Tending Agents determine what needs to be done to keep nodes up-to-date.
1804: Virtual World Tree Stat View for a VIA node

System 1900, “Confidence Recording and Knowledge Management”

1. Continuing from FIG. 5, state 512, illustrated in FIG. 19 is an example of the relationship of confidences (decreasing) going up a branch of the VFT, in a form similar to a Bayesian Belief Network. in one embodiment. This 1900: Confidence Recording and Knowledge Management sub-system, includes 1902: Each VFT VIA node has a VAR record, 1904: The VAR record has fields indicating various attributes, connections and confidences, such as the confidence in a relationship, and 1906: The VFT Agents and VWT Agents contribute inputs and calculations to the VAR records.

2. The system of Agents, data and confidences on Ancestors, attributes, relationships and propositions (MRCA and Speculative Trees) collectively form a system of Knowledge Management. In this system, according to documentation and constraint satisfaction algorithms, each ancestor is given several metrics of confidence regarding such biographic propositions such as their date of birth, place of birth, parents, spouses, children, etc. Every item of information assigned to, or associated to them is given a confidence estimate. Users are allowed to input these values, but they may also be estimated by the Confidence Agents.

3. It should be noted that any particular node may have very high confidences on attributes confirming their existence (ie, a historical figure), but the confidences in relationships from the User' root to that node will always be decreasing.

4. It should also be clear that this system of attributes, weights and probabilities is a form of a Bayesian Belief Network. However, the set of variables and relationships are usually standard and highly repetitive across nodes, and thus only the minimal data are stored. The Agents are imbued with calculation templates called Fuzzy Logic DB, which emulate the process of model evaluation in a formal Bayesian Belief Network. The same system of Knowledge Management used on VFT's, also applies to VWT Agents tending to VWT confidence propagation.

5. The illustrated system 1900 includes:
1900: Confidence Recording sub-system, (connected from 512)
1902: Each VFT VIA node has a VAR record
1904: The VAR record has fields indicating various attributes, connections and confidences, such as the confidence in a relationship.
1906: The VFT Agents and VWT Agents contribute inputs and calculations to the VAR records.

System 2000, “ICW-Ancestor Search Agents”

1. Continuing from FIG. 4, state 404, illustrated in FIG. 20 is a flowchart and illustration of the operation of In-Common-With Ancestor discovery and integration, in one embodiment. In general, the ICW Ancestor Matching System runs a function P=Equiv(Xᵢ,Yⱼ), where the function ‘Equiv’ is a complex adapting association network in one embodiment. The Agents scan the VFT in search of shared attributes in the most-likely areas first, ie, common surnames and ancestors who lived in the same time/places. The search spaces are also reduced due to DNA pruning and association networks built up by data-mining clusters and associated attributes. The system may use brute-force analytic attribute comparisons, or may employ learning systems with positive reinforcement upon successful triangulation, as described further in FIG. 48. The states of the system are described specifically below. Briefly, this embodimentl: 1) Searches two trees for similar nodes, 2) Creates an exchange node for similar nodes, 3) Links exchange node to attribute tables of both nodes, 4) Marks branches (parent, children edges) for evaluation, 5) Spawns, or queues, Agents to walk connected edges, 6) connects match nodes to the VWT as well, 6) grow the VWT with matches and corroborated edges.

2. ICW-A nodes discovered in the Pedigrees are registered with respective MRCA-Vdna nodes for the DNA match pair. These common ancestors have a high probability of being on the path to the MRCA, depending on the degree of endogamy in the pair's trees. The MRCA matching engine may be run, after all User match pairs have been data-mined for ICW-A's, and through the competitive process, the ICW-A's will have their weights to the MRCA adjusted.

3. The pedigree comparison tree for a User and DNA match will have options of what data sets to display. The MRCA engine, will register the results of tests in accordance with the type of test run. Thus, Attributes only (surname, place), ICW-A, ICW-M, ICW-DNA, ICW-DC (Disembodied cousins) and ICW-P (Proximity analysis) results will be viewable independently or combined.

4. The illustrated system 2000 includes:
2000: ICW-Ancestor Search Agents sub-system, (connected from 404)
2002: VFT Records for ‘Selected’ ancestor pairs. Illustrated are two VFT appearing as clouds, with one VIA node actually shown for each, an Ancestor X and Y. It may be assumed the cloud represent the full VFT for each. Each VIA node has a VAR record as indicated by the rectangle pointed to by nodes X and Y.
2004: The Agent Exchange (AX) proxy dispatches Agents and passes messages between Agents and the Agent control engine.
2006: The ICW-Ancestor Agents run the actual comparison of two Ancestor nodes, and output the confidence, P>h? Where P is a floating point number between 0 and 1.
2008: The AX gets the result, and if P>h, where h is a threshold that may adjust, the information may be registered in the Shared attributes DB 248, and may be passed to the VWT Agents for updating, or creating, the equivalent node in the VWT 244. p1 2010: The VWT Agents accept the information from the AX and update the VWT accordingly.
2012: Repetition State: For all VFT Ancestors (X,Y) between DNA Matched User A, B, the following steps are run:
First, all ancestors are ordered by date of birth, such that only ancestors who lived during the same years will be compared.
Next, the set is reduced to only those which could have lived in the same locality (ie, Nation). Next, those individuals with equivalent, or traditionally similar Surnames are ranked higher. Finally, the attribute contexts of the Ancestors are compared, adding weight to those with shared data.
2014: ICW-A Agent Collects the attributes from both and applies to inputs on a matching algorithm.
2016: The algorithm sub-system is run, with the output being the calculated probability P of X,Y being the same entity
A trained neural-network ancestor matching system is described in FIG. 21.
2018: If P> threshold h, then an ICW-A Match node is grown between X and Y, with weight proportional to P. This node will be saved in the VWT.
2020: The ICW-A Attribute is updated on both X and Y Ancestor nodes
2022: Results are registered in the AX such that VWT Agents may update the VWT and the Shared Attributes DB
2024: ICW-A Nodes registered with respective MRCA-Vdna. MRCA Assignment Engine may be run for 1^{st} order assignments

System 2100, “ICW-A Agent FFNN Matching Function”

1. Continuing from FIG. 4, state 404, illustrated in FIG. 21 is an example of for In-Common-With Ancestor discovery via pattern matching, in one embodiment, a feed-forward Neural Network (FFNN), of the matching AI algorithms. In this system data from records of two compared ancestors are fed through a multi-stage feed-forward neural network. The network is pre-trained on partial and full data from known matches and examples of similar but non-equivalent ancestors for negative feedback (the manner of training may vary, but a Kohonen Learning Rule [15] with bias applied to unresponsive nodes is one example). Training adjusts the weights of the interconnects. The network may continue to learn as Ancestors are found to be proven equivalent by DNA or triangulations. The inputs are pre-processed by a Constraint Agent to ensure at least a minimal likelihood of equivalence. If any constraints fail, the system immediately returns a negative result. Generally, a fail occurs if the two are from different non-overlapping generations (time), non intersecting travels (space). Typically, the calling system will call this with one ancestor from each of two DNA matched Users, and if the return value is above a threshold, then an ‘ICW-A’ attribute node is grown connecting the two, with the connection weight proportional to the match confidence. If the engine returns a value below the threshold, then the ICW-A node will die (be deleted). In the MRCA engines, ICW-A matched Ancestors in the Pedigrees of two DNA Matched User's are generally expected to be common ancestors, even if there are more than one. The specific states are elaborated below:

2. The illustrated system 2100 includes:
2100: Sub-system “ICW-A Agent FFNN Matching Function”, (connected from 404)
2102: Two VFT VIA nodes, X and Y, will be compared, receiving data from the respective VFT for each respective VIA node.
2104: Parsing and feature extraction, takes equivalent data from the VFT's nodes being compared, pulling their relevant values and confidences, and inserts into the network input fields as illustrated.
2106: First input layer, connected to principle features. Note that equivalent nodes are cross connected between X and Y. An analysis is done of the similarity of each attribute type (ie, Surname, place of residence, time of residence), and an initial estimate is given for the weights based on the confidence of the association of the attributes. In some data item pairs, a call of the fuzzy-logic DB may be employed to calculate the equivalence of various data types. If the Constraint Agent returns a fail, the match exits with a negative return value.
2108: Hidden layer(s) supports correlations and weightings of data from one ancestor. Note that each node connects to each node in the prior and next layer.
2110: First output consolidation layer, Learned Dominant features
2112: First combined input layer
2114: Hidden layer(s) supports correlations and weightings of data from two ancestors. Note that each node connects to each node in the prior and next layer, in the common full cross-switch N×N network.
2116: Output layer. When all outputs have been received and calculated, the next state is run.
2118: Summed and normalized inputs from output layer form the output Match probability.
2120: If the Match probability is sufficiently high, the attributes cross-connected in layer 1 (2106) are connected as such in the Shared Attributes DB (248), which plays a major role in the MRCA Engine analysis.

System 2200, “Virtual World Tree Tending Agents”

1. Continuing from FIG. 8, state 812, illustrated in FIG. 22 is an example of a ‘Virtual World Tree’ Tending Agent harvesting commonalities between two trees to grow the VWT, in one embodiment. Virtual World Tree Tending Agents find commonalities between trees of DNA matched Users, and leverage that implicit probability of commonality to find connections and tree growth opportunities. Speculative connections, or even ancestor nodes, may be added to the VWT, with the set of evidences used to suggest the nodes or connections. These suggestions will be given priority by the VWT growth system. When the a VWT Tending Agent find a node, or branch, in a VFT which has a significantly lower attribute confidence rating, or overall confidence rating, as compared to the equivalent node or branch in the VWT, the Agent will send a hint to the VFT Annotations Agents, which will present this information to the User in the form of a ‘star’ on the concerned record, and as a list. The information will include the identification of the node, a link to that node, the fields concerned, the lower rating on the VFT, and the higher rating from the VWT, and a link to the VWT node or branch. The User will be give the option to automatically update their data with the VWT data. Note that all User's may vote on the confidence and accuracy of VWT nodes and fields.

2. While VWT Agents walk the web of the VWT nodes and may run comparisons against User VFT's, this process is myopic and can only check the immediate neighborhoods of nodes and edges to find potential overlaps. For non-local searches, a ‘Speculative Tree Search Agent’ service (FIG. 35) must be used, which can actually build many permutations of small networks to attempt to fill missing links between ancestors suspected to be related.

3. The illustrated system 2200 includes:
2200: Sub-system “Virtual World Tree Tending Agents”, (connected from 812)
2202: Given a pair of DNA matched User's A and B, a VFT Agent or VWT Agent will compare the two when triggered through the Agent Exchange.
2204: A signal may be sent to the Agent exchange indicating the two nodes which overlap or appear to be adjacent
2206: A VWT Agent will receive this signal, and depending on the type (overlap, adjacent or possibly related), will either attempt to add it to the VWT itself, or will pass it to a Speculative Tree Search Agent.
2208: The VWT is examined to see if either or both of the nodes already exist, and what relationship they might have
2210: In the example, it is found that the two nodes are in the VWT, but not connected. In this case, the connection is made, with supporting evidence from both nodes to create the confidence level in the VWT. A local copy of the regions of the family trees from both users, and from the VWT is made first, in order to test the changes before committing to the VWT.
2212: This information is saved to the VWT.
2214: For cases where there is not a direct overlap between nodes, or a direct adjacency easily proven by the VWT Agents, the Speculative Tree Search (STS) Agent sub-system may be invoked either automatically or manually. The relevant parts of VFT A an B must be updated or added to the VWT first, to facilitate the STS Agents focus on combinatorial search.

Illustration 2300, MRCA Engine Example 1

1. Continuing from FIG. 7, state 712, illustrated in FIG. 23 is an example of initial MRCA-Vdna VIA candidate set assignment for one pair of DNA matched Users, in one embodiment. As an example of MRCA assignment problem, the figure illustrates: User ‘A’ 2302 genetically matches User ‘B’ 2306 by some degree, which defines a genetic distance range R[x,y] for the likely MRCA. Thus, the set of possible ancestors who might be the match is initially constrained to the sets Rₐ[x,y] 2304 and R_{b}[x,y] 2308. This illustration is continued in FIG. 24.

2. The illustrated system 2300 includes:
2300: The MRCA Engine receives inputs from two or more VFT's, in the form of the MRCA Vdna networks of each, and the VFT's of each.
2302: A first User A's VFT is partially shown, from the root up a couple generations.
2304: User A's VFT set of nodes which are eligible for connection to the MRCA Vdna being test is partially shown. There will be connection from the Vdna to each of these nodes.
2306: A second User B's VFT is partially shown, from the root up a couple generations.
2308: User B's VFT set of nodes which are eligible for connection to the MRCA Vdna being test is partially shown. There will be connections from the Vdna to each of these nodes.

System 2400, MRCA Engine Example 2

1. Continuing from FIG. 7, state 712, illustrated in FIG. 24 is an example of reduced MRCA-Vdna VIA candidate set assignment for one pair of DNA matched Users, in one embodiment. Also, continuing the example of FIG. 23, two DNA matched Users are represented as a first User ‘A’ (2402), and a second User ‘B’ (2406). User A and B are DNA matched, with the genetic distance minimum and maximum range estimation having been used in FIG. 23 to initially constrain the set of potential MRCA Ancestor nodes in the pedigree of each.

2. In FIG. 24, the set of Ancestors eligible for User A have been encircled in a further reduced set Rₐ[x,y] 2404 and similarly for User B in R_{b}[x,y] 2408. These ancestors in the two sets have been connected through a weighted network, by first connecting each ancestor to an MRCA Vdna place-holder, and incrementally to nodes 2416 which are symbolic of attributes shared by two or more individuals—which might be surname, place, time, ethnicity, religion, DNA overlaps, or shared documents. As noted, connection strengths are proportional, in part, to the confidence in the associated attribute, and in part, on the relative importance of the information. For example, a rare surname for the era and place, shared by two ancestors will get higher weight than common surnames. Determination of the weights is part of the ‘Learning’ in the system. Through this system, constraint propagation is accomplished. In a manner similar to how a Suduko solver [16] constrains options for a particular square and thus reduces the search space for other squares, this system continuously reduces the set of potential MRCA node matches between Pairs of Users, or enhances the likelihood of any two Ancestors (nodes) matching, according to attributes sharing.

3. The illustrated system 2400 includes:
2400: MRCA Engine sub-system, example of, (connected from 712)
2402: A first User A's VFT is partially shown, from the root up a couple generations.
2404: The set of VIA's viable for assignment to User A's current MRCA-Vdna under review is reduced, by various means.
2406: A second User B's VFT is partially shown, from the root up a couple generations.
2408: The set of VIA's viable for assignment to User B's current MRCA-Vdna under review may also be independently reduced, by various means.
2410: The selected VIA (Ka) will be pointed to by the MRCA_{ab} Vdna, once chosen.
2412: The selected VIA (Kb) will be pointed to by the MRCA_{ba} Vdna, once chosen.
2414: The Via's not already chosen have higher availability for other MRCA-Vdna assignments, although there may be more than one MRCA between two Users. This condition is described with 3 cases evaluated.
2416: Once the MRCA's and VIA's have been settled on, the two MRCA's from the two Users' are connected together by direct pointers in their description tables and by a special attribute node, which is stored in the Global Shared Attributed DB 248. All prior MRCA connections that went to all initially eligible nodes according to calculated genetic distance, are now distributed to the reduced set, with the connection adjusted according to probability that any VIA Ancestor is the MRCA.

4. Any particular ancestor VIA node may have many MRCA-Vdna nodes. That is, the ancestor will be the MRCA between the User and many other DNA matched Users. If an VIA is already associated to an MRCA-Vdna node, then there are 3 possible situations, and conflict resolution strategies, with an attempted assignment of a new Vdna:
(i) The VIA nodes of both Vdna assignments pass a litmus test of equivalence. In this case, the two Vdna are merged.
(ii) The VIA nodes of both Vdna assignments pass a litmus test of non-equivalence. In this case, the two Vdna compete for ownership of the VIA. The VIA which has the highest confidence of being in the User's pedigree at the given node wins. The other Vdna-VIA combination is recorded as an alternate, for the User to evaluate. It may be a case of adoption, NPE, or name-change, to name a few. The losing Vdna-VIA owner has this assignment recorded as a dislodgement, and the Vdna is added to a pool of nodes to be re-assigned.
(iii)The VIA nodes of both Vdna assignments have insufficient information and confidence to make a judgment. Both are recorded as a dislodgement in their respective pools, and made available for another round of competitive assignments. Note that the criteria for ‘passing’ is set high on the initial rounds, and only after a competitive assignment round has made no progress on reducing the reserve pool, does it reduce the criteria levels.

5. As MRCA-Vdna nodes are confirmed between two Users, they are linked together into a composite MRCA-Vdna Node. This node may again be merged with by another DNA match, or may have already been a composite node. Clicking on the composite node will display a star diagram (FIG. 42).

6. Example of MRCA assignment problem and constraint propagation: As each ancestor moves closer to an ancestor of one of the User's matches' ancestors (in terms of distance in the phase space), It also generally moves away from other ancestors in that set. Thus, those other, more distant, ancestors become more available for assignment as options for other MRCA's for other DNA matches to the User, which may have Ancestors closer to the now more distant ancestors.

7. Nodes which have sufficiently strong evidence connecting them to an MRCA Vdna node not related to the current DNA match under evaluation, will be cancelled out by stimulating their MRCA-Vdna nodes with negative activation packets (packets are described in FIG. 31). Thus, all VFT nodes which are already associated to an MRCA, will act as an activation sink, or even a negative source. If negative stimulation is sent down an MRCA-to-Via path, and that via happens to be the real MRCA for the new pair under study, then the only way to tell if the 3 VIA's are equivalent is to compare them all. If they all 3 match, then the two MRCA's may be connected (merged). The equivalence test is done, for A, B, C: AB, AC, BC.

Illustration 2500, Example of In-Common DNA Segments Limited by Existing DNA Maps to Sub-Trees

1. Continuing from FIG. 10, state 1002, illustrated in FIG. 25 is an example of using DNA mapping concept to reduce the MRCA-Vdna VIA candidate set assignment for one pair of DNA matched Users, in one embodiment. In this illustration, User ‘A’ 2502 matches User ‘B’ 2504 by some ‘Inherited By Descent’ (IBD) DNA segment 2506, which is known to match to DNA already mapped to Ancestor X 2508 for User A, and thus has an MRCA-Vdna node 2512 associated with it which references that DNA segment. Thus, the search space for MRCA_{ab} Vdna is pruned to the set Y 2510, the sub-tree above X 2508. A DNA Agent will prune the Vdna MRCA node connections for match(A˜B), connections to User A's positive likelihood ancestors, to just those that reside in the sub-tree Y. Pruning means, pruned nodes get no stimulus injection from or to the MRCA Vdna node, as the connection weight has gone to zero, or has been removed completely. Also, if an ICW-DNA attribute node has been generated for segment S1, which provides a centroid cluster of all nodes suspected of having this segment, then those nodes which have been pruned from the possible set are likewise pruned from the ICW-DNA node's links.

2. The illustrated system 2500 includes:
2500: Example, In-Common DNA Segments limited by existing DNA maps to sub-trees., (connected from 1002)
2502: A first User A's VFT first few layers shown, with implicit connection to branches above
2504: A second User B's VFT first few layers shown, with implicit connection to branches above
2506: A DNA segment S1 matches between User A and User B
2508: This segment S1 matches the DNA assigned to VIA X in User A's VFT
2510: Thus, User' A and B's MRCA must be at VIA X or in the sub-pedigree above X, depicted by the box Y.
2512: The MRCAab-Vdna connections outside of this box Y are pruned

System 2600, Referencing shared segments to each ancestor in the DNA flow ‘

1. Continuing from FIG. 10, state 1004, or FIG. 4, state 406, illustrated in FIG. 26 is an example of DNA Mapping Agents assigning DNA segments to VFT and VWT VIA nodes, in one embodiment. DNA mapping Agents 2602, initially triggered by each MRCA discovery, will find and compare the matched DNA segments of the two matching User's records 2604 in order to build a segment (S1 in the figure) to share to the nodes in the respective pedigrees 2606. This segment will be captured in an attribute node, we will call ICW-DNA (In-Common-With DNA). This attribute node binds all VIA's in all VFTs who share that DNA. It does not hold the actual DNA, but rather, records the segment location, start and stop, and points to the Chromosome DB (FIG. 27) entries of the respective VIA nodes having it.

2. If two User's share more than one segment, the DNA Agent will be tasked with attempting to determine which MRCA node gets which DNA segment(s), as described in the next paragraphs. An unambiguous MRCA node with fair confidence will get a single shared segment, as will the descendants of that MRCA in the path between the User's node and the MRCA (the circled nodes in the first User A, 2610, and the second User B, 2612). These segments are registered to a node's Chromosome Maps db entry (FIG. 27), both in the VFT and a representative equivalent node in the VWT, through the AX 2608. In this manner, non-MRCA ancestors in the VWT may accumulate segments from the triangulations of all participant Users. This assumes that the VWT tending Agents have done due diligence to merge equivalent nodes from the various node and sub-tree contributing VFTs.

3. After all of a User's DNA matches have been processed to attempt to find an MRCA, the DNA Agents will cycle through all of the User's unresolved matches to attempt to use the already mapped DNA to guide the search and reduce the MRCA eligible set of nodes (as shown in FIG. 25). Given that MRCA analysis starts with highest confidence matches first (generally, matches predicted to be closest relatives), the accompanying DNA Agents will have populated the MRCA's and paths with this DNA. This DNA serves the purpose of what is commonly described as a ‘chromosome map’. For example, if a User has DNA tested his father, then he knows for every DNA matched User whether the MRCA will occur on his father or mother's line (rarely it may be both), since the second User's DNA segment must either match the father's DNA, or not. The segment shared by the two User's, must have been passed down from the MRCA couple, intact. There is a remote chance that a matching segment accumulated parts, which just happen to match the first User. If a second User's DNA segment matches the first User and the first User's father, then this reduces the search space by half. It may further be the case that the User has solved enough MRCA's to have populated his/her grandparents such that one of them has the DNA which fully or partly matches a new DNA-Matched User. The DNA Agent will have the capability to compare a DNA match candidate User's DNA segment (the one that is matched to the first User) to a partial genome of any VIA node.

4. When two User's share a multiplicity of DNA segments, and also have a multiplicity of MRCA candidates, then the DNA Agent must attempt to isolate each DNA segment to a particular MRCA node. Thus, the DNA Agent must compare a DNA segment to each node between the User' and up to each likely MRCA node (each ICW-Ancestor shared between the two User's), and if not yet found, to any DNA registered to any nodes above the known MRCA nodes. That is, an Ancestor of an MRCA candidate node may have the DNA registered, but will not have passed it down to all descendants, since we dont know a-priori which descendants inherited it.

5. The comparison algorithm and results will be as close as possible to that which is used to derive User to User matches, in order to maintain equivalent measures. When any Ancestor (VIA node) accumulates several segments which overlap, and match on those overlaps, they will have attained information potentially not available in the existing DNA sets of the Users. That is, other Users (or Ancestors) may have DNA matches to the new merged segment of the VIA node, but not have matches on the same segment to other Users. Thus, each Ancestor's DNA is added to the matching pool, with ‘flags’ to indicate that empty zones be ignored. If ignored DNA is common IBS (inherited by state), then it will be considered a match for SNP's that also match and which lie in its span. This form of generated DNA, is utilized in FIG. 50, system 5000.

6. Further, the DNA Agents will be employed by a Cluster Analysis search, which will associate overlapping DNA segments, which are not sufficiently long enough to be high confidence IBD, to also an ICW-DNA Shared Attributes DB node, with special annotation defining its' overlap′ origin, and its' relatively low influence (connection weight). This node will provide a minor bit of attraction between the ancestors which have these overlaps. These overlaps are only recorded for segments in the Chromosome DB which have been used to match two Users. This is further described in FIG. 27.

7. DNA Segment propositions are written to Ancestors (nodes) in both the VFT and VWT, through the AX proxy and VFT Agents and VWT Agents.

8. The illustrated system 2600 includes:
2600: Reference shared segments to each ancestor in the DNA flow., (connected from 1004)
2602: DNA Mapping Agents apply DNA from matching User's to VIA' s, according to several analysis methodologies
2604: User Records are accessed to collect DNA information, keeping it encrypted from User's. Only the general position on the chromosome need be shared.
2608: Information regarding matches, ICW-A, ICW-M, is exchanged through the Agent Exchange to the VFT and VWT Agents and DBs.
2610: A DNA segment found to be associated with a VIA is assigned to it
2612: Other VIA' s nodes in other VFT which have the same DNA segment will share it by several means

System 2700, “DNA Map System for each ancestor, to show overlaps”

1. Continuing from FIG. 10, state 1006, illustrated in FIG. 27 is an example of the generation of a stacked chromosome map with links to associated MRCA Vdna nodes, in one embodiment.

2. Given the example of K=5000 VDNA nodes, as shown in the figure, each node 2702 may acquire one or more DNA segment propositions. Each segment will be registered in Chromosome Maps DB 2704, which has for each a data structure 2706 which affords ability to quickly discover which segments overlap, and by what degree. This data structure may be used for various comparisons, such as the DNA relationships of ICW matches.

3. Clicking on any segment 2710 will align and highlight the associated MRCA-Vdna node and show a dialog box 2714, from whence the User' may follow the node to the various VFT MRCA having that segment.

4. The contents of the DNA segments are encrypted, and the start/stop location is not shown.

However, overlap relationships, order and chromosome relative position may be shown.

5. In essence, the accumulation of overlapping segments is not entirely unlike Contig sequencing [17]. If a User's segment overlaps other User's segments on both ends, and there is triangulation with each, then the overlaps are potentially due to intersecting migratory paths. For example: If two Users' share a segment which, for both, contributes to evidence of a particular ethnicity, then that may be used to provide activations to related nodes in both trees. A connection from each virtual tree root node to the ethnicity attribute node (VAN), with weight corresponding to the percentage of ethnicity out of all ethnicities estimated for the User, will cause (all other things equal), a preference for nodes from each virtual tree which also have connections to that ethnicity. In this respect, Inherited-By-State (IBS) DNA matches, although not coming from a particularly recent common ancestor, may cluster Users according to a smaller set than the entire population. In many cases, a simple IBS differential between potential MRCA candidates is sufficient to change the center of gravity for an MRCA nodes' attraction to one or another branch or ancestor. Thus, the DNA Agents, when evaluating overlaps in the 2708 chromosome map, may create ICW-IBS nodes linking VIA nodes which have the concerned segments. In time, it is projected that each SNP and SNP sequence will have an increasingly specific map of geo-spatial change, which can be used to correlate Users. The DNA Agents will discover these overlaps and register the ICW-DNA attribute nodes, as mentioned in FIG. 26.

6. The illustrated system 2700 includes:
2700: DNA Map System for each ancestor, to show overlaps, (connected from 1006)
2702: Given a User' has K DNA matches, each represented by a DNA segment of some length (or SNP count), usually at least 5 centiMorgan.
2704: A chromosome map, stored on a chromosome Maps DB 236, will be made for each User,
2706: The data structure will retain the start, stop of each segment, and will be an array of minimal size that affords quick determination of overlaps, as shown.
The display presented to the User will also show the overlaps, and will stack segments as necessary.
2708: The set of segments, ordered and overlapping, with a scrolling slider-bar, will show the arrangement of segments, associated MRCA nodes, and other information as desired, including surname, MRCA, location etc.
2710: Clicking on any segment, will highlight the associated MRCA node. There will be only one master MRCA node per segment, as all User's who have this segment will have a link from their MRCA to the master MRCA reference.
2712: Clicking on any MRCA node will highlight the associated DNA segments(s), and will pop-up a dialog box.
2714: The MRCA Dialogue box will display general information about the Ancestor to which it is associated, and will allow the User to bring up the browsers for specific information
Expand MRCA's? [X]: Clicking this will take the User to the Display described in FIG. 42.
View VFT Node? [X]: Clicking this will take the User to the VFT Browser, centering the node for the associated Ancestor.
View WFT Node? [X]: Clicking this will take the User to the VWT Browser, centering the node for the associated Ancestor.
View Phenotype? [X]: Clicking this will pop-up web page which describes the known SNPs on this segment, from SNPEDIA [13].

System 2800, “DNA Segment flow graph viewer”

1. Continuing from FIG. 10, state 1008, illustrated in FIG. 28 is an example of a DNA segment flow graph viewer, in one embodiment. The grey numbered rectangles represent DNA segments hypothesized to originate from the Ancestor. The rectangles, such as 2814, represent individuals, either Ancestors or Users. The crossed-circles such as 2810 represent a cross-over function wherein DNA from two individuals has passed through the node. For visualization simplicity, whole segments from each parent are shown here, although in actual recombination the inherited DNA is a pseudo-random cross-over. However, these segments are the actual segments shared by the DNA matched cousins, and thus must have remained discreet coming from the MRCA's recombination point. This visualization graph system will show a segment (though not its details) which has been passed down to any Users, and which has been verified by an MRCA source. Thus, if a segment (or two segments with an significant common sub-segment) ascends two disjoint trees in the VWT, then it can be hypothesized that the segment originates from an MRCA in either tree, or in an as-yet unknown node. Each segment should be associated to the VFT VIA node by an ICW-DNA attribute node, and should likewise be stored in the node's chromosome DB.

2. This DNA flow graph does not represent phasing, nor the fact that each parent has 46 chromosome. It simply back-tracks segments from Users who have matched to their common ancestors. A segment received by a User may be a sub-set of two or more segments received by other Users. Thus, each Ancestor will have a chromosome map to enable easy visualization of intersects, overlaps and origins of segment evidences.

3. The illustrated system 2800 includes:
2800: DNA Segment flow graph viewer to track a segment, not just between two users, but by all paths it is found in, (connected from 1008)
2802: Given the User' has created a Chromosome map, which follows naturally after at least a first pass MRCA mapping cycle with DNA Agents follow-up.
2804: The User may invoke the ‘DNA Segment Flow Tree Viewer’, which displays a family-tree but instead of phenotypes, it will primarily show genotype information
2806: The DNA segments shown are conceptual. The structure of display will depend on what degree of information the User has on the DNA. Pseudo-segments 1 and 4 are shown for Ancestor A1 in this block, indicating those have been associated to this Ancestor.
2808: For the spouse (mate) A2 of 2806, Pseudo-segments 3 and 2 are shown. Recall that these segments were pushed up the tree, so it is no surprise that they all exist in the sub-tree.
2810: A recombination icon accepts the DNA of two parents, and indicates the recipients (here only one, A3, is illustrated).
2812: The example recipient A3 displays segments received, or otherwise assigned to it. In this case, we indicated that it has 2 segments from each parent.
2814: The recipient A7 has received segment 1 from A3, segment 2 from A2, and segment 5 from A4.

System 2900, “Paternal (Y) and Maternal (Mitochondrial) DNA Tracking sub-system”

1. Continuing from FIG. 10, state 1114, or FIG. 4, state 406, illustrated in FIG. 29 , Paternal (Y) and Maternal (mtDNA) Tracking, includes an example of Y and mtDNA specific MRCA-Vdna candidate set adjustment for one pair of DNA matched Users, in one embodiment. If a male User A (2902) has Y chromosome Y1 (2906), then if one of his Matches (User B, 2904) also has that Y1 chromosome, or one of his ancestors is found to have that chromosome (haplogroup) and there are few other good candidates in the ancestry sets of A and B, then an enhancement connection may be made from the MRCA-Vdna nodes of A and B to the respective VFT Ancestor nodes to impart the added likelihood that the Y chromosome is meaningful and potentially leads to, or is on, the MRCA between A and B (2910). As well, a special ICW-DNA Y-chromosome attribute node (or mtDNA) will be made of the particular Y (or mtDNA) haplogroup, and a connection to it made from each ancestor having that haplogroup. Thus, ancestors from the respective sets of User A and User B, who share a haplogroup, will co-stimulate each other during competitive network analysis. The weights of haplogroup association connections will be greater than shared surname connections, as DNA is real, while surnames are often assumed, and/or acquired through NPE (Non Paternal Events). Note that DNA Agents of FIG. 26 accomplish this data mining similar to normal autosomal DNA handling.

2. The illustrated system 2900 includes:
2900: Paternal (Y) and Maternal (Mitochondrial) DNA Tracking sub-system, (connected from 1114)
2902: User A's partial VFT is illustrated, with a paternal line to Y1
2904: User B's partial VFT is illustrated, with a paternal line to his ancestor Yl, where the break in the line indicates multiple generations could have been traversed.
2906: The Ancestor Y1 has a Y chromosome which has been registered for the VIA node, and to the MRCA between the two Users
2908: Indicates that the Ancestor Y1 in User B's tree is equivalent, and points to the same Y1 DNA segment.
2910: The MRCA Vdna node records a pointer to the DNA segments in common between the two Users, and thus their locations, sizes and types. As has been noted, when there are multiple MRCA nodes associated to one ancestor (on the VWT), they each get registered in the ICW-Match list for the Ancestor, and are thus connected together.
2912: DNA segment flow graph viewer shows the paths of Y segments and mtDNA segments.
2914: Data for the segment flow graph viewer is retrieved from the Chromosome Maps
2916: The DNA Segment Flow Tree Viewer is part of the User Tree editing system (from 1016).

Illustration 3000, MRCA Engine sub-system, concept diagram of connectivity between multiple User MRCA Vdna nodes and their eligible VFT VIA nodes.

1. Continuing from FIG. 7, state 710, illustrated in FIG. 30 is an example of a partial embodiment of the MRCA Engine' Competitive Network with Virtual DNA nodes connected to VFT nodes. In this MRCA Engine sub-system 3000, concept diagram of connectivity between multiple User MRCA Vdna nodes and their eligible VFT VIA nodes, starting with Ancestor A 3002, connected to its VFT nodes (2-4), 3004, we see a VFT extending towards the center of the illustration. The dotted line from node 2 to 1 indicates this could be any sub-tree of the pedigree. This is repeated for four Users: B, C and D. There may be many more Users involved, or just two, but this layout illustrates the purpose and action of the system. At 3006, an MRCA Vdna node is shown, which is the combined representation of the respective MRCA nodes for A and B. Each VFT has independent MRCA-Vdna nodes for each DNA match pair, as each is suspected to be the source of the DNA shared between the two matched Users. Thus, between each pair of DNA matched Users, such as A and B, an Virtual DNA Ancestor (Vdna) node is created every time a new DNA match is registered into the system. This node between them will be connected to every ancestor who could be the actual MRCA in both trees, as described in FIG. 12. As an illustration of Pruning, an X is shown (3012) indicating that this connection from the MRCA Vdna to Via 3 is snipped.

2. The intent of this architecture is to facilitate dynamic constraint and influence sharing through a competitive network. Through a network of activations, a virtual tug-of-war will ensue, wherein the activations will increase or decrease the strengths of the signals between ancestors and the MRCA ‘Vdna’ virtual node. At 3008, another similar combined MRCA Vdna node is shown. In the figure we have 4 Users displayed, and MRCA nodes for each User pair A:B, A:C, C:D, B:D, which indicates A˜B, C˜D and B˜D. There may be more, for example, between A:D, if those Users happen to share sufficient DNA. This is an partial example illustration. This network, from the User nodes through the VFT, including the MRCA nodes, and the attributes nodes (to be shown next), are saved to the Global Distributed Competitive Network at 3010, and Spares Arrays DB (610) in one embodiment. In the ‘Dynamic Distributed Analysis’ embodiment, the VFT's, VWT's and attribute connections themselves form the network.

3. The illustrated system 3000 includes:
3000: MRCA Engine sub-system, concept diagram of connectivity between multiple User MRCA Vdna nodes and their eligible VFT VIA nodes.
3002: Starting with Ancestor A, connected to its VFT,
3004: We see a VFT extending towards the center of the illustration. This is repeated for four Users: A, B, C and D.
3006; A MRCA Vdna node is shown, which is the combined representation of the respective MRCA nodes for A and B.
3008: A similar combined MRCA Vdna node is shown for User pairs A:B, A:C, C:D, B:D. There may be more. This is an example illustration.
3010: This network, from the User nodes through the VFT, including the MRCA nodes, and the attributes nodes (to be shown next), are saved to the Global Distributed Competitive Network and Spares Arrays DB (610).
3012: As an illustration of Pruning, an X is shown indicating that this connection from the MRCA Vdna to Via 3 is snipped.

Illustration 3100, MRCA Engine sub-system, “Competitive Network with Attribute nodes connected to VFT nodes.”

1. Continuing from FIG. 7, state 710, illustrated in FIG. 31 is an example of a partial embodiment of the MRCA Engine' Competitive Network with Attribute nodes connected to VFT nodes. In this MRCA Engine sub-system 3100, concept diagram of connectivity between multiple User VFT VIA nodes, starting with Ancestor A 3102, connected to its VFT nodes, we see a sample sub-set of a VFT extending towards the center of the illustration. The dotted lines indicates this could be any sub-tree of the pedigree. This is repeated for four Users: B, C and D. There may be many more Users involved, or just two, but this layout illustrates the purpose and action of the system. At 3106, an attribute node is shown, with a path of connections extending between User' A's VFT and User B's VFT.

2. This second MRCA Engine illustration presents an example of how a competitive network accomplishes a virtual clustering effect. Each User's ancestors have weighted connections to virtual attribute nodes, mostly positive but sometimes zero or negative, according to their purpose. These attribute nodes represent anything that can be used to cluster associated ancestors together. Most commonly, Surname, places of residence during reproductive years, and the years of reproductive life. They will almost always connect together, if at all, by a weighted line wherein the weight of the line indicates the confidence or relevance. For example, if two Ancestors have the Surname XYZ, even if they are exactly the same name, the confidence is proportional to the frequency of the use of the Surname in the particular era. For place & time attributes, the weight of the connection is proportional to the confidence in the overlap having occurred during peak reproductive years. A singular attribute node will lie between two Ancestors if the attribute represents a specific exact record or object (such as a gravestone) 3110. The weighting of these connections is initially determined during creation, partly by the confidence or importance in the connection, and partly by Machine Learning in the ICW-A matching system. Some attribute types, such as ICW-DNA related, are a result of complex searches by DNA Agents. Some attributes are the result of algorithms applied by the ICW-Match analysis Agents. Yet other attributes are the result of disembodied cousin analysis. Most attribute nodes are created as a result of some exercise of the Constraint Agents, thereby embedding into the attribute the intent of a function based on various constraints. One example of this sort of complex derived attribute node is the ICW-Proximity Attribute Node (ICW-P), which binds together ancestors from different trees who could have crossed paths in their reproductive years, or who could be related (parent/child).

3. Depending on the analysis type, initial stimulation may begin at the MRCA Vdna nodes of a set of DNA matched Users, or at the VFT root nodes, or both simultaneously. for example, if MRCAab [3104] is activated, stimulus will propagate to the MRCA-connected VFT VIA nodes of User A and B. These are the nodes which are considered eligible candidates for MRCA between the two DNA matched Users. Each of these VFT nodes will initially get an equal proportion of stimulus, but will propagate stimulus only proportional to its confidence. Then in the example of Fig.31, common attribute node 3106 will receive a stimulus transmission from both A and B trees. Since this node received inputs from both trees, this node will be dominant in the network after the other nodes decay. Now, this node 3106 will be between the two Ancestor VIA nodes from the A and B trees. In one embodiment, in a second phase, after the first phase has settled, the attribute nodes which have collected activation from multiple VIA nodes, will fire that back outwards, which will end up at the connected VFT nodes. in another embodiment, the attribute nodes pass on any packet which has a confidence value higher than a threshold. In both of these embodiments, the VFT nodes will receive packets that originated from other VFTs. If a VFT node receives a majority of packets of different types (from different attributes), and their sum value (with a sum of packets received from distinct VFT nodes) is the highest of all nodes in the current VFT, it will be dominant. That is, if one VFT VIA receives a larger number of packets from another VIA node in another VFT, then those two Ancestor nodes are, in this minimal case, considered the most similar nodes between the two VFTs. They will receive higher ranking in terms of their connections from the MRCA node, and will be labeled accordingly, per FIG. 14.

4. Although the direct path solution through node 3106 may have settled quickly, there may be other nodes still active, and some may be between other pairs of VFT nodes from the trees, or may be crisscrossing in the network. For example, between User's A and D, we see two paths from the root node of A to D, each going through two connected attribute nodes with 3 total links each. If the sum of the 3 connections between these nodes in the two paths were exactly the same, we would have a tie. Given that the connection strengths are floating point numbers, a tie is highly unlikely. A close tie is likely. In any case, the match suggestions will be ranked according to final, total stimulus received. Infinite loops are prevented by the attribute nodes recording the id's of the packets seen so far, and not accepting a packet previously seen.

5. After this MRCA driven analysis, any VFT VIA node may be associated to multiple MRCA nodes. This may simply mean that the User has DNA matches to several other User's who all share the same common ancestor. But, this would require all of the VFT VIA ancestors to be equivalent. This equivalence will be checked by the ICW-A comparison systems. If they are not all equivalent, then a competitive analysis must be run between the several to see which is dominant. The several MRCA nodes get activated, sending activation through their networks to the VFT nodes, on towards the Attribute nodes, and then back to the VFT VIA nodes. The attributes connecting to the disjoint ancestor nodes must be fitted with negative activation nodes, to ensure one or the other VFT' VIAS wins.

6. The signals are packets sent with the originators ID. The MRCA-Vdna collects these and sorts them. In this manner, the confidence of a particular VIA node acts as a tie-breaker.

7. The illustrated system 3100 includes:
3100: MRCA Engine sub-system, MRCA Engine' Competitive Network with Attribute nodes connected to VFT nodes.
3102: The nodes A, B, C and D, and their connected trees, are repeated here from FIG. 30. The dash-lines indicate that some path exists from the User node to the nodes at the ends of the dashed-lines. This illustration assumes the full VFT of each is represented by the mini-trees draw.
3104: The MRCA nodes are the same as FIG. 30, but connections are not drawn in order to keep the image simple.
3106: A plurality of attribute nodes and their connections are shown. The attributes common between two Users have already been connected or merged here, post the initial Ancestor comparison phase.
3108: The halo' d edges form a path between two VIA ancestors of User A and B.
3110: An attribute with direct connections between Ancestors represents either an ICW-A Ancestor (discovered in the ICW-A matching phase), or an exact object or record, that is indisputably the same no matter who points to it. Whether the record or object actually is associated to an Ancestor is captured in the weight of the connection from the Ancestor to that attribute node. Whether two attribute nodes represent the same thing, time and place, event or other characteristic, are indicated by weighted connections between attribute nodes.
3112: The dashed-lines between MRCAab and the VIA ancestors of User A and B indicate the pre-run eligible ancestors for the 3104 MRCAab node.
3114: Activation traverses the network from MRCA nodes, through VFT VIA nodes, through attribute nodes, and is carried by a small datagram packet, which can be sent via direct TCP/IP or UDP, to optimize data exchange rates. The typical activation packet will include its Origin (name and address of generating node), the Type (ie Surname, ICW-Match, DNA etc), the number of Hops traveled where a jump from one node to another is considered one hop. The Value of its current activation package, which will likely have decayed. And, a Path, which records each node visited, in order to avoid loops. The Path attribute enables back-tracking to build a direct connect between to MRCA nodes which have met criteria to be considered equivalent.

System 3200, “MRCA Engine Flowchart”

1. Continuing from FIG. 7, state 714, illustrated in FIG. 32 is a flowchart of one embodiment of the MRCA Engine process of local and global optimization of MRCA assignments. The 3200 MRCA Engine Flowchart illustrates one path of evaluation of the various networks to assign MRCA nodes. Beginning with state 3102, ‘For All Users’, this system may be run in parallel for local analysis, or synchronized, for global analysis. Next, in state 3204: For a current selected User, for each DNA match of that User, the following may be run in parallel or serial. State 3206: The state marker ‘Start Cycle(s)’ receives a list of DNA matched ancestors to evaluate: Next, 3208: Conditional state: Is there another DNA Matched pair to compare? If Yes: goto 3210, else No: Are all DNA-match pairs compared for User? If Yes: Goto 3222, else No: Goto 3228. State 3210: Begin an evaluation by capturing and updating networks to DB, Set weights. Next, state 3212: The 2 (or more) Selected DNA Matched User's MRCA Vdna nodes are stimulated. If the Engine is called by an ICW-Match post-processing, there may be several MRCA Nodes to stimulate. (FIG. 47). Next, state 3214: Activation packets propagate out from MRCA nodes on all connections to eligible, un-pruned VFT nodes. Next state 3216: The activated VFT nodes then send activation packets out on all Attribute connections. Next state 3218: Attribute nodes sum activations. If sum>threshold, then fire on connections to VFT nodes, or other connected VAR or attribute nodes. The attribute node's summing function is smart enough to ensure that a packet has not passed through its node before, by recording the packets ID. The packet itself will also record it's path, such that the terminal receiving VFT VIA node may share this information (ie, for training the matching algorithms). If the next node is another attribute node, go back to 3218, else Goto 3224. State 3224: The VFT nodes each collect packets, tabulate and score. Tabulation involves collecting packets originating from the other VFT, and ordering them by the originating VIA node. Thus, ‘This’ VIA may be associated to many VIA' s from the other VFT, and finding the greatest association is done by the tabulation. Next state 3226: VFT Node pairs are ordered by Activation strengths. Next state 3232: Save Vdna(x,y) VFT-pair ranks. Call 3236: Rank Vector: Save the VFT-pair rankings as a tuple vector (MRCAxy, VFTₓ-VIAᵢ, VFT_{y}-VIAⱼ, Value). This is used in 3222. Next loop to state 3234 (Start Next Cycle). 3234: State marker: Start Next Cycle

2. State 3220 (from state 3208, after all DNA matches have been evaluated for the User): After the network has settled, the VFT's VIA nodes receiving activation packets are evaluated. A VIA node will sort received packets by the ID's of the sending VFT VIA nodes, and sum their occurrences' activations. The VFT VIA node sending the majority of packets (scaled by importance), is considered the leading candidate for the MRCA between the two User's who are rooted in the two VFTs. The algorithm assigns best VFT ancestors to Vdna Nodes, along with the confidence values calculated. That is one embodiment of the local solution. From state 3222 a global assignment is run, wherein each User's set of DNA Matches' Rank Vectors are weighted by DNA Match level between User and DNA Match. A greedy algorithm starts with highest ranked nodes from all DNA matches, and progresses down.

3. After the apparent matches are evaluated and assigned as MRCA nodes, the lagging or unresolved cases are further evaluated. In state 3228: For all Users, for all DNA matches, collect Vdna+VFT node matches which are below acceptance threshold. Next 3230: Apply N-Cluster algorithms to re-ordering assignments to improve objective function (see FIG. 48). Next state 3238: Off-page connector to 718

4. Particularly important to the success of a competitive network is the setting of the weights between connections. There are various common-sense rules that apply to certain types of connects. For example, from the new MRCA Vdna node to all of its candidate Virtual Family Tree VIA nodes should be equally weighted to each, and preferably, normalized. This is clear as there will be overlaps from many User DNA match pairs, so you don't want one of them contributing excessive influence on a particular MRCA (say, beyond 1), while the others somehow have a lower total influence each.

5. Training: When an MRCA is confirmed by triangulation to several Users, with an acceptable chain of confidence from each User to the MRCA, we can use this for learning the importance of various connections in the actual convergence of the network activation state to the correct MRCA. For example, taking the set of all triangulation confirmed MRCA, and data-mining from their networks the recurrent factors or attributes dominant in the selection of their MRCAs. The dominant factors (connections) may be determined by several means, including simply sorting the weights of the connections.

6. Each User match pair may be run several times to determine if the same settled values are received. For any sets that have multiple solutions, the confidence quota is shared between the several MRCA assignments found—thus ensuring that other User's do not assume an over-qualification of the assignment.

7. ICW-A and ICW-M should be relatively dominant in DNA-match pair analysis. This is ensured by giving the connections to these attributes a high connection weight. Surname attribute influence should be less than in-common DNA connection's influence.

8. The illustrated system 3200 includes:
3200: MRCA Engine Flowchart illustrate one path of evaluation of the various networks to assign MRCA nodes.
3102: For All Users, this system may be run in parallel, for local analysis, or synchronized, for global analysis. Goto: 3204.
3204: For a User, for each DNA match of that User, the following may be run in parallel or serial. Goto: 3206.
3206: The state marker ‘Start Cycle(s)’ receives a list of DNA matched ancestors to evaluate: Goto 3208.
3208: Conditional state: Another DNA Matched pair to compare?
Yes: goto 3210,
No: All DNA-match pairs compared for User?
Yes: Goto 3222
No: Goto 3228
3210: Capture /Update networks to DB, Set weights. Goto 3212.
3212: The 2 Selected DNA Matched User's MRCA Vdna nodes are stimulated Goto 3214. If the Engine is called by an ICW-Match post-processing, there may be several MRCA Nodes to stimulate. (FIG. 47).
3214: Activation packets propagate out on all connections to eligible, un-pruned VFT nodes. Goto 3216.
3216: VFT nodes then send activation packets out on Attribute connections. Goto 3218.
3218: Attribute nodes sum activations. If sum >threshold, then fire on connections to VFT nodes, or connected VAR nodes.
Summing function is smart enough to ensure that a packet has not pass through its node before, by looking through the Path in the packet. If the next node is another attribute node, goto 3218, else Goto 3224.
3220: Algorithm assigns best VFT ancestors to Vdna Nodes. Greedy algorithm starts with highest ranked nodes from all DNA matches, and progresses down. Each DNA match's Vdna also gets respective VFT
3222: User's set of DNA Matches' Rank Vectors weighted by DNA Match level between User and DNA Match
3224: VFT nodes each collect packets, tabulate and score. Tabulation involves collecting packets originating from the other VFT, and ordering them by the originating VIA node.
Thus, ‘This’ VIA may be associated to many VIA' s from the other VFT, and finding the greatest association is done by the tabulation. Goto 3226.
3226: VFT Node pairs ordered by Activation strengths. Goto 3232.
3228: For all Users, for all DNA matches, collect Vdna +VFT node matches which are below acceptance threshold (goto 3230)
3230: Apply N-Cluster algorithms to re-ordering assignments to improve objective function (see FIG. 48). Goto 3238.
3232: Save Vdna(x,y) VFT-pair ranks. Call 3236. Goto 3234 (Start Next Cycle).
3234: State marker: Start Next Cycle
3236: Rank Vector: Save the VFT-pair rankings as a tuple vector (MRCAxy, VFTₓ-ViAᵢ, VFT_{y}-VIAⱼ, Value). This is used in 3222.
3238: Off-page connector to 718

System 3300, “Evaluate /Explore Disembodied Cousins”

1. Continuing from FIG. 8, state 810, illustrated in FIG. 33 is an example of Disembodied Cousin evidence accumulation and Triangulation, in one embodiment. Disembodied Cousin evidence accumulation and Triangulation consists of: For every DNA matched pair of cousins, a scan is made of their trees (connected paths), and for each pair of ancestors who meet a criteria of ICW similarity, an ICW-DC (In-Common-With Disembodied Cousin) node 3306 is created connecting the two, and the ancestors are annotated with meta data indicating to whom they are possibly connected, and via which DNA cousins. This ICW-DC node is stored in the local and global shared attributes DB's.

2. This process is a part of ICW-A search [FIG. 20], but is run with relaxed criteria and a more brute-force selection criteria. That is, all potential ‘blood related’ nodes connected in VFT A and B are extracted and compared, which thus includes the known descendants of pedigree nodes. That is, if VIA X is in a VFT A, then any descendant of X carries DNA that could be in User B, if VIA X happens to be the MRCA, or a descendant of the MRCA. Moreover, the path from X to User B through User B's pedigree will always be a descendant path from X in User A's tree which eventual lies outside the pedigree of User A, so long as User A and B are not genetically identical (ie, twins).

3. The candidate selection criteria involves traversing User' A's pedigree breadth-first, and for each node, attempting to find a similar node in User B's tree, either at a pedigree node or any direct descendant of a pedigree node. The process is repeated on User B's pedigree, with a comparison of every pedigree node to every viable node in User A's pedigree, and every descendant. Each node-pair compared is added to a table to prevent repeat checks.

4. Sophisticated programmers might suggest that this process can be done more efficiently by creating a sorted list of every node in User' A's tree, and comparing each to a sorted list of every node in User B's tree. However, this process of listing the nodes still requires a traversal of the trees to ensure only nodes that are in the pedigree or direct descendants of pedigree nodes are included.

5. The illustrated system 3300 includes:
3300: Evaluate / Explore Disembodied Cousins sub-system. (connected from 810).
3302: Partial VFT of User A is shown, with a VIA node C encircled
3304: Partial VFT of User B is shown, with a VIA node D encircled, which is not in B's pedigree.
3306: Pairs of candidates are passed to the ICW-Ancestor matching sub-system, along with a selection of matching criteria and threshold
3308: Results of the matching are passed to the Agent Exchange, along with the intent.
3310: VFT Agents are notified to update associated nodes with additional information
3312: VWT Agents are notified to update associated nodes with additional information

System 3400, Disembodied Cousin evidence accumulation and Triangulation

1. Continuing from FIG. 8, state 810, illustrated in FIG. 34 is an example of Disembodied Cousin evidence accumulation and Triangulation, in one embodiment. In this continuation of the example of Disembodied Cousin evidence accumulation and Triangulation: In many cases, there will be a clustering of ICW-DC ancestors on a branch of a User's tree. We make a hypothesis that each ICW-DC ancestor may have DNA shared with both of the cousins, and may be in the path of the MRCA. The alternative is that it is a collateral branch, which still holds useful information in clustering. The hypothesis can be weighted by the statistical likelihood that two people in the same era and place shared an ancestor (unless there was significant endogamy), the frequency of the surname associated (a Schuyler might be less common than a Johnson), and other shared attributes which might be rare. If this is true, then the various ICW-DC ancestors must be genetically downstream from a common ancestor.

2. When the ICW-DC's converge down a tree to a common ancestor (A) 3402, we can make a guess that no one above the converged ancestor is the MRCA, as there would have to be an equivalent rate of endogamy in order for all the superior nodes to contribute DNA to an descendant node along some other paths. Similarly, if there is a fan-out below an ancestor (B) 3404, then the MRCA is unlikely to be below the ancestor at the vertex of the fan.

3. Thus, in general, the DNA flows suggests we should grow ICW-DC connections to the nodes at the convergence point of the fan-down tree, and at the funnel of the fan-up tree, proportional to the number of ICW ancestors found, amplified by the number of Users who match each other (see FIG. 29).

4. ICW-DC nodes grown between two DNA matched User's VFT VIA nodes, will have additional information indicating the number of disembodied cousins either above or below, and this information will be used to enhance the strength of the connections. For example, if node X₂ has 3 ICW-DC Ancestors circled, and each of those was an ICW-Ancestor from a DNA match, and each is from a different DNA match, then node X₂ will have data indicating how many ancestors above it have ICW-DC Ancestors connections. This data will be displayed on the nodes info-display (1706), to help the User visualize how many ICW-A lead up or down to the particular node. To assist the MRCA-Engine in utilizing this evidence, for each of the ICW-A's contributing evidence, an ICW-DC node is grown between the ICW-A node of the User and each corresponding ICW-DC node in the cousin's VFT. And, to guide the MRCA-Engine with respect to the evidence of which node is the vertex of a fan-up or fan-down, an attribute node is grown from the presumptive vertex to each of the ICW-A nodes, with the type indicating whether it is a fan-up or fan-down case, how many VIA nodes are involved, and a weight proportional to the count of contributing ICW-A nodes. Thus, when the MRCA engine stimulates a pair of MRCA-Vdna nodes, and those in turn stimulate their connected eligible VFT VIA nodes, an advantage will be given to the vertex nodes.

5. The special ICW-DC nodes will also be sent to the Speculative Tree Search sub-system, which will be able to use the information on the structure of ICW-A's to guide search for a common connection between two otherwise unconnected trees. For example, in 3404, if node X₂ has several ICW-A evidences, and the other nodes each have 1, then we can guess that the reason more DNA matches have ICW-Ancestors below this branch is probably because more of the User's own DNA is associated with that branch than with other branches which have less matches.

6. The illustrated system 3400 includes:
3400: Evaluate/Explore Disembodied Cousins, (connected from 810)
3402: A ‘fan-out up’ clustering of ICW-ancestors, suggesting that if DNA is shared with another User through each circled ancestor, the MRCA is unlikely to be higher than convergence node, here X_{2.}
3404: A ‘fan-out down’ clustering of ICW-ancestors, suggesting that if DNA is shared with another User through each circled ancestor, the MRCA is unlikely to be higher than convergence node, here X_{2.}

System 3500, “Speculative Tree Search Agents”

1. Continuing from FIG. 22, state 2214, illustrated in FIG. 35 is an example of one embodiment of Speculative Tree Search Agents attempting to connect nodes suspected to be related. Speculative Tree Search Agents build ‘what-if virtual sub-trees, when an MRCA can not be found between two DNA matched Users, but the search space has been narrowed down sufficiently to suggest that a particular branch in each tree should intersect. The objective is to find an ancestral path (DNA flow) between ancestors in two trees who may be separated by generations, with no known path between them, but who otherwise have strong hints that they have common ancestors. These hints may come from, as an example, a combination of DNA tree pruning, ICW-M and ICW-A clustering, disembodied cousin analysis, or an MRCA analysis that has left only a few branches as candidates but has found no direct link between two DNA matched Users. Other ‘Expert’ knowledge may be coded in, such as the case of middle names often indicating the surname of some notable ancestor.

2. Speculative Virtual Trees: Given an DNA match between two Users' and a higher probability and resulting hypothesis that the MRCA is associated with a particular branch, then there are various strategies of ‘fill-in’. For example, up-ward exploration from a shallow tree and downward exploration from a deep tree. The search strategy and algorithms vary depending on modality. For example, a breadth-first survey of a candidate ancestors' children, resulting in an ordering of the children candidates based on fit and constraint satisfaction. For another example, choosing the best-fit child and descending depth-first, with again an ordering of the children at the next level down. Here, it is clear that the STS Agents make good use of the Constraints and Fuzzy-Logic DB and attributes on the Ancestor Nodes to determine fitness of candidate nodes.

3. In general, the search progresses with two nodes, a top and bottom (X and Y and 3514). Each node must have certain attributes which suggest they may be related (ie, surname, DNA, location, or —the node is one of the few remaining options for a Vdna/VIA match).

4. Given an Ancestor with K (count of) suspected children, each child is evaluated to see if it could lead down to the bottom node. First strategy, if Surname is the common attribute between the bottom and top nodes, is to look at each male child, and then look at their locations, and sort according to which is closest in place and time. Each child node is then ‘explored’, in that if it has children, those are searched in the same manner.

5. If the ancestor of interest does not have children in the VFT or VWT, an initial search is done of all DNA matches (starting with VFT's of User's in the ICW-Match list between the top and bottom node originators, and then progressing to all DNA-match VFT's of the top and bottom nodes) to see if a VFT has this node with children. If so, they are then added to the exploratory tree (along with confidences), and explored. Adding a node means replicating the node's meta data, but with only the pointers (links) to the children, as we do not want to copy entire sub-trees when doing a search.

6. The search of VFT's, in the order prescribed (ICW-Matches between A at 3502 and B at 3504, all remaining DNA matches of A or B, then all remaining VFTs) for a particular ancestor should accumulate a list of all matching ancestors. The data of all matching ancestors that passes a relevance criteria will be merged into one node, will be analyzed by the constraints Agents and confidence Agents, and if passing quality criteria, may be added to the VWT. In this respect, a search for a given ancestor is not repeated multiple time for other cases involving that ancestor.

7. If the VFT and VWT scan is not successful in building a viable ancestor at a particular level, the node will be marked, or ‘bounded’ in the traditional sense of branch-and-bound. The node, based on its current viability value, will be inserted into a list of other nodes pending for further evaluation. In this respect, a breadth-first at level N, and depth-first search is enabled. The viability criteria is initially high, thus this search will explore all paths until each falls below the current viability metric. After this, if no solution is found, the viability watermark will be lowered, and the nodes in the list which are above that watermark will be again searched in the same manner, eventually finding a solution, or adding more nodes to the list, or reaching a dead-end (leaf) for all sub-trees.

8. After the VFT's and VWT are searched for existing nodes, a general genealogic sources search may be executed for any nodes in the pending list which have a viability metric still suggestive of their having a potential path to the target node.

9. After the search has completed, the new branch(es) are added to the VWT, and shared with the Agents of the requesting VFTs. If no viable path is found, but there is still a ‘weak’ path with missing links, this will be added to the VWT as a virtual branch with virtual-ancestor placeholders at each generation. The branch is annotated with information to record the cause of the search. Thus, if other searches are triggered based on similar DNA matching Users, then the evidence for the Virtual branch being the actual branch will increase. The MRCA nodes from the User's VFT's will also need this recorded, such that the same search is not repeated, and furthermore, if an alternate solution is found, the Virtual Branch annotations must be retracted. The reader might recognize this form of search as the ‘Ant algorithms’, wherein the ants leave a pheromone on a path to food. As more ants find the same food, the pheromone increases. It is not known whether ants can erase a track, once the food, or motivation, is gone.

10. The illustrated system 3500 includes:
3500: Speculative Tree Search Agents Sub-System, (connected from 2214)
3502: Example User A's partial VFT is shown, with an ancestor X at generation G=3.
3504: Example User B's partial VFT is shown, with a contiguous path from B to ancestor Y.
3506: The parents Y have offspring delineated by the dashed-rectangle. It is suspected that, due to commonalities between X and Y, and the DNA connection between A and B, thay DNA may have been passed from B's ancestors Y down to A's ancestor X.
3508: One potential path from Y to X is delineated. The dotted-line Ancestors are placeholders, as these ancestors are as yet unknown.
3510: Another potential path from Y to X is delineated. Every child is potentially a path, although if the connecting evidence between X and Y is surname, then the male children of Y have a higher likelihood of being the connection.
3512: A Speculative Tree Search Agent is invoked, which will review the necessary parts of the two VFT, and will build an internal data-structure to search
3514: A minimal tree structure is created by the STS Agent. The objective for the STS Agent is to find a contiguous path of ancestors between X and Y, such that each ancestor found and each relation satisfies a minimum confidence criteria.
3516: Development of search paths will call the Constraint Satisfaction Agent to confirm whether a potential node is feasible and acceptable.
3518: After a search is completed between X and Y, all new Ancestors which have surpassed a threshold in confidence will be submitted to the VWT Agents for insertion into the VWT. This insertion will not create a disconnected graph since the STS Agents are only called by VWT Agents which have already updated the VWT with the relevant parts of VFT A and B.

System 3600, ‘Migration Proximity Influences Sub-System flowchart”

1. Continuing from FIG. 4, state 406, illustrated in FIG. 36 is a flowchart of one embodiment of the Closest-Point-Of-Approach analysis of VFT's of DNA matched Users. The intent of this system is to enable the User, and the system, to determine which pairs of mating-eligible individuals from the respective VFT's of DNA matched Users, had crossed paths physically and temporally. From this analysis, attribute nodes will be created which represent this proximity in the MRCA Engine analysis. Also, it should be noted that proximity analysis does not apply only to determine if two potential parents crossed paths, but may be used to determine if a child and potential parent were in the same place-time . . . preferably at date of birth. The Graphical User Interface (FIG. 37) may call this flow at step 3612 with a pair of Ancestors to manually calculate closest point of approach.

2. As depicted in the flowchart of system 3600: Migration Proximity Influences, a proximity analysis begins at state 3602: For all eligible Ancestors between DNA Matched User A, B, and then 3604: Create a matrix for CPA between each eligible pair, then 3606: Evaluate ICW Matrix to rank similarity of the candidate individuals (taking into account such constraints as age, gender, so as to not try to mate same-sex, or women before or after child-bearing age. From this, we create 3608, an ordered list of pairs of Ancestors to test, of which each pair is passed to 3610: Proximity Search Agents. In state 3612: the Proximity Agents calculate the closest point of approach based on calculated birthdates and travel path timelines. This is done intelligently by the Agent by walking the travels of the two ancestors from place and date of birth to place and date of death. For each decade, the estimated distance between the two is used to calculate the smallest CPA between the two ancestors. In state 3614: the results are saved to the Shared Attributes DB, and then 3616: a ICW-Proximity attribute node (ICW-P) between a pair of Ancestors may be saved to the Shared Attributes DB. Finally, state 3618 registers the changes (new attributes) to the Agent Exchange to notify the calling system of proximal pairs of ancestors. The calling system may be the User, in which case the attributes are graphically annotated.

3. The illustrated system 3600 includes:
3600: Migration Proximity Influences Sub-System flowchart, (connected from 406)
3602: For all eligible Ancestors between DNA Matched User A, B
3604: Create Matrix for CPA between each eligible pair
3606: Evaluate ICW Matrix to rank similarity
3608: Ordered list of pairs of Ancestors to test
3610: Proximity Search Agents
3612: Calculate closest point of approach
3614: Write results of proximal pairs to Shared Attributes DB
3616: A ICW-Proximity attribute node (ICW-P) between a pair of Ancestors may be saved to the Shared Attributes DB.
3618: Registers Changes To Agent Exchange to notify calling system of proximal pairs of ancestors

System 3700, Interactive Migration Map with Vectors and Sliding Time Scale

1. Continuing from FIG. 36, state 3612, illustrated in FIG. 37 is an example of an Ancestor Migration visualization tool with sliding time-windows, pedigree path traces, and proximity halos. This Graphical User Interface enables a User to visually see the migration path of a Ancestor, with highlighting of the edges during a time-period controlled by the date range slider bar. Thus, the date range may be set to the general beginning and end time of, for example, a female Ancestor's reproductive age, in order to see which other (male) ancestors crossed her path during that time. Thus, in system 3700: a sliding scale time window of ancestors migration, shows ancestors and edges in that time frame. The 3704 cross-circle slider movement highlights edges which coincide with that date. On the right of the image, we see 4 sets of ancestors who, in this example, represent a partial pedigree of ancestors who migrated to the colonies. The actual GUI will show dates on the begin and end points of each known data event for each individual. 3702: Only two pairs from two User's pedigrees are depicted in the example, but several may be shown. The top four indicate two pairs of ancestors, whose offspring meet in the colonies, and have issue. Likewise for the bottom two pairs. One can see the intent in the example, that the pedigree of an ancestor can be traced backwards, and those placements of ancestors result in better information for each ancestor in terms of corroboration loosely connect to physical location and DNA affinity.

2. The User may choose to display migration routes for the pedigree or family tree of each particular individual. As shown in 3706: a ‘proximity halo’ may be enabled, which will outline the region around an ancestors presumed travel points, and thus determine if there is a possible overlap of two persons' travels in a time period. Finally, in 3708: Proximity information is stored in an Attribute record, and saved to the shared-attributes DB. As noted in FIG. 36, the discovery of viable proximity for potential couples may be represented by a Proximity Attribute Node (ICW-P), which will ‘draw together’ in the analysis phase-space, through activation packets, two ancestors in differing trees or differing parts of the same tree.

3. The illustrated system 3700 includes:
3700: Interactive Migration Map with Vectors and Sliding Time Scale.
3702: Only one User's pedigree shown. May be N Users. May be pedigree or family tree.
3504: Sliding scale time window of ancestors migration, shows ancestors and edges in that time frame.
   Cross-circle movement highlights edges which coincide with that date.
3706: A ‘proximity halo’ may be enabled, which will outline the region around an ancestors presumed travel points, and thus determine if there is a possible overlap of two persons' travels in a time period.
3708: Proximity information is stored in an Attribute record, and saved to the shared-attributes DB.

System 3800, Evaluate ICW Matches, Example of data-mining and processing

1. Continuing from FIG. 4, state 406, illustrated in FIG. 38 is an example of an In-Common-With Matches (ICW-M) data-mining and processing, in one embodiment. The intent of this system is to data-mine the ICW-M data, wherein an ICW Match between two Users' who themselves DNA match to each other, is a 3rd User to which the two also DNA match. It is thus known (or expected), that each pair has an MRCA. It is possible that all three share one MRCA, or that there is one MRCA share by two, and another MRCA shared by the other pair. In that case, one of the User's has both MRCA's. The theory and functionality of this data-mining and display system is described in FIG. 39, 42-47.

2. In FIG. 38 is displayed an example of data-mining ICW Matches via ICW-Match Search Agents (416): Each node labeled B through F (3802, 3804, 3806) represents a User, and the bi-directional edges represent the genetic association via a shared segment. For each User, such as “13”, each of the common matches are scanned, comparing the trees of the two in the ICW-Match comparison System.

3. For example, User A (3802) might already have an enhanced probability of being related to Users B and G by a given surname ‘S’, which lies on a particular sub-branch of the pedigree. When User G's ICW matches with A are scanned 3804 (which we call 1 step away), a similar pattern matching and weighting is done based on attributes shared between G and A. Each ICW-M of the primary pair (here, A:B), are expanded and data-mined for attributes in common with A,B. Then, each 1-step ICW-M such as C:A, D:A, E:A and G:A is evaluated in terms of the set of ICW-Matches between G and A. For each of the ICW-Matches found in the 1-step match, (here, B, C, D, E, F), the nodes (Users) that have not already been evaluated are examined. Thus, for example, F:G is evaluated 3806. We know that ‘G’ was an ICW-Match between the User (A) and her match B. Both A and B have DNA in common with G. So, now if F and G share DNA, and F must share DNA with A to be in the list, then we have found a triangle (A matches G matches F matches A). Such triangles are evaluated in FIG. 39.

4. After all ICW matches of a User, up to two steps away, are data-mined for common patterns by the ICW-Match-Comparison-System, the common-patterns themselves are analyzed for further emphasis. That is, a common attribute between several ICW matches may be registered in the Shared Attributes DB as an ICW-Match Cluster node, with the type noted and participants connected to it. The MRCA Vdna nodes of ICW-Matches will be connected together as well, with a special node called, naturally, ICW-Match.

5. Generally, if a set of shared matches Y (not shown) each have evidence suggesting a shared ancestor, place or surname (or any significant factor), then a ICW-Match node [3812] will be created connecting the MRCA-Vdna nodes of members of set Y to that common evidence. Note that members of set Y who do not even have family trees may be highly associated to a common ancestor simply by their connections to others who jointly cluster around an common ancestor. The co-stimulation of ICW-Match sets does not imply, or lead to a solution wherein all members of the set have the same MRCA. However, when any two of them are processed in the MRCA engine, the connection from their two MRCA Vdna nodes to the ICW-Match node will cause activation to pass to the network of the other members of the set. Those nodes will in turn pass activation to their ancestor nodes. Most of these activation stimuli will go nowhere and dissipate to nothing. However, there may be some ancestors whose attribute connections connect directly to the ancestors of the pair of cousins being evaluated.

6. In one embodiment of the ICW-match testing, the MRCA-Vdna nodes of all members of a User's ICW Matches will be activated simultaneously. Similar to the pair-wise stimulation algorithm for just two Users, the activations of the MRCA-Vdna nodes will cause the ancestors sharing the most attributes between the members of the set to become dominantly activated. Note that ICW-Ancestors between members of the set will also be co-triggered due to their ICW-A attribute nodes, and with their DNA enhanced connectivity weights, will ensure that any ancestors common to many members of the set will get dominant activation. The ancestors that attain dominant activation may be analyzed for ‘Disembodied Cousin’ DNA flows logic as in FIG. 34. However, the Disembodied Cousin analysis is most useful when all of a User's DNA match cousins have been searched for common ancestors.

7. Note that this methodology may be run independently of DNA mapping, although it is essentially just a limited (blindfolded) form of the DNA mapping, wherein DNA mapping operates on pairs of individuals who DNA match, while ICW-Matching requires 3 Users to match. The DNA mapping algorithm will thus, exercise the same search and analysis system as the ICW-Matches, to attempt to find the common ancestor that originated the DNA held by the matched Users.

8. Note that if the activations passed during an ICW-Match group analysis are packets which identify the group, then multiple groups of ICW-Match sets may be run through this analysis simultaneously. That is, a particular ancestor node may maintain multiple levels of activation, for each of the packet types. While all match sets are being activated, certain ancestor nodes for each match set will become dominant. If two disjoint Match-Sets converge on the same ancestor node, further analysis will be required, in the form of competition.

9. From the perspective of one User, having each of her ICW-match sets activated, each set is expected to converge or settle on either a single VFT VIA node in the User's tree, or on a set of nodes in the VWT, if not all of the activated nodes exist in the User's VFT. Each set will be run with activations passed as a unique packet, containing information about the group, and the activation's path history (to prevent loops). At each step of the simulation, activations at each node will be summed, and if meeting a threshold value, will fire activations to the on-going nodes, according to the strengths of the respective connections. A VFT node, or VWT node will act as a collector. When no nodes meet threshold on the current cycle, all VFT nodes will sum up the activations of all the packets from respective groups. For the nodes which win, an entry is made in the respective MRCA-Vdna node that those nodes have dominated in the ICW-match analysis. This is not a final MRCA solution, but it is a pretty good hint to the experienced genealogist. This information will be collected in the later stage of MRCA engine analysis of all data.

10. ICW Ancestors shared between ICW Matches>2, will have their connections to the MRCA Vdna node enhanced. It is assumed that such ICW-Ancestors have already been discovered between pairs of DNA matched Users, but if not, an ICW-A node will be created between newly discovered ICW-A's. Thus, for all ancestors in a Users' MRCA-potential set, those shared with a group of ICW matches will get higher activation, and will receive special ICW-M Cluster node recognition. Analysis will be done with these ICW Ancestors as disembodied cousins, such that several ancestors found create a Fan-up or Fan-down constraint (see FIG. 34).

11. The illustrated system 3800 includes:
3800: Find, Evaluate ICW Matches Sub-system, (connected from 406)
3802: User A″s ICW matches with User B are illustrated as a ‘star map’ inside the dashed-line circle. A:B means A has ICW-matches to B. If the program User clicks G, another ICW-Match star map is displayed. We will call any new ICW-Matches seen here, as one-step away from the A:B match. However, it is usually the case that matches A:B={C,D,E,G} have a large intersection, such as A:G={C, D, E, B, F}, wherein the intersect is {C, D, E}. The intersect set is very likely clustered around a common ancestor. Thus, these User's VFT's will all be run through a special “ICW-Match-Comparison-System” that attempts to find any attributes similar between the VFT's of any two of the members of the set, and preferably, more. The features evaluated for similarity include, but are not limited to:
Any DNA mapping between the members of the intersect set that is able to limit the eligible ancestor set between the members
Any outright ICW-Ancestors in the respective pedigrees
Surnames, or uncommon first or middle names which are similar to the Surnames of their potential Ancestors in other trees
CPA in time (closest passing in time), mapping all eligible Ancestors of the members of the set simultaneously.
Uncommon (statistically significant) Nationalities of birth, or ethnicities Attributes (records) shared between any two Ancestors in the VFTs, such as Wills, names on marriage records, military service etc.
Simultaneous Disembodied Cousin analysis: Given a reduced set of eligible ancestors for the match of the members of the ICW-Match set, search for descendents of those members which are ‘in-common’ between at least two family trees of the members, where here the search is not limited to just the pedigree VFT, but also includes the member's personal, extended family trees, and includes the associated sub-trees in the VWT. That is, search all possible trees for ancestors or descendants of ancestors, which are connected to the eligible Ancestors of the members of the ICW-Match set.
While this deep data-mining is progressing, each unique bit of ‘in-common-with’ evidence between Ancestors or descendants of the members of the set, is registered to the Shared Attributes DB, with a special notation indicating that the association is in support of the members of the ICW-match set.
Furthermore, the ‘eligible ancestor set’ indicated in the above data mining processes, is pre-evaluated to conform to the constraints placed on the potential Ancestors per the estimated genetic distance between the Users. This should be well understood, as the differing genetic distances provide a direct means of statistical triangulation, especially when there are many contributors (reference points). This genetic distance constraint driven triangulation is described in 3916.
3804: User G's ICW matches with user A are illustrated inside the dashed-line circle. If the program User clicks F, another ICW-Match star map is displayed. We will call any new nodes as two-steps away from the A:B match.
Note that User A is not in this example diagram, however, User B is in both A:B and G:A ICW-Match ‘star maps’.
3806: The star map of the ICW Matches of F:G
3808: The MRCA node between A and B is represented with a dashed arrow. The MRCA nodes between G and A, and between G and B are likewise represented by dashed-line-arrows to an MRCA-Vdna node.
3810: The data-mining of attributes between these ICW matches continues, and may at any point find commonalities such as Surname, on certain VFT VIA nodes, such as ICW-Ancestor X. The relevant search Agents are invoked for each of the various search and analysis functions, except here it is applied severally to the ICW-Match User's trees and data. The dotted-lines from the MRCA nodes to the ICW-Ancestor X indicate that the node is common to several of the ICW-matches, or has attributes such as Surname across several of the ICW-Match User's VFTs'.
3812: In the illustrated example, an “ICW-Match attribute node” is ‘grown’ between the VIA nodes of the separate trees, and is registered to the Shared Attributes DB. This thus captures the possibility that the attributes shared are somehow correlated to the common DNA shared between the Users. Thus, during an MRCA Engine analysis, extra activation will be given to the members connected by these attributes.
3814: The information of 3812 is stored in the Shared Attributes DB.
3816: The ICW-Match Comparison System, takes as inputs pointers to several VFTs, and executes the various search Agents to data-mine the VFT's for potential commonalities. This sub-system, in part, employs the ICW-A algorithm (2000). The common factors (ancestors, places etc), found between the VFT's are connected together through the Shared Attributes DB, are given enhanced weightings due to the DNA influence, and these connections are given connection to an special “ICW-Match Cluster Attribute” node. To assist the general MRCA-Engine, the “ICW-Match Cluster Attribute” is connected to each MRCA-Vdna of the respective User's.

System 3900, Evaluate ICW-M with DNA Mapping steering,

1. Continuing from FIG. 38, and linked from FIG. 4, state 408, illustrated in FIG. 39 is an example of using In-Common-With Matches along with good MRCA data to reduce some MRCA search spaces, in one embodiment. In short, ICW-Match sets which have cases of solved MRCA's between members of the match set, are clustered around those MRCA's, and DNA flow logic is used to determine, or predict, under which branches of the tree Users must lie. This system is primarily used to evaluate ICW-Match data, where the DNA segments are not known, but the fact that several User's DNA match each other is known. However, this system is also applicable to the case where the DNA segments shared between several Users is known to the system (but not necessarily known to the Users). In this case, there is no ambiguity of which segments match (S1, S2, S3), but the mapping of the segments to the VFT graphs follows the same fundamental pattern.

2. ICW-Match analysis, in one embodiment, will start with the closest relatives (participant Users who DNA match) of the User, who have already been tied to an MRCA. Any ICW-matches between the User and the first MRCA-triangulated cousin most likely will find their MRCA with the other two in the pedigree at or above that first MRCA ... unless there happens to be a case of endogamy wherein cousin descendants of the 1⁴ MRCA mated and one of them happens to be an ancestor of both the User and the cousin. In this case, the designated 2^{nd} MRCA is a co-MRCA.

3. As an example, if a User has successfully populated their tree to great-grandparents, and have at least one DNA match confirming each of these great-grandparents, then they may be able to assign all DNA cousins who have ICW-Matches to them to one of the 8 sub-pedigrees of the great-grandparents. This process continues for all DNA cousins with known MRCA's .

4. The case of 3 User's who form a triangle of DNA ICW-Matches (circled in 3912), forms the base case for the global population analysis of ICW-Match clustering. This Global ICW-Match analysis is explained in FIG. 45. In the figure, the ICW-M may be represented as in 3914, where S1-S3 represent the DNA segments shared between the Users. Any one of the S1, S2, and S3 may be the same, or overlapping, segment. The fundamental theory of this system is that you must map the segments to the combined VFTs (or VWT), such that the segments of 3914 have a down-stream flow to their respective Users. Two possible ‘network flows’ are illustrated in 3916 and 3918. Note that the lines between nodes can represent multiple generations in a VFT. However, the actual realistic distance these edges represent are bounded by the ‘genetic distance’ predictors for the DNA matches of the Users. This data will play into the algorithm as well, and will be described in further figures.

5. This restriction of the ICW-matches to the pedigree of the MRCA node is recorded by several means:
i) The MRCA-Vdna node of each ICW-Match updates its connections to the VIA nodes in the two VFT's to reduced the connection weight to nodes (ancestors) below the MRCA, as described in 3916. This is facilitated by connecting MRCA nodes with ICW-Match nodes.
ii) By the genetic distance, an ICW-match X of a DNA cousin Z to the User A which is pinned to an MRCA-AZ, can have its own MRCA-XA pin-pointed by calculating the genetic distance from the DNA cousin Z, up to the MRCA-AZ, and then up and/or down to the ICW-Match X. This may be formulated as a constraint, that the MRCA for A to X must lie within K generations of MRCA-AZ, on any path up or down except down the path to A.
iii) Creation of ICW-M Cluster nodes to bind ancestors who share attributes across the ICW-Match sets. Note that Cluster nodes make point to other cluster nodes to create a hierarchical cluster. The weights of the connections infer a form of connectionist fuzzy logic, and thus propagate constraints.
iv) Creation of ICW-A (common ancestors) nodes with ICW-Match enhancement. That is, an ICW-A node which connects to a ICW-M node, which itself connects to the MRCA's of involved Users, and/or connects to ICW-Match Cluster nodes.

6. The illustrated system 3900 includes:
3900: Sub-System to evaluate ICW-M with DNA Mapping steering, (connected from 408)
3902: User ‘A’ VFT graph indicating a path from A to VFT ancestor X
3904: User ‘B’, a DNA match of User A, with a graph indicating a path from B through her VFT to her equivalent ancestor X
3906: In this example, an MRCA Vdna node has been previously found for User A and B, and is connected to Ancestor X on both pedigrees
3908, 3910: Node X's ancestors may be collected into a set Z, the pedigree of node X.
3912: User A and B have a set of common DNA matches, here illustrated as Users C, D, and E. The sub-graph A:B and C are evaluated in 3914-3918.
3914: Users A and B must have at least one shared segment which we call S1, while B and C share at least S2, which may be overlapping S1, and B and C share at least S3, which may be overlapping S1 and/or S2.
3916: Each set of three co-matching Users as shown in 3914, most likely have a configuration as shown, wherein two or more MRCA's overlap. In any case, the configuration must be such that the shared segments between each pair has a down-stream path from the MRCA to the sharing Users, and the total path length down from the MRCA node of each pair to the actual User nodes is within the range of the estimated genetic distance. Thus, this requirement forms a constraint system which can be used on all ICW-matches simultaneously, or in sub-sets. This constraint is discussed in FIG. 44.
3918: The alternative configuration of DNA flows shown is unlikely, unless User C's ancestors include a case of endogamy wherein cousins X and Y had issue.
3920: The MRCA Vdna Nodes for A-C, A-D, and A-E are given enhanced connections to the eligible nodes in set Z.
This particular run is focused on Users A and B, so C-D, C-E etc is not yet processed.
3922: The MRCA Vdna Nodes for B-C, B-D, and B-E are given enhanced connections to the eligible nodes in set Z
As illustrated in 3916, ICW-Matches are a form of implicit triangulation, in that if User A DNA matches User B and C, and User B also DNA matches user C, we can make an educated guess (without knowing which segments are shared between any of them) that if A and B share segment S1, while B and C share segment S2, and A and C share segment S3, that the segments S1, S2 and S3 must lie on a tree such that two of the segments lies at the MRCA of the three (A, B, C), and that the other may lie between the MRCA and two of the cousins, or also be with the first two. This is true is we assume a directed spanning tree formation, wherein there is no endogamy.

System 4000, “General hardware and network architecture”

1. Illustrated in FIG. 40 is an example of one embodiment of the primary hardware and database components of the system.

2. The illustrated system 4000 includes:
4000: The general hardware and network architecture is illustrated, in one embodiment
4002: All systems and hardware are connected to each other via the Internet through their local area networks. Thus, each system is addressable by hostname registered in a DNS.
4004: The databases reside on distributed disk servers, with replication and caching to reduce overall latency in read/write operations according to geographical distribution of other servers and clients, and may use a distributed data management service such as Perforce.
4006: Distributed Computing Environment is a set of hosts (computers) which run the various searches, comparisons and global analysis. In one embodiment this may be a set of machines configured for high performance computing on massive data sets (ie, millions of Users with 10's of thousands of Ancestors in their trees, and thousands of DNA matches). This set of hosts may include, in one embodiment, the Client PC's of the User's themselves, configured in shared resources distributed computing system such as Beowolf [18].
4008: User Account Servers are specially configured to handle User sensitive data and have high available. Account Servers are the used for redirection of a User to the nearest incorporated system that can handle their activities in the system.
4010: Virtual Family Tree Servers
4012: User Client Hosts are any form of PC, table, phone or system that has a display, User input/output such as a keyboard and mouse, and which facilitates the User's interactions with the Systems applications, such as editing a Family Tree, browsing an Ancestor vector map, displaying a DNA map, displaying MRCA networks, displaying DNA maps etc.
4014: Distributed Agent Control System is a set of servers which service the requests from Agents running on client hosts, family tree servers, the distributed compute environment, and which read/write to the Agent Control Data Db, for example.
4016: Agent Exchange Servers, basically route messages between themselves, the Agent Control Servers, and to/from Agents in the field.
4018: MRCA Compute Engine servers run global analysis of a large set of User's who have ICW Matches between each other. This may include all Users, or a sub-set that has a sufficient min-cut/max-flow partitioning.
4020: Virtual World Tree Servers will maintain a copy of the VWT, with regular updates to keep all in sync.
4022: Messages and activation packages are sent between servers and Agents via small TCP/IP or UDP packets, which thus enable turning a distributed network into a constant high-density stream of packets. In this model, there will be an optimal number of Agents, based on latency of messages between pairs of Agents (running on data servers, exchange servers or processing servers), and number of nodes through which these packets must travel in one cycles time, and the compute time per packet.

System 4100, “MRCA Engine visualization and debug tool”

1. Continuing from FIG. 7, state 722, illustrated in FIG. 41 is an example of the abstract visualization tool for visualizing network stimulation and settling states, in one embodiment

2. In this system 4100: An MRCA Engine visualization and debug tool will show (for example) any selected pair of DNA matched Users, with a state before and after MRCA Engine analysis. To illustrate the MRCA Engine analysis visualization of two (or more) DNA matched Users, two stages (before and after) are shown as an example pair of MRCA nodes, VFT nodes, and attribute nodes. Both panels show a part of User X's VFT (3 nodes), just one MRCA node, and connections to 9 attribute nodes. On the bottom, there are just 3 nodes from a User Y's VFT shown in this example, just one MRCA node representing the MRCA between X and Y, and connections between the VFT nodes and 13 attribute nodes. The nodes are aligned horizontally to a type, which is shown on the left. Attribute nodes between the dotted line are, in this panel, of the same type. The actual tool will enable the user to show the process running for one or all of his/her DNA matches. With potentially 1000's of MRCA nodes, and 1000's of ancestors between each pair of MRCA nodes, and a magnitude order higher of attribute nodes, the User will be wise to focus their analysis on pairs of nodes which concern them. That is pairs of MRCA nodes and sets of VFT which they believe should have had a differing outcome. The User will be able to tweak the connection strengths and add attribute nodes, for example.

3. 4102: The left panel exhibits a small sub-set of the two User's trees. An MRCA node is shown for both, User Y at the bottom, User X at the top. The MRCA node's connections to their viable VFT nodes are indicated by dashed lines. We may here assume that the set of viable VFT nodes has already been reduced by DNA mapping and ICW-Match clustering. Each VFT node will point to attribute nodes for the various data collected on that ancestor, or will otherwise point to constraint creating nodes resulting from other analysis. Illustrated are examples of a first row of Surname attributes, a second row of Closest-Point-of-Approach (CPA) nodes, a third row of CPA years, and a fourth row of miscellaneous records such as Wills, marriage certificates or Census data.

4. 4104: Before the activation cycles, a comparison of the VFT nodes of the two Users is made, and for each having sufficiently high match probability, a connection is made between their equivalent attribute node types, with some help from logic. That is, Surname attributes, if similar in value, are connected together. Similarly, for date-of-birth, date-of-death, and dates and places lived, a call to the mapping proximity calculating Agents (406) is made, to determine which of these attributes should be connected. That is, if both ancestors lived in place K within the same decade, those two nodes are connected with a high mark for ‘CPA’, closest point of approach. The proximity Agents may use intelligence to trace the DOB places and times for the two Ancestors, walking along their travel vectors with date coordination. (3612) For each decade, the estimated distance between the two is used to decide whether to create a connection between the two ancestors with a merged place & year attribute node.

5. 4106: After activation cycles, the nodes which did not find connections to the opposing MRCA will decay (indicated by the nodes withdrawn to their originating VFT node), while those with high confidence, high relevance connections between the two MRCA essentially draw the two MRCA together by their concordant activations. The signal packets being sent between the MRCA nodes will have information including the origin of the packet (MRCA node), the type of attribute nodes it applies to, the number of hops taken, and a value decay proportional 1/confidence of the connection confidence weight of each connection.

6. The illustrated system 4100 includes:
4100: An MRCA Engine visualization and debug tool.
4102: The left panel exhibits a small sub-set of the two User's trees
4104: Before the activation cycles, a comparison of the VFT nodes of the two Users is made.
4106: After activation cycles, the nodes which did not find connections to the opposing MRCA will decay.

System 4200, Merged-MRCA Star Browser Tool

1. Invoked from FIGS. 17, 24 and 27, illustrated in FIG. 42 is an example of an Merged-MRCA browser, in one embodiment. When MRCA-Vdna nodes are confirmed between two Users, they are linked together into a composite MRCA-Vdna Node. This node may again be merged with by another DNA match, or may have already been a composite node. Clicking on the composite node will display a star diagram

2. Note that the DNA triangulations under an MRCA node are not just from the User to his/her DNA matches, but from any User who has a DNA triangulation to the same individual (e.g., they all inherited DNA from this individual). This multiplicity of MRCA triangulations relies on the VIA node being paired with a corresponding VIA node in the VWT (Virtual World Tree). All MRCA-Vdna discoveries are registered to the appropriate nodes in the VWT.

3. The illustrated system 4200 includes:
4200: Clicking on any MRCA-Vdna, in any display, presents a dialogue that allows the User to choose to display the illustrated star-diagram of other MRCA nodes from other User's that have merged to the same ancestor. The MRCA Vdna Browser Tool can also be reached by clicking the MRCA count on any Ancestor having a count>0.
4202: The Star Diagram simply creates a node for each User who has this master MRCA node associated to the same ancestor.
4204: Each MRCA-Vdna node will be annotated with, at least, the Owning User's Id, the associated Ancestor's name and birth and death years.
4206: Clicking on any expanded MRCA node will display the information dialogue for that node as well.
4208: Option will be provide to launch the ICW-M Network Browser (FIG. 43)

System 4300, “ICW-M Graphing System”

1. Following from FIGS. 17, 24 and 27, illustrated in FIG. 43 is an example of one embodiment of an ICW-Match Graphing System. This feature attempts to facilitate an automated data-mining of ICW-match networks. Any 3 User's who DNA match each other, have a very high likelihood of having their MRCA's in the same branches of their VFTs. For any chain of ICW-Matched Users, if any one of them can be anchored to an MRCA, the rest of the User's MRCA's most likely must ‘fit’ to the DNA flows as constrained by that MRCA. If there happen to be 2 or more MRCA's, each associated with one node of the graph, then each of those serves as a probable anchor, such that they chain of ICW-Matches between the anchors must be ‘fit’ to the VFT's such that DNA flows are valid, as described in FIG. 39, and further developed in FIGS. 44-47. Furthermore, each ICW-Match receives priority in ICW-A search, and similarly in ‘Disembodied Cousin’ search and constraint building.

2. This system may be launched from any DNA-Match profile page. It may also be started from FIG. 17, 1716, from any VFT node which has an associated set of ICW-Matches, such that the VAR record will display a number of ICW-M matches. Clicking on that field in the VAR record display, the primary User will be presented a dialog box with a list of other User's IDs, such that each is a DNA match to the primary User, and both share DNA with a 3^{rd} User. The ICW-M list does not mean these Users have the VFT VIA node as a MRCA, but rather, that that those User's likely MRCA shared with the primary User have been narrowed down to be isolated to the current node, or vicinity branches.

3. This sub-system will create a graph of ICW-Matches as described. The graph may potentially expand, so long as there are new ICW-Matches to any existing node already part of the graph. The example displayed happens to be a limited graph, but also one that resulted in a new MRCA discovery between User A and BG.

4. The illustrated system 4300 includes:
4300: An ICW-Match Graphing and Search System displays a graph of a set of ICW-Matched Users (with a glow-highlighted smiley face icon), wherein, an ICW-Match requires that the primary User ‘A’ (not shown) DNA matches two others, who DNA match each other as well. User A's node is not shown, as it is implicit that each of the shown User nodes match the primary User A. In the examples of FIG. 43, User A has ICW matches with Users SM, MA, SML, BF, RC, RB, JC, SP, BW and BG. Each of those Users are checked for ICW Matches with User A. Each unique new ICW-match is added to the graph with connections to other nodes that the selected User has in common with the primary User. Thus, any nodes in the graph which connects to another node forms a DNA-match triangle with the primary User (A), with the logical benefits described in FIG. 39, 3916.
4302: One embodiment of the graph shows Users as nodes and connections depicting an ICW-Match relatedness. In this example, User SML is inspected first. He/She has 5800+Ancestors in their tree, and thus is a good candidate for potential MRCA discovery. This person DNA matches to Users MA and SM, and by the fact of it being an ICW-Match, so does User A. These two Users unfortunately have 0 nodes in their personal VFT. Next, the Investigator (typically User A) or search system, might expand on nodes MA or SM, and see if there are ICW-Matches at those nodes (Users) that might contribute useful information. The ICW-match MA has no family tree (0), but shares an ICW match to user BF. Unfortunately, User BF also has no family tree. He or She does have two people, in his ICW-Match lists, including the new one, RC. This one, also has no family tree (NFT), and also has no ICW-Matches with User A. It is a dead-end. So, the search system (or User) must back-track and try another path.
4304: Next, node SM is expanded, and has new User RB, with 200+members in their VFT. In the dashed-line oval, User RB has been expanded, and the new matches will have been run through the ICW-Match-Comparison-System described in FIG. 38.
4306: An ICW-Ancestor is found between node BG and the User A. Any User who has been positively associated to an MRCA (with respect to the primary User), will be highlighted and labeled with the associated MRCA Ancestor, similar in spirit to the illustration.

System 4400, “ICW-M Graphing System, Transformation Illustration”

1. Continuing from FIG. 43, illustrated in FIG. 44 is an example of one embodiment of an ICW-M Graphing System. An ICW-Match browser alone does not elucidate what the common ancestors are between ICW-Matched Users. A User with particularly good memory, an excess of free time, and an acute obsessive-compulsive habit, may be able to track through a chain of ICW-Matches, looking at pedigrees, and mentally creating a set of common attributes between the pedigrees of the visited User trees. However, there may be an unending chain of ICW-matches, and there may be a large multiplicity of attributes connecting various members of the VFT's of the ICW-Matched Users. Thus, an automated system is provided which will attempt to assign all DNA nodes to eligible Ancestors, while satisfying all constraints, and maximizing an objective function on the total likelihoods of selected MRCA's based on the supporting evidences. Depending on whether the matching DNA segment is known (location, start, stop), or if it is just known that the two User's match to seme degree, the DNA Node will respectively be represented by an ICW-DNA node with appropriate annotation. That is, a blind ICW-Match, wherein the Users only are told that they match, will be represented with an ICW-DNA node with annotation ICW-Match. The theory of this system is described in FIG. 44, 45, 46, and the execution in FIG. 47.

2. The illustrated system 4400 includes:
4400: “ICW-M Graphing System, Transformation Illustration”
4402: A replication of the graph in FIG. 43, for ease of visual comparison to the equivalent DNA augmented graph of 4404.
4404: The graph displayed, ICW-Match DNA Map, is equivalent to the graph of FIG. 43, which is redisplayed on the left at 4202. The transformation 4204 has the following differences:
The primary User A is centrally displayed, whereas in the ICW-Match graph 4302 it is implicit
The connections between every pair that was in 4302 is now split in the middle by a small node representing the DNA segment shared between the two Users. This node will be an ICW-DNA node, and will be replicated in the data for each associated User (see FIG. 46). The ICW-DNA node(s) will point to the DNA of each in their respective Chromosome Mapping DB's. It will also have a local copy of the genetic distance estimate between the two, the match centiMorgans, match confidence, and a link to the MRCA-Vdna nodes of the User who is connected by the ICW-DNA node, and to the VFT node of an assigned MRCA node if one exists.
There is a connect between every ICW node and the primary User A, as we wish to explicitly represent each shared DNA segment.
The ICW-DNA node will contain information about the segment location (start, stop), and about its owners
Any ICW-DNA node which has already been associated to any MRCA-Vdna nodes, will be highlighted, as is the ICW-DNA node between ‘A’ and ‘BG’.

System 4500, “ICW-M Graphing System with DNA mapped to a VFT, illustration”

1. Continuing from FIG. 44, illustrated in FIG. 45 is an example of one embodiment of an ICW-M Graphing System mapped to a VFT. The basic intent of this system is to map each ICW-DNA node to a VIA node in the VFT of the User. The possible choices for the ICW-DNA are constrained by conditions such as MRCA's assigned to various User nodes, and the genetic distance prediction between the User A and the 2nd User, and between both of them and the 3rd User(s) which formed the basis of the ICW-Match. Any and all other constraints applicable, will be utilized and verified for constraint satisfaction.

2. The FIG. 45 illustrated connection (4514) of one ICW-DNA node to one Ancestor in one User's tree is the minimal representation of the use of the ICW-Match graph system. The general solution will be a mapping of each ICW-DNA node to respective nodes in the VFT of each connected User. Thus, the MRCA_{ag} node between User A and User BG will be mapped to an Ancestor node in User BG's VFT as well. As this illustration of the general solution would be impossible to comprehend if drawn, we will illustrate the basic concept with just a sub-set of nodes from 4502, including A, BG and SP in FIG. 46.

3. The illustrated system 4500 includes:
4502: The graph of 4404 is repeated here for visual clarify
4504: An example partial VFT is shown, representing User A from graph 4502. This is only the general representation of User A's VFT, displaying the minimal number of nodes to show the mapping of a DNA node from 4502 to a VIA node Ancestor.
4506: An ICW-Match Assignment Engine takes as inputs the DNA map graph of 4502, and pointers to the VFT's of all involved Users, and the VWT. The system of 4508 is applied first to all relevant sets of 4 ICW-M Users wherein one of them is identified by an MRCA node. Thereafter, system 4510 is applied to all sets wherein two MRCA's enable a triangulation to highly restrict the eligible set for the nodes associated. Finally, the ‘General N-ICW-M Center-of-Gravity Algorithm’ 4812 is applied to sets of ICW-Matches who share various attributes which cluster them around a particular region of a graph.
4508: The Base Triangular Case assignment algorithm is described in FIG. 46.
4510: The Base Two-MRCA's Case assignment algorithm is described in FIG. 47.
4512: The General N-ICW-Match Center of Gravity Algorithm is described in FIG. 48.
4514: The MRCA found between User A and BG is denoted with a donut icon. A dashed line to the VFT or A in 4504 indicates to which VIA node it is associated.

System 4600, Illustration of ‘Base Triangular Case ’ algorithm of “ICW-Match Graphing System with DNA Mapping”

1. Continuing from FIG. 45, illustrated in FIG. 46 is an example of one ‘Base Triangular Case’ Algorithm embodiment of an ICW-M Graphing System with constraint-driven DNA mapping to several Virtual Family Trees. The objective of this system is to assign the DNA segments (ICW-DNA nodes) to ancestors in the VFTs of the connected Users, such that all constraints are satisfied, and attribute matches between the VFT's are maximized (the objective function), wherein the attributes have been weighted in terms of importance and confidence. Thus, an attribute's fitness contribution value is the sum of the products of confidence and importance to the connected objects. The small donut-shaped circles represent ICW-DNA nodes with the DNA segment information, as described previously.

2. The constraints include that the configuration must be such that the shared segments between each pair has a down-stream path from the MRCA to the sharing Users, and the total path length down from the MRCA node of each pair to the actual User nodes is within the range of the estimated genetic distance. Thus, these requirements form a constraint network which can be used on all ICW-matches simultaneously, or in sub-sets.
i) The assignment of ICW-DNA to an VIA node to declare it an MRCA, based on the genetic distance constraint is stated here in pseudo code, where A˜B=i means A DNA matches B with an estimated genetic distance ‘i’. Traditionally, the genetic distance is described as n′th cousinship, but here we define it as total number of generations from A to the MRCA, and back down to B.
ii) Given A˜B=i, B˜C=j, C˜A=k
iii) Let Xa=the set of all nodes of pedigree of X in VFT A, such that the genetic distance from A to any node in Xa, and back down to B, falls in the estimated range around ‘i’.
iv) Let Xb=the set of all nodes of pedigree of X in VFT B, such that the genetic distance from B to any node in Xb, and back down to C, falls in the estimated range around ‘j’.
v) Let Xc=the set of all nodes of pedigree of X in VFT C, such that the genetic distance from C to any node in Xa, and back down to B, falls in the estimated range around ‘k’.
vi) Now, assign the shared DNA of one User pair (say A˜B) to an Ancestor from Xa who has maximal evidence of being the MRCA between A and B, and can be found, or potentially found, in the set of candidates Xb, and such that the total genetic distance from this chosen ancestor to the two Users is within the acceptance range of A˜BH.
vii) Next, assign the shared DNA of another User pair (say B˜C) to an Ancestor from Xb who has maximal evidence of being the MRCA between B and C, and can be found, or potentially found, in the set of candidates Xc, and such that the total genetic distance from this chosen ancestor to the two Users is within the acceptance range of B˜CH.
viii) Next, assign the shared DNA of another User pair (say C˜A) to an Ancestor from Xc who has maximal evidence of being the MRCA between C and A, and can be found, or potentially found, in the set of candidates Xa, and such that the total genetic distance from this chosen ancestor to the two Users is within the acceptance range of C˜A=k.
ix) Repeat the process above for all triplets of ICW-Match connected Users (this may be done in parallel or serial).
x) It should be noted, that the configuration motivated by 4606, and the genetic distance requirements, when applied to many interconnected sets of triangle matches, highly restricts the possible assignments of DNA segments to nodes.

3. The illustrated system 4600 includes:
4602: Illustrated are a 3 User (A, BG, SP) sub-graph of 4404, with the nodes relabeled A=>A, BG=>B, SP=>C for convenience, the ICW-Match DNA Map,
4604: To the right are displayed the sub-graphs of each User's VFT. The shared DNA node between each User is duplicated for each User that shared it, and is associated with an Ancestor node in their graph. In this example, we assume that the donut shaped DNA icon is associated to an MRCA that has been supported by other evidences. The donut icon in the VFT of User A is dash-dot line connected to the same icon in User B's (eg., BG's) partial VFT. The total length (in generations) of the path from the DNA icon to the two Users equates to the genetic distance (gd) between the two, and should fall into the range of the predicted genetic distance. The genetic distance (gd) from the root to the DNA associated node is annotated to each User-to-DNA edge as gd=x, where x is the distance in number of generations.
4606: Given the triangle of matches, there is an implicit constraint that DNA must flow down from the MRCA of two Users down different paths (otherwise, it would not be the MRCA). Thus, the graph shown confirms the MRCA restriction is satisfied for A˜B, A˜C and B˜C, while also ensuring that DNA has a down-ward path from the MRCA nodes to the recipients. Note that if the MRCA node of A˜C moved down to the right, the criterion for A˜C could still be satisfied, but the criterion for B˜C would be impossible, unless it were to move down-right as well, and there were a 1^{st} cousin relationship. Unless Surnames or middle-names suggest otherwise, this sort of endogamy will generally be given the least possible rank of all feasible assignments.
4608: : The essence and implementation of the ‘base triangular case’ algorithm is elaborated in pseudo-code and the general discussion.

System 4700, Illustration of ‘Base Two ‘s Case’ algorithm of “ICW-Match Graphing System with DNA Mapping”

1. Continuing from FIG. 45, illustrated in FIG. 47 is an example of one embodiment of an ICW-M Graphing System with constraint-driven DNA mapping. When the ICW-Match system runs to find the MRCA between A and D, and given that it has discovered the ICW-matches A˜B, A˜C, and has those MRCA's, and given that it has the ICW-matches B˜D and C˜D, then with the described system, it will first run an ICW-A search between MRCA VIA candidates of A and D (for any pairs that have not already been run, or which need to be re-run due to data changes), and then an MRCA-Engine analysis (FIG. 32, 3212) with the contributing MRCA nodes stimulated (note, the MRCA-Engine can stimulate multiple MRCA-Vdna nodes). In general, the following will be run:
i) A search of VFT D and the VWT for nodes similar to nodes in set Xa (date, place, Surname etc.), is made to initialize cross-VFT attributes. This employs the ICW-Ancestor search system of FIG. 20, with the restricted set Xa.
ii) In the MRCA-Engine (FIG. 32):
iii) A˜B, A˜B, B˜D=>MRCAab−>node X will be stimulated.
iv) A˜C, A˜D, C˜D=>MRCAac−>node Y will be stimulated.
v) The MRCAda in User D's VFT will be stimulated, sending activation to all of its eligible VIA nodes.
   (a) VIA nodes in D's VFT which have commonality with A's VFT nodes, may activate some nodes in Xa.
vi) Theoretically, double-stimulus (packets of ICW-M DNA) will be received by node Z and will propagate downstream.
vii) Assuming Node Z receives the greatest activation, Node Z will be labeled as a tentative MRCAad, and will be linked to the ICW-DNA node.

2. The illustrated system 4700 includes:
4700: This graph illustrates basic DNA driven triangulation in an ICW-M set where any triad A˜B, A˜C have known MRCA's, and a fourth A˜D is sought. If D˜C and D˜B, then there is only one sub-tree (the set Xa, no higher than node Z) that all 5 relations can be met. The set Xa is chosen such that the genetic distance from A to any node in Xa, plus the genetic distance to D, is within the predicted distance for A˜D.
4702: The intersecting section of the paths of DNA flow from MRCAab and MRCAac must be the MRCAad, since both A and D must receive DNA shared by both B and C.

System 4800, “General N-Cluster MRCA Assignment Algorithms”

1. Continuing from FIG. 32, state 3230, illustrated in FIG. 48 is an example of several embodiments of an combinatorial optimization MRCA assignment with constraint satisfaction metrics. As noted in FIG. 7, the plurality of objective function metrics includes, but is not limited to, 1) the cumulative measure of equivalence of the Ancestors chosen to be MRCAs, 2) The satisfaction of constraints across all such assignments and their satisfaction rates on the VFTs and VWT, 3) the resulting quality and completeness of the VFT's involved, and/or VWT.

2. In all cases below, eligible Ancestor nodes may be limited, diminished or enhanced (in their fitness within the respective objective functions) by the Constraint factors, which include but are not limited to:
Any DNA mapping between the members of the intersect set that is able to limit the eligible ancestor set between the members
Any outright ICW-Ancestors in the respective pedigrees of the ICW-M set receive majority fitness valuations
Surnames, or uncommon first or middle names which are similar to the Surnames of their potential Ancestors in other trees in the ICW-M set, are given priority and higher fitness valuations than attributes of less significance
CPA in time (closest passing in time), mapping all eligible Ancestors of the members of the ICW-M set simultaneously, via ICW-P attributes, should be met, if possible to calculate. This is only impossible to calculate or estimate, if the there are no evidences of temporal location such as birth place, death place, or similar geo-temporal data points of the individuals parents, siblings or offspring.
Uncommon (statistically significant) Nationalities of birth, or ethnicities in Ancestors in the ICW-M VFTs
Attributes (records) shared between any Ancestors in the ICW-M VFTs, such as Wills, names on marriage records, military service etc.
Simultaneous Disembodied Cousin analysis from VFT Ancestors of the members of the ICW-Match set.
Cluster attractors, such as ICW-Match clusters, as tracked by ICW-DNA nodes. Attractors are limited by DNA match genetic distance estimates as previously described.
ICW-Match DNA flows, such that DNA from a putative MRCA must flow downstream through the pedigree to the matching DNA individuals (Users).

3. In simple words, given a set of DNA matched Users, and their respective sets of VFT ancestors and corresponding MRCA's, the system shall select ancestors (Ki) from the sets X such that assigning MRCA (Mij) nodes to them results in an optimal assignment. There are several algorithms by which the system may do this assignment.

4. 4808 Best-First: Generally, the best MRCA candidate is chosen from the most cluster-enriched (fit) User pairs first. All User's are run asynchronously, in parallel if possible. This algorithm can operate on the VFT's directly, but can also run with the 608 Inter-Match Network.
1. All User MRCA-Vdna candidates (Mij) of a particular User ‘i’, are ordered (queued) by the likelihood of finding a common ancestor between the MRCA's candidate VIA nodes in sets Xi and Xj. Here, Xi is the set of VIA candidates from User Mi, and Xj are the candidates from User Mj. The MRCA node Mij is thus the MRCA between User ‘i’ and User''. The ‘i’ index are pre-selected as DNA matches, and pre-sorted such that the Mij with the highest confidence (and presumably, closest DNA relationship to the User ‘i’) are processed first. Thus, The metric, ‘likelihood of finding a common ancestor’ is, in one embodiment, calculated by taking those sets X which have the fewest elements (fewest VIA nodes), and which already have the highest degree of shared attributes. The example function fcd(Mij) below, suffices to provide a simple ranking of all input MRCA candidates.
   a. fcd(Mij}, where function fcd calculates the ‘cluster density’ such that fcd(Mi, Mj)=Num_Shared_Attributes(Mi,Mj)*(1/(Tot_Num_Members_in Xi+Tot_Num_Members_in_Xj)). This example function calculates a simple density, without regard to weighting of importance on the attributes.
2. From the set Xi of Mi selected, the most likely matching Ancestor for Mi's two Users is chosen.
3. Thence, each next less fit MRCA pair that is related to the prior pair is evaluated, if any more exist. Any improvements in the network are taken into consideration (ie, the prior MRCA assignment reduces the eligible set for the next, related MRCA). If no DNA related MRCA exists, the next best fit of the remaining MRCA's from the set M is chosen.
4. Loop back to step 2, select an Xi of the last Mi.
5. Repeat until all MRCA have been assigned.
6. After all MRCA have been assigned to the User's VFT VIA's in the first round, calculate the fitness of the total assignment. This fitness is the sum of the fitness of each MRCA assignment, and any various global factors (overall quality and completeness of VFT and VWT trees resulting). The fitness of each MRCA assignment is a function of:
   a. The confidence in the match of Ancestors selected for the MRCA, according to the ICW-A search Agent algorithms
   b. The satisfaction of the genetic distance function for the MRCA, with the two selected Ancestors to each respective root User node. Any deviation is a negative addition.
   c. When two or more MRCA's are assigned to the same VIA node, then the MRCA's have to be partitioned into sets according to unique VIA individuals. That is, if the VIA from the other VFTs nodes do not match each other as ICW-A equivalent individuals, then they must be partitioned into sets of individuals who do match each other. The total fitness that could be assigned to any one MRCA is shared between the sets of MRCA-VIA partitions, with fitness weight apportioned according to proportional numbers of VIA nodes in each set. That is, if set 1 has 3 VIAs, and set 2 has 2, then Set 1 MRCA nodes would share ⅗ of the fitness.
7. Next, the worst performing MRCA assignments (eg, those that perform below acceptable criteria for a valid match), are evaluated to see if any other assignment would have performed better. The new assignments are not yet made permanent, but are rather put in an evaluation bin for each MRCA. The new assignment is marked, to prevent it from being ‘re-evaluated’ again in this current round.
   a. If the re-assignment disrupts a prior assignment, then that prior assignment is re-visited. Note that if every prior assignment had already been optimally selected, then the worst performer has been optimally selected from the choices it had. Thus, to make an improvement (if possible), would require a disruption of a prior assignment.
   b. The disrupted assignments are queued and re-evaluated (loop back to step 7).
   c. The re-evaluations continue until the queue is empty, or until there are no further options for re-assignment, as all options have been marked in the current round
8. After the current re-assignment round is completed, the whole re-assignment set is calculated for overall fitness, per the measure of step 6.
9. If the measure of overall fitness has improved, the evaluation selections are made primary for each affected MRCA node.
10. Step 7 re-evaluation is run again, and the results measured again, and compared against the prior run, until there are no further improvements in the overall fitness.

5. 4810 Evolutionary Algorithms: A traditional Genetic Algorithm (GA) implementation requires the selected set (assignments of a Users MRCA-Vdna nodes to eligible Ancestors) to be ordered into a vector, with a population of such vectors representing various assignment sets. The order of MRCA's on every vector must be the same. An initial assignment may include the 4808 Best First, and then vectors generated from randomization of the less optimal assignments, and rounded out with a number of more randomly arranged assignments, to avoid what's called the ‘minimal deception problem’. After a population is created, the optimization process applies an objective function to each vector to determine the fitness of each. A number of the highest fitness vectors are chosen for mating. Then, in the traditional GA mode, iterative cross-over recombination is done with such vectors to generate new offspring (samples). This process is repeated until the there is no significant improvement in fitness of the best performing vector. That vector is then re-evaluated to confirm constraints, and then those assignments are given to the VFT and VWT Agents. Note that, in this system, each column (when vectors are aligned in rows, the column represents a particular MRCA), will have a population of potential Ancestors which may fall into and particular row's assignment of that MRCA. Once an Ancestor gets dropped from the population represented in a column, it can not be added back in by this system. This limitation leads to the following Smart GA.

6. The traditional GA is one embodiment of this algorithm. The preferred embodiment is called a ‘Smart Genetic Algorithm. This system will create sample sets from the best performances of each MRCA. This method may be run on individual VFT's, but running all VFT's in parallel with the 608 Inter-Match Network, facilitates global constraint satisfaction and optimization. This process involves the following flow:
1. Create a large set of constraint satisfactory assignments of Ancestors in a VFT to a User’ MRCA-Vdna Nodes, say K, (number of sets depends on memory and compute time available, but should be high enough that every permutation of assignments for each MRCA is expressed enough times to ensure that its correct assignment shows up enough times, with the correct assignments of those adjacent), with each saved as a vector of tuples, which consists of an MRCA id, two VFT-VIA' s ids, and the fitness of the VIA assignments. This is initially accomplished by:
   a. Randomly select one MRCA-Vdna, Randomly select one Xi for each Mi. Calculate the local fitness of the assignment and save it on the vector ‘tuple’ for the Mi'th node.
   b. The ‘fitness’ of an assignment involves, in one embodiment, a summed metric of
      i. The DNA match confidence and degree
      ii. The matching of the VIA members of an MRCA assignment, which includes, at least:
         1. biographic information (name, date-of-birth, parents, siblings)
         2. physical location overlap
         3. other attributes shared (through co-connection to the same attribute nodes)
      iii. Constraints satisfaction quality. Negative additional fitness may be accomplished by cases of genetic distance violation, or non-convergent DNA flows (a DNA segment does not have a common ancestor, but rather two or more distinct Ancestor paths which do not intersect).
      iv. The quality of the VFT's with the Ancestor involved in the MRCA assignment. That is, equating two Ancestors from two or more VFT's, means that each VFT must determine whether the information associated to that Ancestor in the other VFT(s) actually improves or diminishes its' own quality. It must also allow for the possibility, if there are many members of a triangulated MRCA, and there is a definite fit of this MRCA into the User's tree, but the Ancestors do not match or do not match exactly, that its' own instance of the Ancestor is wrong. That is, if the parents, siblings or descendants match, but the actual current Ancestor at the node does not, then that Ancestor should come under scrutiny.
   c. Repeat la until all MRCA's have been assigned. Calculate the overall fitness for the whole assignment set (which is recorded in the header of the vector of tuples).
   d. Calculation of the overall assignment is a form of the Quadratic Assignment Problem [19, 20], wherein the fitness is based on the summing of the individual assignment's fitness.
2. From the set of assignment vectors, sort and rank them according to their overall fitness values. Note, a vector in this case is the assignments for a single User with his/her MRCA cases assigned to his/her VFT VIA's.
3. If the best performing assignment has successfully assigned every MRCA with high (acceptable) fitness, make that assignment permanent in the MRCA's and stop.
4. If the best performing assignment is unsatisfactory, proceed with a ‘smart reshuffle’, which is similar to cross-over but is not blind. A reshuffle consists of
   a. Sort each vector according to the fitness's of the MRCA assignments it holds, such that performance decreases down the vector.
      i. During the sort, create a hash-table of the vector, with the MRCA id's as keys, and a pointer to the vector index as value, for fast lookup.
   b. For each MRCA Mi, find the N best assignment's fitness from L vectors out of all of the top performing of the overall K vectors. Copy each to N =K-L new vectors
      i. This will result in a new population of Assignment vectors, sized N +L, based on the best performing individual MRCA assignments and overall performances.
      ii. Individual MRCA assignments are like real genes, in that they compete in the environment (fitness calculation).
      iii. The overall vectors of assignments are like individuals, in that they may have flaws, and those flaws limit their fitness
      iv. The recombination described above is able to pick the best MRCA assignments from all vectors, rather than just pair-wise as is done in 2-sex reproduction.
5. Merge the L best overall assignment vectors and the new N vectors, resulting in a new population of size K again.
   a. Calculate the overall fitness of the new vectors.
6. If there has been some improvement in the fitness value of the best performing vector, return to step 3.
   a. That is, if the there is a good solution and no further improvement seen, stop, otherwise it will repeat the process.
7. If the last round (generation) did not result in significant improvement, and the overall fitness is below expectation, the system will have to focus on sub-optimal nodes
   a. Sub-optimal nodes are found by finding and date-mining the worst performing MRCA assignments in the best performing overall vectors.
   b. Any MRCA assignment which consistently shows up in the top performing vectors, but is itself sub-optimal, should be re-sampled.
   c. Regenerate these MRCA assignment by either:
      i. Using the most fit MRCA assignments from all samples, regardless of overall vector fitness
      ii. Regenerating the MRCA's assignment of Xi by trying other nodes from the eligible set X, which have not been tried before
   d. After regenerating the worst-performing MRCA assignments, loop back to step 4.
8. If there is no improvement after a number of ‘Sub-optimal’ node re-shufflings, the system will have to look for ‘conflict nodes’
   a. Conflict nodes are MRCA assignments that result in conflict with other MRCA assignment of the same vector set. There are various manifestations of conflicts
   b. If an Xi assigned to an MRCA (and thus, calculated to be the same individual as Xj) also appears in another MRCA assignment, but the second MRCA has it paired with an individual Xk who does not match Xi, then this is probably a conflict.
   c. If the MRCA assignment leads to a case where DNA can not flow downstream to satisfy all MRCA assignments, then it is in conflict.
      i. Testing for DNA flow consistency requires a build of the representative trees using the VFT's as the framework
      ii. With 1000's of MRCA's per User, there will likely be several MRCA's associated to every VFT VIA node (Ancestor).
      iii. On the affected VFTs, each MRCA is applied, and a DNA packet is sent down from the MRCA to the User root nodes.
      iv. Following the theory of FIG. 46 and FIG. 47, if 3 or more User's are DNA matched, and there is no direct downstream flow for DNA to all of them, then at least one of the MRCA assignments is in conflict. Usually, if a majority of them have a direct DNA path to all DNA matched Users, then the minority MRCA's will be marked as conflict, and will be recycled.
   d. If any conflict nodes are found, they will be marked for recycling (or reassignment), and the procedure will loop back to step 4

7. 4812 ‘General N-Cluster Center-of-Gravity Algorithm’ the ‘General N-ICW-M Center-of-Gravity Algorithm’ is applied to sets of ICW-Matches who share various attributes which cluster them around a particular region of a graph. Given that the VFT's have been data-mined for common attributes, ancestors and DNA, and that those have been registered in the Global Shared Attributes DB as Clusters (for example, a set of ICW-M networks (4404) for each User), then the objective of this algorithm is to engineer an attraction between members of a Cluster or ICW-Match network and their shared, dominant cluster attributes, which thus attracts them to in-common ancestors or ancestor groups. The system will provide negative pressure to enable separation of sets with common-centroid accumulations. This algorithm is essentially the same as the Local MRCA Engine (FIG. 30-32), but with many sets of many MRCA's applied simultaneously. In terms of the similar k-means clustering,[20] we are trying to partition the DNA of all Users involved (the ‘observations’) to ‘k’ specific Ancestors (VIA nodes) or Ancestor Clusters. But, there is no simple distance metric by which to calculate the distance of a DNA segment to each cluster center. There is, of course, no direct physical relation between the DNA code itself and clusters. There is, however, a number of attributes we can associate to the DNA (the pedigree), and likewise to the Ancestors. Note that there will be many descendants of most ancestors, and therefore many DNA segments. Although the attributes associated to a DNA segment may rapidly diverge over time (going down the descendant branches), they will almost always have overlap at the point of inception—if attributes related to that period have been discovered and recorded. If any particular DNA segment is attribute-poor in any region between the descendant and MRCA source, then this system can still work if there are sufficient ICW-Matches through which the descendant's DNA segment can be pulled into a cluster.

8. Therefore, to calculate the distance of a DNA segment to any particular Ancestor or Cluster centroid, we need to quantify the value of the attributes, and their confidences, between the DNA and Ancestor. Unlike K-means, we may also employ various constraints to help sort the DNA into these clusters (such as genetic distance and direct downward spanning-tree DNA flow from the ancestors to Users, for all solutions). We will always want to utilize any DNA mapping to associated to DNA cousin networks, and ICW-Match networks to ‘inherit’ attribute influences.

9. Thus, this algorithm consists of:
1. Give each Cluster and/or ICW-Match network a name (tag), which will be sent with packets. The MRCA's involved are derived from the Cluster and/or ICW-match network.
2. Fire activation through all relevant MRCA's of all Users in a particular named network, with the name tag, and DNA ID. Note that these activations go to nodes which have been pre-pruned to only include Ancestors who are within the genetic distance range.
3. Activation spreads through the network in the same manner as described for the Local MRCA Engine, (FIG. 30-32). Note that activations are travelling through distinct VFT's, and attempting to find where those VFT's intersect, given the evidence of the DNA match.
4. The activations received at each Ancestor are summed by source (DNA ID). These values serve as the corollary of K-mean's distance metric.
5. The Ancestor nodes of a VFT are scanned to make a table (DNA-per-Ancestor), VIA nodes on rows, DNA ID's as columns, with row-column values as a ‘tuple’ of the activation received from a DNA ID, the ID, and the network/cluster name tag. Note that the DNA ID may end up at several ancestors. This format enables us to sum up the number of occurrences of a DNA ID from a particular network or differing networks, and differing MRCA origins.
6. Another table (Ancestors-per-DNA) is simultaneously built, with DNA ID's as the rows, and Ancestor ID as columns. Each Ancestor receiving a DNA-ID packet will record that packet value in the row of the DNA ‘ID. This basically enumerates the ranking of where a DNA segment predominantly ends up.
7. The tables are analyzed. A DNA ID may have the its highest value at a particular Ancestor (Ancestors-per-DNA), while that Ancestor may have other DNA ID's as having higher frequency in DNA-per-Ancestor (total activation). Generally, we want to find DNA segments originating from different sources to a particular Ancestor. That at least implies the Ancestor is the MRCA or downstream from the MRCA. Ancestors receiving multiple sources of the same DNA are evaluated and ordered, such that the oldest (further back in time), is considered the earliest possible known MRCA source.
8. With these tables, further complex analysis will be possible, and may be merited, taking into account ICW-Match relationships of DNA ID's, and applying the algorithms of FIG. 46 and FIG. 47.
9. The output of the analysis will be an assignment of the MRCA to particular Ancestor nodes with confidence derived from the above analysis.

10. The illustrated system 4800 includes:
4800: General N-Cluster MRCA Assignment Algorithm
4802: X₁={k₁, k₂, . . . kᵢ}: The reduced set of eligible VIA nodes from U₁ VFT , for example.
4804: S={Uᵢ, U₂, . . . Uₙ}: The set of Users to evaluate. Often, these will be Users who are associated to a particular cluster saved in the Global Shared Attributes Db, such as in a network of ICW-Matches, and/or DNA Map, and/or Surname cluster in a date-time and place.
4806: M={Mᵢⱼ} are the MRCA Vdna nodes such that members of the set are DNA matched, and subscripts ij correspond to sets Xi and Xj belonging to Ui and Uj.
4808: Best-First Assignment Algorithm : Iteratively assigns the most fit first, in order of decreasing fitness, in each Cluster, in order of Cluster density.
4810: Evolutionary Assignment Algorithm: Uses a modification of a genetic algorithm, with MRCA assignments as swappable genes.
4812: General N-Cluster Center of Gravity Algorithm: Uses an adaption of the intent of K-means and attraction of DNA to a cluster centroid (an Ancestor).

System 4900, MRCA Analysis with Distributed Sparse Matrices Option,

1. Continuing from FIG. 6, state 610, illustrated in FIG. 49 is an example of one embodiment of extraction of the VFT, MRCA-Vdna nodes and Attributes networks to vectors and sparse arrays. In any matrix, the rows and columns represent nodes, and the value of a row, column index represents, at least, its connection weight, in one embodiment.

2. The illustrated system 4900 includes:
4900: Continuation of the stage ‘Accumulate all desired data into competitive networks’ from FIG. 6. For a global analysis, involving thousands or millions of Users, and when a large compute farm or cloud is available, the Users' VFTs and the global attributes DB may be converted to distributed sparse matrices. Operations on the sparse matrices may be executed in parallel
4902: The ‘Global Distributed Competitive Network and Sparse Arrays DB’ are built from all relevant data as described in FIG. 6.
4904: Minimal representations of the graph of FIG. 30, with just two User's VFT's are displayed, User A and B, and labeled Ancestor VIA nodes 1-4, and an MRCA-Vdna node for each, labeled Vdna MRCAab and Vdna MRCAba. The connections from the MRCA to the VIA nodes are labeled xA3, xA4, xB3, XB4.
4906. Minimal representations of the graph of FIG. 30, with just two User's VFT's are displayed, User A and B, and labeled Ancestor VIA nodes 1-4, and four attribute nodes labeled k1, k2, k3, k4.
4908: The vectors shown are sufficient to represent the connectivity of MRCA Vdna nodes to VFT VIA' s, and the VFT tree to Attributes. The elements may be tuples to carry information on the weight of the connection, as well as type of connection, in the case of various attributes or ICW-Match connections.
4910: A typical array of interconnect between nodes of a graph, with the indices representing the weight of the connection (or confidence). In this case, the diagonals ie (A1, A1) may be used to represent the overall confidence in the ancestor.

System 5000, Global DNA Cluster Generation and Analysis with Competitive Networks

1. Branching from FIG. 4, state 424, illustrated in FIG. 50 is an example of one embodiment of the system 5000 Global DNA Cluster Generation and Analysis with Competitive Networks. This system implements a paradigm of neuromorphic inspired dynamic DNA-centric cluster generation, with spontaneous growth of correlation nodes between co-activating nodes, decay of nodes which have lost co-activation, and a system of coalescences of overlapping DNA into new ‘overlap’ or ‘merged’ DNA nodes, a system of ‘floating’ unaccounted-for DNA segments such that they are associated to eligible nodes, and a hierarchical system of DNA clusters wherein a ‘Cell’ node is the vector through which DNA must pass, and ‘Trait’ nodes bind to DNA segment nodes, their Cells, and potentially to VIA nodes of that VIA is known or hypothesized to harbor the Trait.

2. The motivation, intent and operation of this system is described next, but first, a brief summary of FIG. 50 will facilitate the discussion. The blocks 5002, 5004 and 5006 present minimal representations of sub-sets of three VFTs (of User's A, B and C respectively), such that just a few nodes of the first three generations are shown, and then an implied pedigree path leads to the upper sub-tree, which may be anywhere in the pedigree. The upper sub-tree, as in 5008, represents the set of VIA nodes which are still eligible for potential selection as the MRCA node between the two Users associated to the MRCA Vdna node pointing to that box, or a node in that box. When pointing to a specific node in the box, this node has been selected as the most likely MRCA node, but the others are still possible, and remain available for combinatorial optimization engine's use. Connected to a VIA node Y in set 5008, we have an 5012 ‘Trait X’ node. This node is connected to several others, including the 5010 ICW-DNA Segment node, which itself is connected to the 5014 MRCAab Vdna and MRCAba Vdna nodes—thus implying that this DNA segment is shared by Users A and B. The 5012 Trait X node and 5010 Segment node are both connected to the 5018 ICW-DNA Cell node. The Cell node is a cluster centroid of ICW-DNA segment nodes, and Traits, and there will always be at least one Cell node linked to each VIA node, if there are any ICW-DNA segments associated to the VIA node. In the illustration, the MRCAab and MRCAba are connected through an ICW-DNA segment node 5010, implying that the VIA nodes ‘Y’ in the two VFT's are the same individual. Another MRCA node at 5016 is shown, connected to individual Z in B's VFT. For illustration purpose, the DNA segment 5024 associated to MRCA 5016, is found to overlap DNA segment 5010. If the overlap is significant, then the two segments are combined into a ‘phased’ ICW-DNA segment node, as represented by Phased ICW-DNA node 5020. In this illustration, we have MRCA Vdna 5022 linked to phased ICW-DNA 5020, implying that the this generated DNA provides a means to match the connected VIA nodes ‘Z’ in B and C, and the Phased node is linked to those VIA's by dashed lines. This DNA connection might not be possible without the Phased DNA node. Trait X node 5012 is displayed again between the VFT's of User B and User C, as an example to demonstrate how the Trait X might be passed on, and how it might show up in other VIA nodes (being ‘grown’ by a Cluster Agent or DNA Agent), thus providing a binding between all nodes to which the Trait X connects. It should be noted, in the illustration, Trait X associates to VIA nodes which could have inherited the Trait through the associated DNA nodes 5024, 5010, and their combined 5020. Finally, all ICW-DNA nodes (Cell, Segment, Phased, Overlaps etc.) are saved in the GSA-DB, and also link to their respective segments saved in the 236 Chromosome Maps DB's that are associated to every VIA node.

3. In many of the systems described so far, various assumptions on data availability or compute capacity have been guiding factors. For example, the ICW-Match systems and algorithms are needed when the overall system does not have direct access to DNA or match data (segment start, stop, cM etc), but rather, only the conditions that if a User A matches B, and both match C, then C is an ICW-Match. In that case, we do not know which segments match between each pair, nor whether they are the same in a set of 3 ICW-matching individuals. However, as illustrated in FIG'S. 38, 39, 43-47, from this limited information we are still able to fit (or cluster) chains of ICW-matches to VFTs, if we have any attractors, such as anchors of any nodes (User pairs) which have been associated to an MRCA and/or attributes drawing the VIA nodes in-line with VFT branches, and also taking into account the constraints of match-defined DNA flows and also factoring in the genetic distance and range constraints. This clustering in of itself, may significantly reduce the candidate space for any MRCA, and combined with various attribute attractors, may elevate the actual MRCA ancestors to the top of the likelihood list.

4. If we have access to the actual DNA match data, in terms of having at least the matching DNA segment locations on chromosomes (start and stop), and we know, or can derive, any further DNA segment matches, then the systems described in FIG. 10, and further detailed in FIGS. 25-29 may be applicable, and will provide a much higher information resolution than blind ICW-Match data. In this case, system 5000 will (in either continuously running or periodic mode), benefit from the results and functionality of DNA map system's 2600 and 2700. For example, after an MRCA Engine analysis, if an MRCA has been found, the involved DNA segment(s) will have been mapped from involved User's MRCA-Vdna nodes to all appropriate nodes between the User and MRCA ancestor Node (VIA node) with ICW-DNA segment attribute nodes connecting VIA nodes which have this segment, in all trees into a cluster. In FIG. 50, the ICW-DNA node 5010 represents such a mapping. The connection strength from the VIA node to the ICW-DNA node is set to be proportional to the confidence that the Ancestor has the segment represented by the ICW-DNA node.

5. Furthermore, from FIG. 26, when any Ancestor (VIA node) accumulates several segments which overlap, and match on those overlaps, they will have created information potentially not available in the existing DNA sets of the Users. That is, other Users (or Ancestors) may have DNA matches to the new merged segment of the VIA node, but not have matches on the same segment to other Users. If so, this new, merged DNA segment will likewise get an ‘phased’ ICW-DNA node (example: 5020), which points to the nodes producing it, and the chromosome DB entry (not shown). Thus, each Ancestor's accumulated DNA is added to the matching pool, with ‘flags’ to indicate that it is ‘phased’ [22], and that empty zones do not generally count for or against the matching coefficients. If such blank DNA is known to be common IBS (inherited by state), then it may be considered a match for SNP's that also match and which lie in its span.

6. Similarly, as one part of system 5000, as noted in FIG. 26, the DNA Agents will be employed by a Cluster Analysis search, which will (in this case) associate overlapping DNA segments, which are not sufficiently long enough to be high confidence IBD, to an ICW-DNA Shared Attributes DB node, with special annotation defining its' overlap′ origin, and its' relatively low influence (connection weight). This node will provide a minor tug of attraction between the ancestors which have these overlaps. These overlaps are only recorded for segments found in the Chromosome DB which have been used to match two Users.

7. In this system 5000, cluster nodes include collections of any attributes (example 5012) which are connected to a plurality of Ancestors nodes from VFTs or VWT, whose owners are usually DNA matches. Note that this includes, but is not limited to, data-mining of A˜B˜C chains of DNA matches (ie, any set of chained DNA matched Users), as well as User's DNA overlap chains. Furthermore, in this system, attributes may include known genes or the proteins they create, or the physical (phenotype) traits of an individual (organism). Thus, for example, if two individuals are known to have the same phenotype trait X, and are suspected of being related (or being the same person) due to co-activation (or post MRCA discovery linking them), an attribute node grown between both of them will serve to mediate this correlation, passing activation between the two nodes in an competitive network analysis. Cluster Agents will be responsible for this attribute growth, if the two individuals are not ICW-A ancestors (yet). If two individuals are ICW-A or connected by an MRCA-Vdna, then an DNA-Agent may create this node (if it does not already exist), and also link it to the DNA segment shared between the two individuals.

8. In previous analysis systems, the MRCA-Vdna node has been introduced to capture the intent of a place-holder for an unknown MRCA, with a known DNA segment shared between a set of User's who matched to various degrees. In this system 5000, each Ancestor's DNA segments set (held in its' chromosome db), is by default a cluster centroid based on the DNA that the Ancestor ‘distributed’. However, the Ancestor VIA node is not the center of the DNA cluster. For this purpose, we will use the ICW-DNA node, with a special ‘Cell’ class. That is, the ‘Cell’ ICW-DNA node (example 5018) forms the centroid to which all the associated ‘Segment’ ICW-DNA nodes (example 5010) link to. Accordingly, in this system 5000, each DNA segment forms a sub-cluster, centered at the ‘Segment’ ICW-DNA node for that segment, of the sub-set of descendant Cells which received that DNA segment. In the Figure, node 5010 has dotted lines to all the direct-line descendants of VIA nodes ‘Y’, but this is actually pointing to the Cell ICW-DNA nodes associated to those VIA nodes (not shown to minimize clutter).

9. This system 5000 will dynamically create clusters based on DNA match data, existing attribute connections, and the DNA network flows constraints. This work is done by 932 DNA Agents. A DNA network flow requires that, from a confirmed DNA triangulation host, the DNA segment involved may only flow down-stream (that is, a spanning tree extending down from the host). This does not mean the segment flows down all paths, but rather, that it has the potential to flow down. Furthermore, from a known host of the DNA segment (usually a User, but potentially any Ancestor eventually assigned the segment), the DNA must have originated from an Ancestor in the pedigree above the host (that is, a spanning tree above the host), if the current host is not the creator of that segment. The DNA Agents will ensure these constraints are adhered to.

10. As an example of another form of cluster generation, if two individuals (Cells) are found to be related, and connect by DNA segment(s), and both likewise link to a phenotype trait attribute node, then the Cluster analysis will grow a connection between the attribute node and the DNA nodes, with a strength proportional to the number of individuals (Cells) which share the DNA and trait. This is in effect, mirroring the phenotype to the genotype network. The links of the Trait node to will carry with them annotation defining the association as a hypothesis, and not based on observations of the Trait in the individual.

11. In this system 5000, given that an Individual's DNA has been broken up into many DNA segments, each connected to an Segment ICW-DNA, and overlaps have been captured into an Overlap ICW-DNA registering this condition, then for individuals for which the entire genome has been sequenced, and for which, at some level in the VFT, certain segments are not associated to an MRCA-Vdna nor an ICW-DNA, a special ‘Floating Segment ICW-DNA node is created. This node may be linked to all eligible VIA nodes, where ‘eligible’ is defined by the restrictions placed on the segment by prior chromosome mapping. These segments will, in many cases, have overlaps with other segments, either from the User, other Users, or the segments registered to an Ancestor. These overlaps are captured similar to the overlaps described above. Thus, DNA segments which have no hints in terms of DNA matches, are still potentially constrained within sub-trees of the VFT's.

12. Functionality of System 5000 Includes the Following:

13. The ICW-DNA network is simulated by the MRCA-Engine (FIGS. 23, 24, 30, 31, 32), with the variations described below. As usual, the MRCA-Vdna nodes send DNA packets to all eligible VFT VIA's, which then relay them to all connected Attribute Nodes, Trait nodes, and Cell ICW-DNA nodes, which then relay to all connected Segment ICW-DNA nodes. The relayed stimulus packets contain their ID's, and paths traveled, and the genetic distance range expected to the User, and the activation level of each packet is modulated according to the strength of each connection traversed.

14. On a Global Analysis scale, in one embodiment, which we will call the ‘Burst Mode’: when every DNA segment (from MRCA nodes and Chromosome DB's associated to Ancestor nodes and ICW-DNA) is activated simultaneously, and all VFT's are represented in the competitive network (through the 608 Inter-match DB), and given that activation packets carry the ID of the DNA segments or Cells from which it originated, and given amplification at nodes which receive multiple activations from the same DNA ID originating from different trees, and given a decay rate of the activations to ensure limited growth and eventual decay, and given further decay on nodes which have competing multiple DNA ID activations for the same chromosome map location, with negative activation sent back on the losing DNA ID paths, and given a similar competition solution for each DNA ID (Segment) which is on multiple VIA nodes which are not in a direct line of inheritance, such that the top Node (the DNA node on the VIA which has the greatest activation) gains activation while the others decay proportionally, the entire system will be made to ‘settle’ such that each DNA ID should end up with one progenitor Ancestor (or couple), and that DNA ID should only appear in direct downstream paths from the progenitor(s), and each Ancestor will have no more than two DNA representations for any particular span on its' chromosome map, and the progenitor(s) of the segment will have a genetic distance to each User having this segment, which is within the estimated range. A VIA node will reject (ignore) a DNA packet which has a genetic distance range, which is greater or less than the VIA node's genetic distance to the VFT root node. Once such a DNA ID has settled to one progenitor Ancestor, a direct connection is grown to that ancestor between the ICW-DNA segment node and the VFT VIA Ancestor node, and the condition is reported to the MRCA-Vdna node, such that it may register this ‘solution’ for this particular algorithm. Note again that MRCA-Vdna nodes have sets of candidate VIA nodes for each algorithm, such that they may each have independent solution spaces. However, the side-effect of growing the connection from the DNA-Segment node to the Ancestor(s), affects other algorithms that depend on activation passing through attribute nodes connect to each VIA Ancestor.

15. In another simulation embodiment, which we will call the ‘Evolving Mode’, the MRCA-Vdna nodes send out activation packets every time there is an addition or change to the ICW-DNA nodes or attribute nodes, or whenever a settling time has passed. That is, the entire system is continuously (on a periodic beat) sending packets from MRCA-Vdna nodes. Thus in this mode, the system dynamically accommodates all constraints from all VFT's and all DNA matches in a simultaneous, evolving solution. The conditions described in the Burst Mode are honored in this mode as well, as well as the resulting actions of connections growth from a dominant DNA Segment Node to VIA node due to activation association. The type of simulation mode (Burst or Evolution) is encoded into, and sent with each packet, such that both may run overlapping, and nodes will not get confused. That is, each node will have registers (variables) which account for Burst and Evolution mode packets received and passed. Evolution mode does not require the nodes to be uploaded to the 608 Inter-match DB, but rather, has direct peer-to-peer communication between the User's MRCA nodes, VFT nodes, attribute nodes and ICW nodes. This peer-to-peer communication is mediated through the Agent Exchange, and various Agents. If two nodes which are exchanging a packet of activation information lie on different computers, then Agents will have been initiated on each of those computers. The Agents communicate by various message passing protocols, which may include TCP or UDP. The User Datagram Protocol is preferable in Evolutionary mode, as reliability is not critical as it would be in Burst mode. In the ‘Evolutionary’ mode, a node determines which packets are dominant by calculating a frequency metric. That is, a node may receive multiple packets of the same type, or originating from the same Ancestor, or the same Cluster. For each path from a first User A to a DNA matched second User B, passing through Attributes they share, there should be one packet of activation shared. The higher frequency attributes from a first Ancestor ‘wins’ in terms of dominance, over the attributes from another second Ancestor. That is, the metric for an attribute is an average rate. Whereas, in the burst mode, the metric will be a simple summation for the cycle. As noted above, ‘wins’ means that, if there is a consistent, repeated activation association between two Ancestors, then a direct ICW-A node will be grown between them, in the neuromorphic sense. Moreover, this ICW-A node may increase its weights of connections, or decrease them, by rate of activations passing between the two nodes. For example, every ICW-A connection in this modality will have a small decay rate, such that if any Ancestor connected to does not co-activate with other Ancestors connected, then it can be assumed that the Ancestor has lost the shared attributes which motivated the creation of the ICW-A connection in the first place.

16. This global analysis will not lock a DNA ID to any particular Ancestor VIA node, but will result in an enhanced confidence of the DNA node being assigned to its ‘winner’ VIA nodes in the respective VFTs (and thus, increased weights on the connections). Also, as in the MRCA-Engine analysis, nodes in the various VFT's that have the same or similar attributes (surnames, places, dates etc) will receive the majority of activation, benefiting from all User's evidences. This in effect propagates and shares constraints through the DNA match correlation defined by the ICW-DNA clusters to all Users' involved VFTs.

17. It should be noted that several User's may share the same Ancestor (ie, DNA from that Ancestor), and it would be expected that these ancestor nodes, if in the VFT trees of the several Users, would share the same, or similar attributes. If we have, for example, three Users (A, B, C) who share a common, but unknown ancestor (and they are not aware of this fact), and each User only DNA matches to one other, then we want to reveal this Ancestor as being common, by using the evidences linking the ancestor's nodes and the Users. If Users A, B have discovered an ICW-A designated X, and User's B, C have discovered an ICW-A designated as Y, then X and Y should be compared to determine if they too share an ICW-A.

18. But, even this pre-condition of the ICW-A being already discovered between pairs of DNA matched Users is not entirely necessary. For example, given the minimal condition that A˜B˜C, then to find the ancestor common between them (if any), we would need to run an competitive network analysis run with B and all of B's DNA matches (which would include A and C). After an activation and settling time, only the Ancestors who were stimulated by 3 or more User's MRCA Vdna nodes, along with complimenting attributes, would be considered common to all three Users. Notably, this does not lead to false Ancestors, which result (for example) when a User A shares DNA with 2 Users and a specific, but unknown, ancestor X, while those 2 Users match several other Users who collectively have a different, known, common ancestor Y. That is, it should be unlikely to mistake X and Y as being the same individual, if they do not share complimenting attributes. Furthermore, if the DNA segments are known, then if A˜B by S1, and A˜C by S2, while B˜{D,E,F} by S3, and C˜{D,F } by S4, then there should be no motivation to suggest A˜D, unless there is further evidence to suggest S1 and S3 or S4 came from the same MCRA.

### LIST OF REFERENCES

Literature and Online References
1. http://mediacenter.23andme.com/blog/2008/09/09/23andme-and-ancestry-com-partner-to-extend-access-to-genetic-ancestry-expertise/
2. ISOGG Autosomal DNA testing comparison chart: online http://www.isogg.org/wiki/Autosomal DNA testing comparison chart
3. Ancestry. com Q3 2013 Financial Report: http: //corporate. ancestry. com/press/press-releases/2014/02/ancestrycom-llc-reports fourth-quarter-and full year-2013-financial-results/
4. Ancestry DNA Circles, white paper: http://dna.ancestry.com/resource/whitePaper/AncestryDNA-DNA-Circles-White-Paper
5. Strange Attractors: https://en.wilapedia.org/wiki/Attractor
6. Single Nucleotide Polymorphisms https://en.wikipedia.org/wiki/Single-nucleotide_polymorphism
7. Illumina HumanOmniExpress-24Beadchip http://support.illumina.com/array/array_kits/humanomniexpress-24-beadchip-kit.html
8. “Reducing pervasive false positive identical-by-descent segments detected by large-scale pedigree analysis”, Apr. 30, 2014, Molecular Biology and Evolution, Online: http ://mbe.oxfordjournals.org/content/early/2014/04/30/molbev.msul51.full.pdf+html
9. ISOGG facebook group: https://www.facebook.com/groups/isogg
10. GEDMATCH Family Groups: www.gedmatch.com
11. Naive Bayes Classifier: https://en.wikipedia.org/wiki/Naive_Bayes_classifier
12. Chromosome Mapping Guide: http://tinyurl.com/canzmsa (launches a word document)
13. Promethease http://www.snpedia.com/index.php/Promethease
14. Lazarus Project http://thegeneticgenealogist.com/2014/10/20/finally-gedmatch-announces-monetization-strategy-way-raise-dead/
15. Kohonen Learning Rule: https://en.wikipedia.org/wiki/Competitive_learning
16. Peter Norvig's Suduko Solver: http://norvig.com/sudoku.html
17. Contig Sequencing: https://en.wikipedia.org/wiki/Contig
18. Beowulf: https://en.wikipedia.org/wiki/Beowulf_cluster
19. A parallel Genetic Algorithm for solving the Quadratic Graph Matching Problem: http://matthew-scott.com/prj/ga/final.html
20. Javanoginn: http ://www.matthew-scott. com/prj /j avanoginn/
21. K-means clustering: https://en.wikipedia.org/wiki/K-means_clustering
22. DNA Phasing: http://dna-explained.com/2015/01/02/how-phasing-works-and-determining-ibd-versus-ibs-matches/
23. 23andMe and Ancestry DNA Partnership http://mediacenter.23andme.com/blog/2008/09/09/23andme-and-ancestry-com-Partner-to-extend-access-to-genetic-ancestry-expertise/
24. 23andMe Genotyping Technology, online: https://www.23andme.com/more/genotyping/
25. Chromosome Mapping Guide: http://tinyurl.com/canzmsa (launches a word document)
26. Petition to AncestryDNA to share segment matches, and provide a chromosome browser https://www.change.org/p/ancestry-com-dna-11 c-give-ancestrydna-customers-dna-segment-data-a-chromosome-browser-now
27. FTDNA Family Finder overview: http://www.isogg.org/wiki/Family Finder

U.S. Patents

| | | | | |
|---|---|---|---|---|
| 1. | Methods and | WO | Apr. | Ancestry.com |
| | products | 2000018960 A2 | 6, | DNA, LLC |
| | related to | | 2000 | |
| | genotyping | | | |
| | and dna | | | |
| | analysis | | | |
| 2. | Method for | 8738297 | Mar. | Ancestry.com |
| | molecular | | 29, | DNA, LLC |
| | genealogical | | 2002 | |
| | research | | | |
| 3. | Method of | US20060025929 | Jul. | Chris |
| | determining a | A1 | 30, | Eglington |
| | genetic | | 2004 | |
| | relationship | | | |
| | to at least one | | | |
| | individual in | | | |
| | a group of | | | |
| | famous | | | |
| | individuals | | | |
| | using a | | | |
| | combination | | | |
| | of genetic | | | |
| | markers | | | |
| 4. | Genetic | US20090118131 | May | 23andme Inc. |
| | comparisons | A1 | 7, | |
| | between | | 2009 | |
| | grandparents | | | |
| | and | | | |
| | grandchildren | | | |
| 5. | Family | WO | Apr. | 23andme Inc. |
| | inheritance | 2009051766 A1 | 23, | |
| | | | 2009 | |
| 6. | System and | 8,731,819 | Nov. | Good Start |
| | method for | 20150019543 | 2, | Genetics, Inc. |
| | the | | 2012 | |
| | collaborative | | | |
| | collection, | | | |
| | assignment, | | | |
| | visualization, | | | |
| | analysis, and | | | |
| | modification | | | |
| | of probable | | | |
| | genealogical | | | |
| | relationships | | | |
| | based on geo- | | | |
| | spatial and | | | |
| | temporal | | | |
| | proximity | | | |
| 7. | Finding | US | Jan. | 23andme Inc. |
| | relatives in a | 20140006433 | 2, | |
| | database | A1 | 2014 | |
| 8. | Using | 20140067355 | Mar. | Ancestry.com |
| | Haplotypes | | 6, | DNA, LLC |
| | to Infer | | 2014 | |
| | Ancestral | | | |
| | Origins for | | | |
| | Recently | | | |
| | Admixed | | | |
| | Individuals | | | |
| 9. | A social | US20140108527 | Apr. | Fabric Media |
| | genetics | | 17, | Inc. |
| | network for | | 2014 | |
| | providing | | | |
| | personal and | | | |
| | business | | | |
| | services | | | |
| 10. | Family | 20140278138 | Sep. | Ancestry.com |
| | Networks | | 18, | DNA, LLC |
| | | | 2014 | |
| 11. | Method and | 8855935 | Oct. | Ancestry.com |
| | system for | | 7, | DNA, LLC |
| | displaying | | 2014 | |
| | genetic and | | | |
| | genealogical | | | |
| | data | | | |
| 12. | Ancestral- | US | Nov. | Inova Health |
| | Specific | 20140067280 | 8, | System |
| | Reference | A1 | 2013 | |
| | Genomes and | | | |
| | Uses Thereof | | | |

Terminology

These definitions serve to collect terminology which might be unknown or ambiguous, and present the intended or simplified meaning, rather than a specific, well defined or exact meaning as per ‘Websters’ or other authorities on the subject.

1. User: A participant in the system. The terms Member, Customer, Researcher and Participating Individual, equivalently indicate a person, or entity, involved in the subject matter of the sentence employing the term. The term User is commonly used to designate an account of a person on a computer system. Herein, it generally relates to a living person who has contributed a family tree, and is working on that family tree, and who may have contributed a DNA genome encoding to the system executing the methods described herein.

2. Graph, network, tree: Terminology to represent relationships between objects or entities, wherein the objects and their relations are modeled with a graph with nodes and edges between the nodes.

3. Family Tree: A graphical representation of related individuals, with the edges generally equating to the sharing, or transfer of DNA. In some models, the nodes and edges may represent a set of ancestors, ie, those of Irish ethnicity.

4. Pedigree: A family tree which expands from one person to their parents, and to the parents parents and so on. Commonly called a binary tree in computer science.

5. Connection, edges, links: These terms are generally used interchangeably. In terms of a graph, network or family tree, consisting of nodes, a connection is drawn as a line or arrow, but is encoded in a program as simply a variable which holds the address of the connected node.

6. SAR: The organization, Sons of the American Revolution, www.sar.org

7. DAR: The organization, Daughters of the American Revolution, www.dar.org

8. MRCA: Most Recent Common Ancestor. The Ancestor(s) genetically common between two or more people or between two or more living creatures of the same species. Genetically common here implies that the descendants each received genetic material from the common ancestors.

9. Triangulation: When at least 2 people have DNA segment matches shared between all of them, and all members have unique pedigree paths to a common ancestor who first share the DNA. The common ancestor is usually a couple, as a DNA segment is not new until it has been created as a result of mating (recombination). However, in the case where a first Ancestor mated with two others, and the segment passed only through the first Ancestor, then the User's may claim the first Ancestor as the MRCA, or the parents of the first Ancestor. A Strict triangulation claim implies that the paths to the members are of high confidence and supported by documentation. A ‘loose triangulation’ occurs when there is sufficient evidence that a path from a member through a pedigree to an Most Recent Common Ancestor is likely, and that association is made in an attempt to solve the matching puzzle.

10. IBD: Identity By Descent. According to the definition on http://www.isogg.org/wiki/Identical by descent, is a term used in genetic genealogy to describe a matching segment of DNA shared by two or more people that has been inherited from a recent common ancestor without any intervening recombination. The qualification of whether a segment is truly IBD, is independent of the artificial criteria placed on segment length by different observers.

11. IBS: Identical By State: When two people have matching DNA segments that do not lead to a common ancestor, but rather a common ethnicity, wherein the majority of the population has the equivalent segment. To statistically cancel out IBS matches, a longer match requirement in terms of centiMorgans is needed.

12. ICW: In common with: An Ancestor found in two or more family trees, who appears to be the same person.

13. centiMorgan: A centimorgan is a unit of measure representing a 1% chance that a region of DNA will recombine in a single generation. A centimorgan block represents a continuous region of markers that HAVE NOT recombined and is shared between two individuals. The longer the block, the higher the probability a recombination event SHOULD HAVE occurred in that region. When two individuals have a region in common with a high rate of recombination they have a high probability of being related. The centiMorgan value for a particular DNA segment can be derived from the recombination rates as determined and recorded by the International HapMap Project at http://hapmap.ncbi.nlm.nih.gov/.

14. Phasing: http://www.isogg.org/wiki/Phasing the process of assigning alleles to the proper parent

15. HaploScore: An opensource IBD detection system http ://mbe.oxfordjournals.org/content/early/2014/04/30/molbev.msul51.full.pdf+html

16. Genetic distance: A measurement of the overall relationship between two individuals, as estimated by the amount of DNA they share. Related to zygosity, or the degree of similarity of the alleles between two genes.

17. GEDCOM: (Genealogical Data Communication),

What is claimed is:

1. A computer implemented system (100), comprising a holistic set of computerized sub-systems and methods (100-5000), each illustrated in corresponding FIGS. 1-50), which act collectively to enrich a plurality of shared databases, and generate a plurality of reports and graphical displays, and which collectively cooperate to improve and expand individual genealogic family trees, and shared common family trees.

2. The system of claim 1, wherein said system addresses a plurality of problems with a plurality of solutions comprising:
a. address the problem that much or most data in User's family trees may not be qualified in terms of its' accuracy and the User's confidence in it, in a structure and format that is easily used by a computer automated system, and that this system (100) addresses this problem by introducing a Knowledge Management system of meta-data to record these confidences, and a means for Users to specifically enter subjective confidence metrics, and a system of Agents to repeatedly check the accuracy of data and to record it, and;
b. address the problem that the data and knowledge of ‘who DNA matched to any particular User and over what segment(s)’ is not generally available except to the particular User, including that:
i) the full list of DNA matches (putative DNA Cousins) of Users are not shared and that this information, if available to a holistic system such as system (100), can potentially leverage all the information available, and that this is not the case with the known current art, including the ‘Family Networks’ or so-called ‘DNA Circles’ which are limited in depth (generations back in time) and which may associate a User to erroneous DNA Circles when the User DNA-matches several members of a ‘DNA Circle’, and those member's DNA match each other to a certain degree and actually do share an MRCA, but that MRCA is not the actual MRCA between the User and the DNA match members of the DNA Circle, which is often due to cases of endogamy, and that this system (100) avoids these errors through the holistic aggregation of information into a Competitive Neural Network (CNN), and in part through exclusions of false MRCA's by DNA Agents (932) tracing and mapping the DNA segment flows to their origins;
ii) the shared DNA match segment data are not shared between the various DNA assisted Ancestry services, and said system (100) provides data structures and input mechanisms to allow Users to efficiently and securely share this information with the said system (100) such that the various sub-systems may operate on the data;
iii) the discovered, or most probable, MRCA found between sets of DNA matched User's are not shared or published in User's trees or in a common family tree, and that system (100) and its' sub-systems does share this information such that the enhanced confidence derived from the DNA supported MRCA can propagate to other trees which have the Ancestor, and:
c. address the problem that the compute requirements of the system grows with the number of Users involved, and that this system (100) mitigates this problem by potentially using the User's personal compute systems and by introducing a distributed Agent computing model which can run on peer-to-peer networks or monolithic or cluster computing systems, and;
d. address the problem of encoding the potential relationships and other associations between Ancestors in various family trees, and that this system (100) solves this by introducing the concept of a distributed Competitive Neural Network (CNN) wherein the nodes of the CNN are comprised of Virtual Individual Ancestors, Virtual Attribute Nodes containing attributes shared between Ancestors, Virtual DNA nodes to capture the relationship of DNA between Ancestors, and various ‘In Common With’ (ICW) nodes to capture various commonalities including two Users who both match a third User, and common Ancestors found in DNA matched cousin's trees which provide hints that these User's may lead to the MRCA between the two Users, and wherein the connections between the various Nodes are weighted to reflect the confidence and importance of the association between the Nodes, and;
e. address the problem that the known available DNA-assisted Ancestry services do not provide a multi-faceted system to check which Ancestors between two family trees of two DNA-matched Users are potentially related, associated by social circles or time and place, or are the same person, employing multiple factors and methods, and that system (100) and it's sub-systems uniquely provide these enhanced capabilities, including:
i) discovering and recording commonalities between the Ancestors in compared trees via weighted connection nodes;
ii) scaling the impact of the measured commonalities by the confidence in the data in the respective trees;
iii) utilizing logical rules which can intelligently utilize information like the proximity of Ancestors in place and time, and can add nodes connecting Ancestors who could have crossed paths during their reproductive years, according to their known addresses;
iv) using a system described herein as ‘In Common With Disembodied Cousins’ (ICW-DC) analysis, wherein the common individuals found in the trees of DNA matched Users are annotated with that information, and the pattern of the incidence of ICW-DC' s can be used to focus research to a cluster of common ancestors, and that the form of the cluster in the tree (fan-up or fan-down), can be used to logically infer where shared DNA flowed and thus whether a MRCA is above a cluster or below it;
v) a neural network system similar to a convolutional neural network, wherein the various metrics of similarity are measured in different stages of the neural network, with each stage similar to a feature detection, and passing on to the next stage the positive or negative determination of whether a feature or metric passed a threshold, and that this neural network system may be trained on existing family trees; and,
f. address the problem of discovering or narrowing the possibilities for the most likely ‘Most Recent Common Ancestor’ (MRCA) between each pair of DNA matched Users, wherein this problem is severely exacerbated by low-confidence data in family trees and a lack of systematic means of determining which Ancestors are the most relevant to finding the MRCA, and that if the various Users' family trees were qualified in terms of the accuracy and confidence in their data as this system facilitates, and if there were ample data in terms of recording which Ancestors in the family trees of two DNA matched Users were similar or likely to have been associated, then various techniques in Artificial Intelligence (AI) and Machine Learning (ML) could more easily be applied to the problem, and that this system (100) does this by using multiple factors including and comprising:
i) constraint-driven problem space reduction, wherein, for example, the distance to an MRCA between DNA matched Users' accounts for not just one pair of DNA matched Users and their predicted Genetic Distance, but rather, all available and relevant DNA matched Users;
ii) competitive associative network techniques (using the CNN) to give greater attraction to Ancestors in different trees who are similar on multiple factors, and to inhibit, or repel, Ancestors in DNA matched trees who are less likely to be the MRCA;
iii) combinatorial optimization by calculating the fitness of an assignment of putative MRCA to ancestors, using several algorithms;
iv) logical process of elimination across a plurality of DNA matched Users, wherein the increase of probability that a particular common Ancestor is a particular MRCA between a pair of DNA matched Users, reduces the probability that other Ancestors are the MRCA, and thus increases the probability that those other Ancestors are the MRCA for some other DNA match, unless the other DNA match has sufficient evidence to positively associate them to the noted MRCA;
g. address the problem that if an MRCA has been found between a plurality of DNA matched Users, that the shared DNA between those Users may be associated to the discovered MRCA, and that this system (100) automates this process by associating the DNA segment to the MRCA nodes, and:
i) if two or more of the segments associated to an MRCA overlap by several centiMorgans, and are thus matching in the overlap, then the two or more segments may be combined into a larger segment, and that this larger segment represents a reconstruction of the MRCA's DNA, and that this DNA may thus be compared to all sets of DNA, including other reconstructed MRCA DNA, thus potentially leading to more DNA matched Users, or DNA matches between Ancestors; and,
ii) the flow of a DNA segment from the MRCA to each of the DNA matched Users may be predicted, and that the said DNA segment may be associated to each descendant between the MRCA and the respective DNA matched Users' who matched with the DNA segment; and,
iii) the flow of Y DNA and mtDNA, if available, may be restricted to the paternal and maternal branches respectively, and associated to all the ancestors which lie on the respective paternal or maternal path between two DNA cousins who share the segment, and that if the Ancestors in the trees of two DNA matched Users are connected in a Competitive Neural Network by connections to equivalent Y and mtDNA nodes, then Ancestors who share the same haplogroup will be attracted in said Competitive Neural Network; and,
iv) that if a User has a set of DNA matches to other Users, and if a sub-set of those DNA matches have segments which overlap (matching) each other on a continuous length, then in this system (100) the overlap of each pair of Users may be recorded in an associative ICW-DNA node, such that each such pair of Users may have their respective MRCA drawn toward, in the associative neural network, the Ancestors that any segment gets assigned to by an MRCA assignment; and,
h. address the problem, that there are many sub-trees of well curated relationships in various family trees and that the good vetted data of one tree that could solve a problem for a User with another family tree, is not readily available to the Users and that this system (100), by recording the User's family trees into light-weight meta-data Virtual Family Trees, and by capturing the well-curated data of all family trees into a set of light-weight meta-data Virtual World Trees, affords the AI and ML systems in the holistic set of sub-systems, the ability to explore possible connections between Ancestors in different family trees by having a multiplicity of Agents building Tentative sub-trees or by having Agents creating Speculative Ancestor nodes to connect sub-trees which have significant evidence of relationship supported by the DNA matches between Users and other associations collected by the system.

3. The system of claim 1, wherein said system (100), herein also called the ‘holistic system’, receives and acts on a plurality of inputs comprising:
a. a plurality of genealogic family trees, which may be loaded by GEDCOM import, which codify the ancestry of a plurality of participating Users;
b. a plurality of genetic data sets comprising the genomic sequencing of single nucleotide polymorphisms (SNPs), or any part of the genome of the Users, wherein each User will have obtained this genetic data from a genomic sequencing service and will have uploaded it to their respective ‘member DNA data’ databases (DB or DBs in the plural) in their respective User accounts in the system, wherein the format of the genomic data will be in a standard format such as ‘human reference build 37’;
c. a plurality of relationship estimations between various Users as calculated by 3rd party systems, based typically on the lengths of DNA segments shared between pairs of Users, wherein the relationship estimation may include:
i) an estimation of the Genetic Distance in term of generations between each pair of Users, usually stated in terms of degrees of separation by cousinship;
ii) an confidence rating of the relationship estimation;
iii) information describing the location and lengths of the shared DNA segments between pairs of DNA matched Users;
d. a plurality of supporting evidences and attributes for the elements of a User's family tree, or a databases access to those family trees in order to derive the evidences and attributes assigned to each ancestor and relationship in a User's family tree on a 3rd party service provider;
e. a plurality of historical, genealogic, and journalistic data as retrieved by sub-systems of the invention searching various public databases, or 3rd party databases as permitted by arrangements with those 3rd parties and sources;

4. The system of claim 1, wherein said system (100), processes the inputs and derived data to create or modify data comprising:
a. a plurality of ‘Virtual Family Trees’ (VFTs) illustrated in FIG. 11), each constructed of a plurality of ‘Virtual Individual Ancestor’ (VIA) nodes, each of which may have a plurality of connections to parents and/or children, such that each VFT is a lightweight data-structure to represent at least a User's full pedigree out to the maximum number of generations that a DNA supported MRCA may occur at according to the Users' DNA matches list;
b. a plurality of ‘MRCA Virtual DNA’ (MRCA-Vdna or just MRCA) nodes which are allocated to a first User's account, the nodes of which each represent one or more propositions for the putative MRCA between two User's, the two Users being a first User and a second User who have been predicted to be related by DNA matching, wherein each MRCA node is initialized with bi-directional pointers between it and the VIA nodes in the owning first User's VFT that fall within the estimated Genetic Distance range of the predicted relationship between the first User and second User, as further described and illustrated in FIG. 12) and its' discussion, and such that each MRCA node will initially be a placeholder, and as analysis progresses, the eligible bi-directional links between it and the VFT VIA nodes will decay or enhance their connection weights, and that some will die off (be deleted) as they pass below a threshold, effectively reflecting that the probability that the VFT VIA node is not the MRCA between the two DNA matched Users;
c. a plurality of ‘Virtual Attribute Nodes’ (VANs) which represent evidences and attributes associated to the ancestors represented in said VFTs, and which are used to create part of a Competitive Neural Network, wherein said network is comprised of nodes and interconnections, wherein said interconnects are weighted to represent the probability that the two connected nodes are associated, and the weights regulate activation passed between nodes according to various algorithms and sub-systems described and claimed in the invention, and, wherein said VAN's have built-in to their data the connections to other nodes, and the VAN's may be stored on Local Shared Attributes DB's if only related to at most two VFTs, otherwise they may be copied to a Global Shared Attributes DB, which shares a bi-directional pointer to the copy in the Local shared attribute DB;
d. a plurality of ‘Virtual Ancestor Records’ (VARs) which record or point to (as in a record pointer) the supporting evidences and attributes and their confidences and weights, related to each VIA node;
e. a plurality of ‘In Common With’ nodes of various types, which represent results of complex analysis by the sub-systems and Agents, and which connect to and define a subset of the previously mentioned Competitive Neural Network in the manner of VAN's, wherein, examples include the ICW-Cell node, which points to all the ICW-DNA nodes of a particular individual, and ICW-DNA nodes which represent segments of DNA shared between Users and their MRCA Ancestors;
f. a plurality of ‘Chromosome Maps’ along with a set of ICW-DNA nodes pointing to their respective DNA segments in the respective chromosome map DB, wherein each VIA node (putative ancestor or individual) in each VFT will have an associated chromosome map after at least one DNA segment has been triangulated to that VIA node, as a result of various sub-systems which make such assignments of MRCA to VIA nodes, wherein such chromosome maps do not hold complete DNA data, but rather only hold the indicia of DNA segments as stored securely in a User's DNA database, or a created Ancestors' DNA database.

5. The system of claim 1, wherein said holistic system executes the various sub-systems, algorithms and methods described herein, with results comprising:
a. a plurality of ‘Virtual Ancestor Records’ (VAR), nodes and connections updated with automatically calculated or manually entered confidences and weights;
b. a plurality of ‘MRCA Virtual DNA’ nodes with updates on connections to their sets of eligible VIA nodes, including pruning of some connections or variation in the weight of various connections from the MRCA node to eligible VIA nodes, according to the outputs of the sub-systems which ran the relevant analysis, and including possible connections to ICW-DNA nodes and ‘Trait X’ nodes;
c. a plurality of additions or modifications to the set of virtual ‘attribute’ nodes (VANs), their properties, connections, or state;
d. a plurality of additions or modifications to the ‘Virtual Family Trees’ (VFTs) of various Users according to the work of the various sub-systems which interact with them;
e. a plurality of additions or modifications to one or more Virtual World Tree (VWT) according to the work of the various sub-systems which interact with it;
f. a plurality of additions or modifications to the Chromosome Maps and ICW-DNA nodes of various VIA nodes in either VFT's or VWT's, according to the work of the various sub-systems which interact with them;
g. a plurality of graphical user interface (GUI) representations of the data generated, comprising:
i) displays of the Users' VFT pedigree as illustrated in FIG. 14), along with display of MRCA assignments to VIA nodes,
ii) display of two VFT pedigrees facing each other as illustrated in FIG. 13), along with display of VFT paths from the MRCA assignment(s) VIA to the respective Users VIA node;
iii) display of a VFT VIA's VAR record values, including a weight ‘W’ and confidence metric ‘P’ for each attribute, as illustrated in FIG. 15);
iv) display of a reduced VIA node's VAR record as illustrated in FIGS. 17) and (18), with automated display of the Ancestor's country of birth flag, automated display of the Ancestors country of death flag, and automated display of an DNA icon if the Ancestor has DNA triangulations, and the count of said triangulations shown in the image, along with other items displayed such as counts of ICW-A, ICW-M matches;
v) a display of the ICW-A feed-forward network and state of nodes, as described in FIG. 21), sub-system (2100);
vi) a display of a DNA segment alignment and overlap and MRCA ordering viewer, as described in sub-system (2700);
vii) a DNA segment flow graph viewer, as described in sub-system (2800);
viii) a graphical display of a Competitive Neural Network, as illustrated in FIGS. 30) and (31), sub-system (3000);
ix) an annotation of ICW Disembodied Cousins icons to User's VFT to facilitate visualization of fan-up and fan-down clusters;
x) an ‘Interactive Migration Map with Vectors and Sliding Time Scale’;
xi) an MRCA Vdna Star Browser tool, as illustrated in FIG. 42), sub-system (4200);
xii) an ICW-Match automated graphing system, as illustrated in FIG. 43), sub-system (4300).

6. The system of claim 1, comprising a networked computer system having at least one computer display device, at least one processor device, at least one database and storage media having computer-executable instructions configured to programmatically execute the methods on the data and produce outputs, wherein said networked computer system, in the preferred embodiment consists of a distributed computer system connected by a network as illustrated in the block diagram of FIG. 40), wherein one embodiment of the primary hardware and database components are described therein, and the architecture being distributed with the intent that an Agent based system may execute a plurality of computer programs called Agents herein, which communicate with each other through ‘Agent Exchanges’ (904), which are controlled by an Agent Control System (900) and through direct peer-to-peer message passing interface over the network, or through normal ICP (inter-process communication on Unix).

7. The system of claim 1, which is in part comprised of a set of lightweight data structures used by all sub-systems, those data-structures forming parts of the elements of the Competitive Neural Network system, and those data structures comprising, but not limited to:
a. a plurality of Virtual Ancestor Record (VAR), as described in sub-system (1700) and FIG. 17), maintain meta-data of the biographic information related to an individual, wherein any evidence related to an individual, his/her relationships, travels, ownership etc., may be named in this record, should get a confidence measure, and should point to its originating source if any exists, and wherein the VAR will also contain internally derived data, such as connections to various other nodes, and their confidences;
b. a plurality of Virtual Individual Ancestor (VIA) nodes, as introduced above, wherein a VIA node either describes a specific individual (usually an Ancestor), or is a placeholder in a User's VFT pedigree for an Ancestor who must have existed (if in the pedigree), or is speculated to have existed (if in filling a gap in a speculative tree), and wherein a VIA node contains a VAR which has a plurality of fields to define all biographic information about the individual represented by the VIA, and wherein a VIA node may also point to a ‘Chromosome Map’ database, which stores all DNA segments that have been associated to the individual, either through 3rd party sequencing, or through the process of MRCA discover, and such that the root node of a VFT will always have a chromosome map database, and such that a VIA node may have a pointer to the owning User's external family tree node, and such that a VIA node, like all nodes, has a record for simulations in which Agents may write their information regarding ID, activation and other items;
c. a plurality of Virtual Family Trees (VFT), wherein in one embodiment of the invention methodology, a VFT pedigree is automatically created for each participating individual (User), with each ancestor represented by a Virtual-Individual-Ancestor Node (VIA), wherein the VIA nodes and pedigree network for an individual participant are created extending back a sufficient number of generations to encompass the initial reach of genomic analysis, such that this virtual family tree is a scaffold, designed to provide a light-weight data structure to hold information relevant to nodes (ancestors), and their connections (relations), and the connections' feasibility weights, wherein nearly every VIA node will be an eventual MRCA, so as a placeholder, it serves as a reference and linking point for various algorithms which attempt to associate MRCA's to VIA nodes;
d. a plurality of Virtual World Trees (VWT), being an amorphous network comprised of VIA nodes and connections, which serves the purposes of a general, shared family tree to which various Agents share high quality family tree information through ‘VWT tending Agents’, and whereby special ‘Speculative Search Agents’ as described in sub-system (3500), may use search algorithms to attempt to find high quality paths between Ancestors in different VFT's and/or the associated VWT sub-graphs, and if found, will stitch the discovered connections into the associated VWT and then share with the various VFT's such that they may enhance their respective trees;
e. a plurality of Virtual Attribute Nodes (VAN's), which represent any characteristic or information that may be in common between Ancestors, Users or their DNA, such as a particular surname, ethnicity, or place visited or lived in;
f. a plurality of Local and Global Shared-Attributes DB's and represented Networks, wherein a plurality of VAN's are stored in the databases;
g. a plurality of ‘In Common With’ (ICW) nodes of various types, which represent characteristics or information shared between Ancestors or Users, such as two Ancestors being the same person in different trees, and two User's sharing a common DNA match to a third User;
h. a plurality of sets of MRCA Virtual DNA (MRCA-Vdna, or MRCA) nodes per User, representing place-holders of the DNA-match between two Users, such that each MRCA node will initially be linked to every potential VIA node candidate in each of the two User's VFT's, and the weights on the links will be normalized with respect to the number of links, and such that initially they are set to 1/ (number of links) such that each link initially has equal likelihood of being the MRCA between the two VFT's.

8. The system of claim 1, which is in part comprised of, a set of main computer programs running on one or more computers and managing a plurality of databases, as illustrated in FIG. 40) and described as sub-system (4000), which in general,
a. Create and manage a plurality of shared databases;
b. Create, Initialize and monitor a plurality of ‘Agent Exchanges’, which are described in the sub-system (900) ‘Agent Control System’, which is variably called the ‘Agent Management System’ (906);
c. Schedule and initiate primary program sequences as illustrated and described in system (100);
d. Perform all tasks of conventional modern computers, such as reading and writing data to short and long term storage media, processing that data according to the instructions of various programs, display that data onto visual media as requested.

9. The system of claim 1, which is in part comprised of a sub-system (200) ‘New User Initialization System’, which itself comprises: Create, initialize and manage a plurality of User accounts, including creation of a new User's Account, Profile, VFT scaffold, loading and constraint checking of Evidences along with initial confidence estimations per sub-system (1100), register User's DNA matches, create User's ‘Chromosome Map’ Db, create User's local shared attributes DB., and create User MRCA-Vdna nodes one per DNA matched User in the first User's set of matches, wherein create of said MRCA-Vdna nodes also includes their initialization process in sub-system (1200).

10. The sub-system (200) of claim 1, which is in part comprised of a sub-system (1100) ‘User VFT create and setup’, wherein the Virtual Family Trees (VFT), in one embodiment of the invention methodology, is in part a pedigree of each participating individual (User), with each ancestor represented by a Virtual-Individual-Ancestor node (VIA), and the VIA nodes and pedigree network for an User are created extending back a sufficient number of generations to encompass the initial reach of genomic analysis (the distance in generations to the furthest predicted MRCA), and this virtual family tree is a scaffold, designed to provide a light-weight data structure to hold information relevant to nodes (ancestors), and their connections (relations), and the connections' feasibility weights, and such that each VIA node is lightweight, meaning using minimal memory, and not holding any large data files such as images, documents or DNA, and each VIA node is initialized with any available meta-data from the corresponding Ancestor in the User's primary family tree, wherein the biographic information is summarized on the VIA node, including such items as names, data of birth, residences with place and date, etc., and such that the original digitized records are not copied into the VIA node, but rather, pointed to by pointers from the related fields in the VIA nodes' VAR record, and such that upon completion of the basic creation phase, the ‘Confidence Agents’ and ‘Constraint Agents’ are activated on the VFT to generate initial values and estimates for confidences and whether items and relationships pass basic constraints, and furthermore the description of sub-system (1100) from FIG. 11) is included here.

11. The sub-system (200) of claim 1, which is in part comprised of a sub-system (1200) ‘Create User MRCA Vdna Nodes’, wherein each MRCA-Vdna node first points to the record defining the DNA relationship between the first and second User, then it determines the genetic range of the probable ancestors based on the information obtained from sequencing it and makes bi-directional connections to the VIA nodes of the first User's VFT that fall within the estimated Genetic Distance, and wherein each connection will be given an initial strength (weight) equal to 1/(number of candidate nodes), such that each VIA node has equal likelihood of being the MRCA Ancestor, and wherein it will also point to the DNA segment shared between the two Users which should be stored in the User's chromosome DB., and at some point the MRCA-Vdna will point to an ICW-Cell node, and wherein the sub-system (1200) illustrates the concept of a plurality of MRCA Nodes by a VFT, and wherein the description of sub-system (1200) is included herein.

12. The system of claim 1, which is in part comprised of a sub-system (300) ‘Continuous accumulation of genealogic evidences’, which consists of data input manually or collected automatically by Agents from external sources, and:
a. wherein a User may input data directly into their personal family tree, which will then be linked to by the respective VAR field in the respective VIA node, and a confidence measure will be assigned to the new data item, either by the User or by a VFT Agent, or by a ‘Confidence Agent’, or by a ‘Constraint Agent’, each of which are run at various times by their respective sub-system flows, and
b. wherein, User's data input, or other sub-systems data input, registers triggers in the Agent Exchanges, to cause the appropriate sub-system Agents to act on the new data found in a User's VFT, VIA nodes and VARs, and
c. wherein all new genealogic evidences, including biographic information, are individually saved to VAN's by either creating a connection to an existing VAN, or by creating a new VAN node, and then creating a connection to that node, and
d. wherein the connection to the VAN is given a weight proportional to the confidence in the data's relevance and viability.

13. The system of claim 1, which is in part comprised of a sub-system (400) ‘Data-mine User's own and User's Matches’ Trees', which comprises according to the figures and their respective descriptions, a computer program (usually involving an Agent Exchange) running a plurality of sub-systems listed here, which themselves automatically operate on the structures and elements of the Competitive Neural Network system, including the VFT's of Users, the general VWT, and the attribute network, wherein additions and modifications to these structures and elements act holistically to capture associations, inferences, constraints, confidences and dependencies, and such that the plurality of sub-systems comprise in part:
a. the sub-system ‘Find, Record: General Attribute Commonalities’ (as described in 402), which in effect, entails connecting a VIA's VAR record field for each attribute to an VAN and creating a weight for the connection according to the confidence in the association or viability of the attribute;
b. the sub-system ‘Find, record ICW Ancestors’ (as described in 404), which employs ICW-A Search Agents' as described in one embodiment in block-diagram (2000) and sub-system (2100), will compare VIA nodes from the two trees of two DNA matched individuals, comparing such things as their surnames, place of birth, date of birth and death, and wherein the system will use intelligence to sort the candidates to ensure that VIA nodes compared had lived in overlapping life-times, and wherein this evaluation will entail use of the constraints Agents to ensure that individuals tested have compatible properties, and furthermore the comparison will use the ‘Proximity Search Agents’ (420), which will ensure they lived in the same general time and place;
c. the sub-system ‘Evaluate ICW Ancestors’ (412) which runs the confidence analysis sub-system (1500) on each Common Ancestor discovered;
d. the sub-system ‘Queue ICW Ancestors to VWT’ (414), which thus registers any ICW-A matches to the Virtual World Tree, wherein registration is done through the Agent Exchanges (AX), and wherein the VWT Tending Agents are launched when such a job is queued with an AX;
e. the sub-system ‘Find, Evaluate ICW Matches’ (406);
f. the sub-system ‘Evaluate MRCA-Known ICW Matches’ (408);
g. the sub-system ‘Run any sub-stage data through the MRCA Assignment Engine’ (410);
h. the sub-system ‘Run ICW-A Search Agents’ (418);
i. the sub-system ‘Run Common Match Cluster Agents’, (416);
j. the sub-system ‘Run Proximity Search Agents’ (420);
k. the sub-system ‘Run Attribute Search Agents’ (422), which data-mine attributes common between the Ancestors of User's trees and registers them in the Shared Attributes DB, wherein a shared attribute is saved in a VAN, and connected to the field of the attributed in the VIA's VAR (virtual ancestor record), and where each Ancestor's attributes, if found to be shared with any other Ancestors (VIA nodes), will be associated with a VAN node in the global shared attributes database, and thus, each attribute that is shared forms a cluster center of VIA's which share that attribute;
l. the sub-system ‘Run Cluster Mining Agents’ (424), and which invokes the sub-system (938).

14. The system of claim 1, which is in part comprised of a sub-system (500) ‘Continuous evaluation of tree and data quality and Constraint Checks’, which is comprised of the following sub-systems, which are each triggered by sufficient accumulation of changes in their respective domains, and which are controlled by the ‘Agent Management System’, including ‘Agent Exchanges’, and which are comprised of in part:
a. a ‘User Confidence Input Editor’, which allows User's to enter or modify automatically generated confidences, and which afford Users an ability to vote on validity or relevance of records associated to an Ancestor in the VWT, in order to assign it a consensus confidence metric;
b. an ‘Evaluate User tree and data Quality’, represents the changed-data triggers evaluation to send to the Agent Exchange, to launch appropriate Agents;
c. an ‘Constraint Satisfaction Agents Launch’ as detailed as sub-system (1600);
d. an ‘Confidence Agents Launch’ as detailed as sub-system (1500);
e. an ‘VFT Annotation Agents Launch’ as detailed as sub-system (1700);
f. an ‘VWT Annotation Agents Launch’ as detailed as sub-system (1800);
g. an ‘Record Confidences to (232) Member Ancestors Trees’ which writes to the databases (242) Virtual Family Trees, (244) Virtual World Tree, as detailed in sub-system (1900).

15. The system of claim 1, which includes a distributed Competitive Neural Network (CNN), which enables the discovery of highly associated or similar entities in different parts of the network (such as Ancestors in two different family trees), and which is illustrated in FIG. 30) and FIG. 31), and which consists of nodes and connections between them, wherein the nodes of the CNN are comprised any Nodes created in the system (100) and it's sub-systems, including Virtual Individual Ancestors, Virtual Attribute Nodes (VANs) containing attributes shared between Ancestors, Virtual DNA nodes to capture the relationship of DNA between Ancestors, and various ‘In Common With’ (ICW) nodes to capture various commonalities including two Users who both match a third User, and common Ancestors found in DNA matched cousin's trees which provide hints that these User's may lead to the MRCA between the two Users, and wherein the ‘connections’ between the various Nodes of the CNN represent the probability that the two connected nodes are associated, and wherein the connections are weighted to reflect the confidence and importance of the association between the Nodes, and wherein the weights regulate activation passed between nodes according to various algorithms and sub-systems, and wherein the connections are not physical connections, but rather virtual, in that messages and activations are mediated by Agents which follow the pointers between nodes, and deliver a packet of data of the network, with the packet representing information such as the activation or inhibition sent, the type of signal sent, the nodes visited in between, constraints that are relevant to the packet, and the decay period, to name a few, and wherein said VANs have built-in to their data the connections to other nodes, and the VANs may be stored on Local Shared Attributes DB's if only related to at most two VFTs, otherwise they may be copied to a Global Shared Attributes DB, which shares a bi-directional pointer to the copy in the Local shared attribute DB.

16. The system of claim 1, which is in part comprised of a sub-system (600) ‘Accumulate all desired data into the Competitive Network system’, which is periodically run by means of their respective Agents communicating to the Tending Agents (920) of the VFT and VWT, wherein the activity may simply be an update of connections and weights, or may results in an extraction of the network into sparse arrays for supercomputer analysis, and wherein The shared various data elements from various collection agencies such as those shown in state (602), may be ‘extracted’ into their relevant DB's (604), and stitched into a ‘Competitive Network’ (606), and global Inter-Match network (608), wherein the ‘Competitive Network’, in one embodiment, is basically the holistic combination of the existing Virtual Family Trees, their connections to Local and Global Shared Attributes DB nodes (and the attribute Clusters built therein), and their connections to MRCA Vdna nodes, and thus the competitive network strives to embody all evidences which could guide the User and System in sorting out which Ancestor(s) associates to which MRCA(s), and wherein some of the evidence sources input to the competitive network include: (401) Attribute Commonalities, (412) ICW Ancestor Connections, (408) ICW User Matches Connections, (810) Disembodied Cousin Influences (by ICW-DC nodes), (1000) DNA Mapping Influences, (812) VWT Influences and Connections, and (3600) Migration Proximity Influences via ICW-Proximity Attribute Nodes (ICW-Ps), as described in sub-system (4900).

17. The system of claim 1, which is in part comprised of a sub-system (700) ‘Run concurrent MRCA assignment optimization’, as described in the FIG. 7) and its' explanation, with the methodology comprising:
a. for a small set, easily computed on a single multi-core workstation, the ‘MRCA Engine’ may be employed, and;
b. for a larger set, perhaps involving hundreds or thousands of Users who have been found to have a high-density of interconnectedness, a distributed implementation of the ‘MRCA Engine’ is used, wherein activation packets are sent between ‘nodes’ via a network protocol such as TCP/IP or UDP datagrams, and;
c. for a global analysis involving thousands or millions of Users, and when a large compute farm or cloud is available, the Users' VFTs and the global attributes DB may be converted to an Inter-Match Network (608), and then to distributed sparse matrices in sub-system (4900) FIG. 49), and such that operations are executed on the sparse matrices in parallel or asynchronously, and;
d. for a global analysis involving a plurality of thousands or millions of Users, the several algorithms in the sub-system (4800), General N-Cluster and MRCA Assignment Algorithms, may be used, and;
e. for an on-going DNA flows based analysis spanning across all Users on a distributed computer network (ie, the internet), the sub-system (5000) ‘Global DNA Cluster Generation and Analysis with Competitive Neural Networks’ is employed.

18. The system of claim 1, whereby after the results of an execution of sub-system (700) ‘Run concurrent MRCA assignment optimization’ are obtained, for each successful MRCA assignment, confidence enhancements are propagated from the MRCA VIA node down the direct DNA flow path to the User, in all VFT's which have a VIA node connecting to said MRCA VIA assignment node, and thus, if two User's have a successful determination of their MRCA to a VIA node X, then the connection and other confidences from that VIA node X, down to each User in their respective VFT trees are enhanced, and furthermore, if an MRCA node has been merged with other MRCA nodes, indicating a plurality of Users' have successfully triangulated to the MRCA node, then the confidences in paths are proportionally enhanced, and the enhancement of each connection or VIA node is regulated by its' initial confidence, such that if a node had very low confidence, it will get very little enhancement, and if a node or connection has maximal confidence (100% or 1.0), it will get no further confidence enhancement.

19. The system of claim 1, whereby after results of each execution of sub-system (600) are obtained, for each successful MRCA assignment, the system will dispatch various Agents to automatically propagate confidences of discovered MRCA's from descendants across all involved trees (ie, DNA matched Users' trees) into a common tree such as a Virtual World Tree.

20. The system of claim 1, whereby after the results of an execution of sub-system (700) ‘Run concurrent MRCA assignment optimization’ are obtained, any successful MRCA assignments results are annotated to VFT VIA nodes by ‘Tree Annotation Agents’ from sub-system (1700), such that same may be easily viewable by Users, as illustrated in FIG. 14), wherein the marker appears like a ticker-tape with annotation to show the level of confidence in the Ancestor according to the number of DNA MRCA's connecting to it.

21. The system of claim 1, wherein a sub-system (1300) ‘MRCA Assignments Display’, in which the VFT of two DNA matched Users' who have found an MRCA, will be displayed as shown, with the pedigrees of each starting from the edge of the screen and expanding towards the middle of the screen, such that the path of the DNA flows can be shown.

22. The system of claim 1, whereby after a results of sub-system (600) ‘Accumulate all desired data into the Competitive Network System’ are obtained, for each successful MRCA assignment, ability to automatically share high quality ancestors from one DNA Users' triangulation-confirmed pedigree to those of DNA cousins who share some or all of that pedigree, or who have paths to the ancestor associated with the MRCA, through a shared ‘Virtual World Tree’ (VWT), wherein the sharing of high-quality Ancestors is done by VWT Tending Agents described which traverse a User's tree, looking for equivalent Ancestors in the VWT, and if found, and if they VWT ancestor is better, updating the User's VFT node, or on the other hand, if the User's version of the Ancestor is better, then updating the VWT with the improved information, and if the two have significant contradictions, adjusting the confidences to reflect the reduced certainty.

23. The system of claim 1, which is in part comprised of a sub-system (800) ‘Continuous exploration and growth of virtual trees’, including:
a. propagate enhanced confidences from new MRCA assignments to the descendants of the MRCA who lie on a path between DNA matched Users who have the MRCA,
b. evaluate Queued ICW Ancestors to add to VWT,
c. evaluate Queued Speculative Trees for addition to VWT,
d. evaluate if Users' VFT Trees should inherit enhanced sub-trees from VWT, on User option,
e. evaluate and explore Disembodied Cousins, is detailed in sub-system (3300), (3400),
f. dispatch Virtual World Tree Tending Agents as detailed in sub-system (1800) and (2200),
g. dispatch Speculative Tree Search Agents, as detailed in sub-system (3500),
h. assimilate discoveries from all the various search systems, on all trees, and integrate them in a manner which propagates the inherent constraints and confidences, as discovered by many Users, into the VWT.

24. The system of claim 1, which is in part comprised of a sub-system (900) ‘Agent Control System’, which is equivalently called the ‘Agent Management System’, which is comprised of, in part, a set of light-weight computer programs described as ‘Agents’, running on a single monolithic system, or alternatively, on a set of distributed networked computer systems, with the general purposes of the various Agents comprising in part to calculate, record and display indicators of likelihood of relatedness of virtualized individuals and their ancestors in the software data structures described in the invention according to several methods described in various sub-systems, and to calculate, record and display various metrics of confidence on genealogic data and inferences associated with virtualized ancestors, using several methods described regarding Agents herein, and wherein the Agent systems are comprised of:
a. sub-system (922) ‘Attribute Agents’, which run data mining on VFT's to find common attributes, not focused on ICW-A matches, and store in a local or global shared attributes DB (428);
b. sub-system (916) ‘Confidence Agents’, which are in part comprised of a sub-system (1500) ‘Confidence and Constraint Agents Launch’:
c. sub-system (918) ‘Constraint Agents’, which are in part comprised of a sub-system (1600) ‘Constraint Satisfaction Calculating Agents’;
d. sub-system (920) ‘Virtual World Tree Tending Agents’;
e. sub-system (934) ‘Virtual Family Tree Agents’;
f. sub-system (924) ‘Migration Proximity Search’ Agents;
g. sub-system (926) ‘Tree Probability Agents’;
h. sub-system (928) ‘In Common With Match Agents;
i. sub-system (930) ‘In Common With Ancestor Agents’ which evaluate the likelihood that two VIA nodes represent the same individual, by means of a custom neural network, wherein the VIA nodes are one each from the VFT of two DNA matched Users;
j. sub-system (938) ‘Cluster Agents’.

25. The system of claim 1, which is in part comprised of a sub-system ‘MRCA Assignments Displays’, which includes the several sub-systems depicting the assignment of MRCA's to VIA, comprising:
a. sub-system (1300), which allows the User to see two pedigrees simultaneously, and whose description is by reference included here in full;
b. sub-system (1400), which displays DNA icons next to triangulation confirmed VIAs, the description of which is by reference included here in full;
c. sub-system (1700), which has an icon for DNA triangulation count, whose description is by reference included here in full;
d. sub-system (2700), which displays a Chromosome Map with MRCA's pointing to associated segments, and with special actions when any segment is clicked, as described in the description of sub-system (2700) and FIG. 27);
e. sub-system (3100), which displays MRCA connections to VIA's according to a current estimation of probable assignment to a VIA;
f. sub-system (4200), which expands an MRCA which has a multiplicity of DNA triangulations, into the MRCA nodes seen by owning Users.

26. The system of claim 1, which is in part comprised of the sub-system (1700) represented in FIG. 17) as an illustration of the information display of one example node from a Virtual Family Tree, in one embodiment, with the description of ‘system (1700)’ included here in full, and that:
a. this claim provides a computer automated visibility into confidences intended by those researchers (‘Users’) when viewing their personal family trees, and,
b. this claim provides a unique ability to automatically tag an ancestor profile or sub-tree as ‘speculative’, or ‘placeholder’, or ‘missing-link’.

27. The system of claim 1, which is in part comprised of the sub-system (1800) represented in FIG. 18) as an illustration of the ‘Statistics View’ elements as related to a Virtual Family Tree node, in one embodiment, with the description of ‘system (800)’ included here in full.

28. The system of claim 1, which is in part comprised of the sub-system (1900) represented in FIG. 19) as an illustration of the relationship of confidences (usually decreasing) going up a branch of the VFT, in a form of Bayesian Belief Network, in one embodiment, with the description of ‘system (1900)’ included here in full.

29. The system of claim 1, which is in part comprised of the sub-system (2000) represented in FIG. 20) as a flowchart and illustration of the operation of In-Common-With Ancestor discovery and integration, in one embodiment, with the description of ‘system (2000)’ included here in full, and that, this claim provides a unique automated ability to easily find, link to, and cooperatively analyze in-common-with ancestors (ICW) across DNA matched Users' trees, with benefit of the holistic system described.

30. The system of claim 1, which is in part comprised of the sub-system (2100) represented in FIG. 21) as an illustration of a Neural Network for In-Common-With Ancestor discovery via pattern matching, in one embodiment of the Ancestor matching AI algorithms, with the description of ‘system (2100)’ included here in full, which compares two ancestors to determine likelihood that they are the same person, by taking as inputs into the first layer of inputs, called the ‘Parsing and Feature Extraction’ layer, the key information from the Ancestors VAR records, processing that information with Constraint Agents and using the Fuzzy Logic DB, and then passing this refined data to a first layer of neurons, which then feed the information forward to other layers, and to neurons in the compared Ancestors data path, and onward through several hidden layers of neurons and connections, until the output is a probability measure of whether the two are the same individual, and that the nodes, connections and processing in the neuron nodes will have been trained by feeding it examples from manually vetted family trees, wherein if two Ancestors are known to be the same person to some level of confidence, but have somewhat different information, the neural net will be trained by modulating weights of connections through backpropagation until the output correlates to the confidence given for the Ancestors.

31. The system of claim 1, which is in part comprised of the sub-system (2200) represented in FIG. 22) as an illustration of a ‘Virtual World Tree’ Tending Agent harvesting commonalities between two trees to grow the VWT, in one embodiment, with the description of ‘system (2200)’ included here in full.

32. The system of claim 1, which is in part comprised of the sub-system (2300) represented in FIG. 23) as an illustration of initial MRCA-Vdna VIA candidate set assignment for one pair of DNA matched Users, in one embodiment, wherein the MRCA Vdna set is as set of pointers to the set of Ancestors which could be the MRCA, given the predicted relationship of the two DNA matched Users for whom the MRCA Vdna is a placeholder for their MRCA, with the description of ‘system (2300)’ included here in full.

33. The system of claim 1, which is in part comprised of the sub-system (2400) and (2500) represented in FIGS. 24) and (25) as an illustration of reduced MRCA-Vdna VIA candidate set assignment for one pair of DNA matched Users, in one embodiment, wherein the set of eligible, or likely, Ancestors has been reduced by various means and algorithms built into the holistic system, including DNA steering by ‘chromosome mapping’, or by the combinatorial assignment algorithms, or by the ICW matching algorithms, or by others, with the description of ‘system (2400)’ included here in full.

34. The system of claim 1, which is in part comprised of a sub-system (932) ‘DNA Agents’, which are described in the sub-system (900) ‘Agent Control System’, (1000) ‘DNA Mapping Influences’, (2600) ‘Referencing Shared Segments to each Ancestor in the DNA Flow’, (2800) ‘DNA Segment Flow Graph Viewer’, (3100) ‘MRCA Engine’, and sub-system (5000) ‘Global DNA Cluster Generation and Analysis with Competitive Neural Networks’, wherein the DNA Agents populate Ancestors' nodes with pointers to the DNA segments that have been putatively associated to the Ancestor, and as an Ancestor's DNA inventory increases, with potentially overlapping DNA segments re-creating the genome of the Ancestor, the Ancestor's DNA is presented to the DNA matching algorithms such that User's may match directly to the Ancestor, or Ancestor's may be matched to each other, and furthermore, that such a continuation of accumulation of DNA and recycling it into the matching system as a new User, creates the potential to generate matches from Ancestors born many hundreds of years ago.

35. The system of claim 1, which is in part comprised of the sub-system (2600) represented in FIG. 26) as an illustration of DNA Mapping Agents assigning DNA segments to VFT VIA nodes, in one embodiment, with the description of ‘system (2600)’ included here in full, and, this claim provides a unique ability to automatically incrementally recreate ancestors' genomes from all MRCA's and to automatically re-use those virtual ancestors in the general matching system as a regular User, but with only partial DNA.

36. The system of claim 1, which is in part comprised of the sub-system (2700) ‘DNA Map System for each ancestor, to show overlaps’, represented in FIG. 27) as an illustration of the generation of a stacked chromosome map with links from DNA segments to associated MRCA Vdna nodes, in one embodiment, with the description of ‘system (2700)’ included here in full, which postulates that the IBS shared DNA data is at least beneficial in this system to attracting Ancestors who are ethnically close, and which provides improvements over prior art by providing a system to automatically map shared genome data according to most likely ‘most recent common ancestors’ (MRCA's), and inversely, from all MRCA's to a chromosome/surname map, which is commonly called ‘chromosome mapping’ in prior art, and wherein this is enabled in a manner in this invention such that the Users need not publicly expose their actual DNA information to other Users, as the work is done securely within the confines of the programs, and information that is sent over networks is encrypted.

37. The system of claim 1, which is in part comprised of the sub-system (2800) represented in FIG. 28) as an illustration of a DNA segment flow graph viewer, in one embodiment, with the description of ‘system (2800)’ included here in full, wherein this display allows a User to trace the flow of one or more DNA segment from one or more MRCA through their family tree.

38. The system of claim 1, which is in part comprised of the sub-system (2900) represented in FIG. 29) as an illustration of Y and mtDNA specific MRCA-Vdna candidate set adjustment for one pair of DNA matched Users, in one embodiment, with the description of ‘system (2900)’ included here in full, wherein the Ancestors in the trees of two DNA matched Users are connected in an associative network by connections to equivalent Y and mtDNA nodes, such that Ancestors who share the same haplogroup will be attracted in the Competitive Neural Network.

39. The system of claim 1, which is in part comprised of the sub-system (704) ‘MRCA Constraint Satisfaction and Assignment Optimization Engine’, which is comprised of the following sub-systems:
a. the sub-system (3000) represented in FIG. 30) as an illustration of an embodiment of the MRCA Engine' Competitive Network with Virtual DNA nodes connected to VFT nodes, with the description of'system (3000)' included here in full;
b. the sub-system (3100) represented in FIG. 31) as an illustration of an embodiment of the MRCA Engine' Competitive Neural Network with Attribute nodes connected to VFT nodes, with the description of'system (3100)' included here in full;
c. the sub-system (3200) represented in FIG. 32) is a flowchart of one embodiment of the MRCA Engine process of local and global optimization of MRCA assignments, with the description of ‘system (3200)’ included here in full;
d. the sub-system (4100) represented in FIG. 41) as an illustration of the abstract visualization tool for visualizing an ‘MRCA Engine’ network stimulation and settling states, in one embodiment, with the description of ‘system (4100)’ included here in full;
e. and whereas the above sub-systems cooperatively and holistically provide a unique automated ability to use various data points shared across DNA matched User's trees to focus MRCA search efforts, including documents shared between Ancestors of different pedigrees.

40. The system of claim 1, which is in part comprised of the sub-system (3300) Disembodied Cousin evidence accumulation and Triangulation method, in one embodiment, with the description of systems (3300) and (3400) included here in full, and which also comprises;
a. for every DNA matched pair of cousins, a scan is made of their trees (connected paths from the DNA cousin), and for each pair of ancestors who meet a criteria of ICW similarity such that they could be the same person, an ICW-DC (In-Common-With Disembodied Cousin) node (3306) is created connecting the two, and the ancestors (VIA nodes) are annotated with meta data indicating to whom they are possibly connected, and by which DNA cousins;
b. the ICW-DC node is stored in the local and global shared attributes DB's;
c. the ICW-DC nodes grown between two DNA matched User's VFT VIA nodes, will have additional information indicating the number of disembodied cousins either above or below in a path that DNA could have flowed, and this information will be used to enhance the strengths (weights) of the connections;
d. this data will be displayed on the nodes info-display (1706), to help the User visualize how many ICW-A lead up or down to the particular node;
e. and, for each of the ICW-A's contributing evidence, an ICW-DC node is grown between the ICW-A node of the User and each corresponding ICW-DC node in the cousin's VFT;
f. and, to guide the MRCA-Engine with respect to the evidence of which node is the vertex of a fan-up or fan-down, an attribute node is grown from the presumptive vertex to each of the ICW-A nodes, with the type indicating whether it is a fan-up or fan-down case, how many VIA nodes are involved, and a weight proportional to the count of contributing ICW-A nodes;
g. and, that these collections of ICW-DC nodes suggest that any MRCA between the two Users most likely is not above a fan-out up vertex, nor below a fan-out down vertex, because the assumption is made that the ‘disembodied cousins’, if they are not just statistical coincidences, represent cousin ancestors who are on a path that DNA flowed from an MRCA to one or the other DNA matched cousins, and if there are multiple paths above a vertex, then it is unlikely that all those cousin Ancestors provided the same DNA segment to a User, and if there are multiple paths leading down from a vertex, then it is unlikely that the MRCA is below the vertex, since the DNA mostly likely passed through the vertex heading down to the each of the cousins, and thus the vertex is the lowest likely MRCA, unless there happens to be a case of endogamy wherein cousins below the vertex produced offspring who may be the MRCA;
h. and, when the MRCA engine stimulates a pair of MRCA-Vdna nodes, and those in turn stimulate their connected eligible VFT VIA nodes, an advantage will be given to the VIA nodes which connect to ICW-DC nodes, and to the Ancestors connected to the vertex nodes between clusters of disembodied cousins.

41. The system of claim 1, which is in part comprised of the sub-system (3500) represented in FIG. 35) as an illustration of one embodiment of Speculative Tree Search (STS) Agents attempting to connect nodes suspected to be related, wherein sub-system (3500) further comprises;
a. a unique ability to automatically create speculative trees or connecting ancestors, and re-evaluate local DNA matching completeness, with the holistic support of constraints, fuzzy logic and various clustering systems;
b. speculative Tree Search Agents build ‘what-if virtual sub-trees, when an MRCA can not be found between two DNA matched Users, but the search space has been narrowed down sufficiently to suggest that a particular branch in each tree should intersect, and wherein the objective is to find an ancestral path (DNA flow) between ancestors in two trees who may be separated by generations, with no known path between them, but who otherwise have strong hints that they have common ancestors, and whereas these hints may come from, as an example, a combination of DNA tree pruning, ICW-M and ICW-A clustering, disembodied cousin analysis, or an MRCA analysis that has left only a few branches as candidates but has found no direct link between two DNA matched Users, and whereas other ‘Expert’ knowledge may be coded in, such as the case of middle names often indicating the surname of some notable ancestor;
c. and, given an DNA match between two Users' and a higher probability and resulting hypothesis that the MRCA is associated with a particular branch, then there are various strategies of ‘fill-in’, including up-ward exploration from a shallow tree and downward exploration from a deep tree, and wherein the search strategy and algorithms vary depending on modality which may include, for example, a breadth-first survey of a candidate ancestors' children, resulting in an ordering of the children candidates based on fit and constraint satisfaction, and for another example, choosing the best-fit child and descending depth-first, with again an ordering of the children at the next level down, wherein here, it is clear that the STS Agents make good use of the Constraints and Fuzzy-Logic DB and attributes on the Ancestor Nodes to determine fitness of candidate nodes;
d. and, in general, the search progresses with two nodes, a top and bottom (X and Y and 3514), wherein each node must have certain attributes which suggest they may be related (ie, surname, DNA, location, or —the node is one of the few remaining options for a Vdna/VIA match);
e. and given an Ancestor with K (count of) suspected children, each child is evaluated to see if it could lead down to the bottom node, wherein a first strategy comprises: if Surname is the common attribute between the bottom and top nodes, look at each male child, and then look at their locations, and sort according to which is closest in place and time, and then each child node is ‘explored’, in that if it has children, those are searched in the same manner;
f. and, if the ancestor of interest does not have children in the VFT or VWT, an initial search is done of all DNA matches (starting with VFT's of User's in the ICW-Match list between the top and bottom node originators, and then progressing to all DNA-match VFT's of the top and bottom nodes) to see if a VFT has this node with children, and if so, they are then added to the exploratory tree (along with confidences), and explored, wherein adding a node means replicating the node's meta data, but with only the pointers (links) to the children, as we do not want to copy entire sub-trees when doing a search;
g. and the search of VFT's, in the order prescribed (ICW-Matches between A at (3502) and B at (3504), all remaining DNA matches of A or B, then all remaining VFTs) for a particular ancestor should accumulate a list of all matching ancestors, and the data of all matching ancestors that passes a relevance criteria will be merged into one VIA node (representing that Ancestor), and will be analyzed by the constraints Agents and confidence Agents, and if passing quality criteria, may be added to the VWT, and furthermore, in this respect, a search for a given ancestor is not repeated multiple times for other cases involving that ancestor;
h. and if the VFT and VWT scan is not successful in building a viable ancestor at a particular level, the node will be marked, or ‘bounded’ in the traditional sense of branch-and-bound, and the node, based on its current viability value, will be inserted into a list of other nodes pending for further evaluation, and in this respect, a breadth-first at level N, and depth-first search is enabled, wherein the viability criteria is initially high, thus this search will explore all paths until each falls below the current viability metric, and after this, if no solution is found, the viability watermark will be lowered, and the nodes in the list which are above that watermark will be again searched in the same manner, eventually finding a solution, or adding more nodes to the list, or reaching a dead-end (leaf) for all sub-trees;
i. and after the VFT's and VWT are searched for existing nodes, a general genealogic sources search may be executed for any nodes in the pending list which have a viability metric still suggestive of their having a potential path to the target node;
j. and after the search has completed, the new branch or branches are added to the VWT, and shared with the Agents of the requesting VFTs, and if no viable path is found, but there is still a ‘weak’ path with missing links, this will be added to the VWT as a virtual branch with virtual-ancestor placeholders at each generation, whereas the branch is annotated with information to record the cause of the search, and thus, if other searches are triggered based on similar DNA matching Users, then the evidence for the Virtual branch being the actual branch will increase, and furthermore, the MRCA nodes from the User's VFT's will also need this recorded, such that the same search is not repeated, and furthermore, if an alternate solution is found, the Virtual Branch annotations must be retracted, and wherein the this form of search is similar to the ‘Ant algorithms’, wherein the ants leave a pheromone on a path to food, and as more ants find the same food, the pheromone increases.

42. The system of claim 1, which is in part comprised of the sub-system (3600) represented in FIG. 36) as a flowchart of one embodiment of the Closest-Point-Of-Approach analysis of VFT's of DNA matched Users, which is also comprised of:
a. the sub-system (3700) represented in FIG. 37), an illustration of an Ancestor Migration visualization tool with sliding time-windows, pedigree path traces, and proximity halos;
b. an automated ability to discover mating eligible and likely ancestors residing in the family trees of DNA matched Users, based on proximity of co-location during the same reproductive time period, and use that data in automated MRCA analysis, and wherein from this analysis, attribute nodes will be created which represent this proximity in the MRCA Engine analysis, and furthermore, proximity analysis may be used to determine if a child and potential parent were in the same place-time ... preferably at date of birth;
c. An algorithm for proximity discovery, as depicted in the flowchart of system (3600), consisting of:
i) Migration Proximity Influences, a proximity analysis begins at state (3602):
ii) for all eligible Ancestors between DNA Matched User A, B, and then;
iii) (3604): create a matrix for CPA between each eligible pair, then;
iv) (3606): evaluate the ICW Matrix to rank similarity of the candidate individuals (taking into account such constraints as age, gender, so as to not try to mate same-sex, or women before or after child-bearing age, and then;
v) from this, we create (3608), an ordered list of pairs of Ancestors to test, of which each pair is passed to (3610) Proximity Search Agents;
vi) then in state (3612), the Proximity Agents calculate the closest point of approach based on calculated birthdates and travel path timelines, wherein this is done intelligently by the Agent by walking the travels of the two ancestors from place and date of birth to place and date of death, and for each decade, the estimated distance between the two is used to calculate the smallest CPA between the two ancestors;
vii) in state (3614) the results are saved to the Shared Attributes DB, and then;
viii) in state (3616) a ICW-Proximity attribute node (ICW-P) between a pair of Ancestors may be saved to the Shared Attributes DB;
ix) and finally, state (3618) registers the changes (new attributes) to the Agent Exchange to notify the calling system of proximal pairs of ancestors, wherein the calling system may be the User, in which case the attributes are graphically annotated.

43. The system of claim 1, which is in part comprised of the sub-system (3800) represented in FIG. 38) as an illustration of an In-Common-With Matches data-mining and processing system, in one embodiment, with cluster analysis enrichment improvements arising from said system (3800) of which comprises an automated system and methods to ‘data-mine and cluster’ in-common-with (ICW) matching members between two matching members, such as a 3^{rd} member who matches both of a pair of matching members, and which in general makes the estimation that clusters of highly inter-connected Users (DNA cousins) may share a common ancestor or at least a commonality in some biographic data, such as the time and place that their common ancestors lived in, or the social groups those ancestors mingled in, and that this improvement on the ICW-Match clustering analysis leverages the various commonalties between the VIA nodes in the DNA cousins' to highlight those ancestors between the members of a cluster, who share a majority of common attributes, and which further comprises:
a. the sub-system (3900) represented in FIG. 39) as an illustration of a method of using In-Common-With Matches along with good MRCA data to algorithmically reduce some MRCA search spaces, in one embodiment, wherein some ICW-Match sets which have cases of solved MRCA's between members of the match set, are clustered around those MRCA's, and DNA flow logic is used to determine, or predict, under which branches of the tree Users must lie, and that this system is primarily used to evaluate ICW-Match data, wherein the DNA segments are not known, but the fact that several User's DNA match each other is known, and wherein this system is also applicable to the case where the DNA segments shared between several Users is known to the system (but not necessarily known to the Users), and in this case, there is no ambiguity of which segments match (the S1, S2, S3 in FIG. 39), but the mapping of the segments to the VFT graphs follows the same fundamental pattern, wherein this analysis comprises:
i) ICW-Match analysis, in one embodiment, will start with the closest relatives (participant Users who DNA match) of the User, who have already been tied to an MRCA, wherein any ICW-matches between the User and the first MRCA-triangulated cousin most likely will find their MRCA with the other two in the pedigree at or above that first MRCA . . . unless there happens to be a case of endogamy wherein cousin descendants of the 1⁴ MRCA mated and one of them happens to be an ancestor of both the User and the cousin, and wherein in this case, the designated 2^{nd} MRCA is a co-MRCA;
ii) if a User has successfully populated their tree to great-grandparents, and have at least one DNA match confirming each of these great-grandparents, then they may be able to assign all DNA cousins who have ICW-Matches to them to one of the 8 branches of sub-pedigrees of the great-grandparents, and this process continues for all DNA cousins with known MRCA's;
iii) the the case of 3 User's who form a triangle of DNA ICW-Matches (circled in 3912), forms the base case for the global population analysis of ICW-Match clustering, wherein this Global ICW-Match analysis is explained in FIG. 45), and in said FIG. 45), the ICW-M may be represented as in (3914), where S1 -S3 represent the DNA segments shared between the Users, and any one of the S1, S2, and S3 may be the same, or overlapping, segment, and whereas the fundamental theory of this system is that you must map the segments to the combined VFTs (or VWT), such that the DNA segments (S1 -53) of (3914) have a down-stream flow to their respective Users, and wherein two possible ‘network flows’ are illustrated in (3916) and (3918), and wherein the lines between nodes can represent multiple generations in a VFT, but the actual realistic distance these edges represent are bounded by the ‘Genetic Distance’ predictors for the DNA matches of the Users;
iv) and wherein this restriction of the ICW-matches to the pedigree of the MRCA node is recorded by several means:
(1) the MRCA-Vdna node of each ICW-Match updates its connections to the VIA nodes in the two VFT's to reduce the connection weight to nodes (ancestors) below the MRCA, as described in (3916), wherein this is facilitated by connecting MRCA nodes with ICW-Match nodes;
(2) by the Genetic Distance, an ICW-match X of a DNA cousin Z to the User A which is pinned to an MRCA-AZ, can have its own MRCA-XA pin-pointed by calculating the ‘Genetic Distance’ from the DNA cousin Z, up to the MRCA-AZ, and then up and/or down to the ICW-Match X, and that this may be formulated as a constraint, that the MRCA for A to X must lie within K generations of MRCA-AZ, on any path up or down except down the path to A;
(3) by creation of ‘ICW-M Cluster nodes’ to bind ancestors who share attributes across the ICW-Match sets, wherein cluster nodes may point to other cluster nodes to create a hierarchical cluster, and wherein the weights of the connections infer a form of connectionist fuzzy logic, and thus propagate constraints;
(4) and by creation of ICW-A (common ancestors) nodes with ICW-Match enhancement, for example: an ICW-A node which connects to a ICW-M node, which itself connects to the MRCA's of involved Users, and/or connects to ICW-Match Cluster nodes;
b. the sub-system (4300) represented in FIG. 43) as an illustration of one embodiment of an automated ICW-M Graphing System sub-system, with the description of ‘system (4300)’ included here in full, wherein each node represents a DNA cousin to who the User matches, and each bi-directional line indicates that the two connected DNA cousins also match each other, wherein it may be estimated that there is some relationship (by either DNA, social circles, location or other attracting force) that causes a cluster of DNA cousins to have a high degree of interconnectedness, and wherein in the display, any DNA cousin with who the User has a confirmed MRCA, will have extra emphasis on their node, such as the double-circle or donut-icon;
c. the sub-system (4400) represented in FIG. 44) as an illustration of one embodiment of an ICW-M Graphing System, with the description of ‘system (4400)’ included here in full, wherein a typical mind-map of connections between Users who match each other as well as the first User, is expanded to include an intermediary ICW-DNA node between each pair of Users, such that the intermediary node represents and records the DNA segment(s) shared between the two connected Users, and the connection strengths are proportional to the amount of DNA shared;
d. the sub-system (4500) represented in FIG. 45) as an illustration of one embodiment of an ICW-M Graphing System mapped to a VFT, with the description of ‘system (4500)’ included herein, wherein the basic objective of this system is to map each ICW-DNA node to a VIA node in the VFT of the User, wherein the possible choices for the ICW-DNA are constrained by conditions such as MRCA's assigned to various User nodes, and the genetic distance prediction between a first User (A)and the 2 nd User (B), and between both of them and the 3rd User(s) which formed the basis of the ICW-Match, and that any and all other constraints applicable, will be utilized and verified for constraint satisfaction, and wherein this information is passed to the ‘General N-ICW-Match Center of Gravity Algorithm’ (4512), and wherein when an MRCA is found, or predicted, between a pair of DNA matched Users, the ICW-DNA node shared between them in the ICW-M graph will be connected to each Users' respective VFT VIA Ancestor node representing the discovered MRCA, such that Ancestor nodes continuously accumulate putative DNA from MRCA match discoveries;
e. the sub-system (4600) represented in FIG. 46) as an illustration of one ‘base triangular case’ algorithm embodiment of an ICW-M Graphing System with constraint-driven DNA mapping to several Virtual Family Trees, with the description of ‘system (4600)’ included by reference herein, wherein the genetic distance constraints, along with the DNA flows constraints, are combined to limit the group of ancestors that could be the MRCA between pairs of DNA matched cousins;
f. the sub-system (4700) represented in FIG. 47) as an illustration of one embodiment of an ICW-M Graphing System with constraint-driven DNA mapping, with the description of ‘system (4700)’ included here in full.

44. The system of claim 1, which is in part comprised of the sub-system (4200) represented in FIG. 42) as an illustration of an Merged-MRCA browser, in one embodiment, whereas when MRCA-Vdna nodes are confirmed between two Users, they are linked together into a composite MRCA-Vdna Node, and this node may again be merged with by another DNA match, or may have already been a composite node, and thus, if a MRCA-Vdna Node is a composite, then in this graphical display, clicking on the composite node will display a star diagram of the individual MRCA-Vdna Nodes, with the User then able to click any one of those nodes to jump to the respective User's MRCA to VFT display.

45. The system of claim 1, which is in part comprised of the sub-system (4800) represented in FIG. 48), as an illustration of the embodiment of an ‘Combinatorial MRCA Assignment’ with constraint satisfaction metrics, wherein the system, given a set of DNA matched Users and their respective sets of VFT ancestors and corresponding MRCA's, shall ,as illustrated in FIG. 48) in general, select ancestors (Ki) from the sets X of eligible ancestors using one of the described algorithms in this claim, such that assigning MRCA (Mij) nodes to them results in an optimal assignment according to the objective functions of the algorithms used, and wherein the plurality of objective function metrics includes, but is not limited to:
a. the cumulative measure of equivalence of the Ancestors chosen to be MRCAs,
b. the satisfaction of constraints across all such assignments and their satisfaction rates on the VFTs and VWT,
c. and the resulting total quality and completeness of the VFT's involved, and/or VWT;
and which provides a unique ability to automatically apply constraint satisfaction algorithms to the mapping problem of a massive plurality of DNA cousins per user in combined sets of over a million each of DNA participants, using as constraints (for example) the holistic factors of confidence, DNA mappings or isolations, various data points, in order to highlight most likely branches for the MRCA between any pair of DNA matched Users, wherein in all cases eligible Ancestor nodes may be limited, diminished or enhanced (in their fitness within the respective objective functions) by the Constraint factors, which comprise:
d. any DNA mapping between the members of the intersect set that is able to limit the eligible ancestor set between the members;
e. any outright ICW-Ancestors in the respective pedigrees of the ICW-M set receive majority fitness valuations;
f. surnames, or uncommon first or middle names which are similar to the Surnames of their potential Ancestors in other trees in the ICW-M set, are given priority and higher fitness valuations than attributes of less significance;
g. CPA in time (closest passing in time), mapping all eligible Ancestors of the members of the ICW-M set simultaneously, via ICW-P attributes, should be met, if possible to calculate, wherein this is only impossible to calculate or estimate, if the there are no evidences of temporal location such as birth place, death place, or similar geo-temporal data points of the individuals parents, siblings or offspring;
h. uncommon (statistically significant) Nationalities of birth, or ethnicities in Ancestors in the ICW-M VFTs;
i. attributes (records) shared between any Ancestors in the ICW-M VFTs, such as Wills, names on marriage records, military service etc.;
j. simultaneous Disembodied Cousin analysis from VFT Ancestors of the members of the ICW-Match set;
k. cluster attractors, such as ICW-Match clusters, as tracked by ICW-DNA nodes, wherein attractors are limited by DNA match Genetic Distance estimates;
l. ICW-Match DNA flows, such that DNA from a putative MRCA must flow downstream through the pedigree to the matching DNA individuals (Users),
and wherein the sub-systems selection and objective function methods comprise the ‘Best-First’, ‘Evolutionary Algorithms’ and the ‘General N-Cluster Center-of-Gravity Algorithm’.

46. The sub-system of claim 44, comprising a sub-system method (4808) called ‘Best-First’, wherein the best MRCA candidate is chosen from the most cluster-enriched (fit) User pairs first, and all User's are run asynchronously, in parallel if possible, and such that the algorithm can operate on the VFT's directly, but can also run with the (608) Inter-Match Network, and that the detailed algorithm comprises the following steps:
(1) all User MRCA-Vdna candidates (Mij) of a particular User ‘i’, are ordered (queued) by the likelihood of finding a common ancestor between the MRCA's candidate VIA nodes in sets Xi and Xj, where Xi is the set of VIA candidates from User Mi, and Xj are the candidates from User Mj, and where the MRCA node Mij is thus the MRCA between User ‘i’ and User ‘j’, and the ‘i’ index are pre-selected as DNA matches, and pre-sorted such that the Mij with the highest confidence (and presumably, closest DNA relationship to the User ‘i’) are processed first, and thus, the metric, ‘likelihood of finding a common ancestor’ is, in one embodiment, calculated by taking those sets X which have the fewest elements (fewest VIA nodes), and which already have the highest degree of shared attributes, and wherein the example function fcd(Mij) below, suffices to provide a simple ranking of all input MRCA candidates:
a. fcd(Mij I, where function fcd calculates the ‘cluster density’ such that fcd(Mi, Mj)=Num_Shared_Attributes(Mi,Mj)*(1/(Tot_Num_Members_in Xi+Tot_Num_Members_in_Xj)), where this example function calculates a simple density, without regard to weighting of importance on the attributes;
(2) from the set Xi of Mi selected, the most likely matching Ancestor for Mi's two Users is chosen;
(3) thence, each next less fit MRCA pair that is related to the prior pair is evaluated, if any more exist, and any improvements in the network are taken into consideration (ie, the prior MRCA assignment reduces the eligible set for the next, related MRCA), and then, if no DNA related MRCA exists, the next best fit of the remaining MRCA's from the set M is chosen;
(4) loop back to step (2), select an Xi of the last Mi;
(5) repeat until all MRCA have been assigned;
(6) after all MRCA have been assigned to the User's VFT VIA's in the first round, calculate the fitness of the total assignment, wherein this fitness is the sum of the fitness of each MRCA assignment, and any various global factors (overall quality and completeness of VFT and VWT trees resulting), and wherein the fitness of each MRCA assignment is a function of:
a. the confidence in the match of Ancestors selected for the MRCA, according to the ICW-A search Agent algorithms;
b. the satisfaction of the Genetic Distance function for the MRCA, with the two selected Ancestors to each respective root User node, wherein any deviation is a negative addition;
c. when two or more MRCA's are assigned to the same VIA node, then the MRCA's have to be partitioned into sets according to unique VIA individuals, wherein, if the VIA from the other VFTs nodes do not match each other as ICW-A equivalent individuals, then they must be partitioned into sets of individuals who do match each other, and wherein the total fitness that could be assigned to any one MRCA is shared between the sets of MRCA-VIA partitions, with fitness weight apportioned according to proportional numbers of VIA nodes in each set, wherein, if set 1 has 3 VIAs, and set 2 has 2, then Set 1 MRCA nodes would share ⅗ of the fitness;
(7) next, the worst performing MRCA assignments (eg, those that perform below acceptable criteria for a valid match), are evaluated to see if any other assignment would have performed better, and the new assignments are not yet made permanent, but are rather put in an evaluation bin for each MRCA, and the new assignment is marked, to prevent it from being ‘re-evaluated’ again in this current round, and:
a. if the re-assignment disrupts a prior assignment, then that prior assignment is re-visited, wherein if every prior assignment had already been optimally selected, then the worst performer has been optimally selected from the choices it had, and thus, to make an improvement (if possible), would require a disruption of a prior assignment;
b. the disrupted assignments are queued and re-evaluated by looping back to step (7);
c. The re-evaluations continue until the queue is empty, or until there are no further options for re-assignment, as all options have been marked in the current round,
(8) after the current re-assignment round is completed, the whole re-assignment set is calculated for overall fitness, per the measure of step (6);
(9) if the measure of overall fitness has improved, the evaluation selections are made primary for each affected MRCA node;
(10) step (7) re-evaluation is run again, and the results measured again, and compared against the prior run, until there are no further improvements in the overall fitness.

47. The sub-system of claim 44, comprising a sub-system method (4810) called ‘Evolutionary Algorithms’, which consists of ‘Smart Genetic Algorithms’, wherein the system will create sample sets from the best performances of each MRCA, and the method may be run on individual VFT's, but can also run all VFT's in parallel with the (608) Inter-Match Network, which thus facilitates global constraint satisfaction and optimization, and, A traditional Genetic Algorithm (GA) implementation requires the selected set (assignments of a User's MRCA-Vdna nodes to eligible Ancestors) to be ordered into a vector, with a population of such vectors representing various assignment sets, wherein the order of MRCA's on every vector must be the same, and wherein an initial assignment may include the (4808) Best First, and then vectors generated from randomization of the less optimal assignments, and rounded out with a number of more randomly arranged assignments, to avoid what's called the ‘minimal deception problem’, and wherein after a population is created, the optimization process applies an objective function to each vector to determine the fitness of each, and wherein a number of the highest fitness vectors are chosen for mating, and wherein, in the traditional GA mode, iterative cross-over recombination is done with such vectors to generate new offspring (samples), and wherein this process is repeated until there is no significant improvement in fitness of the best performing vector, and wherein that vector is then re-evaluated to confirm constraints, and then those assignments are given to the VFT and VWT Agents, and wherein it is noted that, in this system, each column (when vectors are aligned in rows, the column represents a particular MRCA), will have a population of potential Ancestors which may fall into and particular row's assignment of that MRCA, and wherein once an Ancestor gets dropped from the population represented in a column, it can not be added back in by this system, and wherein this limitation leads to the Smart GA, wherein The traditional GA is one embodiment of this algorithm, and the preferred embodiment is called a ‘Smart Genetic Algorithm, and whereas this system will create sample sets from the best performances of each MRCA, and this method may be run on individual VFT's, but running all VFT's in parallel with the (608) Inter-Match Network, facilitates global constraint satisfaction and optimization, and whereas this process is comprised of the the following flow:
(1) create a large set of constraint satisfactory assignments of Ancestors in a VFT to a User’ MRCA-Vdna Nodes, say K, (number of sets depends on memory and compute time available, but should be high enough that every permutation of assignments for each MRCA is expressed enough times to ensure that its correct assignment shows up enough times, with the correct assignments of those adjacent), with each saved as a vector of tuples, which consists of an MRCA id, two VFT-VIA' s ids, and the fitness of the VIA assignments, wherein this is initially accomplished by:
(a) randomly select one MRCA-Vdna, randomly select one Xi for each Mi, then calculate the local fitness of the assignment and save it on the vector ‘tuple’ for the Mi'th node;
(b) the ‘fitness’ of an assignment involves, in one embodiment, a summed metric of
(i) the DNA match confidence and degree;
(ii) the matching of the VIA members of an MRCA assignment, which includes, at least:
1. biographic information (name, date-of-birth, parents, siblings)
2. physical location overlap
3. other attributes shared (through co-connection to the same attribute nodes);
(iii)constraints satisfaction quality, wherein negative additional fitness may be accomplished by cases of Genetic Distance violation, or non-convergent DNA flows (a DNA segment does not have a common ancestor, but rather two or more distinct Ancestor paths which do not intersect);
(iv) the quality of the VFT's with the Ancestor involved in the MRCA assignment, wherein, equating two Ancestors from two or more VFT's, means that each VFT must determine whether the information associated to that Ancestor in the other VFT(s) actually improves or diminishes its' own quality, and where it must also allow for the possibility, if there are many members of a triangulated MRCA, and there is a definite fit of this MRCA into the User's tree, but the Ancestors do not match or do not match exactly, that its' own instance of the Ancestor is wrong, wherein, if the parents, siblings or descendants match, but the actual current Ancestor at the node does not, then that Ancestor should come under scrutiny;
(c) repeat la until all MRCA's have been assigned, then calculate the overall fitness for the whole assignment set (which is recorded in the header of the vector of tuples);
(d) calculation of the overall assignment is a form of the Quadratic Assignment Problem, wherein the fitness is based on the summing of the individual assignment's fitness;
(2) from the set of assignment vectors, sort and rank them according to their overall fitness values, wherein we note, a vector in this case is the assignments for a single User with his/her MRCA cases assigned to his/her VFT VIA's;
(3) if the best performing assignment has successfully assigned every MRCA with high (acceptable) fitness, make that assignment permanent in the MRCA's and stop;
(4) if the best performing assignment is unsatisfactory, proceed with a ‘smart reshuffle’, which is similar to cross-over but is not blind, wherein a reshuffle consists of:
(a) sort each vector according to the fitness's of the MRCA assignments it holds, such that performance decreases down the vector;
(i) during the sort, create a hash-table of the vector, with the MRCA id's as keys, and a pointer to the vector index as value, for fast lookup;
(b) for each MRCA Mi, find the N best assignment's fitness from L vectors out of all of the top performing of the overall K vectors, then copy each to N=K-L new vectors, such that:
(i) this will result in a new population of Assignment vectors, sized N+L, based on the best performing individual MRCA assignments and overall performances;
(ii) individual MRCA assignments are like real genes, in that they compete in the environment (fitness calculation);
(iii) the overall vectors of assignments are like individuals, in that they may have flaws, and those flaws limit their fitness;
(iv) the recombination described above is able to pick the best MRCA assignments from all vectors, rather than just pair-wise as is done in 2-sex reproduction;
(5) merge the L best overall assignment vectors and the new N vectors, resulting in a new population of size K again:
(a) Calculate the overall fitness of the new vectors;
(6) if there has been some improvement in the fitness value of the best performing vector, return to step 3, such that
(a) if the there is a good solution and no further improvement seen, stop, otherwise it will repeat the process;
(7) if the last round (generation) did not result in significant improvement, and the overall fitness is below expectation, the system will have to focus on sub-optimal nodes:
(a) sub-optimal nodes are found by finding and date-mining the worst performing MRCA assignments in the best performing overall vectors;
(b) any MRCA assignment which consistently shows up in the top performing vectors, but is itself sub-optimal, should be re-sampled;
(c) regenerate these MRCA assignment by either:
(i) using the most fit MRCA assignments from all samples, regardless of overall vector fitness;
(ii) regenerating the MRCA's assignment of Xi by trying other nodes from the eligible set X, which have not been tried before;
(d) after regenerating the worst-performing MRCA assignments, loop back to step 4;
(8) if there is no improvement after a number of ‘Sub-optimal’ node re-shufflings, the system will have to look for ‘conflict nodes’:
(a) conflict nodes are MRCA assignments that result in conflict with other MRCA assignment of the same vector set, and wherein there are various manifestations of conflicts;
(b) if an Xi assigned to an MRCA (and thus, calculated to be the same individual as Xj) also appears in another MRCA assignment, but the second MRCA has it paired with an individual Xk who does not match Xi, then this is probably a conflict;
(c) if the MRCA assignment leads to a case where DNA cannot flow downstream to satisfy all MRCA assignments, then it is in conflict;
(i) testing for DNA flow consistency requires a build of the representative trees using the VFT's as the framework;
(ii) with 1000's of MRCA's per User, there will likely be several MRCA's associated to every VFT VIA node (Ancestor);
(iii) on the affected VFTs, each MRCA is applied, and a DNA packet is sent down from the MRCA to the User root nodes;
(iv) following the theory of FIG. 46) and FIG. 47), if 3 or more Users are DNA matched, and there is no direct downstream flow for DNA to all of them, then at least one of the MRCA assignments is in conflict, whereas, usually, if a majority of them have a direct DNA path to all DNA matched Users, then the minority MRCA's will be marked as conflict, and will be recycled;
(d) if any conflict nodes are found, they will be marked for recycling (or reassignment), and the procedure will loop back to step.

48. The sub-system of claim 44, comprising a sub-system method, (4812) called ‘General N-Cluster Center-of-Gravity Algorithm’ wherein the ‘General N-ICW-M Center-of-Gravity Algorithm’ is applied to sets of ICW-Matches who share various attributes which cluster them around a particular region of a graph, and wherein, given that the VFT's have been data-mined for common attributes, ancestors and DNA, and that those have been registered in the Global Shared Attributes DB as Clusters (for example, a set of ICW-M networks (4404) for each User), then the objective of this algorithm is to engineer an attraction between members of a Cluster or ICW-Match network and their shared, dominant cluster attributes, which thus attracts them to in-common ancestors or ancestor groups, and wherein the system will provide negative pressure to enable separation of sets with common-centroid accumulations, and wherein this algorithm is essentially the same as the Local MRCA Engine FIGS. 30-32), but with many sets of many MRCA's applied simultaneously, and wherein, in terms of the similar k-means clustering, we are trying to partition the DNA of all Users involved (the ‘observations’) to ‘k’ specific Ancestors (VIA nodes) or Ancestor Clusters, and wherein there is no simple distance metric by which to calculate the distance of a DNA segment to each cluster center, but there is, of course, no direct physical relation between the DNA code itself and clusters, and there is, however, a number of attributes we can associate to the DNA (the pedigree), and likewise to the Ancestors, and wherein it is noted that there will be many descendants of most ancestors, and therefore many DNA segments, and wherein although the attributes associated to a DNA segment may rapidly diverge over time (going down the descendant branches), they will almost always have overlap at the point of inception—if attributes related to that period have been discovered and recorded, and wherein if any particular DNA segment is attribute-poor in any region between the descendant and MRCA source, then this system can still work if there are sufficient ICW-Matches through which the descendant's DNA segment can be pulled into a cluster, and therefore, to calculate the distance of a DNA segment to any particular Ancestor or Cluster centroid, we need to quantify the value of the attributes, and their confidences, between the DNA and Ancestor, and whereas, unlike K-means, we may also employ various constraints to help sort the DNA into these clusters (such as Genetic Distance and direct downward spanning-tree DNA flow from the ancestors to Users, for all solutions), wherein we will always want to utilize any DNA mapping to associated to DNA cousin networks, and ICW-Match networks to ‘inherit’ attribute influences, wherein this algorithm consists of:
(1) give each Cluster and/or ICW-Match network a name (tag), which will be sent with packets, then, the MRCA's involved are derived from the Cluster and/or ICW-match network;
(2) fire activation through all relevant MRCA's of all Users in a particular named network, with the name tag, and DNA ID, wherein we note that these activations go to nodes which have been pre-pruned to only include Ancestors who are within the Genetic Distance range;
(3) activation spreads through the network in the same manner as described for the Local MRCA Engine, FIGS. 30-32), wherein we note that activations are travelling through distinct VFT's, and attempting to find where those VFT's intersect, given the evidence of the DNA match;
(4) the activations received at each Ancestor are summed by source (DNA ID), wherein these values serve as the corollary of K-mean's distance metric;
(5) the Ancestor nodes of a VFT are scanned to make a table (DNA-per-Ancestor), VIA nodes on rows, DNA ID's as columns, with row-column values as a ‘tuple’ of the activation received from a DNA ID, the ID, and the network/cluster name tag, wherein we note that the DNA ID may end up at several ancestors, and wherein this format enables us to sum up the number of occurrences of a DNA ID from a particular network or differing networks, and differing MRCA origins;
(6) another table (Ancestors-per-DNA) is simultaneously built, with DNA ID's as the rows, and Ancestor ID as columns, wherein each Ancestor receiving a DNA-ID packet will record that packet value in the row of the DNA ‘ID, and wherein this basically enumerates the ranking of where a DNA segment predominantly ends up;
(7) the tables are analyzed, wherein a DNA ID may have the its highest value at a particular Ancestor (Ancestors-per-DNA), while that Ancestor may have other DNA ID's as having higher frequency in DNA-per-Ancestor (total activation), and wherein generally, we want to find DNA segments originating from different sources to a particular Ancestor, and that at least implies the Ancestor is the MRCA or downstream from the MRCA, and then ancestors receiving multiple sources of the same DNA are evaluated and ordered, such that the oldest (further back in time), is considered the earliest possible known MRCA source;
(8) with these tables, further complex analysis will be possible, and may be merited, taking into account ICW-Match relationships of DNA ID's, and applying the algorithms of FIG. (46) and FIG. 47);
(9) the output of the analysis will be an assignment of the MRCA to particular Ancestor nodes with confidence derived from the above analysis.

49. The system of claim 1, which is in part comprised of the sub-system (5000) ‘Global DNA Cluster Generation and Analysis with Competitive Neural Networks’ as represented in FIG. 50), where sub-system (5000) comprises:
a. a paradigm of neuromorphic inspired dynamic DNA-centric cluster generation, with spontaneous growth of correlation nodes between co-activating nodes, and decay of nodes which have lost co-activation, and;
b. a system to coalescence overlapping DNA into new ‘overlap’ or ‘merged’ DNA nodes, and;
c. a system of ‘floating’ DNA segments shared between two or more Users, wherein floating means an MRCA has not been found for the shared DNA segment, and such that they are associated to eligible nodes by pointers thus creating a cluster, and;
d. a hierarchical system of DNA clusters wherein a ‘Cell’ node is the vector through which DNA must pass, and;
e. a system of ‘Trait’ nodes which represent the best-known phenotype of DNA SNP's, which bind to DNA segment nodes, their Cells, and potentially to VIA nodes if a VIA is known or hypothesized to harbor the Trait, and;
f. a means of simulating the ICW-DNA network by the MRCA-Engine FIGS. 23, 24, 30, 31, 32), with several variations described below, and whereas the MRCA-Vdna nodes send DNA packets to all eligible VFT VIA's, which then relay them to all connected Attribute Nodes, Trait nodes, and Cell ICW-DNA nodes, which then relay to all connected Segment ICW-DNA nodes, and wherein the relayed stimulus packets contain their ID's, and paths traveled, and the Genetic Distance range expected to the User, and the activation level of each packet is modulated according to the strength of each connection traversed;
g. a plurality of competitive neural network (CNN) analysis modes being comprised of at least two modes of highlighting the most associated ancestors between trees which include a ‘Burst Mode’ and ‘Evolving Mode’, wherein these example modes comprise:
i) a ‘Burst Mode’ which relies on one burst of activations being sent out and then settling (decaying), until the winners are left, and wherein every DNA segment (from MRCA nodes and Chromosome DB's associated to Ancestor nodes and ICW-DNA) is activated simultaneously, and all VFT's are represented in the competitive neural network (through the 608) Inter-match DB), and wherein, given that activation packets carry the ID of the DNA segments or Cells from which it originated, and given amplification at nodes which receive multiple activations from the same DNA ID originating from different trees, and given a decay rate of the activations to ensure limited growth and eventual decay, and given further decay on nodes which have competing multiple DNA ID activations for the same chromosome map location, with negative activation sent back on the losing DNA ID paths, and given a similar competition solution for each DNA ID (Segment) which is on multiple VIA nodes which are not in a direct line of inheritance, such that the top Node (the DNA node on the VIA which has the greatest activation) gains activation while the others decay proportionally, the entire system will be made to ‘settle’ such that each DNA ID should end up with one progenitor Ancestor (or couple), and that DNA ID should only appear in direct downstream paths from the progenitor(s), and each Ancestor will have no more than two DNA representations for any particular span on its' chromosome map, and the progenitor(s) of the segment will have a Genetic Distance to each User having this segment, which is within the estimated range, and wherein: a VIA node will reject (ignore) a DNA packet which has a Genetic Distance range, which is greater or less than the VIA node's Genetic Distance to the VFT root node, and wherein once such a DNA ID has settled to one progenitor Ancestor, a direct connection is grown to that ancestor between the ICW-DNA segment node and the VFT VIA Ancestor node, and the condition is reported to the MRCA-Vdna node, such that it may register this ‘solution’ for this particular algorithm, and wherein the side-effect of growing the connection from the DNA-Segment node to the Ancestor(s), affects other algorithms that depend on activation passing through attribute nodes connect to each VIA Ancestor, and;
ii) an ‘Evolving Mode’ in which an average of a rate of activation received is used to determine dominance, wherein the MRCA-Vdna nodes send out activation packets every time there is an addition or change to the ICW-DNA nodes or attribute nodes, or whenever a settling time has passed, and wherein the entire system is continuously (on a periodic beat) sending packets from MRCA-Vdna nodes, and wherein in this mode, the system dynamically accommodates all constraints from all VFT's and all DNA matches in a simultaneous, evolving solution, and wherein the conditions described in the Burst Mode are honored in this mode as well, as well as the resulting actions of connections growth from a dominant DNA Segment Node to VIA node due to activation association, and furthermore, the type of simulation mode (Burst or Evolution) is encoded into, and sent with each packet, such that both may run overlapping, and nodes will not get confused, and wherein each node will have registers (variables) which account for Burst and Evolution mode packets received and passed, and wherein evolution mode does not require the nodes to be uploaded to the (608) Inter-match DB, but rather, has direct peer-to-peer communication between the User's MRCA nodes, VFT nodes, attribute nodes and ICW nodes, and wherein this peer-to-peer communication is mediated through the Agent Exchanges, and various Agents, and if two nodes which are exchanging a packet of activation information lie on different computers, then Agents will have been initiated on each of those computers, and wherein the Agents communicate by various message passing protocols, which may include TCP or UDP, and wherein the User Datagram Protocol is preferable in Evolutionary mode, as reliability is not critical as it would be in Burst mode, and wherein, in the ‘Evolutionary’ mode, a node determines which packets are dominant by calculating a frequency metric, wherein a node may receive multiple packets of the same type, or originating from the same Ancestor, or the same Cluster, and where, for each path from a first User A to a DNA matched second User B, passing through Attributes they share, there should be one packet of activation shared, and wherein the higher frequency attributes from a first Ancestor ‘wins’ in terms of dominance, over the attributes from another second Ancestor, wherein the metric for an attribute is an average rate, and whereas, in the burst mode, the metric will be a simple summation for the cycle, and furthermore, a ‘wins’ means that, if there is a consistent, repeated activation association between two Ancestors, then a direct ICW-A node will be grown between them, in the neuromorphic sense, and furthermore, this ICW-A node may increase its weights of connections, or decrease them, by rate of activations passing between the two nodes, such that, every ICW-A connection in this modality will have a small decay rate, such that if any Ancestor connected to does not co-activate with other Ancestors connected, then it can be assumed that the Ancestor has lost the shared attributes which motivated the creation of the ICW-A connection in the first place, and it shall be allowed to decay away, and;
h. an ability to cluster, or associate phenotypes to genotypes, as described, comprising:
i) a plurality of ICW-Cell nodes, wherein a ‘Cell’ represents a collection of chromosomes and DNA, and wherein each such node connects to a VFT node, and connects to a plurality of ICW-DNA segment nodes, and connects to a plurality of Trait nodes, wherein the Trait nodes point to a DNA segment node and that the Trait represent the putative phenotype of the DNA segment;
i. a plurality of ICW-DNA phased nodes, where a phased node is a construction of DNA in the popular mean of phasing DNA from known relatives, and
j. an ability to recreate, in part, an ancestor's phenotype from accumulated DNA on an MRCA node, and the traits correlated to that DNA, as described in various public-domain SNP catalogs;
k. an ability to discover which DNA sequences lead to resistance (Traits) to various diseases and conditions, by correlating survival and morbidity of a population (cohort) to DNA, as might be motivated in the event of, for example, a world-wide pandemic.

50. The system (100) and it's Agent-based sub-systems and Competitive Neural Network sub-systems, which in consideration of the holistic interaction of Agents, nodes, competitive neural network (CNN), constraints and evolving fuzzy logic, defines a general form of adaptive cognitive computing based on distributed networked computing systems with mobile Agents mediating activation between nodes proportional to connection weights, and, wherein said activations are transported as packets of information describing the type of packet, the path the packet (carried by an Agent) has traveled, and the distance the packet has traveled in terms of hops, and said Agents may carry with them fuzzy logic coded functions which may affect their actions at any nodes, according to their own state and the state of the node visited, and the states of other Agents presently at that node, which together form inputs to the fuzzy logic functions, and wherein that fuzzy logic may have outputs comprised of one or more of the following:
a. if a visited node is the destination node, then the Agent will register itself with that node, leaving its state and travel history, and thence terminate itself, and such that the visited node will have accumulated the registrations of all Agents that have visited it (since the last reset);
b. if a visited node has only one connection, that being the connection the Agent came in on, then said Agent may register with the node the fact that it has visited, leaving its identification, type and state, and thence terminate itself, as it has reached a dead-end;
c. if a visited node has a plurality of connections, and the visiting Agent discovers that it (or a copy of itself) has already visited the node, it will terminate itself, as this represents a loop condition;
d. if a visited node has only two connections, one being the connection the Agent came in on, then said Agent may register with the node the fact that it has visited, leaving its identification, type and state, and thence continue onwards down the next connection to the next node;
e. if a visited node has a plurality of connections, one being the connection the Agent came in on, then said Agent may register with the node the fact that it has visited, leaving its identification, type and state, and thence replicate itself with one copy each continuing onwards down the next connection to each of the next nodes;
f. in the above conditions, if an Agent also carries with it certain constraints, its actions may be controlled by the fuzzy logic it carries, such that, for example, if the Agent represents a DNA segment, and must only flow downstream (from Ancestor to Descendants), then if it is traversing a VFT or VWT, it will thusly only propagate itself (or copies of itself) down connections which satisfy said constraints, that being the children of the node it is currently on, and such that, for another example, if an Agent is exploring paths for an ICW-Match analysis, it may have with it a maximum generation (hops) counter as determined by the estimated Genetic Distance between two Users, and may deduct one from the counter after each hop, and terminate or stop after its counter depletes;
. . . and wherein Agents may, according to their type and intent, initiate growth or decay of connections or growth or decay of connection strengths, such as when an Agent representing a particular origination entity, travels from one VIA node through the network to another VIA node, and there is evidence on that receiving node that the entity has been there previously, and the activation from that entity accumulated surpasses a threshold, and given this action the Agent thus reinforces the connection, or creates a shortcut,
. . . and wherein Agents may, according to their type and intent, initiate growth of a new node and connections, such as when an Agent representing a Trait or DNA segment, travels from one VIA node through multiple hops through the network to another VIA node, and there is evidence on that receiving node that the DNA or Trait has been there previously, and the activation accumulated surpasses a threshold, and thus the Agent creates a shortcut, and wherein the Agents may carry with them an ‘activation’ packet, and the value of said activation may decrease (decay) after each hop, and may likewise be amplified at a node which satisfies some constraint on the Agent, such as a constraint that total activation originating from a source and accumulating at a node must surpass a threshold, and wherein the nature of an algorithm requires Agents to compete in certain cases, such that (for example), if a receiving node collects several Agents, but can only let one win, then it may enhance the result of the most ‘strong’ Agent (which may be according to the activation the Agent arrived with), while simultaneously sending the losing Agents home with an instruction to decrease the connection weights of the paths taken by those Agents.
